(19) United States
(12) Patent Application Publication
(10) Pub. No.: US 2021/0004807 A1
(43) Pub. Date: Jan. 7, 2021

(54) APPARATUS AND METHOD FOR PROVIDING TRANSACTION SECURITY AND/OR ACCOUNT SECURITY

(71) Applicant: RAYMOND ANTHONY JOAO, YONKERS, NY (US)

(72) Inventor: RAYMOND ANTHONY JOAO, YONKERS, NY (US)

(21) Appl. No.: 16/903,477

(22) Filed: Jun. 17, 2020

Related U.S. Application Data
(60) Provisional application No. 62/869,535, filed on Jul. 1, 2019.

(51) Int. Cl. G06Q 20/40

(52) U.S. Cl. CPC G06Q 20/4015; G06Q 20/24; G06Q 20/4093

(57) ABSTRACT

A transaction security apparatus, including a database which stores information regarding an account, information regarding a user associated with the account, and information regarding a travel itinerary or schedule of the user; a receiver which receives information regarding a transaction involving the account and which includes information regarding the transaction, information regarding the account, and information regarding a position or location of the communication device; and a processor which information regarding the transaction. The processor determines a position, location, or geographic location, of the communication device and processes information for authenticating the user by processing information for comparing the position, location, or geographic location, of the communication device with or against an expected position, location, or geographic location, of the user, based on the itinerary or schedule of the user. If the processor determines that the user is authenticated, the processor processes information for allowing the transaction.

### RELATED APPLICATIONS

This application claims the benefit of the priority of U.S. Provisional Patent Application Ser. No. 62/869,535, filed Jul. 1, 2019, and entitled “APPARATUS AND METHOD FOR PROVIDING TRANSACTION SECURITY AND/OR ACCOUNT SECURITY”, the subject matter and teachings of which are hereby incorporated by reference herein in their entirety.

### FIELD OF THE INVENTION

The present invention pertains to an apparatus and method for providing transaction security and/or account security and, in particular, the present invention pertains to an apparatus and method for providing transaction security and/or account security which provides for enhanced account security safeguards, enhanced transaction security safeguards, and/or enhanced security and safeguarding of account information and/or account holder information.

### BACKGROUND OF THE INVENTION

Fraudulent transactions on, involving, or relating to, credit card accounts, debit card accounts, charge card accounts, credit accounts, debit accounts, charge accounts, bank accounts, checking accounts, saving account, brokerage accounts, electronic money accounts, healthcare insurance accounts, and/or any number or variety of other accounts, have been occurring for years and result in tremendous financial losses and/or inconveniences each year for those victimized by same. Notwithstanding the widespread use of systems which provide transaction alerts and systems which allow an account holder to restrict or limit a use of an account, the occurrence of these fraudulent transactions continue, giving rise to the need for enhanced account and/or transaction security safeguards.

Although systems exist which can transmit an alert or an alert message to an account holder, so as to provide the account holder with notification as to an occurrence of a transaction, these systems have not been able to prevent fraudulent transactions from occurring on or involving an account in the first place. These systems, which can still be valuable to an account holder, also require that the account holder take or perform some type or form of action or actions in reporting a fraudulent transaction. Reporting fraudulent transactions can also be inconvenient and time consuming.

Although systems also exist which allow an account holder to restrict or limit a use of an account, these systems have also not been able to prevent fraudulent transactions from occurring on or involving an account.

Another reason why problems continue to exist in attempting to secure the above-noted, as well as other types of, accounts lies in the very nature of how transactions involving these accounts typically occur. Typically, most transactions involving the above-noted, and other, accounts require that an account holder provide account information regarding, or other information used to authenticate the, the respective account, in the transaction process. It is submitted that the practice of providing or divulging account or account-related information to a third party, in any transaction, and on relying on that third party to safeguard the same and/or to not misappropriate the same, also makes the above-noted, and other, accounts susceptible to fraudulent transactions and/or unauthorized account use.

It is also submitted that existing systems fail to take into account the position or location of transaction devices and/or participants of a transaction since such information could prove to be beneficial in determining whether transactions might be legitimate and/or authorized transactions or unauthorized and/or fraudulent transaction.

It is also submitted that, while various types or kinds of transaction processing routines may be available for use in a transaction, existing systems fail to allow individuals and/or entities, who or which participate in a transaction (“transaction participant” or “transaction participants”), to select the type or a combination of types, of transaction processing and/or transaction processing system(s) which they want to utilize in processing the transaction. For example, although there are various traditional banking transaction processing systems, credit card and/or debit card transaction processing systems, processing systems for use with or in connection with any of the other various types or kinds of accounts described herein, and/or blockchain distributed ledger and/or blockchain transaction processing systems, known in the art of transaction processing, it is submitted that there appears to be no system or technology which exists in the marketplace which can allow a transaction participant to specify or to select the transaction processing system which is to be used in processing a transaction and/or which can allow a transaction participant to specify or to select a combination of transaction processing systems which are to be used in processing a transaction.

Another problem which is associated with various accounts, and/or cards associated with accounts, lies in the need to authenticate a user or a user's use of, attempted use of, or any action(s) or transaction(s) on, with, or involving, the same. Another problem lies in authenticating the user's geographic location at the time of a use of an account, and/or a card associated with the account, in any action, transaction, or activity, on, with, or involving, the same, so as to ensure that the respective action, transaction, or activity, is legally performed within the geographic limits of a jurisdiction, state, province, region, or country.

As a result, there are numerous problems and shortfalls associated with present day systems for providing transaction security and/or account security. The present invention overcomes many of these problems and shortfalls.

### SUMMARY OF THE INVENTION

The present invention pertains to an apparatus and method for providing transaction security and/or account security and, in particular, the present invention pertains to an apparatus and method for providing transaction security and/or account security which provides for enhanced account security safeguards, enhanced transaction security safeguards, and/or enhanced security and safeguarding of account information and/or account holder information which overcomes the shortfalls of the prior art.

The present invention provides an apparatus and method which allows an account holder to conduct a transaction while maintaining control over his or her account information and dispenses with the need for the account holder to provide his or her account information to a counterparty in a transaction.

The present invention can be utilized in connection with, or in conjunction with, credit card accounts, credit accounts, charge card accounts, charge accounts, debit card accounts, or debit accounts, bank accounts, checking accounts, or savings accounts, cryptocurrencies, cryptocurrency accounts, gambling accounts, gaming accounts, sports betting accounts, lottery gaming accounts, lottery accounts, brokerage accounts, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, electronic money accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, text messaging accounts, a customer loyalty accounts, social network membership accounts, or any other accounts, as well as any cards, devices, and/or other entities, which can be used with or which can be associated with any of the herein-described accounts, wherein an account holder or other individual authorized to use the account can utilize same without having to provide an account number or any other account identifying information to a counterparty. It is important to note that, for the purposes of the present invention, a cryptocurrency is also an account.

The apparatus of the present invention includes a central processing computer which can perform any of the processing routines and functionality typically performed by any transaction authorization processing computer used for processing transactions on, involving, or regarding, any of the herein-described accounts. The central processing computer can also perform any the processing routines and/or functionality described herein as being performed by the apparatus of the present invention.

Any number of central processing computers can be utilized in connection with the present invention. The central processing computer can be dedicated to performing transaction authorization processing for a given type of account and/or any number of and/or types of accounts. For example, if a credit account issued by the VISA® financial services company is being used in a transaction, the central processing computer can be a VISA® transaction processing computer which can process transactions for any number of accounts issued or serviced by the VISA® financial services company. A central processing computer can also be utilized to process transactions involving any number or types of accounts serviced by any bank, financial institution, or financial intermediary, or for any number or types of accounts serviced by any number of banks, financial institutions, or financial intermediaries. A central processing computer can also be utilized to process transactions involving any number or types of accounts serviced by any account provider, account administrator, or account service provider. A central processing computer can also perform transaction authorization processing for any number or, or any type or kind of an any, or any combination of, credit accounts, credit card accounts, debit accounts, debit card accounts, charge accounts, charge card accounts, bank accounts, checking accounts, savings accounts, electronic money accounts, gambling accounts, gaming accounts, sports betting accounts, lottery gaming accounts, lottery accounts, brokerage accounts, healthcare insurance accounts, and/or any of the other accounts described herein, such as, but not limited to, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, text messaging accounts, customer loyalty accounts, social network membership accounts, or any other accounts described herein, as well as any cards, devices, and/or other entities, which can be used with or which can be associated with any of the herein-described accounts.

A single central processing computer can also be adapted to service any one type or any number or combination of types of any other the credit accounts, credit card accounts, debit accounts, debit card accounts, charge accounts, charge card accounts, bank accounts, checking accounts, savings accounts, electronic money accounts, gambling accounts, gaming accounts, sports betting accounts, lottery gaming accounts, lottery accounts, brokerage accounts, healthcare insurance accounts, and/or any of the other accounts described herein, such as, but not limited to, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, or any other accounts, as well as any cards, devices, and/or other entities, which can be used with or which can be associated with any of the herein-described accounts.

The central processing computer can be any computer, computer system, group of computers, server, server system, or group of servers, which can be programmed and/or equipped to perform any of the herein-described functions, operations, or actions, described herein as being performed by the central processing computer and/or the apparatus of the present invention.

Any of the central processing computer(s) described as being utilized in connection or in conjunction with the present invention can also be performed by or implemented using cloud computer hardware and/or software. In this regard, any and/or all of the transaction authorization processing computers described herein can be implemented using a cloud computing architecture, server computers or network computers, and/or any cloud computing hardware and/or software. In this manner, the present invention can be utilized in connection with any number of central processing computer(s) and/or the apparatus of the present invention can also be utilized in connection with a cloud computing system, network, and/or architecture. Any number, type, or kind, of central processing computer(s) can be utilized in the apparatus of the present invention.

The apparatus of the present invention also includes a communication device which can be utilized by any account holder who or which utilizes the apparatus of the present invention. The communication device can be utilized to communicate with, transmit signals, data, information, or a message, to, receive signals, data, information, or a message, from, or to access, or which can be linked with, or which can be wirelessly linked with, any of the central processing computers described herein.

The communication device can be connected with, linked to, wirelessly connected with, or wirelessly linked to or with, the central processing computer. The communication device can also be connected with, linked to, wirelessly connected with, or wirelessly linked to or with, the central processing computer during operation of the apparatus of the present invention as described herein, and/or at any desired time or times.

The communication device can be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the communication device.

The communication device can include a central processing unit or device, an input device, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a retinal scanning device, a fingerprint recognition device, a voice recognition device, a retinal scanner, a fingerprint device, a voice recognition device, a handprint recognition device, a handprint geometry recognition device, a facial feature recognition device, and/or any one or more of the biometric devices used to control access to a computer or a computer network which are known to those skilled in the art at the time of the filing of this patent application, a pointing device, a mouse, an output device, a database or a memory device and/or system, a random access memory (RAM) device, a read only memory (ROM) device, a video recording system or equipment, a camera(s), an audio recording system, device, or equipment, a microphone, a receiver or any number of receivers, a transmitter or any number of transmitters, a network interface device, an information or content gathering device, and/or any other devices, equipments, or systems, typically found in and/or utilized by any of the herein-described communication devices described herein as being utilized in connection with the apparatus of the present invention. The communication device can also be equipped with a global positioning device which can be utilized to calculate, determine, or ascertain, the position or location of the communication device.

The communication device can also contain, include, or be equipped with, a transmitter(s), a receiver(s), or any other network interface devices or equipment for facilitating bi-directional communication with, and/or data and/or information exchange with, the central processing computer.

The communication device can also include, contain, or be equipped with a camera, a digital video recording system or equipment, a microphone, a digital audio recording system or equipment, or any another digital video and audio recording device or equipment or other digital media recoding equipment, that can allow the communication device to record and store, for later play-back, any of the video and/or audio information which can or may be obtained using the apparatus of the present invention. The communication device can also be used to take or record a photograph, picture, video, a video clip, audio, or an audio clip, of the account holder or any other user, individual, or entity.

The communication device can also be equipped with the needed hardware and/or software to function as a point of sale (POS) transaction authorization processing system or device which can communicate, in a bi-directional manner, with any central processing computer and/or any transaction processing computer or any transaction authorization processing computer.

Any number of communication devices can be assigned to, utilized by, or associated with, any account holder.

The apparatus also includes an account holder bank computer system which can be any computer, computer system, or group of computers, of, associated with, or used by the account holder's bank, financial institution, or financial intermediary, and which service any and/or all of the account holder's accounts.

The account holder bank computer system can process transactions involving, and/or maintain any and/or all data, information, transactions records, and/or any other data and/or information regarding, the account holder's accounts. The account holder bank computer system can also process transactions involving, and/or maintain any and/or all data, information, transactions records, and/or any other data and/or information, regarding the accounts of any number of account holders.

The account holder bank computer system can be connected with, linked to, wirelessly connected with, or wirelessly linked to or with, the central processing computer and/or the communication device(s) of, used by, or associated with, an account holder. The account holder bank computer system can be connected with, linked to, wirelessly connected with, or wirelessly linked to or with, the central processing computer and/or the communication device(s) of, used by, or associated with, an account holder, during operation of the apparatus of the present invention as described herein, and/or at any desired time or times.

Any number of account holder bank computer systems can be utilized in connection with the apparatus of the present invention.

The apparatus of the present invention also includes a counterparty communication device which can be utilized by any counterparty who or which utilizes the apparatus of the present invention. The term “counterparty” can refer to, or means, any merchant, store, wholesale store, retailer, retail store, vendor, supplier, customer, client, bank, financial institution, financial intermediary, service provider, goods provider, third party, or any other individual, person, or entity, who or which is a party to, enters into, engages in, or participates in, any transaction with the account holder to with an account holder.

The counterparty communication device can be utilized to communicate with, transmit signals, data, information, or a message, to, receive signals, data, information, or a message, from, or to access, or which can be linked with, or which can be wirelessly linked with, any of the central processing computers described herein and/or with any of the communication devices described herein.

The counterparty communication device can be connected with, linked to, wirelessly connected with, or wirelessly linked to or with, the central processing computer and/or with the communication device. The counterparty communication device can also be connected with, linked to, wirelessly connected with, or wirelessly linked to or with, the central processing computer and/or the communication device during operation of the apparatus of the present invention as described herein, and/or at any desired time or times.

The counterparty communication device can be, or can be a component of, a point of sale (POS) transaction device, a point of transaction device, a transaction authorization device, a cash register, or any other transaction device which can be used by a counterparty. The counterparty communication device can also be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the counterparty communication device.

The counterparty communication device can include a central processing unit or device, an input device, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a retinal scanning device, a fingerprint recognition device, a voice recognition device, a retinal scanner, a fingerprint device, a voice recognition device, a handprint recognition device, a handprint geometry recognition device, a facial feature recognition device, and/or any one or more of the biometric devices used to control access to a computer or a computer network which are known to those skilled in the art at the time of the filing of this patent application, a pointing device, a mouse, an output device, a database or a memory device and/or system, a random access memory (RAM) device, a read only memory (ROM) device, a video recording system or equipment, a camera(s), an audio recording system, device, or equipment, a microphone, a receiver or any number of receivers, a transmitter or any number of transmitters, a network interface device, an information or content gathering device, and/or any other devices, equipments, or systems, typically found in and/or utilized by any of the herein-described counterparty communication device described herein as being utilized in connection with the apparatus of the present invention. The counterparty communication device can also be equipped with a global positioning device which can be utilized to calculate, determine, or ascertain, the position or location of the counterparty communication device.

The counterparty communication device can also contain, include, or be equipped with, a transmitter(s), a receiver(s), or any other network interface devices or equipment for facilitating bi-directional communication with, and/or data and/or information exchange with, the central processing computer and/or the communication device.

The counterparty communication device can also include, contain, or be equipped with a camera, a digital video recording system or equipment, a microphone, a digital audio recording system or equipment, or any another digital video and audio recording device or equipment or other digital media recoding equipment, that can allow the counterparty communication device to record and store, for later play-back, any of the video and/or audio information which can or may be obtained using the apparatus of the present invention. The counterparty communication device can also be used to take or record a photograph, picture, video, a video clip, audio, or an audio clip, of the counterparty or an individual associated with the counterparty.

Any number of counterparty communication devices can be assigned to, utilized by, or associated with, any counterparty.

The apparatus also includes a counterparty bank computer system which can be any computer, computer system, or group of computers, of, associated with, or used by the counterparty's bank, financial institution, or financial intermediary, and which service any and/or all of the counterparty's accounts.

The counterparty bank computer system can process transactions involving, and/or maintain any and/or all data, information, transactions records, and/or any other data and/or information regarding, the counterparty's accounts. The counterparty bank computer system can also process transactions involving, and/or maintain any and/or all data, information, transactions records, and/or any other data and/or information, regarding the accounts of any number of counterparties.

It is important to note that any counterparty can also be an account holder in a given transaction, and that any account holder can also be a counterparty in a given transaction.

The counterparty bank computer system can be connected with, linked to, wirelessly connected with, or wirelessly linked to or with, the central processing computer and/or the counterparty communication device(s) of, used by, or associated with, a counterparty. The counterparty bank computer system can be connected with, linked to, wirelessly connected with, or wirelessly linked to or with, the central processing computer and/or the counterparty communication device(s) of, used by, or associated with, a counterparty, during operation of the apparatus of the present invention as described herein, and/or at any desired time or times.

Any number of counterparty computer systems can be utilized in connection with the apparatus of the present invention.

The apparatus of the present invention is utilized on, and/or over, the Internet and/or the World Wide Web. The apparatus of the present invention can also utilize wireless Internet and/or World Wide Web services, equipment and/or devices. The present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

In a preferred embodiment, each of the central processing computer(s), the communication device(s), the counterparty communication device(s), the account holder bank computer system(s), and the counterparty bank computer system(s), can be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any central processing computer(s), communication device(s), counterparty communication device(s), account holder bank computer system(s), and counterparty bank computer system(s).

Each of the central processing computer(s), the communication device(s), the counterparty communication device(s), the account holder bank computer system(s), and the counterparty bank computer system(s), can have a web site or web sites associated therewith.

The apparatus and method of the present invention can also provide for a cloud-based account security and/or transaction security apparatus and method which can be utilized to perform any and/or all of the functionality described herein as being performed by the apparatus 100 of the present invention and which can also be utilized to perform cloud-based data and/or information access, processing, storage, utilization, and/or record keeping, of any data and/or information described herein as being processed and/or utilized by the apparatus 100 of the present invention.

The central processing computer can be a computer, a computer system, a group of computers, a network computer, or a network computer system, or any other communication device which can provide the functionality of, and which can be utilized as a central processing computer. The central processing computer can be adapted to process transaction authorization data and/or information for any of the accounts described herein. The central processing computer can also be an Internet computer, an Internet server computer, and/or a web site server computer. The central processing computer includes a central processing unit or CPU, a random access memory device(s) (RAM) and a read only memory device(s) (ROM), each of which is connected to the CPU, and a user input device, for entering data, information, and/or commands, into the central processing computer, which includes any one or more of a keyboard, a scanner, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a touch screen, and/or a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus of the present invention, into the central processing computer. The input device can also be any other input device(s) which are or can be utilized with or in connection with any of the central processing computer(s) described herein as being utilized in connection with the apparatus of the present invention. The input devices are also connected to or with, or linked to or with, the CPU. In a preferred embodiment, the input device can also include a retinal scanner, a fingerprint recognition device, a voice recognition device, or any other type or kind of biometric device which can be used for determining whether or not a user or operator of the central processing computer is an authorized user, individual, or person. The central processing computer also includes a display device for displaying data and/or information to a user or operator.

The central processing computer also includes a transmitter(s), for transmitting signals and/or data and/or information, or a message(s), to any one or more of the communication devices(s), the counterparty communication device(s), the account holder bank computer system(s), and the counterparty bank computer system(s), and/or any other central processing computer(s) described herein.

The central processing computer can also be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any of the communication devices(s), the counterparty communication device(s), the account holder bank computer system(s), and the counterparty bank computer system(s), and/or any other central processing computer(s) described herein.

The central processing computer also includes a receiver(s), for receiving signals and/or data and/or information, or a message(s), from any of the communication devices(s), the counterparty communication device(s), the account holder bank computer system(s), and the counterparty bank computer system(s), and/or any other central processing computer(s) described herein.

The central processing computer also includes a database(s) which is also connected to or linked with the CPU, which can contain and/or include any and/or all of the data and/or information needed or desired for performing any and/or all of the functions and/or functionality described herein as being performed by the apparatus and method of the present invention and/or the central processing computer.

The central processing computer also includes an output device, which is also connected to the CPU, for outputting any data and/or information, described herein. The output device can be a printer, a display, a transmitter, a modem, and/or any other device which can be used to output data or information.

The central processing computer can also be equipped with a global positioning device which can be connected to the CPU and which can be utilized to calculate, determine, or ascertain, the position or location of the central processing computer. The central processing computer can also include a video and/or audio recording device which can include a camera, a video recoding device, a microphone, and/or an audio recording device. The video and/or audio recording device can be utilized to take a picture, record video, record a video clip, record sound, record audio, or record an audio clip, of a user of the central processing computer and/or to record any picture, a sound or voice, video information, or audio information at the central processing computer.

The communication device is associated with or used by an account holder. The communication device can also be associated with or used by any user or individual who or which is authorized to use the account of the account holder.

The communication device can be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the communication device. The communication device can also be a cellular telephone, a personal digital assistant, or a Smartphone or smart phone which can be utilized as an electronic wallet.

The communication device includes a central processing unit or CPU which can be a microprocessor. The CPU may also be a microcomputer, a minicomputer, a macro-computer, and/or a mainframe computer, depending upon the application.

The communication device also includes a random access memory device(s) (RAM) and a read only memory device(s) (ROM), each of which is connected to the CPU and a user input device, for entering data, information, and/or commands, into the communication device, which includes any one or more of a keyboard, a scanner, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a touch screen, and/or a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus of the present invention, into the communication device. The input device can also be any other input device(s) which are or can be utilized with or in connection with any of the communication device(s) described herein as being utilized in connection with the apparatus of the present invention.

The input devices are also connected to or with, or linked to or with, the CPU. The input device can also include a retinal scanner, a fingerprint recognition device, a voice recognition device, or any other type or kind of biometric device which can be used for determining whether or not a user or operator of the communication device is an authorized user, individual, or person. The communication device also includes a display device for displaying data and/or information to a user or operator.

The communication device also includes a transmitter(s), for transmitting signals and/or data and/or information, or a message(s), to any one or more of the central processing computer(s), the counterparty communication device(s), the account holder bank computer system(s), and the counterparty bank computer system(s), and/or any other communication devices(s) described herein. The communication device can also be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any of the central processing computer(s), the counterparty communication device(s), the account holder bank computer system(s), and the counterparty bank computer system(s), and/or any other communication devices(s) described herein.

The communication device also includes a receiver(s) for receiving signals and/or data and/or information, or a message(s), from any of the central processing computer(s), the counterparty communication device(s), the account holder bank computer system(s), and the counterparty bank computer system(s), and/or any other communication devices(s) described herein.

The communication device also includes a database(s) which is also connected to or linked with the CPU, which can contain and/or include any and/or all of the data and/or information needed or desired for performing any and/or all of the functions and/or functionality described herein as being performed by the apparatus and method of the present invention and/or the communication device.

The communication device also includes an output device which is also connected to the CPU, for outputting any data and/or information, described herein. The output device can be a printer, a display, a transmitter, a modem, and/or any other device which can be used to output data or information.

The communication device can also be equipped with a global positioning device which can be connected to the CPU and which can be utilized to calculate, determine, or ascertain, the position or location of the communication device.

The communication device can also include a video and/or audio recording device which can include a camera, a video recoding device, a microphone, and/or an audio recording device. The video and/or audio recording device can be utilized to take a picture, record video, record a video clip, record sound, record audio, or record an audio clip, of a user of the communication device and/or to record any picture, a sound or voice, video information, or audio information at the communication device.

The counterparty communication device is associated with or used by a counterparty in any transaction involving a respective account, the account holder of or associated with the account or any user or individual authorized to use the account. The counterparty communication device can also be associated with or used by any user or individual who or which is authorized to use the counterparty communication device on behalf of the counterparty.

The counterparty communication device can be, or can be a component of, a point of sale (POS) transaction device, a point of transaction device, a transaction authorization device, a cash register, or any other transaction device which can be used by a counterparty. The counterparty communication device can also be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the counterparty communication device. The counterparty communication device can also be a cellular telephone, a personal digital assistant, or a Smartphone or smart phone which can be utilized as an electronic wallet by the counterparty.

The counterparty communication device includes a central processing unit or CPU which can be a microprocessor. The CPU may also be a microcomputer, a minicomputer, a macro-computer, and/or a mainframe computer, depending upon the application.

The counterparty communication device also includes a random access memory device(s) (RAM) and a read only memory device(s) (ROM), each of which is connected to the CPU, and a user input device, for entering data, information, and/or commands, into the counterparty communication device, which includes any one or more of a keyboard, a scanner, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a touch screen, and/or a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus of the present invention, into the counterparty communication device. The input device can also be any other input device(s) which are or can be utilized with or in connection with any of the counterparty communication device(s) described herein as being utilized in connection with the apparatus of the present invention.

The input devices are also connected to or with, or linked to or with, the CPU. The input device can also include a retinal scanner, a fingerprint recognition device, a voice recognition device, or any other type or kind of biometric device which can be used for determining whether or not a user or operator of the counterparty communication device is an authorized user, individual, or person. The counterparty communication device also includes a display device for displaying data and/or information to a user or operator.

The counterparty communication device also includes a transmitter(s) for transmitting signals and/or data and/or information, or a message(s) to any one or more of the central processing computer(s), the communication device(s), the account holder bank computer system(s), and the counterparty bank computer system(s), and/or any other counterparty communication devices(s) described herein. The counterparty communication device can also be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any of the central processing computer(s), the communication device(s), the account holder bank computer system(s), and the counterparty bank computer system(s), and/or any other counterparty communication devices(s) described herein.

The counterparty communication device also includes a receiver(s), for receiving signals and/or data and/or information, or a message(s), from any of the central processing computer(s), the communication device(s), the account holder bank computer system(s), and the counterparty bank computer system(s), and/or any other counterparty communication devices(s) described herein.

The counterparty communication device also includes a database(s) which is also connected to or linked with the CPU, which can contain and/or include any and/or all of the data and/or information needed or desired for performing any and/or all of the functions and/or functionality described herein as being performed by the apparatus and method of the present invention and/or the counterparty communication device.

The counterparty communication device also includes an output device, which is also connected to the CPU, for outputting any data and/or information, described herein. The output device can be a printer, a display, a transmitter, a modem, and/or any other device which can be used to output data or information.

The counterparty communication device can also be equipped with a global positioning device which can be connected to the CPU and which can be utilized to calculate, determine, or ascertain, the position or location of the counterparty communication device.

The counterparty communication device can also include a video and/or audio recording device which can include a camera, a video recoding device, a microphone, and/or an audio recording device. The video and/or audio recording device can be utilized to take a picture, record video, record a video clip, record sound, record audio, or record an audio clip, of a user of the counterparty communication device and/or to record any picture, a sound or voice, video information, or audio information at the counterparty communication device.

It is important to note any account holder described herein can also be a counterparty in any given transaction and that any counterparty described herein can also be an account holder in any given transaction.

The apparatus and method of the present invention can be utilized to perform account security and/or transaction security in a transaction involving any of the herein-described and/or herein-identified accounts. The present invention can provide account security and/or transaction security by allowing an account holder, or any other user or individual authorized to perform a transaction on or involving an account, to perform or engage in a transaction with a counterparty without having to provide his or her account information to that counterparty. In this manner, without having to provide account information to a counterparty, the threat of a security breach involving the account holder's account can be drastically reduced by the present invention.

In a preferred embodiment, information involving the counterparty can be provided to the account holder or authorized user or individual. The information regarding the counterparty can include information regarding the identity of the counterparty, or information regarding an account of or associated with the counterparty to which payment is to be made to the counterparty, and/or any other information needed or desired for processing and/or for performing a transaction involving the account holder or authorized user or individual and the counterparty.

Once the account holder or authorized user or individual has obtained the information regarding the counterparty, the account holder or the authorized user or individual can utilize a communication device in order to generate and transaction authorization message which can include the counterparty's information, the account holder's account information, and/or the transaction amount. The transaction authorization message can then be transmitted to the central processing computer which can perform transaction authorization processing for the account holder's account. The central processing computer can then process information regarding the transaction using the information contained in the transaction authorization message, and can any one or more of determine whether or not the account is active or not-active, whether or not a hold has been place on the account to prevent the accounts use in any transaction(s), whether or not an account card has been lost or stolen, whether or not an account number has been reported as having been compromised or inadvertently released to others, or whether or not account security has been breached, or whether or not the transaction is prohibited by any limitation(s) or restriction(s) placed on the account, whether or not an account credit or spending limit has been reached, or whether or not the transaction is authorized, or whether or not the transaction is not authorized.

If the central processing computer determines for any reason that the transaction is not authorized, a message can be generated and transmitted to the communication device and/or to the counterparty communication device. If the central processing computer determines the transaction to be authorized, it can process the transaction and effectuate or make payment to the counterparty and/or can effectuate or make a corresponding entry, payment entry, and/or a respective credit, debit, or charge, entry, and/or effectuate or make any appropriate accounting entry or accounting entries to the account holder's account and/or to the counterparty's account. The central processing computer can effectuate or make any accounting entry or accounting entries to the account holder's account by generating and transmitting a signal, data, information, or a message, to the account holder's account holder bank computer system. The central processing computer can also effectuate or make any accounting entry or accounting entries to the counterparty's account by generating and transmitting a signal, data, information, or a message, to the counterparty's counterparty bank computer system. In this regard, an account holder can utilize his or her account in a transaction involving a counterparty without having to provide his or her account information to that counterparty.

Any of the various signals, data, information, and/or messages, or any other information, messages, communications, or transmissions, described herein as being generated or transmitted by any of the herein-described central processing computers, communication devices, and/or counterparty communication devices, can be generated and/or transmitted as or in an e-mail message, an instant messaging message, an SMS message, an MMS message, an electronic transmission, an electronic communication, an electronic data and/or information transfer, an electronic data and/or information exchange, interchange, or communication, a telephone call message, a recorded telephone call message, an answering machine message, a facsimile transmission, a facsimile message, or any other message, communication, or transmission.

Any of the signals, data, information, or messages, described herein as being transmitted from the central processing computer to the counterparty communication device will not contain or will not include any data and/or information regarding the account of the account holder which is utilized in the transaction.

The present invention can be utilized in a same, a similar, and/or an analogous, manner, in connection with face-to-face transactions, in-person transactions, on-line transactions, Internet transactions, electronic commerce transactions, telephone transactions, or any other non-face-to-face transactions or non-in-person transactions.

In utilizing the present invention, information regarding the manufacturer, brand name, model, and/or serial number, and/or IP address, of each communication device associated with any account can be registered with the central processing computer for processing transactions of the account. An account holder can limit or restrict account use to use in connection with a registered communication device or to use in connection with one or more registered communication devices. The information regarding the manufacturer, the brand name, the model, and/or the serial number, and/or the IP address, of the communication device used in the transaction can be included in any transaction authorization message. The apparatus of the present invention can process the information in the transaction authorized message in connection with the information regarding the communication device registered with the account and can authorize or allow the transaction if the communication device is confirmed as being a communication device registered with the account, or the present invention will not authorize or will disallow the transaction if the communication device is determined to not be a registered communication device on the account.

The present invention can also generate and transmit alert messages or notification messages containing information regarding a transaction and can transmit same to the communication device of or associated with the account holder or other authorized user or individual and/or to a counterparty communication device of or associated with the counterparty.

The communication device can also be programmed to process any of the counterparty's transaction identifying information, and/or information regarding the amount of the transaction or the transaction amount, and/or any information regarding, time, date, and/or the account used or selected, and/or any information regarding the position and/or location of the communication device, using any limitation(s) or restriction(s) placed on the account, and can automatically disallow the use of the account in the transaction prior to generating any transaction authorization message.

The present invention can also, during a transaction or at any other time transmit a file photograph of the account holder and/or any user or individual authorized to use the account to the counterparty communication device so that the counterparty or the counterparty's employee can ascertain if the individual conducting the transaction involving the account is, in fact, the account holder or an authorized user or individual. The present invention can also transmit a file photograph of the counterparty to the communication device so that the account holder can ascertain if the individual conducting the transaction involving the account is, in fact, the counterparty.

The communication device can also store electronic money or electronic funds which can be transferred to the communication device in a transaction and/or which can also be transferred from the communication device in a transaction. A digital representation of the electronic money or the electronic funds can be stored in the database of the communication device. Electronic money or electronic funds can be added or electronically deposited into the communication device and can be electronically withdrawn when needed to make a payment pursuant to a transaction. In this regard, the communication device can also serve as an electronic wallet.

A counterparty communication device can also store electronic money or electronic funds which can be transferred to the counterparty communication device in a transaction and/or which can also be transferred from the counterparty communication device in a transaction. A digital representation of the electronic money or the electronic funds can be stored in the database of the counterparty communication device. Electronic money or electronic funds can be added or electronically deposited into the counterparty communication device and can be electronically withdrawn when needed to make a payment pursuant to a transaction. In this regard, the counterparty communication device can also serve as an electronic wallet.

Any of the herein-described communication devices can also be utilized as an electronic wallet and/or an personal electronic valet which can store information regarding, and enable an account holder or individual to gain immediate access to and/or use of, any and/or all of an account holder's or an individual's various accounts, which can be or which can include any and/or all of the account holder's or the individual's credit card accounts, credit accounts, charge card accounts, charge accounts, debit card accounts, or debit accounts, bank accounts, checking accounts, or savings accounts, gambling accounts, gaming accounts, sports betting accounts, lottery gaming accounts, lottery accounts, brokerage accounts, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, electronic money accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, or any other accounts.

In addition to providing access to and use of any and/or all of the account holder's or the individual's various accounts, the communication device can also store and provide immediate access to the account holder's or the individual's driver's license, identification information, social security card, any professional license(s), vehicle registration(s), automobile insurance card(s), passport(s), home insurance policy, malpractice insurance policy, health insurance policy, life insurance policy, disability insurance policy, employee identification information, student identification information, association or club membership information, and/or an electronic version or any account card(s) associated with any of the account holder's various accounts, memberships, club memberships, and/or any other activities. In this regard, the communication device can also store and provide easy access to any other information, personal information, and/or professional information, regarding the account holder or the individual.

The present invention can also be utilized to dispense with the need for using paper checks in connection with transactions involving bank accounts, checking accounts, or savings accounts. A counterparty need only provide an account holder with information regarding the account in which a payment is to be made, the account holder can effectuate payment in a same, a similar, or an analogous, manner as described herein, and payment can be made to a respective account of the counterparty.

Further, the account holder need only be identified as a payor or payer in a transaction by his or her name, user name, e-mail address, or any other identifier, without his or her respective account or account number, or other account identifying information, having to be disclosed to the counterparty.

The present invention also provides account security and/or transaction security by allowing an account holder to engage in a transaction without having to disclose or divulge, or without having to provide, to a counterparty, any of his or her account information. Further, the present invention provides account security and/or transaction security for the counterparty as the counterparty need only provide account information for an account to which only a payment can be made. Put simply, the counterparty is only using an account for which he, she, or it, can only be paid, and/or the counterparty is only using an account which can never be used to create a liability for the counterparty or otherwise expose the counterparty to a liability.

With the account of the counterparty being one for or to which a payment can only be made to the counterparty, and not an account which from which a payment can from the counterparty, the counterparty's account is protected as well. In this regard, the present invention provides account security and/or transaction security to or for the account of the account holder and to or for the account of a counterparty in a transaction.

Any of the counterparties described herein can also be any merchant, vendor, supplier, goods provider, products provider, service provider, professional services provider, healthcare services provider, entertainment services provider, legal services provider, insurance company or provider, or any other individual, person, or entity, or any third party who or which can engage in any type or kind of transaction with any other individual, person, entity, or account holder.

Any central processing computer can also be programmed to automatically generate a periodic transaction record or a periodic transaction statement showing activity and/or transactions, and/or attempted transactions, on or involving a respective account. The central processing computer can generate and transmit the periodic transaction record or periodic transaction statement to the communication device of the account holder or authorized user or individual periodically, daily, weekly, monthly, bi-monthly, quarterly, annually, or at any pre-determined or pre-specified time interval. The central processing computer can also generate and transmit the periodic transaction record or periodic transaction statement to the communication device of the account holder at any time and/or upon request by the account holder or authorized user or individual.

Period transaction records or periodic transaction statements can also be provided by the present invention for any account and/or for any and/or all accounts of or for an account holder which are serviced by the present invention. Periodic transaction records or periodic transaction statements can also be provided by the present invention which show activity and/or transactions, and/or attempted transactions, on or involving a respective account along with information regarding the communication device which was utilized in or involved in the transaction. Periodic transaction records or periodic transaction statements can also be provided by the present invention which show activity and/or transactions, and/or attempted transactions, grouped by the respective communication device which was used in the transaction or in the attempted transaction.

The present invention can also be used to make recurring payments to a counterparty for or on behalf of the account holder. For example, if an account holder has a recurring bill or recurring bills, such as, for example, a regularly occurring bill or a monthly bill from a counterparty, the account holder can utilize the present invention in order to pay the bill or bills when they are due to be paid. These recurring bills can be, but are not limited to, a monthly or other periodic bill from a utility service provider, a telephone company, an Internet service provider, a cable television company, a satellite television company, or any other provider of any good(s), product(s), or service(s), a healthcare professional, a legal professional, a bank, a financial institution, or a financial intermediary, or a club, a membership club or a membership association, a gym or fitness facility, an insurance company, or any other counterparty which may provide the account holder with a bill monthly, quarterly, semi-annually, annually, or at any other time interval.

The account holder can program the communication device with information regarding the recurring bill, which information can include or contain information regarding the counterparty involved, any counterparty identifier information, any counterparty payment identifier information, any counterparty communication device information, a telephone number of the counterparty's counterparty communication device, and/or a uniform resource locator (url), a website address, an IP address or web site address associated with the counterparty's transaction page or pages, or an IP address, of, assigned to, or associated with, the counterparty's counterparty communication device, and/or any other data and/or information regarding the counterparty, and/or any identifier information for or regarding the counterparty which can be utilized by the central processing computer to identify and/or ascertain any of the herein described contact information for the counterparty's counterparty communication device, and/or any other data and/or information associated with the counterparty's counterparty communication device, and/or any data and/or information described herein as being included in or contained in a counterparty's transaction identifying information for the counterparty, and/or a transaction authorization message.

The account holder can also program the communication device with information regarding the account holder's account which is selected to be utilized in making the payment to the counterparty (“the selected account”), the date on which payment is to be made to the counterparty for the recurring bill, the transaction amount or an authorized range for the transaction amount for the recurring bill, and/or any counterparty issued or counterparty assigned account number or account identifier, billing number or billing identifier, or payment number or payment identifier, which was previously assigned to the account holder by the counterparty for the specific purpose of making the recurring payments to the counterparty, and/or any other data and/or information described herein as being included in or contained in a transaction authorization message.

Once programmed, the communication device can automatically detect the occurrence of the date on which payment is to be made for the recurring bill, and, upon detecting the date on which the payment is to be made for the recurring bill, the communication device can automatically access the central processing computer which services the account holder's selected account. Thereafter, the central processing computer can process information for the transaction and/or process information for authorizing the transaction, can access and communicate with the counterparty's counterparty communication device, and/or can determine if the transaction is authorized or allowed or not authorized or not allowed, and, if the transaction is determined to be authorized or allowed, the central processing computer can effectuate the making of the payment to the counterparty pursuant to or for the recurring bill. In making payment of the recurring bill, the central processing computer can also provide the counterparty with the counterparty issued or counterparty assigned account number or account identifier, billing number or billing identifier, or payment number or payment identifier, which was previously assigned to the account holder by the counterparty so as to insure proper crediting to the account holder's account with the counterparty.

The central processing computer, if applicable, can also perform any of processing steps and/or routines described herein as being performed by the central processing computer in its interaction with the counterparty's counterparty communication device, in a same, a similar, and/or an analogous, manner as described herein. The central processing computer can report the transaction to the account holder by generating and transmitting an account holder alert message or an account holder notification message and can transmit same to the communication device and/or to any other communication device(s) of or associated with the account holder. The central processing computer can also record and/or store any and/or all of the data and/or information pertaining to the transaction or the attempted transaction regarding the payment of the recurring bill.

The central processing computer, if applicable, can also perform any of processing steps and/or routines described herein as being performed by the central processing computer in its interaction with the counterparty's counterparty communication device, in a same, a similar, and/or an analogous, manner as described herein. The central processing computer can also report the transaction to the account holder by generating and transmitting an account holder alert message or an account holder notification message and can transmit same to the communication device and/or to any other communication device(s) of or associated with the account holder. The central processing computer can also record and/or store any and/or all of the data and/or information pertaining to the transaction or the attempted transaction regarding the payment of the recurring bill.

The account holder can use the communication device in order to program the central processing computer, which services the account which is to be used in making the payment, to automatically make the payments to the counterparty for or regarding the recurring bill or recurring bills.

The account holder can use the communication device to access the central processing computer, which services the account which is to be used in making the payment, and to program the central processing computer with information regarding the recurring bill, which information can include or contain information regarding the counterparty involved, any counterparty identifier information, any counterparty payment identifier information, any counterparty communication device information, a telephone number of the counterparty's counterparty communication device, and/or a uniform resource locator (url), a website address, an IP address or web site address associated with the counterparty's transaction page or pages, or an IP address, of, assigned to, or associated with, the counterparty's counterparty communication device, and/or any other data and/or information regarding the counterparty, and/or any identifier information for or regarding the counterparty which can be utilized by the central processing computer to identify and/or ascertain any of the herein described contact information for the counterparty's counterparty communication device, and/or any other data and/or information associated with the counterparty's counterparty communication device, and/or any data and/or information described herein as being included in or contained in a counterparty's transaction identifying information for the counterparty, and/or a transaction authorization message.

The account holder can also program the central processing computer, which services the account which is to be used in making the payment, with information regarding the account holder's account which is selected to be utilized in making the payment to the counterparty (“the selected account”), the date on which payment is to be made to the counterparty for the recurring bill, the transaction amount or an authorized range for the transaction amount for the recurring bill, and/or any counterparty issued or counterparty assigned account number or account identifier, billing number or billing identifier, or payment number or payment identifier, which was previously assigned to the account holder by the counterparty for the specific purpose of making the recurring payments to the counterparty, and/or any other data and/or information described herein as being included in or contained in the transaction authorization message.

Once programmed, the central processing computer can automatically detect the occurrence of the date on which payment is to be made for the recurring bill, and, upon detecting the date on which the payment is to be made for the recurring bill, the central processing computer can process information for the transaction and/or process information for authorizing the transaction, can access and communicate with the counterparty's counterparty communication device, and/or can determine if the transaction is authorized or allowed or not authorized or not allowed, and, if the transaction is determined to be authorized or allowed, the central processing computer can effectuate the making of the payment to the counterparty pursuant to the recurring bill. In making payment of the recurring bill, the central processing computer can also provide the counterparty with the counterparty issued or counterparty assigned account number or account identifier, billing number or billing identifier, or payment number or payment identifier, which was previously assigned to the account holder by the counterparty so as to insure proper crediting to the account holder's account with the counterparty.

The central processing computer, if applicable, can also perform any of processing steps and/or routines described herein as being performed by the central processing computer in its interaction with the counterparty's counterparty communication device, in a same, a similar, and/or an analogous, manner as described herein. The central processing computer can also report the transaction to the account holder by generating and transmitting an account holder alert message or an account holder notification message and can transmit same to the communication device and/or to any other communication device(s) of or associated with the account holder. The central processing computer can also record and/or store any and/or all of the data and/or information pertaining to the transaction or the attempted transaction regarding the payment of the recurring bill.

The present invention can also be utilized to dispense with the need to provide any account information, or any other information, of, associated with, or regarding, a respective account holder to a counterparty in a transaction.

Any and/or all of the herein-described periodic transaction records or a periodic transaction statements generated and/or provided by the present invention, can also include, for each transaction or for each attempted transaction on or involving an account, a photograph, picture, video, a video clip, audio, or an audio clip, of the account holder or any other user, individual, or entity, involved in the transaction, and/or a photograph, picture, video, a video clip, audio, or an audio clip, of the counterparty, or of an agent or employee of the counterparty to or involved in the transaction.

The present invention can also be utilized in connection with, or in conjunction with, a distributed ledger and with Blockchain technology. A distributed ledger and Blockchain technology can be utilized along with a central processing computer, in a combined system, wherein certain of the transactions, described herein as being performed by the present invention, can be processed and/or performed by and/or with a central processing computer and/or certain other transactions can be processed and/or performed by and/or with, and/or using, a distributed ledger and Blockchain technology or Blockchain technologies. Any and/or all transactions, described herein as being performed and/or processed by the present invention, can also be processed and/or performed by and/or with, and/or using, a distributed ledger and Blockchain technology or Blockchain technologies, and/or any cryptocurrency Blockchain technology or technologies.

Any type of Blockchain technology can be utilized in connection with the present invention. For example, the present invention can utilize a distributed ledger(s) along with any Blockchain technology or technologies, Bitcoin Blockchain technology or technologies, Ethereum Blockchain technology or technologies, Bitcoin Cash Blockchain technology or technologies, Litecoin Blockchain technology or technologies, Privacy Coin Bitcoin technology or technologies, and/or any other suitable Blockchain technology or technologies, and/or Smart contracts and/or Smart contract technology or technologies and/or decentralized autonomous organizations (DAOs), decentralized autonomous organizations (DAOs) technology or technologies, and/or any combination of same.

The present invention can also be utilized with any suitable cryptocurrency, such as, but not limited to, Bitcoin, Bitcoin Cash, Ethereum, Ripple, Dash, Monero, Zcash, Digibyte, Litecoin, any privacy coins, and/or any other cryptocurrency and/or privacy coin cryptocurrency. In this regard, any of the embodiments described herein can be performed with or utilizing any currency or any cryptocurrency. Further, any of the accounts described herein, and any of the transactions on or involving any of the accounts described herein can involve or utilize any currency or cryptocurrency.

Applicant incorporates by reference herein the subject matter and teachings of “Blockchain Technology Explained” by Alan T. Norman, “Blockchain” by Abraham K. White, “Blockchain—A Practical Guide To Developing Business, Law, And Technology Solutions” by Joseph J. Bambara and Paul R. Allen, and “Blockchain—Ultimate Guide To Understanding Blockchain, Bitcoin, Cryptocurrencies, Smart Contracts And The Future of Money” by Mark Gates, in their entirety, for all of their respective subject matter and teachings regarding distributed ledger technology and/or technologies, Blockchain technology and/or technologies, Bitcoin technology and/or technologies, Bitcoin Blockchain technology and/or technologies, Ethereum technology and/or technologies, Ethereum Blockchain technology and/or technologies, cryptocurrencies, cryptocurrency technology and/or technologies, and/or smart contract technology and/or technologies, and/or decentralized autonomous organizations (DAOs) technologies, and/or peer-to-peer technology and/or technologies, and/or any other technology or technologies related thereto or which can be utilized in conjunction distributed ledgers, Blockchain technologies, Smart contracts, decentralized autonomous organizations (DAOs), and/or cryptocurrencies.

By utilizing a distributed ledger and a suitable Blockchain technology, the present invention can reduce the amount of processing performed by, and reliance on, a central processing computer and/or can eliminate the need for a central processing computer and any centralized entity which might operate the central processing computer.

The present invention can include a central processing computer and distributed ledger and Blockchain technology system which can perform any and/or all of the functions described herein as being performed by the central processing computer and/or the apparatus of the present invention.

Any and/or all of the various transactions, functions, and/or functionalities, described herein as being provided or performed by the apparatus and method of the present invention can be provided or performed by either a central processing computer component of the central processing computer/distributed ledger/Blockchain technology system and/or by the distributed ledger and Blockchain technology system component of the central processing computer/distributed ledger/Blockchain technology system.

For example, any and/or all of the processing of any financial transactions or any other transactions, described herein can be performed by and/or with the distributed ledger and Blockchain technology system component of the central processing computer/distributed ledger/Blockchain technology system, while any and/or all non-financial transactions or other functionalities can be processed or performed by or with the central processing computer component of the central processing computer/distributed ledger/Blockchain technology system.

For example, the central processing computer component can be utilized to generate, transmit, and/or store, any of the alerts, alert messages, account holder alert messages, account holder notification messages, transaction authorization messages, transaction notification messages, merchant alert messages, merchant notification messages, payment messages, payment commitment messages, alert response messages, notification response messages, and/or any of the various signals, data, information, and/or messages, or any other information, messages, communications, or transmissions, described herein as being generated, transmitted, and/or stored, by any of the herein-described central processing computers, communication devices, counterparty communication devices, and/or by the apparatus of the present invention, and/or the central processing computer component can be utilized to generate, transmit, and/or store, any of the statements, records, historical statements, historical records, transaction records, periodic transaction records, and/or periodic transaction statement, and/or any data and/or information, and/or any of the transaction information, and/or any of photographs, pictures, videos, video clips, audio, or audio clips, described herein.

Any and/or all of the steps, processing routines, and/or functionalities, described herein as being performed by the apparatus of the present invention and/or by the central processing computer can be performed by the central processing computer/distributed ledger/Blockchain technology system.

In an embodiment which utilizes a central processing computer and distributed ledger and Blockchain technology system, the transaction authorization message can be transmitted to, received by, and/or processed at or by, the central processing computer component of the central processing computer and distributed ledger and Blockchain technology system and/or the distributed ledger and Blockchain technology system component of the central processing computer and distributed ledger and Blockchain technology system. Any of the herein-described alerts, alert messages, account holder alert messages, account holder notification messages, transaction authorization messages, transaction notification messages, merchant alert messages, merchant notification messages, payment messages, payment commitment messages, and/or any of the various signals, data, information, and/or messages, or any other information, messages, communications, or transmissions, described herein as being generated, transmitted, and/or stored, by apparatus of the present invention can be generated by, transmitted from, and/or stored by, the central processing computer component of the central processing computer and distributed ledger and Blockchain technology system and/or by the distributed ledger and Blockchain technology system component of the central processing computer and distributed ledger and Blockchain technology system.

Any photograph, picture, video, a video clip, audio, or an audio clip, described herein as being utilized by, or in connection with, the apparatus of the present invention can also be transmitted by or from, and/or can be stored by, the central processing computer component of the central processing computer and distributed ledger and Blockchain technology system and/or by the distributed ledger and Blockchain technology system component of the central processing computer and distributed ledger and Blockchain technology system.

A distributed ledger and Blockchain technology system can also be utilized to process and/or to perform any and/or all of the transactions and/or functions described herein as being provided and/or performed by the apparatus and method of the present invention. The distributed ledger and Blockchain technology system can perform and/or can process any and/or all of the functions and/or transactions described herein as being performed by the central processing computer and/or the apparatus of the present invention.

In an embodiment which utilizes a distributed ledger and Blockchain technology system, the transaction authorization message can be transmitted to, received by, and/or processed at or by, the distributed ledger and Blockchain technology system, and any of the herein-described alerts, alert messages, account holder alert messages, account holder notification messages, transaction authorization messages, transaction notification messages, merchant alert messages, merchant notification messages, payment messages, payment commitment messages, and/or any of the various signals, data, information, and/or messages, or any other information, messages, communications, or transmissions, described herein as being generated, transmitted, and/or stored, by apparatus of the present invention can be generated by, transmitted from, and/or stored by the distributed ledger and Blockchain technology system.

In a preferred embodiment, any photograph, picture, video, a video clip, audio, or an audio clip, described herein as being utilized by, or in connection with, the apparatus of the present invention can also be transmitted by or from, and/or can be stored by, the distributed ledger and Blockchain technology system.

The apparatus of the present invention can also include a distributed ledger and Blockchain technology system which can be utilized without an account holder bank computer system and without a counterparty bank computer system in order to process and/or to perform any and/or all of the transactions and/or functions described herein as being provided and/or performed by the apparatus and method of the present invention.

The apparatus and method of the present invention can provide for all of the benefits of using a distributed ledger and Blockchain technology system in order to secure any and/or all of the transactions, including, but not limited to, financial transactions and/or non-financial transactions, which can be processed by, or which can be performed by or with, the apparatus of the present invention.

The present invention can be utilized to process and/or to provide security for transactions of all types or kinds involving accounts of all types or kinds. The present invention can also process and/or to provide security for transactions of all types or kinds including, but not limited to, transactions between individuals, transactions between entities, transactions between individuals and entities, and/or in peer-to-peer transactions.

The communication device can also be utilized to display any and/or all of the account holder's credit cards, charge cards, debit cards, banks accounts, checking accounts, savings accounts, electronic money accounts, electronic funds accounts, cryptocurrencies, cryptocurrency accounts, and/or any other payment accounts, from which the account holder can make or effectuate payment to the merchant in a transaction. The account holder can select the account(s) or the payment type(s) or kind(s) which he or she desires to use in the transaction with the merchant. The communication device can allow the account holder to select multiple accounts or payment types or kinds so as to divide up the total transaction amount among the selected accounts or payment types or kinds. The account holder can also specify the amounts to be paid using each selected account or payment type of kind by specifying a monetary amount to be paid with or using, or by specifying a percentage of the total transaction cost to be paid with or using, each selected account or payment type of kind. The communication device can also be programmed to automatically allocate the payment of the transaction cost, either by monetary amounts or percentages, among the selected accounts or payment types of kinds.

The account holder can also select any cryptocurrency or any cryptocurrency account for use in a transaction. The account holder can also select to use a plurality of accounts and/or a cryptocurrency or a cryptocurrency account, or any number of cryptocurrencies or cryptocurrency accounts, along with any one or more of the herein-described types or kinds of accounts, so as to use any combination of an account or accounts and/or an account, a cryptocurrency or cryptocurrency account of any combination of cryptocurrencies and/or cryptocurrency accounts, in a transaction. The account holder can select one or more of the accounts and/or cryptocurrencies or cryptocurrency accounts which he or she wants to use in a transaction from a from a menu of accounts and/or cryptocurrencies or cryptocurrency accounts provided via the display device of the communication device. The account holder's use of a combination of accounts, a cryptocurrency or cryptocurrency accounts and/or cryptocurrencies or cryptocurrency accounts, can provide for additional transaction security by providing an enhanced form of a multi-factor authentication for transactions.

The merchant's transaction identifying information can also include position or location information for the merchant so as to establish the merchant's position or location at the time of the transaction. In the case of a merchant operating at a fixed or known location, the position or location of the merchant, or of the merchant's counterparty communication device, can be included in or among the merchant's transaction identifying information. The position or location information for the merchant can also be stored the database of the central processing computer and/or the database of the merchant's counterparty communication device. In a case where the merchant's counterparty communication device is a mobile of wireless device, or any other device, which is not associated with a fixed location, then the position or location of the merchant's counterparty communication device can be determined by the global positioning device of the merchant's counterparty communication device, and the merchant's counterparty communication device can be programmed to generate the merchant's transaction identifying information, for the transaction, so as to include the determined position or location information of the merchant's counterparty communication device at the time of the transaction.

The transaction record for or corresponding to any transaction can also include, where a combination of accounts, a cryptocurrency, a cryptocurrency account, or any number of cryptocurrencies or cryptocurrency accounts, or any combination of same, are used in the transaction, information regarding each such account, cryptocurrency, or cryptocurrency account.

Where a combination of accounts, a cryptocurrency, a cryptocurrency account, or any number of cryptocurrencies or cryptocurrency accounts, or any combination of same, are used in the transaction, the communication device can also generate a transaction authorization message for each such account, cryptocurrency, or cyptocurrency account and transmit same to the central processing computer for appropriate processing. It is to be noted that the central processing computer can be or can include multiple central processing computers, multiple computers, and/or multiple computer systems, for enabling the present invention to process all transactions necessary involving all accounts, cryptocurrencies, or cryptocurrency accounts, utilized in the transaction.

The data and/or information contained or included in the transaction authorization message can also include data and/or information regarding the position or the location of the communication device, as determined by the global positioning device of the communication device, at the time of the generation of the transaction authorization message. The position or the location information can be utilized in order to identify the position or the location of the communication device at the time of the generation of the transaction authorization message, and/or at the time of the transaction, in order to determine whether the transaction is an authorized transaction or an unauthorized transaction, or to identify a fraudulent use of an account in an instance in which the account holder was not at that position or that location at the time of the transaction or at the time of the attempted transaction. It is also important to note that, in instances where the communication device is located at a fixed location, the position or location information for the communication device can be stored in the database of the communication device. The position or location information for the communication device can also be stored in the database of the central processing computer.

Each transaction authorization message can also be generated so as to include information identifying the communication device which is being utilized in the transaction. The communication device can store the transaction authorization message in the transaction record for the transaction. Where a combination of accounts, a cryptocurrency, a cryptocurrency account, or any number of cryptocurrencies or cryptocurrency accounts, or any combination of same, are used in the transaction, each transaction authorization message can also be generated so as to include information identifying the communication device which is being utilized in the transaction. The communication device can store all of the transaction authorization messages in the transaction record for the transaction.

Where a combination of accounts, a cryptocurrency, a cryptocurrency account, or any number of cryptocurrencies or cryptocurrency accounts, or any combination of same, are used in the transaction, the communication device can also be programmed to transmit each of the transaction authorization messages to the central processing computer 10 and to receive any signal(s), data, information, or message(s) described herein as being transmitted to the communication device 20 from the central processing computer 10 in the transaction authorization process and/or otherwise.

The central processing computer can also utilize any information regarding the position or the location of the communication device, as determined by the global positioning device of the communication device, at the time of the generation of the transaction authorization message in order to determine whether or not the transaction is allowed or authorized or disallowed or not authorized. It is envisioned that an account holder can, at any time, place a geographical limitation(s) or restriction(s) on a use of the account. In this regard, by processing information regarding the position or the location of the communication device at the time of the generation of the transaction authorization message, the central processing computer can also determine whether or not the transaction is allowed or authorized or disallowed or not authorized in view of any such geographical limitation(s) or restriction(s) which may have been placed on the use of the account. The position or the location information, determined by the global positioning device and transmitted along with the transaction authorization message, can be utilized by the account holder to show or prove that he or she was not at the location or place of, and, therefore, did not engage in, the transaction.

Where a combination of accounts, a cryptocurrency, a cryptocurrency account, or any number of cryptocurrencies or cryptocurrency accounts, or any combination of same, are used in the transaction, the central processing computer can also receive and process the data and/or information contained in each of the transaction authorization messages transmitted from the communication device.

The central processing computer can also generate an account holder alert message or an account holder notification message, containing information regarding the transaction, including, but not limited to, the credit account or credit card account, or other account, involved, the merchant involved, and the amount of the transaction or transaction amount. Where a combination of accounts, a cryptocurrency, a cryptocurrency account, or any number of cryptocurrencies or cryptocurrency accounts, or any combination of same, are used in the transaction, the central processing computer can also generate the account holder alert message or an account holder notification message to include information regarding and/or identifying each of, and/or all of, the accounts, a cryptocurrency, a cryptocurrency account, or any number of cryptocurrencies or cryptocurrency accounts, or any combination of same, used in the transaction.

The central processing computer can also transmit a position or a location request message to the merchant's counterparty communication device in order to ascertain the position or the location of the merchant's counterparty communication device at the time of the transaction or during the processing of the transaction. The merchant's counterparty communication device can receive the position or the location request message, the global positioning device of the merchant's counterparty communication device can determine the position or the location of the merchant's counterparty communication device in response to the position or the location request message, and the merchant's counterparty communication device can transmit the position or the location information to the central processing computer. The central processing computer can also compare the position or the location of the communication device with the position or the location of the merchant's counterparty communication device in order to verify that the communication device and the merchant's counterparty communication device are at the same location or in close proximity to each other, thereby evidencing the likelihood that the parties are engaged in an authorized transaction. For example, if the transaction is an in-store transaction, it would be expected that the communication device and the merchant's counterparty communication device would be at the same location or in close proximity with one another, and such might be indicative that the transaction is an authorized transaction. If, on the other hand, it is determined that the communication device and the merchant's counterparty communication device are not at the same location or not in close proximity with one another, then such might be indicative that the transaction is not an authorized transaction.

If any information regarding the position or the location of the communication device is ascertained by the global positioning device and transmitted to the central processing computer in the transaction authorization message, the information regarding the position or the location of the communication device can also be included in or contained in the account holder alert message or the account holder notification message. If the information regarding the position or the location of the merchant's counterparty communication device is ascertained by the global positioning device and transmitted to the central processing computer, the information regarding the position or the location of the merchant's counterparty communication device can also be included in or contained in the account holder alert message or the account holder notification message.

If the information regarding the position or the location of the communication device is ascertained by the global positioning device and transmitted to the central processing computer in the transaction authorization message, the information regarding the position or the location of the communication device can also be included in or contained in the merchant alert message or a merchant notification message. If the information regarding the position or the location of the merchant's counterparty communication device is ascertained by the global positioning device and transmitted to the central processing computer, the information regarding the position or the location of the merchant's counterparty communication device can also be included in or contained in the merchant alert message or a merchant notification message.

In an instance when an account holder has notified one or more of the issuers or services of any of his or her accounts, that he or she will be traveling to a certain destination or destinations, the central processing computer can also compare the position or location of the communication device with the position or location of the destination or destination as a manner by which to determine that the transaction is an authorized or an unauthorized transaction.

Where a combination of accounts, a cryptocurrency, a cryptocurrency account, or any number of cryptocurrencies or cryptocurrency accounts, or any combination of same, are used in the transaction, the central processing computer can perform any of the herein-described operations for each of, and/or for all of, the accounts, cryptocurrency, or cryptocurrency account, or any number of cryptocurrencies or cryptocurrency accounts, or any combination of same, used in the transaction.

Where a combination of accounts, a cryptocurrency, a cryptocurrency account, or any number of cryptocurrencies or cryptocurrency accounts, or any combination of same, are used in the transaction, the central processing computer can store, in the database, any and/or all data and/or information regarding the transaction, the transaction authorization messages, the picture, the video file, the audio file, the transaction authorized messages, or the transaction not authorized message, and, if applicable, any payment message, payment commitment message, payment messages, or payment messages for each account, cryptocurrency, or cryptocurrency account, used in the transaction.

The present invention can allow an account holder to engage in a transaction with a merchant or a counterparty by using any combination of accounts, a cryptocurrency, a cryptocurrency account, or any number of cryptocurrencies or cryptocurrency accounts, in a transaction, without having to provide the merchant or the counterparty with any information regarding any of his or her accounts, cryptocurrency, cryptocurrency account, or any number of cryptocurrencies or cryptocurrency accounts, and without having to provide an account number, account identifier, or any other account information, which can be subject to any misappropriation or misuse.

The present invention can also be utilized in a same, a similar, and/or an analogous, manner, with any of the herein-described communication devices, and with any of the herein-described accounts, cryptocurrencies, or cryptocurrency accounts, or any combination of same.

The account holder can also program the communication device to effectuate a payment of a recurring bill by using any of the herein-described accounts, cryptocurrencies, or cryptocurrency accounts, or any combination of same.

The present invention can also be utilized in order to allow an account holder to select or to dictate the type or manner of transaction processing utilized in processing a transaction involving his or her accounts, cryptocurrencies, cryptocurrency accounts, and/or any other payment accounts. For example, the present invention can be utilized in order to allow an account holder to select or to dictate that a transaction be processed using a distributed ledger and blockchain technology system. The present invention can also be utilized in order to allow an account holder to select or to dictate that a transaction be processed using a traditional or conventional centralized transaction system, such as those utilized in processing credit transactions, debits card transactions, banking transactions, and/or any other non-blockchain transactions.

The present invention can also be utilized in order to allow an account holder to select or to dictate that a transaction be processed using a combination of a distributed ledger and blockchain technology system along with a traditional or conventional centralized transaction system, such as those utilized in processing credit transactions, debits card transactions, banking transactions, and/or any other non-blockchain transactions. In such applications, certain portions of the transaction can be processed using a distributed ledger and blockchain technology system while another portions of the transaction can be processed using a traditional or conventional centralized transaction system and information regarding, or a record of, the transaction can be stored on, and accessible via, a central processing computer, such as the central processing computer, or any other suitable server computer.

The present invention can be utilized in order to allow an account holder to select or to dictate the type or manner of transaction processing utilized in processing a transaction involving his or her accounts, cryptocurrencies, cryptocurrency accounts, and/or any other payment accounts. An account holder can select to use a distributed ledger and blockchain system, a traditional or conventional centralize transaction processing system, or both, in order to process a transaction. An account holder can also select the account or the payment type or kind which he or she desires to use in a transaction, and the account holder can also select multiple accounts or payment types or kinds, so as to divide up the total transaction amount among the selected accounts or payment types or kinds, in engaging in a transaction.

The present invention can also be utilized to provide account security, or an enhanced account security, for any account, cryptocurrency, or cryptocurrency account, by allowing an account holder to require or to provide an instruction that no single account, cryptocurrency, or crytocurrency account, can be utilized to effectuate payment for an entire amount or for the total cost of any given transaction. In this regard, for example, an account holder or other individual, in effectuating payment for a transaction, would be required to utilize two or more accounts, two or more cryptocurrencies, two or more cryptocurrency accounts, any combination of an account(s) and a cryptocurrency or cryptocurrencies, any combination of an account(s) and a cryptocurrency account(s), any combination of a cryptocurrency or cryptocurrencies and a cryptocurrency account(s), or any other combination of two or more sources for payment, in effectuating payment for or regarding a transaction. In this regard, if so dictated by the account holder, no one single account, cryptocurrency, or cryptocurrency account, can be utilized to effectuate payment in a transaction. In this manner, no one single account, cryptocurrency, or crytocurrency account, can be utilized in an unauthorized manner unless utilized with one or more other accounts, cryptocurrencies, or crytocurrency accounts. It is submitted that such a practice would require that any individual, attempting a transaction using an account of an account holder, possess or have access to information regarding at least one other account, crytocurrency, or cryptocurrency account, before using any account, crytocurrency, or cryptocurrency account, of the account holder.

The present invention can also be utilized to perform or to effectuate various conventional banking and/or investment transactions, functionalities, and/or services, such as, for example, effectuating interest payments for or regarding, and/or for overseeing, administering, and/or servicing, loans of any type or kind, for or regarding any of the herein-described accounts, cryptocurrencies, and/or cryptocurrency accounts. A distributed ledger and Blockchain technology system can be utilized in conjunction with smart contracts and/or smart contract technology in order to effectuate interest payments to accounts, cryptocurrencies, and/or cryptocurrency accounts, as well as to oversee, administer, and/or service, loans and/or mortgages and/or liens involving any type or kind of personal property, real property, commercial property, or any other article or entity which can be the subject of, or can be involved in or in connection with, a respective loan, mortgage, or lien, and/or which can serve as collateral for and/or as security for a respective loan, mortgage, or lien.

In any and/or all of the embodiments described herein, the apparatus of the present invention and/or any of the components of same, such as, for example, any of the here-described central processing computer(s), the central processing computer/distributed ledger/Blockchain technology systems, the distributed ledger/Blockchain technology systems, communication devices, counterparty communication devices, account holder bank computer systems, and/or counterparty bank computer systems, can be programmed for automatic activation, automatic operation, and/or automatic de-activation.

Any of the apparatus, the central processing computer(s), the central processing computer/distributed ledger/Blockchain technology system(s), the distributed ledger/Blockchain technology system(s), the communication device(s), and/or the counterparty communication device(s), can be programmed for automatic activation, automatic operation, and/or automatic de-activation.

The apparatus and methods of the present invention can also be utilized in order to perform position-based or location-based transaction security, account security, or transaction, authentication, which authentication can be based on the position, location, or geographic location (also referred to herein as the “geolocation”), of the communication device and, hence, the user or individual, at a time, or at the time, of any performance, or attempted performance, by the user or individual, of any transaction on, with, using, or involving, any of the herein-described accounts, or cards associated with any of the herein-described accounts, at a time, or at the time, of any action or transaction with the central processing computer, the central processing computer/distributed ledger/Blockchain technology system, the distributed ledger and Blockchain technology system, or the distributed ledger and Blockchain technology system, and/or at a time, or at the time, of any transmission of any of the data, information, signal(s), message(s), or response(s), described herein or otherwise, from the communication device to the central processing computer, the central processing computer/distributed ledger/Blockchain technology system, the distributed ledger and Blockchain technology system, or the distributed ledger and Blockchain technology system.

The position, location, or geographic location, information for, or associated with, the communication device can be obtained, in the case of stationary communication devices, such as, for example, home, work, or personal, computers, by determining the position or location of, for, or associated with, the IP address of, for, associated with, or assigned to, the respective communication device, or, in the case of mobile communication devices, such as, for example, cellular telephones, Smartphones or smart phones, personal digital assistants, tablets, tablet computers, laptop computers, notebook computers, handheld computers, or other mobile devices, by determining the position or location of the respective communication device by using the global positioning device of the communication device. Under certain circumstances, it may also be possible to determine or ascertain the position or location, of the mobile communication device via an IP address or by “pinging” the same. By “pinging”, Applicant refers to the technique(s) known and used by those skilled in the art, at the time of the filing of this application, to request, obtain, and determine, the position or location of a mobile communication device.

The central processing computer, the central processing computer/distributed ledger/Blockchain technology system, the distributed ledger and Blockchain technology system, or the distributed ledger and Blockchain technology system, can determine or can ascertain, or can look-up, the position, location, or geographic location, of a stationary communication device, which is utilized in any transaction, or attempted transaction, on, with, using, or involving, any of the herein-described accounts, or cards associated with any of the herein-described accounts, any action or transaction, or attempted action or transaction, with the central processing computer, the central processing computer/distributed ledger/Blockchain technology system, the distributed ledger and Blockchain technology system, or the distributed ledger and Blockchain technology system, and/or any transmission of any of the data, information, signal(s), message(s), or response(s), described herein or otherwise, from the communication device to the central processing computer, the central processing computer/distributed ledger/Blockchain technology system, the distributed ledger and Blockchain technology system, or the distributed ledger and Blockchain technology system, at a time, or at the time, of the same, by using the IP address of the respective communication device.

The central processing computer, the central processing computer/distributed ledger/Blockchain technology system, the distributed ledger and Blockchain technology system, or the distributed ledger and Blockchain technology system, can also determine or can ascertain, or can look-up, the position, location, or geographic location, of a mobile communication device, which is utilized in any transaction, or attempted transaction, on, with, using, or involving, any of the herein-described accounts, or cards associated with any of the herein-described accounts, any action or transaction, or attempted action or transaction, with the central processing computer, the central processing computer/distributed ledger/Blockchain technology system, the distributed ledger and Blockchain technology system, or the distributed ledger and Blockchain technology system, and/or any transmission of any of the data, information, signal(s), message(s), or response(s), described herein or otherwise, from the communication device to the central processing computer, the central processing computer/distributed ledger/Blockchain technology system, the distributed ledger and Blockchain technology system, or the distributed ledger and Blockchain technology system, at a time, or at the time, of the same, by using position or location information for the mobile communication device as obtained by or from the global positioning device of the same.

The central processing computer, the central processing computer/distributed ledger/Blockchain technology system, the distributed ledger and Blockchain technology system, or the distributed ledger and Blockchain technology system, can also determine or can ascertain, or can look-up, the position, location, or geographic location, of a mobile communication device by transmitting a request for position or location information of or for a respective mobile communication device (also referred to as “pinging” the respective mobile communication device), and by receiving information in response to that request. If the respective stationary communication device is equipped with a global positioning device, the central processing computer, the central processing computer/distributed ledger/Blockchain technology system, the distributed ledger and Blockchain technology system, or the distributed ledger and Blockchain technology system, can also determine or can ascertain, or can look-up, the position, location, or geographic location, of that stationary communication device by “pinging” the same as well.

Once the position, location, or geographic location, of the respective communication device is determined or ascertained, then the central processing computer, the central processing computer/distributed ledger/Blockchain technology system, the distributed ledger and Blockchain technology system, or the distributed ledger and Blockchain technology system, can compare the position, location, or geographic location, of the respective communication device with an expected location of the user or individual using the same at a time, or at the time, of any performance, or attempted performance, by the user or individual, of any transaction on, with, using, or involving, any of the herein-described accounts, or cards associated with any of the herein-described accounts, at a time, or at the time, of any action or transaction with the central processing computer, the central processing computer/distributed ledger/Blockchain technology system, the distributed ledger and Blockchain technology system, or the distributed ledger and Blockchain technology system, and/or at a time, or at the time, of any transmission of any of the data, information, signal(s), message(s), or response(s), described herein or otherwise, from the communication device to the central processing computer, the central processing computer/distributed ledger/Blockchain technology system, the distributed ledger and Blockchain technology system, or the distributed ledger and Blockchain technology system.

It is envisioned that any user or individual, who utilizes the apparatus of the present invention in order to use, and/or to perform any transaction on, with, or involving, any of the accounts described herein, and/or any card(s) associated with any such account(s), can have stored for or on his or her behalf, in the central processing computer, the central processing computer/distributed ledger/Blockchain technology system, the distributed ledger and Blockchain technology system, or the distributed ledger and Blockchain technology system, and/or in the database of same, information regarding his or her typical or usual itinerary or schedule, including any typical or usual traveling itinerary or schedule (hereinafter also referred to as an “itinerary” or “schedule”).

The information regarding the user's or individual's itinerary or schedule can include information regarding the user's or individual's typical or regular itinerary or schedule for any and/or all days of the user's or individual's typical week, work week, weekend, or any trips, vacations, or any deviations from the user's or individual's typical or regular itinerary or schedule. The information regarding the user's or individual's itinerary or schedule can be entered into a communication device used by, or associated with, the user or individual and can be transmitted to, and received at, the central processing computer, the central processing computer/distributed ledger/Blockchain technology system, the distributed ledger and Blockchain technology system, or the distributed ledger and Blockchain technology system, and can be stored in the respective database of same.

Information regarding the user's or individual's itinerary or schedule, for given times during given days of the week, can also be monitored and recorded automatically by the communication device, data and/or information regarding or corresponding to same can be stored in the database of the communication device, and/or can be automatically transmitted to, and received at, the central processing computer, the central processing computer/distributed ledger/Blockchain technology system, the distributed ledger and Blockchain technology system, or the distributed ledger and Blockchain technology system, and can be stored in the respective database of same. In this regard, the communication device can be programmed to periodically and/or continuously, and automatically, monitor the position or location and/or the global positioning position or location, as determined by the global positioning device, of the user's or individual's travels and/or movement, at pre-determined and/or at pre-selected time intervals, in order to record the user's or individual's travels or movements during certain times and/or days of the week so as to determine, ascertain, or predict, an expected itinerary or schedule, or an expected travel itinerary or schedule, for the user of individual for a given day or for given days. This information can thereafter be utilized as, or to supplement, to complement, or to modify, any data and/or information regarding a previously stored itinerary or schedule of or for the user or individual.

Information recorded automatically by the communication device can also be utilized for determining and/or for storing an expected itinerary or schedule for the user or individual. The apparatus, the central processing computer, the central processing computer/distributed ledger/Blockchain technology system, the distributed ledger and Blockchain technology system, or the distributed ledger and Blockchain technology system, and/or the communication device, can utilize any software, programs, or algorithms, or any artificial intelligence (AI) or machine learning software, programs, or algorithms, for recording, for storing, and/or for predicting, and/or for updating, any itinerary or schedule, for determining, for ascertaining, or for predicting, a user's or individual's position, location, or geographic location, at any given time during any given day. The respective databases of the central processing computer, the central processing computer/distributed ledger/Blockchain technology system, the distributed ledger and Blockchain technology system, or the distributed ledger and Blockchain technology system, and the communication device can include or contain any itinerary or schedule information for the user or individual as well as any software, programs, or algorithms, or any artificial intelligence (AI) or machine learning software, programs, or algorithms, for recording, storing, and/or predicting, and/or for updating, the itinerary or schedule of or for the user or individual.

The apparatus and methods of the present invention can be utilized in order to authenticate a user or individual in any action, transaction, or activity, or to authenticate an action or transaction attempted to be performed or effectuated by a user or individual on, with, using, or involving, any of the herein-described accounts, or cards associated with any of the herein-described accounts, or to authenticate any action or transaction with the central processing computer, the central processing computer/distributed ledger/Blockchain technology system, the distributed ledger and Blockchain technology system, or the distributed ledger and Blockchain technology system, or any transmission of any of the data, information, signal(s), message(s), or response(s), described herein or otherwise, from the communication device to the central processing computer, the central processing computer/distributed ledger/Blockchain technology system, the distributed ledger and Blockchain technology system, or the distributed ledger and Blockchain technology system, at a time of, or at the time of, the same, by using and processing information regarding the position, location, or geographic location, of the communication device which is being used by the user or individual and, hence, the position, location, or geographic location, of the user or individual.

The apparatus and methods of the present invention can be utilized in order to authenticate a user or individual by the position, location, or geographic location, of the user's or individual's communication device (also referred to herein as “location-based authentication”) each time and/or any time the user or individual performs, or attempts to perform, an action or transaction on, with, using, or involving, any of the herein-described accounts, or cards associated with any of the herein-described accounts, or performs any action or transaction with the central processing computer, the central processing computer/distributed ledger/Blockchain technology system, the distributed ledger and Blockchain technology system, or the distributed ledger and Blockchain technology system, transmits any of the data, information, signal(s), message(s), or response(s), described herein or otherwise, from the communication device to the central processing computer, the central processing computer/distributed ledger/Blockchain technology system, the distributed ledger and Blockchain technology system, or the distributed ledger and Blockchain technology system, or performs any action, transaction, or activity, which is or may be capable of being performed or being effectuated by or via the apparatus and methods of the present invention.

In this regard, the apparatus of the present invention can perform location-based authentication for any action, transaction, or activity, any time the user or individual performs, or attempts to perform, an action or transaction on, with, using, or involving, any of the herein-described accounts, or cards associated with any of the herein-described accounts, or performs any action or transaction with the central processing computer, the central processing computer/distributed ledger/Blockchain technology system, the distributed ledger and Blockchain technology system, or the distributed ledger and Blockchain technology system, transmits any of the data, information, signal(s), message(s), or response(s), described herein or otherwise, from the communication device to the central processing computer, or performs any action, transaction, or activity, which is or may be capable of being performed or being effectuated by or via the apparatus and methods of the present invention.

The central processing computer, the central processing computer/distributed ledger/Blockchain technology system, the distributed ledger and Blockchain technology system, or the distributed ledger and Blockchain technology system, can perform processing routines to determine whether or not the user or individual, and/or any herein-described action, transaction, or activity, performed, or attempted to be performed, by the user or individual is authenticated. If determined to be authenticated, the central processing computer, the central processing computer/distributed ledger/Blockchain technology system, the distributed ledger and Blockchain technology system, or the distributed ledger and Blockchain technology system, can authenticate and allow the respective, action, transaction, or activity, on, with, using, or involving, the respective account, the respective action or transaction with the central processing computer, the central processing computer/distributed ledger/Blockchain technology system, the distributed ledger and Blockchain technology system, or the distributed ledger and Blockchain technology system, the respective transmission of any data, information, signal(s), message(s), or response(s), described herein or otherwise, from the communication device to the central processing computer, the central processing computer/distributed ledger/Blockchain technology system, the distributed ledger and Blockchain technology system, or the distributed ledger and Blockchain technology system, or the action, transaction, or activity, which is or may be capable of being performed or being effectuated by or via the apparatus and methods of the present invention. If determined to not be authenticated, the central processing computer, the central processing computer/distributed ledger/Blockchain technology system, the distributed ledger and Blockchain technology system, or the distributed ledger and Blockchain technology system, can disallow the respective, action, transaction, or activity, on, with, using, or involving, the respective account, the respective action or transaction with the central processing computer, the central processing computer/distributed ledger/Blockchain technology system, the distributed ledger and Blockchain technology system, or the distributed ledger and Blockchain technology system, the respective transmission of any data, information, signal(s), message(s), or response(s), described herein or otherwise, from the communication device to the central processing computer, the central processing computer/distributed ledger/Blockchain technology system, the distributed ledger and Blockchain technology system, or the distributed ledger and Blockchain technology system, or the action, transaction, or activity, which is or may be capable of being performed or being effectuated by or via the apparatus and methods of the present invention, or the respective attempt to do the same.

The central processing computer, the central processing computer/distributed ledger/Blockchain technology system, the distributed ledger and Blockchain technology system, or the distributed ledger and Blockchain technology system, can also determine whether or not the determined and authenticated position, location, or geographic location, is located within the geographic limits of a jurisdiction, state, province, region, or country, so as to ensure and/or to document, in any appropriate manner, that any respective action, transaction, or activity, is legally performed within the geographic limits of a jurisdiction, state, province, region, or country.

The apparatus of the present invention can also be utilized in a same, a similar, and/or an analogous, manner, as described herein, in order to authenticate any merchant or counterparty involved in any transaction with any user or individual. In this regard, the apparatus of the present invention can perform the herein-described position-based authentication or location-based authentication methods and/or routines for or regarding a counterparty communication device of, associated with, or used by, any merchant or counterparty who or which is involved in any transaction with the user or individual and which involves any account. In this regard, the apparatus can perform the herein-described position-based authentication or location-based authentication methods and/or routines for or regarding the merchant or counterparty by determining the position, location, and/or geographic location, of and for the merchant's or counterparty's counterparty communication device and by comparing the same against an expected position, location, or geographic location, for the merchant or counterparty, based on the merchant's or counterparty's itinerary or schedule.

Any communication device(s) associated with an account holder can be de-activated by the account holder, or by any other authorized user or individual, via the central processing computer. The account holder, or other authorized user or individual, can access any central processing computer with which the lost, stolen, misplaced, or defective, communication device is registered, or which central processing computer services an account which is also serviced with or by the lost, stolen, misplaced, or defective, communication device. The account holder can access the central processing computer with any other authorized communication device and can transmit a signal, data, information, or a message, which included information regarding an instruction to de-activate the lost, stolen, misplaced, or defective, communication device.

Any counterparty communication device(s) associated with a counterparty can be de-activated by the counterparty, or by an agent or employee, or other authorized user or individual, of or associated with the counterparty via the central processing computer. The counterparty, or an agent or employee, or other authorized user or individual, of or associated with the counterparty, can access any central processing computer with which the lost, stolen, misplaced, or defective counterparty communication device is registered, or which central processing computer services an account which is also serviced with or by the lost, stolen, misplaced, or defective, counterparty communication device. The counterparty, or an agent or employee, or other authorized user or individual, of or associated with the counterparty, can access the central processing computer with any other authorized counterparty communication device and can transmit a signal, data, information, or a message, which includes information regarding an instruction to de-activate the lost, stolen, misplaced, or defective, counterparty communication device.

The present invention can be utilized to perform a transaction on and/or involving any of the herein-described and/or herein-identified accounts. The present invention can allow an account holder to select to perform or engage in a transaction by using a single account, or by using multiple accounts. The present invention can also allow an account holder to select to the transaction processing type for processing a transaction or for certain portions of a transaction.

The present invention can also utilize position or location information regarding the position or location of a communication device and/or a merchant's counterparty communication device is processing a transaction and/or for determining if the transaction is authorized or allowed or unauthorized or not allowed. The present invention also provides a system for providing multifactor authentication in and for transactions by providing a video recording, video information, or a video clip, a picture or a photograph, or an audio recording or an audio clip, of individuals or parties involved in a transaction. The present invention also provides a system for providing multifactor authentication in and for transactions by providing for the processing of transactions which involve multiple accounts or multiple types or kinds of accounts, cryptocurrencies, and/or crypto currency accounts.

### BRIEF DESCRIPTION OF THE DRAWINGS

In the Drawings:

FIG. 1 illustrates a preferred embodiment of the apparatus of the present invention, in block diagram form;

FIG. 2 illustrates a preferred embodiment of the central processing computer of FIG. 1, in block diagram form;

FIG. 3 illustrates a preferred embodiment of the communication device of FIG. 1, in block diagram form;

FIG. 4 illustrates a preferred embodiment of the counterparty communication device of FIG. 1, in block diagram form; and

FIGS. 5A and 5B illustrate a preferred embodiment method for utilizing the apparatus of the present invention, in flow diagram form;

FIG. 6 illustrates another preferred embodiment apparatus of the present invention, in block diagram form;

FIG. 7 illustrates yet another preferred embodiment apparatus of the present invention, in block diagram form;

FIG. 8 illustrates still another preferred embodiment apparatus of the present invention, in block diagram form;

FIGS. 9A and 9B illustrate another preferred embodiment method for utilizing the apparatus 200 of FIG. 6, in flow diagram form; and

FIGS. 10A and 10B illustrate a preferred embodiment method for utilizing the apparatus 100 of FIG. 1, in flow diagram form;

FIG. 11 illustrates a preferred embodiment method for using the apparatus of FIG. 6, in flow diagram form; and

FIG. 12 illustrates another preferred embodiment method for using the apparatus of FIG. 1, in flow diagram form.

### DESCRIPTION OF THE PREFERRED EMBODIMENTS

The present invention pertains to an apparatus and method for providing transaction security and/or account security and, in particular, the present invention pertains to an apparatus and method for providing transaction security and/or account security which provides for enhanced account security safeguards, enhanced transaction security safeguards, and/or enhanced security and safeguarding of account information and/or account holder information.

In a preferred embodiment, the present invention provides an apparatus and method which allow an account holder to conduct transactions while maintaining control over his or her account information and dispenses with the need for the account holder to provide his or her account information to a counterparty in a transaction.

The present invention can be utilized in connection with, or in conjunction with, credit card accounts, credit accounts, charge card accounts, charge accounts, debit card accounts, or debit accounts, bank accounts, checking accounts, or savings accounts, cryptocurrencies, cryptocurrency accounts, gambling accounts, gaming accounts, sports betting accounts, lottery gaming accounts, lottery accounts, brokerage accounts, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, electronic money accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, or any other accounts, as well as any cards, devices, and/or other entities, which can be used with or which can be associated with any of the herein-described accounts, wherein an account holder or other individual authorized to use the account can utilize same without having to provide an account number or any other account identifying information to a counterparty. It is important to note that, or the purposes of the present invention, a cryptocurrency is also an account.

Applicant hereby incorporates by reference herein the subject matter and teachings of U.S. Provisional Patent Application Ser. No. 62/869,535, filed Jul. 1, 2019, and entitled “APPARATUS AND METHOD FOR PROVIDING TRANSACTION SECURITY AND/OR ACCOUNT SECURITY”, the subject matter and teachings of which are hereby incorporated by reference herein in their entirety.

Applicant hereby incorporates by reference herein the subject matter and teachings of U.S. patent application Ser. No. 14/458,316, filed Aug. 13, 2014, and entitled “APPARATUS AND METHOD FOR PROVIDING TRANSACTION SECURITY AND/OR ACCOUNT SECURITY”, the subject matter and teachings of which are hereby incorporated by reference herein in their entirety.

Applicant also hereby incorporates by reference herein the subject matter and teachings of U.S. patent application Ser. No. 14/328,434, filed Jul. 10, 2014, and entitled “APPARATUS AND METHOD FOR PROVIDING TRANSACTION SECURITY AND/OR ACCOUNT SECURITY”, the subject matter and teachings of which are hereby incorporated by reference herein in their entirety.

Applicant hereby incorporates by reference herein the subject matter and teachings of U.S. patent application Ser. No. 14/283,820, filed May 21, 2014, and entitled “APPARATUS AND METHOD FOR PROVIDING TRANSACTION SECURITY AND/OR ACCOUNT SECURITY”, the subject matter and teachings of which are hereby incorporated by reference herein in their entirety.

Applicant also hereby incorporates by reference herein the subject matter and teachings of U.S. patent application Ser. No. 14/289,673, filed May 29, 2014, and entitled “APPARATUS AND METHOD FOR PROVIDING TRANSACTION SECURITY AND/OR ACCOUNT SECURITY”, the subject matter and teachings of which are hereby incorporated by reference herein in their entirety.

Applicant hereby incorporates by reference herein the subject matter and teachings of U.S. Provisional Patent Application Ser. No. 62/035,541, filed Aug. 11, 2014, and entitled “APPARATUS AND METHOD FOR PROVIDING TRANSACTION SECURITY AND/OR ACCOUNT SECURITY”, the subject matter and teachings of which are hereby incorporated by reference herein in their entirety.

Applicant hereby incorporates by reference herein the subject matter and teachings of U.S. Provisional Patent Application Ser. No. 61/880,757, filed Sep. 20, 2013, and entitled “APPARATUS AND METHOD FOR PROVIDING TRANSACTION SECURITY AND/OR ACCOUNT SECURITY”, the subject matter and teachings of which are hereby incorporated by reference herein in their entirety.

Applicant hereby incorporates by reference herein the subject matter and teachings of U.S. Provisional Patent Application Ser. No. 61/957,360, filed Jul. 1, 2013, and entitled “APPARATUS AND METHOD FOR PROVIDING TRANSACTION SECURITY AND/OR ACCOUNT SECURITY”, the subject matter and teachings of which are hereby incorporated by reference herein in their entirety.

Applicant also hereby incorporates by reference herein the subject matter and teachings of U.S. Provisional Patent Application Ser. No. 61/956,801, filed Jun. 17, 2013, and entitled “APPARATUS AND METHOD FOR PROVIDING TRANSACTION SECURITY AND/OR ACCOUNT SECURITY”, the subject matter and teachings of which are hereby incorporated by reference herein in their entirety.

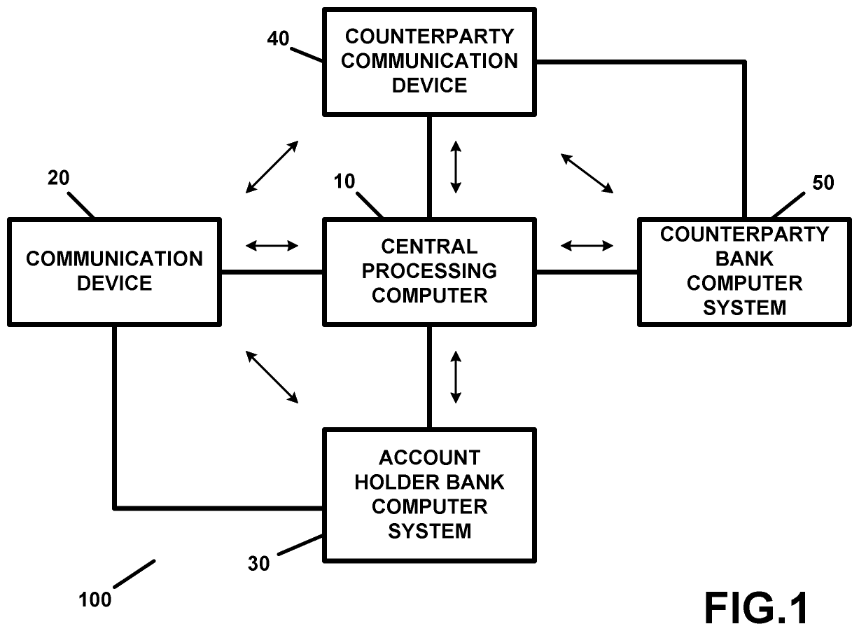

FIG. 1 illustrates a preferred embodiment of the apparatus of the present invention which is denoted generally by the reference numeral 100, in block diagram form. With reference to FIG. 1, the apparatus 100 includes a central processing computer 10 which can perform any of the processing routines and functionality typically performed by any transaction authorization processing computer used for processing transactions on, involving, or regarding, any of the herein-described credit card accounts, credit accounts, debit card accounts, debit accounts, charge card accounts, charge accounts, bank accounts, checking accounts, savings accounts, electronic money accounts, gambling accounts, gaming accounts, sports betting accounts, lottery gaming accounts, lottery accounts, brokerage accounts, healthcare insurance accounts, and/or any of the other accounts described herein. In a preferred embodiment, the central processing computer 10 can also perform any the processing routines and/or functionality described herein as being performed by the apparatus 100 of the present invention.

In a preferred embodiment, any number of central processing computers 10 can be utilized in connection with the apparatus 100. In the preferred embodiment, the central processing computer 10 can be dedicated to performing transaction authorization processing for a given type of account. For example, a central processing computer 10 can be dedicated to performing transaction authorization processing for all accounts issued or serviced by the VISA® financial services company. A central processing computer 10 can also be dedicated to performing transaction authorization processing for all accounts issued or serviced by the MASTERCARD® financial services company. In a same manner, a central processing computer 10 can also be dedicated to performing transaction authorization processing for any particular type of account or for any account provider.

In this regard, the central processing computer 10 can perform transaction authorization processing for any number and/or types of any of the accounts described herein. For example, if a credit account issued by the VISA® financial services company is being used in a transaction, the central processing computer 10 can be a VISA® transaction processing computer which can process transactions for any number of accounts issued or serviced by the VISA® financial services company. If a credit account issued by the MASTERCARD® financial services company is being used in a transaction, the central processing computer 10 can be a MASTERCARD® transaction authorization processing computer which can process transactions for any number of accounts issued or serviced by the MASTERCARD® financial services company.

In another preferred embodiment, the processing computer 10 can perform transaction authorization processing for any number and/or types of any of the accounts described herein or otherwise. In another preferred embodiment, the processing computer 10 can also perform transaction authorization processing for any number and/or types of any of the accounts described herein or otherwise, including, but not limited to any accounts which can be issued by or serviced any financial intermediary, any insurance company, any healthcare insurance company or entity, any healthcare payer, any life insurance company or entity, any disability insurance company or entity, or any other insurer or payer of any type or kind.

In a preferred embodiment, a central processing computer 10 can also be utilized to process transactions involving any number or types of accounts serviced by any bank, financial institution, or financial intermediary, or for any number or types of accounts serviced by any number of banks, financial institutions, or financial intermediaries. In another preferred embodiment, a central processing computer 10 can also be utilized to process transactions involving any number or types of accounts serviced by any account provider, account administrator, or account service provider. In a preferred embodiment, a central processing computer 10 can perform transaction authorization processing for any number or, or any type or kind of an any, or any combination of, credit accounts, credit card accounts, debit accounts, debit card accounts, charge accounts, charge card accounts, bank accounts, checking accounts, savings accounts, electronic money accounts, gambling accounts, gaming accounts, sports betting accounts, lottery gaming accounts, lottery accounts, brokerage accounts, healthcare insurance accounts, and/or any of the other accounts described herein, such as, but not limited to, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, or any other accounts described herein, as well as any cards, devices, and/or other entities, which can be used with or which can be associated with any of the herein-described accounts.

In another preferred embodiment, a single central processing computer 10 can also be adapted to service any one type or any number or combination of types of any other the credit accounts, credit card accounts, debit accounts, debit card accounts, charge accounts, charge card accounts, bank accounts, checking accounts, savings accounts, electronic money accounts, gambling accounts, gaming accounts, sports betting accounts, lottery gaming accounts, lottery accounts, brokerage accounts, healthcare insurance accounts, and/or any of the other accounts described herein, such as, but not limited to, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, or any other accounts, as well as any cards, devices, and/or other entities, which can be used with or which can be associated with any of the herein-described accounts.

In a preferred embodiment, the central processing computer 10 can be any computer, computer system, group of computers, server, server system, or group of servers, which can be programmed and/or equipped to perform any of the herein-described functions, operations, or actions, described herein as being performed by the central processing computer 10 and/or the apparatus 100 of the present invention.

In another preferred embodiment, any of the central processing computer(s) 10 described as being utilized in connection or in conjunction with the apparatus 100 and method or the present invention can also be performed by or implemented using cloud computer hardware and/or software. In this regard, any and/or all of the central processing computers 10 described herein can be implemented using a cloud computing architecture, server computers or network computers, and/or any cloud computing hardware and/or software. In this manner, the apparatus 100 of the present invention can be utilized in connection with any number of central processing computer(s) 10 and the apparatus 100 of the present invention can also be utilized in connection with a cloud computing system, network, and/or architecture. Any number, type, or kind, of central processing computer(s) 10 can be utilized in the apparatus 100 of the present invention.

With reference once again to FIG. 1, the apparatus 100 also includes a communication device 20 which can be utilized by any account holder who or which utilizes the apparatus 100 of the present invention. In a preferred embodiment, the communication device 20 can be utilized to communicate with, transmit signals, data, information, or a message, to, receive signals, data, information, or a message, from, or to access, or which can be linked with, or which can be wirelessly linked with, any of the central processing computers 10 described herein.

In a preferred embodiment, the communication device 20 can be connected with, linked to, wirelessly connected with, or wirelessly linked to or with, the central processing computer 10. In a preferred embodiment, the communication device 20 can also be connected with, linked to, wirelessly connected with, or wirelessly linked to or with, the central processing computer 10 during operation of the apparatus 100 of the present invention as described herein, and/or at any desired time or times.

In a preferred embodiment, the communication device 20 can be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the communication device 20.

In a preferred embodiment, the communication device 20 can include a central processing unit or device, an input device, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a retinal scanning device, a fingerprint recognition device, a voice recognition device, a retinal scanner, a fingerprint device, a voice recognition device, a handprint recognition device, a handprint geometry recognition device, a facial feature recognition device, and/or any one or more of the biometric devices used to control access to a computer or a computer network which are known to those skilled in the art at the time of the filing of this patent application, a pointing device, a mouse, an output device, a database or a memory device and/or system, a random access memory (RAM) device, a read only memory (ROM) device, a video recording system or equipment, a camera(s), an audio recording system, device, or equipment, a microphone, a receiver or any number of receivers, a transmitter or any number of transmitters, a network interface device, an information or content gathering device, and/or any other devices, equipments, or systems, typically found in and/or utilized by any of the herein-described communication devices 20 described herein as being utilized in connection with the apparatus 100 of the present invention. In a preferred embodiment, the communication device 20 can also be equipped with a global positioning device 20J which can be utilized to calculate, determine, or ascertain, the position or location of the communication device 20.

In a preferred embodiment, the communication device 20 can also contain, include, or be equipped with, a transmitter(s), a receiver(s), or any other network interface devices or equipment for facilitating bi-directional communication with, and/or data and/or information exchange with, the central processing computer 10.

In a preferred embodiment, the communication device 20 can also include, contain, or be equipped with a camera, a digital video recording system or equipment, a microphone, a digital audio recording system or equipment, or any another digital video and audio recording device or equipment or other digital media recoding equipment, that can allow the communication device 20 to record and store, for later play-back, any of the video and/or audio information which can or may be obtained using the apparatus 100 of the present invention. The communication device 20 can also be used to take or record a photograph, picture, video, a video clip, audio, or an audio clip, of the account holder or any other user, individual, or entity.

In a preferred embodiment, the communication device 20 can serve as a transaction authorization processing device which can communicate, in bi-directional manner, with any central processing computer 10 which can perform transaction authorization processing for any account described herein. The communication device 20 can also be equipped with the needed hardware and/or software to function as a point of sale (POS) transaction device which can communicate, in a bi-directional manner, with any central processing computer 10 and/or any transaction processing computer or any transaction authorization processing computer.

In a preferred embodiment, any number of communication devices 20 can be assigned to, utilized by, or associated with, any account holder.

With reference once again to FIG. 1, the apparatus 100 also includes an account holder bank/credit issuer computer system 30 (hereinafter “account holder bank computer system 30”) which can be any computer, computer system, or group of computers, of, associated with, or used by the account holder's bank, financial institution, or financial intermediary, and which service any and/or all of the account holder's accounts.

In a preferred embodiment, the account holder bank computer system 30 can process transactions involving, and/or maintain any and/or all data, information, transactions records, and/or any other data and/or information regarding, the account holder's accounts. In a preferred embodiment, the account holder bank computer system 30 can also process transactions involving, and/or maintain any and/or all data, information, transactions records, and/or any other data and/or information, regarding the accounts of any number of account holders.

In a preferred embodiment, the account holder bank computer system 30 can be connected with, linked to, wirelessly connected with, or wirelessly linked to or with, the central processing computer 10 and/or the communication device(s) 20 of, used by, or associated with, an account holder. In a preferred embodiment, the account holder bank computer system 30 can be connected with, linked to, wirelessly connected with, or wirelessly linked to or with, the central processing computer 10 and/or the communication device(s) 20 of, used by, or associated with, an account holder, during operation of the apparatus 100 of the present invention as described herein, and/or at any desired time or times.

Any number of account holder bank computer systems 30 can be utilized in connection with the apparatus 100 of the present invention.

With reference once again to FIG. 1, the apparatus 100 also includes a counterparty communication device 40 which can be utilized by any counterparty who or which utilizes the apparatus 100 of the present invention. In the preferred embodiment, the term “counterparty” refers to any merchant, store, wholesale store, retailer, retail store, vendor, supplier, customer, client, bank, financial institution, financial intermediary, service provider, goods provider, third party, or any other individual, person, or entity, who or which is a party to, enters into, engages in, or participates in, any transaction with the account holder to with an account holder.

In a preferred embodiment, the counterparty communication device 40 can be utilized to communicate with, transmit signals, data, information, or a message, to, receive signals, data, information, or a message, from, or to access, or which can be linked with, or which can be wirelessly linked with, any of the central processing computers 10 described herein and/or with any of the communication devices 20 described herein.

In a preferred embodiment, the counterparty communication device 40 can be connected with, linked to, wirelessly connected with, or wirelessly linked to or with, the central processing computer 10 and/or with the communication device 20. In a preferred embodiment, the counterparty communication device 40 can also be connected with, linked to, wirelessly connected with, or wirelessly linked to or with, the central processing computer 10 and/or the communication device 20 during operation of the apparatus 100 of the present invention as described herein, and/or at any desired time or times.

In a preferred embodiment, the counterparty communication device 40 can be, or can be a component of, a point of sale (POS) transaction device, a point of transaction device, a transaction authorization device, a cash register, or any other transaction device which can be used by a counterparty. In a preferred embodiment, the counterparty communication device 40 can also be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the counterparty communication device 40.

In a preferred embodiment, the counterparty communication device 40 can include a central processing unit or device, an input device, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a retinal scanning device, a fingerprint recognition device, a voice recognition device, a retinal scanner, a fingerprint device, a voice recognition device, a handprint recognition device, a handprint geometry recognition device, a facial feature recognition device, and/or any one or more of the biometric devices used to control access to a computer or a computer network which are known to those skilled in the art at the time of the filing of this patent application, a pointing device, a mouse, an output device, a database or a memory device and/or system, a random access memory (RAM) device, a read only memory (ROM) device, a video recording system or equipment, a camera(s), an audio recording system, device, or equipment, a microphone, a receiver or any number of receivers, a transmitter or any number of transmitters, a network interface device, an information or content gathering device, and/or any other devices, equipments, or systems, typically found in and/or utilized by any of the herein-described counterparty communication device 40 described herein as being utilized in connection with the apparatus 100 of the present invention. In a preferred embodiment, the counterparty communication device 40 can also be equipped with a global positioning device which can be utilized to calculate, determine, or ascertain, the position or location of the counterparty communication device 40.

In a preferred embodiment, the counterparty communication device 40 can also contain, include, or be equipped with, a transmitter(s), a receiver(s), or any other network interface devices or equipment for facilitating bi-directional communication with, and/or data and/or information exchange with, the central processing computer 10 and/or the communication device 20.

In a preferred embodiment, the counterparty communication device 40 can also include, contain, or be equipped with a camera, a digital video recording system or equipment, a microphone, a digital audio recording system or equipment, or any another digital video and audio recording device or equipment or other digital media recoding equipment, that can allow the counterparty communication device 40 to record and store, for later play-back, any of the video and/or audio information which can or may be obtained using the apparatus 100 of the present invention. The counterparty communication device 40 can also be used to take or record a photograph, picture, video, a video clip, audio, or an audio clip, of the counterparty or an individual associated with the counterparty.

In a preferred embodiment, any number of counterparty communication devices 40 can be assigned to, utilized by, or associated with, any counterparty.

With reference once again to FIG. 1, the apparatus 100 also includes a counterparty bank computer system 50 which can be any computer, computer system, or group of computers, of, associated with, or used by the counterparty's bank, financial institution, or financial intermediary, and which service any and/or all of the counterparty's accounts.

In a preferred embodiment, the counterparty bank computer system 50 can process transactions involving, and/or maintain any and/or all data, information, transactions records, and/or any other data and/or information regarding, the counterparty's accounts. In a preferred embodiment, the counterparty bank computer system 50 can also process transactions involving, and/or maintain any and/or all data, information, transactions records, and/or any other data and/or information, regarding the accounts of any number of counterparties.

It is important to note that any counterparty can also be an account holder in a given transaction, and that any account holder can also be a counterparty in a given transaction.

In a preferred embodiment, the counterparty bank computer system 50 can be connected with, linked to, wirelessly connected with, or wirelessly linked to or with, the central processing computer 10 and/or the counterparty communication device(s) 40 of, used by, or associated with, a counterparty. In a preferred embodiment, the counterparty bank computer system 50 can be connected with, linked to, wirelessly connected with, or wirelessly linked to or with, the central processing computer 10 and/or the counterparty communication device(s) 40 of, used by, or associated with, a counterparty, during operation of the apparatus 100 of the present invention as described herein, and/or at any desired time or times.

Any number of counterparty computer systems 50 can be utilized in connection with the apparatus 100 of the present invention.

In the preferred embodiment, the apparatus 100 of the present invention is utilized on, and/or over, the Internet and/or the World Wide Web. The apparatus 100 of the present invention, in the preferred embodiment, can also utilize wireless Internet and/or World Wide Web services, equipment and/or devices. Although the Internet and/or the World Wide Web is a preferred communication system, network, and/or medium, utilized, the present invention, in any and/or all of the embodiments described herein, can also be utilized with any appropriate communication network or system including, but not limited to, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems.

In a preferred embodiment, each of the central processing computer(s) 10, the communication device(s) 20, the counterparty communication device(s) 40, the account holder bank computer system(s) 30, and the counterparty bank computer system(s) 50, can be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any central processing computer(s) 10, communication device(s) 20, counterparty communication device(s) 40, account holder bank computer system(s) 30, and counterparty bank computer system(s) 50.

In a preferred embodiment, each of the central processing computer(s) 10, the communication device(s) 20, the counterparty communication device(s) 40, the account holder bank computer system(s) 30, and the counterparty bank computer system(s) 50, can have a web site or web sites associated therewith.

The apparatus 100 and method of the present invention can also provide for a cloud-based account security and/or transaction security apparatus and method which can be utilized to perform any and/or all of the functionality described herein as being performed by the apparatus 100 of the present invention and which can also be utilized to perform cloud-based data and/or information access, processing, storage, utilization, and/or record keeping, of any data and/or information described herein as being processed and/or utilized by the apparatus 100 of the present invention.

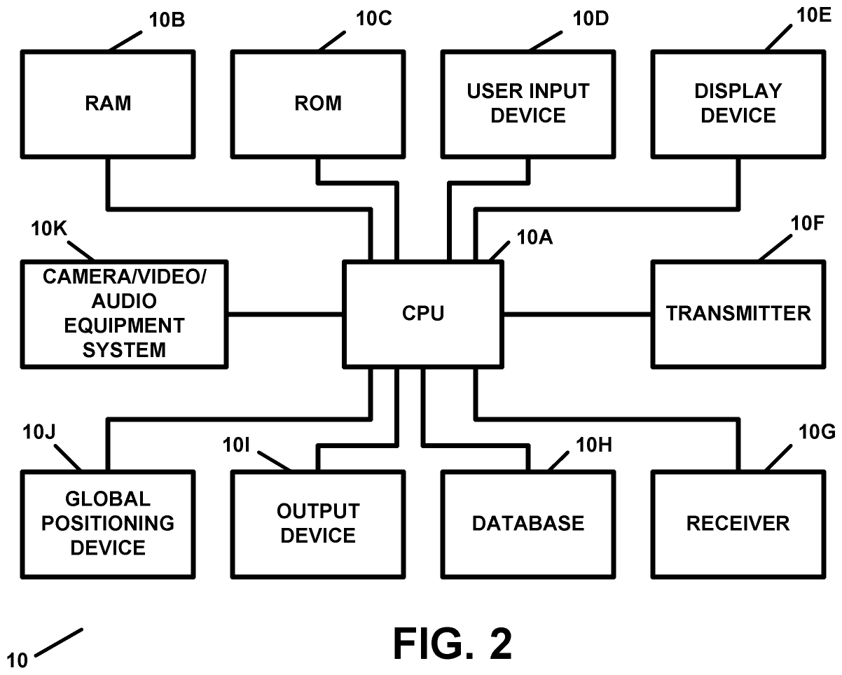

FIG. 2 illustrates a preferred embodiment of the central processing computer 10 of FIG. 1, in block diagram form. The central processing computer 10, in the preferred embodiment, is a computer, a computer system, a group of computers, a network computer, or a network computer system, or any other communication device which can provide the functionality of, and which can be utilized as a central processing computer 10. In the preferred embodiment, the central processing computer 10 can be adapted to process transaction authorization data and/or information for any of the accounts described herein. In a preferred embodiment, the central processing computer 10 can also be an Internet computer, an Internet server computer, and/or a web site server computer. In the preferred embodiment, the central processing computer 10 includes a central processing unit or CPU 10A, which in the preferred embodiment, is a microprocessor. The CPU 10A may also be a microcomputer, a minicomputer, a macro-computer, and/or a mainframe computer, depending upon the application.

The central processing computer 10 also includes a random access memory device(s) 10B (RAM) and a read only memory device(s) 10C (ROM), each of which is connected to the CPU 10A, and a user input device 10D, for entering data, information, and/or commands, into the central processing computer 10, which includes any one or more of a keyboard, a scanner, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a touch screen, and/or a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus 100 of the present invention, into the central processing computer 10. The input device 10D can also be any other input device(s) which are or can be utilized with or in connection with any of the central processing computer(s) 10 described herein as being utilized in connection with the apparatus 100 of the present invention. The input devices 10D are also connected to or with, or linked to or with, the CPU 10A. In a preferred embodiment, the input device 10D can also include a retinal scanner, a fingerprint recognition device, a voice recognition device, or any other type or kind of biometric device which can be used for determining whether or not a user or operator of the central processing computer 10 is an authorized user, individual, or person. The central processing computer 10 also includes a display device 10E for displaying data and/or information to a user or operator.

The central processing computer 10 also includes a transmitter(s) 10F, for transmitting signals and/or data and/or information, or a message(s), to any one or more of the communication devices(s) 20, the counterparty communication device(s) 40, the account holder bank computer system(s) 30, and the counterparty bank computer system(s) 50, and/or any other central processing computer(s) 10 described herein. The central processing computer 10 can also be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any of the communication devices(s) 20, the counterparty communication device(s) 40, the account holder bank computer system(s) 30, and the counterparty bank computer system(s) 50, and/or any other central processing computer(s) 10 described herein.

The central processing computer 10 also includes a receiver(s) 10G, for receiving signals and/or data and/or information, or a message(s), from any of the communication devices(s) 20, the counterparty communication device(s) 40, the account holder bank computer system(s) 30, and the counterparty bank computer system(s) 50, and/or any other central processing computer(s) 10 described herein.

The central processing computer 10 also includes a database(s) 10H, which is also connected to or linked with the CPU 10A, which can contain and/or include any and/or all of the data and/or information needed or desired for performing any and/or all of the functions and/or functionality described herein as being performed by the apparatus 100 and method of the present invention and/or the central processing computer 10.

In a preferred embodiment, the database 10H contains and/or includes data and/or information regarding each account holder who or which utilizes the apparatus 100 of the present invention, and for each account holder, his, her, or its, name, address, contact information, telephone number(s), cellular telephone number(s), wireless telephone number(s), personal communication device telephone number(s), e-mail address(es), IP address(es), text message number(s) or information, SMS message(s) or information, MMS message(s) or information, employer information, work information, emergency contact information, and/or any other contact or other information, account information, information regarding any and/or all accounts of the account holder, account numbers, account expiration dates, security codes or numbers, personal identification numbers (PINs), password(s), access code(s), social security numbers, account credit limit(s), account spending limit(s), account deductible(s), and/or any other data and/or information regarding each account holder and his, her, or its, accounts. In the case of individuals, the database 10H can also contain and/or include data and/or information regarding the account holder's relatives, friends, next of kin, or other contact information or emergency contact information.

The database 10H can also contain and/or include, for each account holder or for each user of an account of an account holder, a description of the account holder or user, a photograph or video clip of the account holder or user, data and/or information regarding a digital voiceprint of the account holder or user or data and/or information for verifying an identity of the account holder or user by his or her voiceprint, data and/or information regarding a retinal scan of the account holder or user or data and/or information for verifying an identity of the account holder or user by his or her retinal scan, data and/or information regarding a fingerprint of the account holder or user or data and/or information for verifying an identity of the account holder or user by his or her fingerprint, and/or any other data and/or information for identifying and identity of the account holder or user using biometric data and/or information.

In a preferred embodiment, the database 10H can also contain and/or include, for each account holder or user, data and/or information regarding each communication device 20 which is or can be used by the account holder or user in utilizing the apparatus 100 and method of the present invention, including, but not limited to, data and/or information regarding an identification of each communication device 20, a description of, or type or kind of, the communication device 20, manufacturer, model number, and/or serial number or any other identification information, of, for, or regarding, the communication device 20, and/or the assigned telephone number, e-mail address, text messaging or SMS messaging number, MMS messaging number, and/or IP address, or any network identification information, of, for, or associated with, the communication device 20.

The database 10H can also contain and/or include, for each account serviced by the apparatus 100, data and/or information about the account holder, the account holder's account number(s), credit and/or account limit(s), spending limit(s), previous transactions, previous purchases, previous unauthorized transactions made on or involving the account or attempted to be made on or involving the account, previous unauthorized purchases made on or involving the account or attempted to be made on or involving the account, number of authorized and/or unauthorized transaction or purchases, account statements, historical account statements, and/or any other data and/or information needed, desired, and/or necessary, to manage and/or process an account transaction as described herein. The database 10H also contains and/or includes data and/or information regarding account statements, historical account statements, pending transactions, pending authorizations, and/or any other data and/or information regarding account activity and/or account activities.

The database 10H can also contain and/or include, for each account serviced by the apparatus 100, information regarding an account holder's requests or instructions to receive alerts or alert messages regarding any transactions occurring on any of his, her, or its accounts.

The database 10H can also contain or include, for each account, the phone number, telephone number, uniform resource locator (url), or IP address of the respective central processing computer 10 which performs transaction authorization processing for the respective account. The database 10H can also contain or include a link(s) or hyperlink(s) to any central processing computer(s) 10 associated with any of the accounts held by, owned by, or associated with, each account holder serviced by the apparatus 100 of the present invention. The database 10H can also contain or include a link(s) or hyperlink(s) to any transaction page or web page or any transaction pages or web pages associated with the central processing computer(s) 10 associated with any of the accounts held by, owned by, or associated with, each account holder.

The database 10H can also contain or include a link(s) or hyperlink(s) to each of the herein-described communication devices 20, counterparty communication devices 40, account holder bank computer system(s) 30, the counterparty bank computer system(s) 50, and/or any other central processing computer(s) 10, which are utilized in connection with the apparatus 100 of the present invention.

The database 10H can also contain and/or include data and/or information regarding each counterparty, merchant, store, wholesale store, retailer, retail store, vendor, supplier, customer, client, bank, financial institution, financial intermediary, service provider, goods provider, third party, or any other individual, person, or entity, who or which utilizes the apparatus 100 and method of the present invention and/or who or which is or can be a party to, enters into, engages in, or participates in, any transaction with any account holder who or which utilizes the apparatus 100 and method of the present invention (hereinafter referred to as “counterparty” or “merchant”). The database 10H can also contain and/or include, for each counterparty or merchant described herein, data and/or information regarding his, her, or its, name and/or counterparty identifier or counterparty identifying information and/or merchant identifier or merchant identifying information for or associated with each account type(s), account, credit card type(s), credit card account(s), charge card type(s), charge card account, debit card type(s), debit card account, bank account(s), checking account(s), savings account(s), payment account(s), electronic payment account(s), third party payment account(s), payment identifier, member identifier, customer identifier, client identifier, or other account information and/or counterparty identifier or counterparty identifying information and/or merchant identifier or merchant identifying information the respective counterparty or merchant has with, or has been assigned by or with, each account servicing entity, account servicing bureau, credit card serving company, charge card servicing company, debit card servicing company, bank, financial institution, financial intermediary, insurance company, healthcare insurance company, healthcare payer, or any other provider of any goods, products, or services (also referred to herein as “account servicing entity”). In this regard, the database 10H contains data and/or information regarding each respective account or identifier which the respective counterparty or merchant has with each account serving entity and/or the database 10H contains data and/or information regarding each respective account or identifier associated with each membership, subscription, or account or identifier, which the respective counterparty or merchant has with each account servicing entity or has been assigned by each account servicing entity.

The database 10H can also contain and/or include data and/or information regarding each of the herein-described counterparties or merchants, including, but not limited to, his, her, or its, name, address, contact information, which contact information can include, but is not limited to, telephone number(s), e-mail address(es), IP address(es), text message number(s) or information, SMS message(s) number(s) or information, MMS message(s) number(s) or information, cellular telephone number(s), and/or any other data and/or information for facilitating contact or communication with a respective counterparty or merchant.

The database 10H can also contain and/or include data and/or information regarding each the counterparty communication device 40 or counterparty communication devices 40, of, associated with, or used by any of the herein-described counterparties or merchants, including, but not limited to, for each counterparty communication device 40, which can include any of the herein-described counterparty communication devices 40, point-of-sale (POS) devices, point-of-transaction devices, transaction devices, transaction authorization devices, transaction authorization processing devices, or any other transaction devices, the type or kind or device, the manufacturer and model of same, and contact information, telephone number(s), e-mail address(es), IP address(es), text message number(s) or information, SMS message(s) number(s) or information, MMS message(s) number(s) or information, cellular telephone number(s), and/or any other data and/or information for facilitating contact or communication with the respective counterparty communication device 40.

In this regard, the database 10H can contain and/or include data and/or information regarding each counterparty communication device 40 utilized by each respective counterparty or merchant, including, but not limited to, for each communication device 40, whether the communication device 40 be any of the devices described herein as being a counterparty communication device 40, or a point-of-sale device, a point-of-transaction device, a card swiping device equipped for use in processing transactions or for processing information for processing transaction payments, a transaction device, a transaction authorization device, a transaction authorization processing device, or any other transaction device or other device, the telephone number(s), e-mail address(es), IP address(es) or information, text messaging number(s) or information, SMS messaging number(s) or information, MMS messaging number(s) or information, and/or any other contact information, for or associated with each counterparty communication device 40 which can or may be utilized for facilitating communication with the respective counterparty communication device 40 and/or which can or may be used for facilitating communication with and/or between the respective counterparty communication device 40 and any of the central processing computer(s) 10, the communication device(s) 20, the account holder bank computer system(s) 30, and/or the counterparty bank computer system(s) 50, and/or any other counterparty communication devices 40, described herein.

The database 10H can also contain and/or include, for each of the herein-described counterparties or merchants, any data and/or information regarding any of the herein-described counterparty transaction identifying information and/or merchant transaction identifying information, and/or any other data and/or information described herein as being contained in or included in same for that respective counterparty or merchant. The database 10H can also contain and/or include, for each of the herein-described counterparties or merchants, data and/or information regarding any payment account information, telephone number(s), e-mail address(es), IP address(es), text message number(s) or information, SMS message(s) number(s) or information, MMS message(s) number(s) or information, wireless telephone number(s), personal communication device telephone number(s), point-of-sale transaction devices telephone number(s), e-mail address(es), IP address(es), text message number(s) or information, SMS message(s) number or information, MMS message(s) number or information, emergency contact information, and/or any other contact or other information, account information, information regarding any and/or all accounts of the respective counterparty or merchant, account number(s), account identifier(s), account expiration dates, security codes or numbers, personal identification numbers (PINs), password(s), access code(s), payment instructions, employer identification numbers, account credit limit(s), account spending limit(s), account deductible(s), and/or any other data and/or information regarding each counterparty or merchant and/or his, her, or its, respective accounts.

The database 10H can also contain and/or include, for each of the herein-described counterparties and/or merchants, a description of the respective counterparty or merchant, a photograph or video clip of the counterparty's or merchant's principal(s), employee(s), or agent(s), authorized to engage in transactions or to utilize the apparatus 100, data and/or information regarding a digital voiceprint of the of the counterparty's or merchant's principal(s), employee(s), or agent(s), authorized to engage in transactions or to utilize the apparatus 100, or data and/or information for verifying an identity of the counterparty's or merchant's principal(s), employee(s), or agent(s), by his or her voiceprint, data and/or information regarding a retinal scan of the counterparty's or merchant's principal(s), employee(s), or agent(s), or data and/or information for verifying an identity of the counterparty's or merchant's principal(s), employee(s), or agent(s), by his or her retinal scan, data and/or information regarding a fingerprint of the counterparty's or merchant's principal(s), employee(s), or agent(s), or data and/or information for verifying an identity of the counterparty's or merchant's principal(s), employee(s), or agent(s), by his or her fingerprint, and/or any other data and/or information for identifying and identity of the counterparty's or merchant's principal(s), employee(s), or agent(s), using biometric data and/or information.

In a preferred embodiment, the database 10H can also contain and/or include, for each of the herein-described counterparties or merchants, data and/or information regarding each counterparty communication device 40 which is or can be used by the respective counterparty or merchant in utilizing the apparatus 100 and method of the present invention, including, but not limited to, data and/or information regarding an identification of each counterparty communication device 20, a description of, or type or kind of, the counterparty communication device 40, manufacturer, model number, and/or serial number or any other identification information, of, for, or regarding, the c counterparty communication device 40, and/or the assigned telephone number, e-mail address, text messaging or SMS messaging number, MMS messaging number, and/or IP address, or any network identification information, of, for, or associated with, the respective counterparty communication device 40.

The database 10H can also contain and/or include, for each counterparty or merchant account serviced by the apparatus 100, information about the respective counterparty or merchant, the counterparty's or merchant's account number(s), credit and/or account limit(s), spending limit(s), previous transactions, previous purchases, previous unauthorized transactions made on the account or attempted to be made on the account, previous unauthorized purchases made on the account or attempted to be made on the account, number of authorized and/or unauthorized transaction or purchases, account statements, historical account statements, and/or any other data and/or information needed, desired, and/or necessary, to manage and/or process an account transaction as described herein. The database 10H also contains and/or includes data and/or information regarding account statements, historical account statements, pending transactions, pending authorizations, and/or any other data and/or information regarding account activity and/or account activities for any counterparty or merchant accounts.

The database 10H can also contain and/or include, for each account serviced by the apparatus 100, information regarding a counterparty's or merchant's requests or instructions to receive alerts or alert messages regarding any transactions occurring on any of his, her, or its, accounts.

The database 10H can also contain or include, for each counterparty or merchant account, the phone number or IP address of the respective central processing computer 10 which performs transaction authorization processing for the respective account. The database 10H can also contain or include a link(s) or hyperlink(s) to any central processing computer(s) 10 associated with any of the counterparty or merchant accounts held by, owned by, or associated with, each counterparty or merchant serviced by the apparatus 100 of the present invention. The database 10H can also contain or include a link(s) or hyperlink(s) to any transaction page or pages associated with the central processing computer(s) 10 associated with any of the accounts held by, owned by, or associated with, each counterparty or merchant.

The database 10H can also contain or include, for each account, the times or hours of operation for each of the respective central processing computer(s) 10 which perform transaction authorization processing for any of the accounts serviced by the apparatus 100 of the present invention.

The database 10H can also contain or include, for each account, data and/or information regarding specific limitations and/or restrictions which may be placed on a particular account, which may be pre-selected and/or programmed by the account holder and/or which may include limitations and/or restrictions on the usage of the account or any cards or account numbers associated with the account and/or which may be placed on the account by the entity which issued the account or which services the account. The limitations and/or restrictions may include the types of transactions which are allowed and/or authorized, the goods and/or services which may be purchased with the account, the vendors, stores and/or service providers, which may be authorized to accept the payment via the account, limits on the dollar or other monetary amounts of transactions pertaining to each authorized vendor, seller, and/or service provider, daily spending limits, and/or the geographical area or location wherein authorized account use may be limited, and/or authorized times for account usage, such as, but not limited to, specific days, dates, time of day, time of month, year, and/or any other time of use, and/or any other limitation and/or restriction regarding amount of transaction, parties involved, geographical area, and/or times of allowed usage.

The database 10H can also contain or include, for each account, data and/or information regarding transactions processed on or involving the account. The data and/or information can also include, for each of any number of transactions for each or any number of accounts, a picture, a photograph, or a video clip, of the account holder or other user or individual involved in a transaction, and/or audio information, a voice message or sample, and/or a voice print, which is a digital representation of a voice message or sample, obtained from the account holder or other user or individual involved in the transaction, for each of any number of transactions processed by the central processing computer 10. For example, for any given account, the central processing computer 10 can store information for any number of transactions occurring on a given account. In this manner, a picture, a photograph, or a video clip, of the account holder or user or individual involved in a transaction, and/or audio information, a voice message or sample, and/or a voice print, which is a digital representation of a voice message or sample, obtained from the account holder or other user or individual involved in the transaction, can be stored for any number of transactions on a respective account, in order to perform identity verification for an account holder or other user or individual involved in a transaction.

The database 10H can also contain or include copies of any of the images, digital copies, photographs, or pictures, of any of the respective documents, authorization forms, checks, forms, receipts, request forms, or other entities, which have been, or which were, offered, presented, submitted, processed, involved, or used, in or involving, or related to, a transaction or transactions on or involving any of the accounts serviced by the apparatus 100.

It is envisioned that an account holder, or other authorized user or individual, of a respective account can submit a photograph or picture or his or her face which can be stored in the database 10H as a “file photograph” or a “file picture” associated with the respective account. In a preferred embodiment, the “file photograph” or “file picture” can be stored as a digital file. It is also envisioned that the account holder or authorized user or individual can also submit a pre-recorded voice message which can be digitized into a voice print which can be stored as a “file voiceprint”.

In processing a transaction involving a respective account, the central processing computer 10 can process a picture, a photograph, or a video clip, of the account holder or user or individual involved in the transaction, and/or audio information, a voice message or sample, and/or a voice print, obtained from the account holder or user or individual involved in the transaction using the respective “file photograph”, “file picture”, and/or “file voice print”, and/or can provide the “file photograph”, “file picture”, and/or “file voice print”, to a counterparty communication device 40 so that the operator of same can use same in verifying that the account holder or user or individual is the account holder associated with the account or is an authorized user or individual associated with the account.

The database 10H can also contain or include account statements or periodic transaction records, for each of the account holder accounts or user accounts serviced by the apparatus 100. The database 10H can also contain or include account statements or periodic transaction records for each of the counterparty accounts or merchant accounts serviced by the apparatus 100.

The database 10H can also contain and/or include, for each account holder account or user account, and for each communication device(s) 20 associated with the account holder or user or the account holder account or user account, data and/or information regarding account statements, historical statements, periodic transaction records, and/or any other data and/or information regarding past transactions which have occurred on the respective account, data and/or information regarding the communication device 20 utilized in connection with a particular transaction, and/or any information for providing periodic transaction statements showing or listing activities, and/or attempted transactions which have occurred on an account, the communication device 20 involved, the counterparty communication device 40 involved, the date and time of the transaction, the account holder or user involved in the transaction, or the counterparty or merchant involved in the transaction, and/or the transaction amount and the subject of the transaction, such as, but not limited to, the products, goods, or services, which are the subject of the transaction.

The database 10H can also contain and/or include data and/or information for providing periodic transaction reports showing or listing, for each communication device 20 associated with an account, or attempted activities, on or involving the account, including transactions which have occurred on or using the communication device 20, including, but not limited to, data and/or information regarding the transaction, the counterparty communication device 40 involved, the date and time of the transaction, the account holder or user involved in the transaction, or the counterparty or merchant involved in the transaction, and/or the transaction amount and the subject of the transaction, such as, but not limited to, the products, goods, or services, which are the subject of the transaction or activities that were authorized or completed and/or which were not authorized or disallowed.

The database 10H can also contain or include, for each account, data and/or information regarding a barcode containing information regarding the account number associated with the respective account, data and/or information regarding a two-dimensional containing information regarding the account number associated with the respective account, and/or data and/or information regarding a QR code or Quick Response code containing information regarding the account number associated with the respective account. The database 10H can also contain data and/or information and/or software processing routines for scanning, reading, and/or deciphering, data and/or information contained in a barcode, a two-dimensional barcode, and/or a QR code or Quick Response code.

In a preferred embodiment, the database 10H contains and/or includes data and/or information regarding each merchant, vendor, seller, supplier, or any provider of any good(s), product(s), or service(s), service provider, professional service provider, or any other person, individual, business, or other entity (hereinafter also referred to as a “counterparty”) who or which utilizes the apparatus 100 of the present invention, and for each counterparty, his, her, or its, name, address, contact information, telephone number(s), cellular telephone number(s), wireless telephone number(s), personal communication device telephone number(s), e-mail address(es), IP address(es), text message number(s) or information, SMS message(s) or information, SMS message(s) or information, and/or any other contact or other information, account information for any account into which payments are received for the counterparty and/or any other accounts of the counterparty, information regarding any and/or all accounts of the counterparty, account numbers, account expiration dates, security codes or numbers, personal identification numbers (PINs), password(s), access code(s), social security numbers or employer identification numbers, account credit limit(s), account spending limit(s), account deductible(s), and/or any other data and/or information regarding each counterparty and his, her, or its, accounts. In the case of individuals, the database 10H can also contain and/or include data and/or information regarding the counterparty's contact information or emergency contact information.

The database 10H can also contain and/or include, for each counterparty or for each user of an account of a counterparty, a description of the counterparty, an employee or agent of the counterparty, or user, a photograph or video clip of the counterparty, an employee or agent of the counterparty, or user, data and/or information regarding a digital voiceprint of the counterparty, an employee or agent of the counterparty, or user, or data and/or information for verifying an identity of the counterparty, an employee or agent of the counterparty, or user, by his or her voiceprint, data and/or information regarding a retinal scan of the counterparty, an employee or agent of the counterparty, or user, or data and/or information for verifying an identity of the counterparty, an employee or agent of the counterparty, or user, by his or her retinal scan, data and/or information regarding a fingerprint of the counterparty, an employee or agent of the counterparty, or user, or data and/or information for verifying an identity of the counterparty, an employee or agent of the counterparty, or user, by his or her fingerprint, and/or any other data and/or information for identifying and identity of the counterparty, an employee or agent of the counterparty, or user, using biometric data and/or information.

In a preferred embodiment, the database 10H can also contain and/or include, for each counterparty, an employee or agent of the counterparty, or user, data and/or information regarding each counterparty communication device 40 which is or can be used by the counterparty, an employee or agent of the counterparty, or user, in utilizing the apparatus 100 and method of the present invention, including, but not limited to, data and/or information regarding an identification of each counterparty communication device 40, a description of, or type or kind of, the counterparty communication device 40, manufacturer, model number, and/or serial number or any other identification information, of, for, or regarding, the counterparty communication device 40, and/or the assigned telephone number, e-mail address, text messaging or SMS messaging number, MMS messaging number, and/or IP address, or any network identification information, of, for, or associated with, the counterparty communication device 40.

The database 10H can also contain and/or include, for each account serviced by the apparatus 100 for the counterparty, information about the counterparty, the counterparty's account number(s) for any and/or all accounts of the counterparty, previous transactions made or involving the account, previous unauthorized transactions made on or involving the account or attempted to be made on or involving the account, previous unauthorized sales made on or involving the account or attempted to be made on or involving the account, number of authorized and/or unauthorized transactions or sales, account statements, historical account statements, and/or any other data and/or information needed, desired, and/or necessary, to manage and/or process an account transaction for a counterparty as described herein. The database 10H can also contain and/or include data and/or information regarding account statements, historical account statements, pending transactions, pending authorizations, and/or any other data and/or information regarding account activity and/or account activities for the counterparty.

The database 10H can also contain and/or include, for each account serviced by the apparatus 100 for a counterparty, information regarding an counterparty's requests or instructions to receive alerts or alert messages regarding any transactions occurring on any of his, her, or its accounts.

The database 10H can also contain or include, for each account serviced by the apparatus 100, the phone number or IP address of the respective central processing computer 10 which performs transaction authorization processing for the respective account. The database 10H can also contain or include a link(s) or hyperlink(s) to any central processing computer(s) 10 associated with any of the accounts held by, owned by, or associated with, each counterparty serviced by the apparatus 100 of the present invention. The database 10H can also contain or include a link(s) or hyperlink(s) to any transaction page or web page or pages or web pages associated with the central processing computer(s) 10 associated with any of the accounts held by, owned by, or associated with, each counterparty who or which utilizes the apparatus 100 of the present invention.

The database 10H can also contain or include, for each account of a counterparty, the times or hours of operation for each of the respective central processing computer(s) 10 which perform transaction authorization processing for any of the accounts serviced for the counterparty by the apparatus 100 of the present invention.

The database 10H can also contain or include, for each account of a counterparty, data and/or information regarding specific limitations and/or restrictions which may be placed on a particular account, which may be pre-selected and/or programmed by the counterparty and/or which may include limitations and/or restrictions on the usage of the account or any cards or account numbers associated with the account and/or which may be placed on the account by the entity which issued the account or which services the account. The limitations and/or restrictions may include the types of transactions which are allowed and/or authorized, the goods and/or services which may be sold with the account, the employees or agents of the counterparty, or other users, who or which may be authorized to perform transactions on or involving the account, limits on the dollar or other monetary amounts of transactions which can be entered into involving the account, daily use limitations, and/or the geographical area or location wherein authorized account use may be limited, and/or authorized times for account usage, such as, but not limited to, specific days, dates, time of day, time of month, year, and/or any other time of use, and/or any other limitation and/or restriction regarding amount of transaction, parties involved, geographical area, and/or times of allowed usage.

The database 10H can also contain or include, for each account of a counterparty, data and/or information regarding transactions processed on or involving the account. The data and/or information can also include, for each of any number of transactions for each or any number of accounts of a counterparty, a picture, a photograph, or a video clip, of the counterparty, or of an employee or agent of same, or other authorized user, who or which can be involved in a transaction on or involving the account, and/or audio information, a voice message or sample, and/or a voice print, which is a digital representation of a voice message or sample, obtained from the counterparty, or of an employee or agent of same, or other authorized user, who or which can be involved in a transaction on or involving the account, for each of any number of transactions processed by the central processing computer 10. For example, for any given account, the central processing computer 10 can store information for any number of transactions occurring on a given account. In this manner, a picture, a photograph, or a video clip, of the counterparty, or of an employee or agent of same, or other authorized user, who or which can be involved in a transaction on or involving the account, and/or audio information, a voice message or sample, and/or a voice print, which is a digital representation of a voice message or sample, obtained from the counterparty, or of an employee or agent of same, or other authorized user, who or which can be involved in a transaction on or involving the account, can be stored for any number of transactions on a respective counterparty account, in order to perform identity verification for a counterparty or other user or individual involved in a transaction on or involving an account of the counterparty.

The database 10H can also contain or include copies of any of the images, digital copies, photographs, or pictures, of any of the respective documents, authorization forms, checks, forms, receipts, request forms, or other entities, which have been, or which were, offered, presented, submitted, processed, involved, or used, in or involving, or related to, a transaction or transactions on or involving any of the accounts of a counterparty serviced by the apparatus 100.

It is envisioned that a counterparty, or an employee or agent of the counterparty, or any other authorized user or individual, of a respective counterparty account can submit a photograph or picture or his or her face which can be stored in the database 10H as a “file photograph” or a “file picture” associated with the respective counterparty account. In a preferred embodiment, the “file photograph” or “file picture” can be stored as a digital file. It is also envisioned that the counterparty, or an employee or agent of the counterparty, or any other authorized user or individual, of a respective counterparty account can also submit a pre-recorded voice message which can be digitized into a voice print which can be stored as a “file voiceprint”.

In processing a transaction involving a respective counterparty account, the central processing computer 10 can process a picture, a photograph, or a video clip, of the counterparty, or an employee or agent of the counterparty, or any other authorized user or individual involved in the transaction, and/or audio information, a voice message or sample, and/or a voice print, obtained from the counterparty, or an employee or agent of the counterparty, or any other authorized user or individual involved in the transaction using the respective “file photograph”, “file picture”, and/or “file voice print”, and/or can provide the “file photograph”, “file picture”, and/or “file voice print”, to a communication device 20 so that the account holder or other authorized user of the account holder's account can use same in verifying that the counterparty, or an employee or agent of the counterparty, or any other authorized user or individual is, in fact, the counterparty, or an employee or agent of the counterparty, or any other authorized user or individual with whom the account holder or other authorized user or individual is intending to conduct the transaction.

The database 10H can also contain or include, for each counterparty account, data and/or information regarding account statements, historical statements, periodic transaction records, and/or any other data and/or information regarding past transactions and/or activities, and/or attempted transactions or attempted activities, on or involving the counterparty account, including transactions or activities that were authorized or completed and/or which were not authorized or disallowed.

The database 10H can also contain or include, for each counterparty account, data and/or information regarding a barcode containing information regarding the counterparty account number associated with the respective counterparty account, data and/or information regarding a two-dimensional containing information regarding the account number associated with the respective counterparty account, and/or data and/or information regarding a QR code or Quick Response code containing information regarding the account number associated with the respective counterparty account. The database 10H can also contain data and/or information and/or software processing routines for scanning, reading, and/or deciphering, data and/or information contained in a barcode, a two-dimensional barcode, and/or a QR code or Quick Response code.

The database 10H can also contain or include, for each account held by the account holder which is serviced by the apparatus 100 of the present invention, data and/or information regarding or pertaining to the account, the type of the account, such as, but not limited to, whether the account is a credit account, a credit card account, a charge card account, a charge account, a debit card account, or a debit account, or a bank account, a checking account, or a savings account, or a brokerage account, a pension account, an individual retirement account (IRA), or a self-employed pension (SEP) account, or a “smart” card account, a currency card account, a healthcare account, a Medicare account, or a Medicaid account, or an employee benefits account, a cafeteria account, or a spending account, or a subscription account for any goods, products, or services, or an insurance account, a healthcare insurance account, a healthcare spending account, a life insurance account, or a disability insurance account, or a tuition account, a pharmacy account, or credit report account, a financial account, an electronic money account, or an electronic cash account, or a communication account, a telephone account, a wireless communication device account, a non-wireless communication device account, a cellular communication device account, a cellular telephone account, an Internet account, or an Internet service provider account, an electronic signature account, an e-mail account, a membership account, a text messaging account, a customer loyalty membership account, a club membership account, a social network membership account, or any other account of the type or variety described herein, and/or the account number or an account identifier for the account, the telephone number, e-mail address, or the IP address, identified with the account, and/or any and/or all data and/or information regarding the account issuer or the account service provider, servicing entity, or transaction authorizing processing provider or entity, including, but not limited to, the telephone number, e-mail address, or the IP address, for, associated with, or identified with, the account, and/or with the account issuer or the account service provider, servicing entity, or transaction authorizing processing provider or entity, or any other entity which issued and/or which services the account, whether the account issuer or the account service provider, servicing entity, or transaction authorizing processing provider or entity, or any other entity, is the VISA®, MASTERCARD®, DISCOVER®, or AMERICAN EXPRESS®, financial services company, or any bank, financial institution, financial intermediary, brokerage firm, financial services company or entity, insurance company, or any provider of any good(s), product(s), or service(s), or any other entity which issues or which services any account described herein, or any entity which provides transaction authorization processing for or which provides transaction authorization processing services for any of the herein-described accounts, the telephone number, uniform resource locator (url), IP address, e-mail address, and/or web address, of the respective central processing computer 10 which processes transaction authorization requests and/or transactions for, on, or involving the respective account, and/or the telephone number, uniform resource locator (url), IP address, e-mail address, and/or web address, needed to perform transaction authorization processing by the pertinent and/or the respective central processing computer 10 which processes transaction authorization requests and/or transactions for, on, or involving the respective account.

In this regard, the data and/or information regarding the account also includes any needed and/or desired data and/or information for allowing an account holder communication device 20 to access and/or communicate with the respective central processing computer 10, which performs transaction authorization processing for a transaction on or involving the account, in order to obtain transaction authorization processing for a transaction. For example, in the case of a credit account, the data and/or information for that account can include a telephone number or IP address which be utilized by the account holder communication device 20 to access the central processing computer 10, which performs transaction authorization processing for that credit account, with his or her communication device 20. The data and/or information for that account can include a telephone number or IP address which be utilized by the account holder communication device 20 to access and/or communicate with, automatically and/or otherwise, the central processing computer 10, which performs transaction authorization processing for that credit account.

The database 10H can also contain and/or include, for each account, any access code(s), security code(s), password(s), or any other data and/or information regarding the account. The database 10H can also contain and/or include, for each account and for each communication device 20 registered to be utilized with the account, the manufacturer, model number, and/or serial number, and/or telephone number, e-mail address, IP address, text messaging number, SMS messaging number, MMS messaging number, or any other identifying information and/or contact information for or regarding each such communication device 20.

The database 10H can also contain or include, for each account held by the counterparty which is serviced by the apparatus 100 of the present invention, data and/or information regarding or pertaining to the counterparty's account, the type or kind of the account, such as, but not limited to, a financial account or a non-financial account, or any other of the types or variety of accounts described herein, the account number or an account identifier for the counterparty account, the telephone number, e-mail address, or the IP address, identified with the counterparty account, and/or data and/or information for or regarding the account issuer or the account service provider, servicing entity, or transaction authorizing processing provider or entity, including, but not limited to, the telephone number, e-mail address, or the IP address, for, associated with, or identified with, the counterparty account, and/or with the account issuer or the account service provider, servicing entity, or transaction authorizing processing provider or entity, or any other entity which issued and/or which services the counterparty account.

The database 10H can also contain or include, for each account held by the counterparty, data and/or information regarding the counterparty communication device(s) 40 associated with the counterparty account, and the telephone number, e-mail address, or the IP address, or other contact information, identified with each counterparty communication device 40. In this regard, the data and/or information regarding the counterparty account also includes any needed and/or desired data and/or information for allowing any respective central processing computer 10 to access and/or communicate with the respective counterparty communication device 40 in or during, or as part of, a processing of a transaction authorization processing operation or activity and/or to obtain transaction authorization processing information from the counterparty communication device 40 and/or to transmit any of the herein-described messages, transaction authorized messages, transaction not authorized messages, or any other messages, signals, data and/or information, from the pertinent central processing computer 10, to the counterparty communication device 40. For example, in the case of a credit account transaction, the data and/or information for the counterparty's account can include a telephone number or IP address which can be utilized by the central processing computer 10, which performs transaction authorization processing for that credit account, to access and/or communicate with the counterparty communication device 40. The data and/or information for that account can include a telephone number or IP address which be utilized by the central processing computer 10, which performs transaction authorization processing for that credit account, to access and/or communication with, automatically and/or otherwise, the counterparty communication device 40.

The database 10H can also contain and/or include, for each account, any access code(s), security code(s), password(s), or any other data and/or information regarding the account. The database 10H can also contain and/or include, for each account and for each counterparty communication device 40 registered to be utilized with the counterparty account, the manufacturer, model number, and/or serial number, and/or telephone number, e-mail address, IP address, text messaging number, SMS messaging number, MMS messaging number, or any other identifying information and/or contact information for or regarding each such counterparty communication device 40.

The database 10H can also contain or include any of the data and/or information described herein as being stored in the databases of any of the communication devices 20 and counterparty communication devices 40 described herein. The database 10H can also contain or include any data and/or information stored in any of the account holder bank computer system(s) 30 and counterparty bank computer system(s) 50 described herein.

The database 10H can also contain or include any and/or all data and/or information and/or any software programs, routines, and/or software applications or “apps”, needed or desired for performing any and/or of the processing routines, functions, and/or functionality, described herein as being provided by or performed by the apparatus 100 of the present invention and/or by the central processing computer(s) 10, the communication devices(s) 20, the counterparty communication device(s) 40, the account holder bank computer system(s) 30, and the counterparty bank computer system(s) 50, described herein.

The database 10H can also contain or include any and/or all data and/or information and/or any software programs, routines, and/or software applications or “apps”, needed or desired for performing any and/or of the processing routines, functions, and/or functionality, described herein as being provided by any of the herein-described communication devices 20 or counterparty communication devices 40, which such data and/or information and/or software applications or “apps”, being downloadable to the communication device(s) 20 and/or counterparty communication device(s) 40 if and when needed or desired.

In a preferred embodiment, the database 10H can also contain or include any and/or all data and/or information needed, desired, or utilized, by the apparatus 100, or by the central processing computer(s) 10 and/or by the communication devices(s) 20, the counterparty communication device(s) 40, the account holder bank computer system(s) 30, and the counterparty bank computer system(s) 50 described herein for or in performing any and/or all of the processing routines, operations, functions, and/or functionality, described herein as being performed by the apparatus 100 and method of the present invention.

The central processing computer 10 also includes an output device 101, which is also connected to the CPU 10A, for outputting any data and/or information, described herein. In the preferred embodiment, the output device 101 can be a printer, a display, a transmitter, a modem, and/or any other device which can be used to output data or information.

The central processing computer 10 can also be equipped with a global positioning device 10J which can be connected to the CPU 10A and which can be utilized to calculate, determine, or ascertain, the position or location of the central processing computer 10.

The central processing computer 10 can also include a video and/or audio recording device 10K which, in a preferred embodiment, can include a camera, a video recoding device, a microphone, and/or an audio recording device. The video and/or audio recording device 10K can be utilized to take a picture, record video, record a video clip, record sound, record audio, or record an audio clip, of a user of the central processing computer 10 and/or to record any picture, a sound or voice, video information, or audio information at the central processing computer 10.

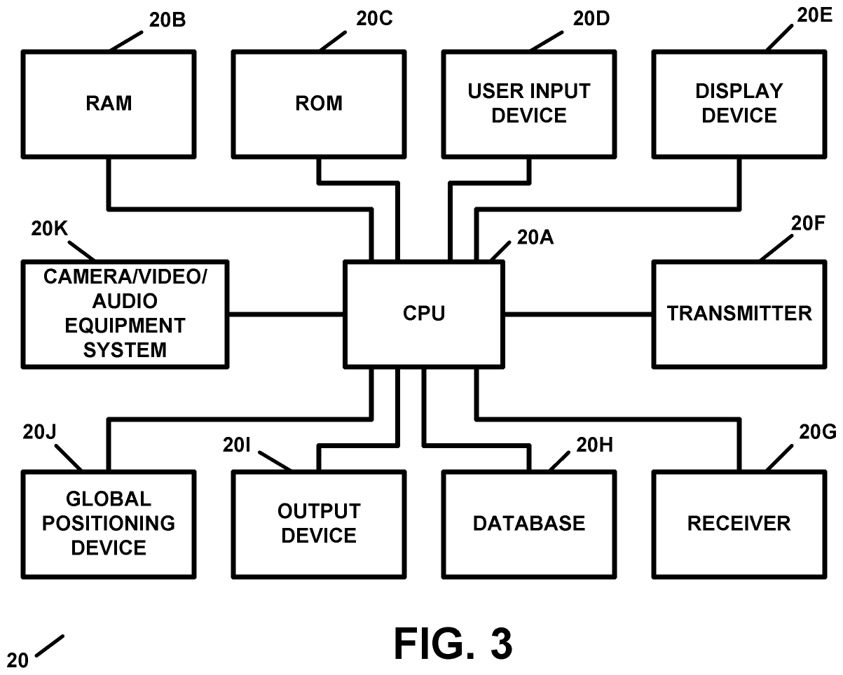

FIG. 3 illustrates a preferred embodiment of the communication device 20 of FIG. 1, in block diagram form. In a preferred embodiment, the communication device 20 is associated with or used by an account holder. In another preferred embodiment, the communication device 20 can also be associated with or used by any user or individual who or which is authorized to use the account of the account holder.

In a preferred embodiment, the communication device 20 can be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the communication device 20. In a preferred embodiment, the communication device 20 can also be a cellular telephone, a personal digital assistant, or a Smartphone or smart phone which can be utilized as an electronic wallet.

In the preferred embodiment, the communication device 20 includes a central processing unit or CPU 20A, which in the preferred embodiment, is a microprocessor. The CPU 20A may also be a microcomputer, a minicomputer, a macro-computer, and/or a mainframe computer, depending upon the application.

The communication device 20 also includes a random access memory device(s) 20B (RAM) and a read only memory device(s) 20C (ROM), each of which is connected to the CPU 20A, and a user input device 20D, for entering data, information, and/or commands, into the communication device 20, which includes any one or more of a keyboard, a scanner, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a touch screen, and/or a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus 100 of the present invention, into the communication device 20. The input device 20D can also be any other input device(s) which are or can be utilized with or in connection with any of the communication device(s) 20 described herein as being utilized in connection with the apparatus 100 of the present invention.

The input devices 20D are also connected to or with, or linked to or with, the CPU 20A. In a preferred embodiment, the input device 20D can also include a retinal scanner, a fingerprint recognition device, a voice recognition device, or any other type or kind of biometric device which can be used for determining whether or not a user or operator of the communication device 20 is an authorized user, individual, or person. The communication device 20 also includes a display device 20E for displaying data and/or information to a user or operator.

The communication device 20 also includes a transmitter(s) 20F, for transmitting signals and/or data and/or information, or a message(s), to any one or more of the central processing computer(s) 10, the counterparty communication device(s) 40, the account holder bank computer system(s) 30, and the counterparty bank computer system(s) 50, and/or any other communication devices(s) 20 described herein.

The communication device 20 can also be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any of the central processing computer(s) 10, the counterparty communication device(s) 40, the account holder bank computer system(s) 30, and the counterparty bank computer system(s) 50, and/or any other communication devices(s) 20 described herein.

The communication device 20 also includes a receiver(s) 20G, for receiving signals and/or data and/or information, or a message(s), from any of the central processing computer(s) 10, the counterparty communication device(s) 40, the account holder bank computer system(s) 30, and the counterparty bank computer system(s) 50, and/or any other communication devices(s) 20 described herein.

The communication device 20 also includes a database(s) 20H, which is also connected to or linked with the CPU 20A, which can contain and/or include any and/or all of the data and/or information needed or desired for performing any and/or all of the functions and/or functionality described herein as being performed by the apparatus 100 and method of the present invention and/or the communication device 20.

In a preferred embodiment, the database 20H contains and/or includes, for each account with which the communication device 20 can be utilized, data and/or information regarding the account holder of the account and any authorized user or individual who can utilize the account, including, but not limited to, his, her, or its, name, address, contact information, telephone number(s), cellular telephone number(s), wireless telephone number(s), personal communication device telephone number(s), e-mail address(es), IP address(es), text message number(s) or information, SMS message(s) or information, MMS message(s) or information, employer information, work information, emergency contact information, and/or any other contact or other information, account information, information regarding any and/or all accounts of the account holder, account numbers, account expiration dates, security codes or numbers, personal identification numbers (PINs), password(s), access code(s), social security numbers, account credit limit(s), account spending limit(s), account deductible(s), and/or any other data and/or information regarding the account holder of the account and any user(s) or individual(s) authorized to use the account. In the case of individuals, the database 20H can also contain and/or include data and/or information regarding the account holder's relatives, friends, next of kin, or other contact information or emergency contact information.

The database 20H can also contain or include, for each account, the phone number or IP address of the respective central processing computer 10 which performs transaction authorization processing for the respective account. The database 20H can also contain or include a link(s) or hyperlink(s) to each of any of the central processing computer(s) 10 associated with any of the accounts held by, owned by, or associated with, the account holder. The database 20H can also contain or include a link(s) or hyperlink(s) to any transaction page or pages associated with the central processing computer(s) 10 associated with any of the accounts held by, owned by, or associated with, the account holder. The database 20H can also contain or include a link(s) or hyperlink(s) to any counterparty communication device(s) 40 associated with any of counterparty who or with which the account can be utilized, and/or who or with which the account holder or any authorized user or individual associated with a respective account can engage in a transaction(s). The database 20H can also contain or include, for each account, the times or hours of operation for each of the respective central processing computer 10 which performs transaction authorization processing for the respective account.

The database 20H can also contain or include, for each account, contact information and/or customer service information, including, but not limited to telephone number(s), e-mail address(es), or instant messaging number or SMS messaging number, MMS messaging number, or account administrator information or customer service agent information, for the respective central processing computer 10 which performs transaction authorization processing for the respective account.

The database 20H can also contain or include a link(s) or hyperlink(s) to any account holder bank computer system(s) 30 associated with a respective account or which administers a financial account associated with the respective account. The database 20H can also contain or include a link(s) or hyperlink(s) to any counterparty bank computer system(s) 50 associated with a respective counterparty with whom the account can be utilized.

The database 20H can also contain and/or include, for each account holder of the account and for any or each user or individual authorized to use the account, a description of the account holder or user or individual, a photograph or video clip of the account holder or user or individual, data and/or information regarding a digital voiceprint of the account holder or user or individual, or data and/or information for verifying an identity of the account holder or user or individual by his or her voiceprint, data and/or information regarding a retinal scan of the account holder or user or individual or data and/or information for verifying an identity of the account holder or user or individual by his or her retinal scan, data and/or information regarding a fingerprint of the account holder or user or individual or data and/or information for verifying an identity of the account holder or user or individual by his or her fingerprint, and/or any other data and/or information for identifying and identity of the account holder or user or individual using biometric data and/or information.

In a preferred embodiment, the database 20H can also contain and/or include, for each account holder or user or individual, data and/or information regarding each communication device 20 which is or can be used by the account holder or user or individual in utilizing the apparatus 100 and method of the present invention, including, but not limited to, data and/or information regarding an identification of each communication device 20, a description of, or type or kind of, the communication device 20, manufacturer, model number, and/or serial number or any other identification information, of, for, or regarding, the communication device 20, and/or the assigned telephone number, e-mail address, text messaging or SMS messaging number, MMS messaging number, and/or IP address, or any network identification information, of, for, or associated with, the communication device 20.

The database 20H can also contain and/or include, for each account serviced by the communication device 20, information about the account holder, the account holder's account number(s), credit and/or account limit(s), spending limit(s), previous transactions, previous purchases, previous unauthorized transactions made on or involving the account or attempted to be made on or involving the account, previous unauthorized purchases made on or involving the account or attempted to be made on or involving the account, number of authorized and/or unauthorized transaction or purchases, account statements, historical account statements, and/or any other data and/or information needed, desired, and/or necessary, to manage and/or process an account transaction as described herein. The database 20H also contains and/or includes data and/or information regarding account statements, historical account statements, pending transactions, pending authorizations, and/or any other data and/or information regarding account activity and/or account activities.

The database 20H can also contain and/or include, for each account serviced by the communication device 20, data and/or information about the account holder, the account holder's account number(s), credit and/or account limit(s), spending limit(s), previous transactions, previous purchases, previous unauthorized transactions made on or involving the account or attempted to be made on or involving the account, previous unauthorized purchases made on or involving the account or attempted to be made on or involving the account, number of authorized and/or unauthorized transaction or purchases, account statements, historical account statements, and/or any other data and/or information needed, desired, and/or necessary, to manage and/or process an account transaction as described herein. The database 20H also contains and/or includes data and/or information regarding account statements, historical account statements, pending transactions, pending authorizations, and/or any other data and/or information regarding account activity and/or account activities.

The database 20H can also contain and/or include, for each account serviced by the communication device 20, data and/or information regarding an account holder's requests or instructions to receive alerts or alert messages regarding any transactions occurring on any of his, her, or its accounts.

The database 20H can also contain or include, for each account serviced by the communication device 20, the phone number, telephone number, url, or IP address of the respective central processing computer 10 which performs transaction authorization processing for the respective account. The database 20H can also contain or include a link(s) or hyperlink(s) to any central processing computer(s) 10 associated with any of the accounts held by, owned by, or associated with, each account holder serviced by the apparatus 100 of the present invention and/or by the communication device 20. The database 20H can also contain or include a link(s) or hyperlink(s) to any transaction page or web page or pages or web pages associated with the central processing computer(s) 10 associated with any of the accounts held by, owned by, or associated with, each account holder.

The database 20H can also contain or include a link(s) or hyperlink(s) to each of the herein-described communication devices 20, counterparty communication devices 40, account holder bank computer system(s) 30, the counterparty bank computer system(s) 50, and/or any other central processing computer(s) 10, which are utilized in connection with the apparatus 100 of the present invention.

The database 20H can also contain or include, for each account, the times or hours of operation of the communication device 20 and/or for each of the respective central processing computer(s) 10 which perform transaction authorization processing for any of the accounts serviced by the apparatus 100 of the present invention and/or by the communication device 20.

The database 20H can also contain or include, for each account serviced by the communication device 20, data and/or information regarding specific limitations and/or restrictions which may be placed on a particular account, which may be pre-selected and/or programmed by the account holder and/or which may include limitations and/or restrictions on the usage of the account or any cards or account numbers associated with the account and/or which may be placed on the account by the entity which issued the account or which services the account. The limitations and/or restrictions may include the types of transactions which are allowed and/or authorized, the goods and/or services which may be purchased with the account, the vendors, stores and/or service providers, which may be authorized to accept the payment via the account, limits on the dollar amounts or other monetary amounts of transactions pertaining to each authorized vendor, seller, and/or service provider, daily spending limits, and/or the geographical area or location wherein authorized account use may be limited, and/or authorized times for account usage, such as, but not limited to, specific days, dates, time of day, time of month, year, and/or any other time of use, and/or any other limitation and/or restriction regarding amount of transaction, parties involved, geographical area, and/or times of allowed usage.

The database 20H can also contain or include, for each account serviced by the communication device 20, data and/or information regarding transactions processed on or involving the account. The data and/or information can also include, for each of any number of transactions for each or any number of accounts, a picture, a photograph, or a video clip, of the account holder or other user or individual involved in a transaction, and/or audio information, a voice message or sample, and/or a voice print, which is a digital representation of a voice message or sample, obtained from the account holder or other user or individual involved in the transaction, for each of any number of transactions processed by the central processing computer 10 and/or the communication device 20 for the account. For example, for any given account, the central processing computer 10 and/or the communication device 20 can store information for any number of transactions occurring on a given account. In this manner, a picture, a photograph, or a video clip, of the account holder or user or individual involved in a transaction, and/or audio information, a voice message or sample, and/or a voice print, which is a digital representation of a voice message or sample, obtained from the account holder or other user or individual involved in the transaction, can be stored for any number of transactions on a respective account, in order to perform identity verification for an account holder or other user or individual involved in a transaction.

The database 20H can also contain or include copies of any of the images, digital copies, photographs, or pictures, of any of the respective documents, authorization forms, checks, forms, receipts, request forms, or other entities, which have been, or which were, offered, presented, submitted, processed, involved, or used, in or involving, or related to, a transaction or transactions on or involving any of the accounts serviced by the communication device 20.

It is envisioned that an account holder, or other authorized user or individual, of a respective account can submit a photograph or picture or his or her face which can be stored in the database 20H as a “file photograph” or a “file picture” associated with the respective account. In a preferred embodiment, the “file photograph” or “file picture” can be stored as a digital file. It is also envisioned that the account holder or authorized user or individual can also submit a pre-recorded voice message which can be digitized into a voice print which can be stored in the communication device 20 as a “file voiceprint”.

In processing a transaction involving a respective account, the communication device 20 can process a picture, a photograph, or a video clip, of the account holder or user or individual involved in the transaction, and/or audio information, a voice message or sample, and/or a voice print, obtained from the account holder or user or individual involved in the transaction using the respective “file photograph”, “file picture”, and/or “file voice print”, and/or can provide the “file photograph”, “file picture”, and/or “file voice print”, to a central processing computer 10 and/or to a counterparty communication device 40 so that the operator of same can use same in verifying that the account holder or user or individual is the account holder associated with the account or is an authorized user or individual associated with the account.

The database 20H can also contain or include, for each account serviced by the communication device 20, data and/or information regarding account statements, historical statements, periodic transaction records, and/or any other data and/or information regarding past transactions and/or activities, and/or attempted transactions or attempted activities, on or involving the account, including transactions or activities that were authorized or completed and/or which were not authorized or disallowed.

The database 20H can also contain or include, for each account serviced by the communication device 20, data and/or information regarding a barcode containing information regarding the account number associated with the respective account, data and/or information regarding a two-dimensional containing information regarding the account number associated with the respective account, and/or data and/or information regarding a QR code or Quick Response code containing information regarding the account number associated with the respective account. The database 20H can also contain data and/or information and/or software processing routines for scanning, reading, and/or deciphering, data and/or information contained in a barcode, a two-dimensional barcode, and/or a QR code or Quick Response code.

The database 20H can also contain and/or include, for each account serviced by the communication device 20, information regarding an account holder's requests or instructions to receive alerts or alert messages regarding any transactions occurring on any of his, her, or its account(s).

The database 20H can also contain or include data and/or information regarding specific limitations and/or restrictions which may be placed on a particular account, which may be pre-selected and/or programmed by the account holder and which may include limitations and/or restrictions on the usage of the account or any cards or account numbers associated with the account. The limitations and/or restrictions may include the types of transactions which are allowed and/or authorized, the goods and/or services which may be purchased with the account, the vendors, stores and/or service providers, which may be authorized to accept the payment via the account, limits on the dollar or other monetary amounts of transactions pertaining to each authorized vendor, seller, and/or service provider, daily spending limits, and/or the geographical area or location wherein authorized account use may be limited, and/or authorized times for account usage, such as, but not limited to, specific days, dates, time of day, time of month, year, and/or any other time of use, and/or any other limitation and/or restriction regarding amount of transaction, parties involved, geographical area, and/or times of allowed usage.

The database 20H can also contain or include, for each account, data and/or information regarding transactions processed on or involving the account. The data and/or information can also include, for each of any number of transactions for each or any number of accounts, a picture, a photograph, or a video clip, of the account holder or other user or individual involved in a transaction, and/or audio information, a voice message or sample, and/or a voice print, which is a digital representation of a voice message or sample, obtained from the account holder or other user or individual involved in the transaction, for each of any number of transactions processed by the communication device 20. For example, for any given account, the communication device 20 can store information for any number of transactions occurring on a given account. In this manner, a picture, a photograph, or a video clip, of the account holder or user or individual involved in a transaction, and/or audio information, a voice message or sample, and/or a voice print, which is a digital representation of a voice message or sample, obtained from the account holder or other user or individual involved in the transaction, can be stored for any number of transactions on a respective account, in order to perform identity verification for an account holder or other user or individual involved in a transaction.

The database 20H can also contain or include copies of any of the images, digital copies, photographs, or pictures, of any of the respective documents, authorization forms, checks, forms, receipts, request forms, or other entities, which have been, or which were, offered, presented, submitted, processed, involved, or used, in or involving, or related to, a transaction or transactions on or involving any of the accounts serviced by the communication device 20.

As noted herein, it is envisioned that an account holder, or other authorized user or individual, of a respective account can take a photograph or picture or his or her face which can be stored in the database 20H as a “file photograph” or a “file picture” associated with the respective account. In a preferred embodiment, the “file photograph” or “file picture” can be stored as a digital file in the communication device database 20H. It is also envisioned that the account holder or authorized user or individual can also record a voice message which can be digitized into a voice print which can be stored as a “file voiceprint”.

In processing a transaction involving a respective account, the communication device 20 can process a picture, a photograph, or a video clip, of the account holder or user or individual involved in the transaction, and/or audio information, a voice message or sample, and/or a voice print, obtained from the account holder or user or individual involved in the transaction using the respective “file photograph”, “file picture”, and/or “file voice print”, and/or can provide the “file photograph”, “file picture”, and/or “file voice print”, to a counterparty communication device 40 so that the operator of same can use same in verifying that the account holder or user or individual is the account holder associated with the account or is an authorized user or individual associated with the account. In processing a transaction involving a respective account, the communication device 20 can process a picture, a photograph, or a video clip, of the account holder or user or individual involved in the transaction, and/or audio information, a voice message or sample, and/or a voice print, obtained from the account holder or user or individual involved in the transaction using the respective “file photograph”, “file picture”, and/or “file voice print”, and/or can provide the “file photograph”, “file picture”, and/or “file voice print”, to the central processing computer 10.

The database 20H can also contain or include, for each account, data and/or information regarding a barcode containing information regarding the account number associated with the respective account, data and/or information regarding a two-dimensional containing information regarding the account number associated with the respective account, and/or data and/or information regarding a QR code or Quick Response code containing information regarding the account number associated with the respective account. The database 20H can also contain data and/or information and/or software processing routines for scanning, reading, and/or deciphering, data and/or information contained in a barcode, a two-dimensional barcode, and/or a QR code or Quick Response code.

The database 20H can also contain or include any of the data and/or information described herein as being stored in the databases of any of the other communication devices 20 associated with the respective account or accounts and/or any counterparty communication devices 40 described herein. The database 20H can also contain or include any data and/or information stored in any of the account holder bank computer system(s) 30 and counterparty bank computer system(s) 50 described herein.

The database 20H can also contain or include any and/or all data and/or information and/or any software programs, routines, and/or software applications or “apps”, needed or desired for performing any and/or of the processing routines, functions, and/or functionality, described herein as being provided by or performed by the communication device 20, and/or by any of the apparatus 100 of the present invention and/or by the central processing computer(s) 10, and/or by any counterparty communication device(s) 40, any account holder bank computer system(s) 30, and/or any counterparty bank computer system(s) 50.

The database 20H can also contain or include any and/or all data and/or information for or regarding the account holder or authorized user or individual for facilitating using the communication device 20 as an electronic wallet. In this regard, the database 20H can contain or include an electronic version of the respective account holder's, user's, or individual's, driver's license, identification information, social security card, any professional license(s), vehicle registration(s), automobile insurance card(s), passport(s), home insurance policy, malpractice insurance policy, health insurance policy, life insurance policy, disability insurance policy, and/or an electronic version or any account card(s) associated with any of the account holder's various accounts, which can be any one or more, or any combination, of the various accounts described herein.

The database 20H can also contain or include any and/or all data and/or information and/or any software programs, routines, and/or software applications or “apps”, needed or desired for performing any and/or of the processing routines, functions, and/or functionality, described herein as being performed by or provided by the communication device 20, any other communication devices 20 associated with the account, and/or any counterparty communication devices 40, with such data and/or information and/or software applications or “apps”, being downloadable to the communication device 20 if and when needed or desired.

In a preferred embodiment, the database 20H can also contain or include any and/or all data and/or information needed, desired, or utilized, by the apparatus 100, or by the central processing computer(s) 10 and/or by the communication devices 20 and/or any other communication device 20 utilized with or associated with the account, and/or by any counterparty communication device(s) 40, any account holder bank computer system(s) 30, and/or any counterparty bank computer system(s) 50 described herein for or in performing any and/or all of the processing routines, operations, functions, and/or functionality, described herein as being performed by the communication device 20 and/or the apparatus 100 and method of the present invention.

The communication device 20 also includes an output device 201, which is also connected to the CPU 20A, for outputting any data and/or information, described herein. In the preferred embodiment, the output device 201 can be a printer, a display, a transmitter, a modem, and/or any other device which can be used to output data or information.

The communication device 20 can also be equipped with a global positioning device 20J which can be connected to the CPU 20A and which can be utilized to calculate, determine, or ascertain, the position or location of the communication device 20.

The communication device 20 can also include a video and/or audio recording device 20K which, in a preferred embodiment, can include a camera, a video recoding device, a microphone, and/or an audio recording device. The video and/or audio recording device 20K can be utilized to take a picture, record video, record a video clip, record sound, record audio, or record an audio clip, of a user of the communication device 20 and/or to record any picture, a sound or voice, video information, or audio information at the communication device 20.

In a preferred embodiment, the communication can serve as a transaction authorization processing device which can communicate, in bi-directional manner, with any central processing computer 10 which can perform transaction authorization processing for any account described herein. In this regard, in a preferred embodiment, the communication device 20 can also be equipped with the needed hardware and/or software to function as a point of sale (POS) transaction device which can communicate, in a bi-directional manner, with any central processing computer 10 and/or any transaction processing computer or any transaction authorization processing computer.

In another preferred embodiment, the communication device 20 can include, and/or can be utilized in conjunction with, any of the herein-described user input devices 20D which can be separate and apart from the communication device 20. In such an embodiment, such user input device(s) 20D can be wirelessly linked to the CPU 20A or to the communication device 20 with, using, or via, a Wi-Fi connection or Wi-Fi equipment, or a Bluetooth connection or Bluetooth equipment, or any combination of same.

In another preferred embodiment, the communication device 20 can include, and/or can be utilized in conjunction with, any of the herein-described output devices 201 which can be separate and apart from the communication device 20. In such an embodiment, such output device(s) 201 can be wirelessly linked to the CPU 20A or to the communication device 20 with, using, or via, a Wi-Fi connection or Wi-Fi equipment, or a Bluetooth connection or Bluetooth equipment, or any combination of same.

In another preferred embodiment, the communication device 20 can include, and/or can be utilized in conjunction with, any of the herein-described camera/video/audio equipment systems 20K which can be separate and apart from the communication device 20. In such an embodiment, such camera/video/audio equipment system(s) 20K can be wirelessly linked to the CPU 20A or to the communication device 20 with, using, or via, a Wi-Fi connection or Wi-Fi equipment, or a Bluetooth connection or Bluetooth equipment, or any combination of same.

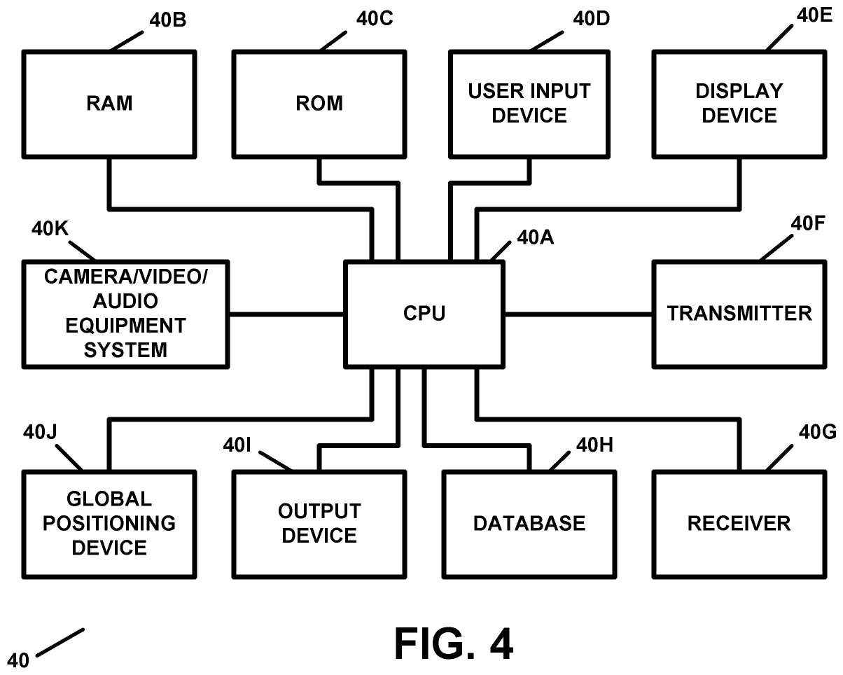

FIG. 4 illustrates a preferred embodiment of the counterparty communication device 40 of FIG. 1, in block diagram form. In a preferred embodiment, the counterparty communication device 40 is associated with or used by a counterparty in any transaction involving a respective account, the account holder of or associated with the account or any user or individual authorized to use the account. In another preferred embodiment, the counterparty communication device 40 can also be associated with or used by any user or individual who or which is authorized to use the counterparty communication device 40 on behalf of the counterparty.

In a preferred embodiment, the counterparty communication device 40 can be, or can be a component of, a point of sale (POS) transaction device, a point of transaction device, a transaction authorization device, a cash register, or any other transaction device which can be used by a counterparty. In a preferred embodiment, the counterparty communication device 40 can also be a personal computer, a laptop computer, a notebook computer, a tablet, a tablet computer, a cellular telephone, a personal digital assistant, a wireless telephone, a wireless communication device, a personal communication device, a personal communications services device, a smart phone, a Smartphone, a mobile telephone, a hand-held device or computer, a palm-top device or computer, a watch, a telephone, a television, an interactive television, a digital television, a smart television or entertainment device, an internet-enabled television or entertainment device, or any other suitable device, which can be equipped to perform the functions described herein as being performed by the counterparty communication device 40. In a preferred embodiment, the counterparty communication device 40 can also be a cellular telephone, a personal digital assistant, or a Smartphone or smart phone which can be utilized as an electronic wallet by the counterparty.

In the preferred embodiment, the counterparty communication device 40 includes a central processing unit or CPU 40A, which in the preferred embodiment, is a microprocessor. The CPU 40A may also be a microcomputer, a minicomputer, a macro-computer, and/or a mainframe computer, depending upon the application.

The counterparty communication device 40 also includes a random access memory device(s) 40B (RAM) and a read only memory device(s) 40C (ROM), each of which is connected to the CPU 40A, and a user input device 40D, for entering data, information, and/or commands, into the counterparty communication device 40, which includes any one or more of a keyboard, a scanner, a card reader, a barcode reader, a barcode scanner, a two-dimensional barcode reader, a two-dimensional barcode scanner, a QR code reader, a QR code scanner, an imaging device, a camera for obtaining an image of a barcode, a two-dimensional barcode, and/or a QR code, a two-dimensional image sensor, an account information data entry device, a card swiping device, a touch screen, and/or a user pointing device, such as, for example, a mouse, a touch pad, and/or an audio input device and/or a video input device, a microphone or an audio recording device, a camera or a video recording device, and/or any device, electronic and/or otherwise which can be utilized for inputting and/or entering data and/or information, of any kind or type pertinent to the operation of the apparatus 100 of the present invention, into the counterparty communication device 40. The input device 40D can also be any other input device(s) which are or can be utilized with or in connection with any of the counterparty communication device(s) 40 described herein as being utilized in connection with the apparatus 100 of the present invention.

The input devices 40D are also connected to or with, or linked to or with, the CPU 40A. In a preferred embodiment, the input device 40D can also include a retinal scanner, a fingerprint recognition device, a voice recognition device, or any other type or kind of biometric device which can be used for determining whether or not a user or operator of the counterparty communication device 40 is an authorized user, individual, or person. The counterparty communication device 40 also includes a display device 40E for displaying data and/or information to a user or operator.

The counterparty communication device 40 also includes a transmitter(s) 40F, for transmitting signals and/or data and/or information, or a message(s), to any one or more of the central processing computer(s) 10, the communication device(s) 20, the account holder bank computer system(s) 30, and the counterparty bank computer system(s) 50, and/or any other counterparty communication devices(s) 40 described herein. The counterparty communication device 40 can also be equipped with transmitters, receivers, network interface devices, and/or any other appropriate hardware and/or software, so as to communicate, in a bi-directional manner with, so as to transmit signals, data, information, or a message to, and/or so as to receive signals, data, information, or a message from, any of the central processing computer(s) 10, the communication device(s) 20, the account holder bank computer system(s) 30, and the counterparty bank computer system(s) 50, and/or any other counterparty communication devices(s) 40 described herein.

The counterparty communication device 40 also includes a receiver(s) 40G, for receiving signals and/or data and/or information, or a message(s), from any of the central processing computer(s) 10, the communication device(s) 20, the account holder bank computer system(s) 30, and the counterparty bank computer system(s) 50, and/or any other counterparty communication devices(s) 40 described herein.

The counterparty communication device 40 also includes a database(s) 40H, which is also connected to or linked with the CPU 40A, which can contain and/or include any and/or all of the data and/or information needed or desired for performing any and/or all of the functions and/or functionality described herein as being performed by the apparatus 100 and method of the present invention and/or the counterparty communication device 40.

In a preferred embodiment, the database 40H contains and/or includes data and/or information regarding the counterparty and any counterparty account(s) associated with the counterparty and/or any authorized user or individual who can utilize the counterparty communication device 40 or use any account(s) of or associated with the counterparty, including, but not limited to, his, her, or its, name, address, contact information, telephone number(s), cellular telephone number(s), wireless telephone number(s), personal communication device telephone number(s), e-mail address(es), IP address(es), text message number(s) or information, SMS message(s) or information, MMS message(s) or information, help center, customer service center or agent, and/or any other contact or other information for or regarding the counterparty, counterparty account information, information regarding any and/or all accounts of the counterparty, account numbers, account expiration dates, security codes or numbers, personal identification numbers (PINs), password(s), access code(s), account credit limit(s), account spending limit(s), account deductible(s), and/or any other data and/or information regarding the counterparty, any account(s) of the counterparty, and/or any user(s) or individual(s) authorized to use the counterparty's account.

The database 40H can also contain or include, for each account of or associated with the counterparty, the phone number or IP address of the respective central processing computer 10 which performs transaction authorization processing for the respective account. The database 40H can also contain or include a link(s) or hyperlink(s) to each of any of the central processing computer(s) 10 associated with any of the accounts held by, owned by, or associated with, the counterparty. The database 40H can also contain or include a link(s) or hyperlink(s) to any transaction page or pages associated with the central processing computer(s) 10 associated with any of the accounts held by, owned by, or associated with, the counterparty. The database 40H can also contain or include a link(s) or hyperlink(s) to any counterparty communication device(s) 40 associated with any counterparty who or with which the counterparty's account can be utilized, and/or who or with which the counterparty or any authorized user or individual associated with a respective counterparty account can engage in a transaction(s). The database 40H can also contain or include, for each account, the times or hours of operation for each of the respective central processing computer 10 which performs transaction authorization processing for the respective counterparty account.

The database 40H can also contain or include, for each counterparty account, contact information and/or customer service information, including, but not limited to telephone number(s), e-mail address(es), or instant messaging number or SMS messaging number, MMS messaging number, or account administrator information or customer service agent information, for the respective central processing computer 10 which performs transaction authorization processing for the respective counterparty account.

The database 40H can also contain or include a link(s) or hyperlink(s) to any counterparty bank computer system(s) 50 associated with a respective counterparty account or which administers a financial account associated with the respective account. The database 40H can also contain or include a link(s) or hyperlink(s) to any account holder bank computer system(s) 30 associated with a respective account holder.

The database 40H can also contain and/or include, for each counterparty of or associated with counterparty account and for any of each user or individual authorized to use the counterparty account, a description of the counterparty or user or individual, a photograph or video clip of the counterparty or user or individual, data and/or information regarding a digital voiceprint of the counterparty or user or individual, or data and/or information for verifying an identity of the counterparty or user or individual by his or her voiceprint, data and/or information regarding a retinal scan of the counterparty or user or individual or data and/or information for verifying an identity of the counterparty or user or individual by his or her retinal scan, data and/or information regarding a fingerprint of the counterparty or user or individual or data and/or information for verifying an identity of the counterparty or user or individual by his or her fingerprint, and/or any other data and/or information for identifying and identity of the counterparty or user or individual using biometric data and/or information.

In a preferred embodiment, the database 40H can also contain and/or include, for each counterparty or user or individual, data and/or information regarding each counterparty communication device 40 which is or can be used by the counterparty or user or individual in utilizing the apparatus 100 and method of the present invention, including, but not limited to, data and/or information regarding an identification of each counterparty communication device 40, a description of, or type or kind of, the counterparty communication device 40, manufacturer, model number, and/or serial number or any other identification information, of, for, or regarding, the counterparty communication device 40, and/or the assigned telephone number, e-mail address, text messaging or SMS messaging number, MMS messaging number, and/or IP address, or any network identification information, of, for, or associated with, the counterparty communication device 40.

The database 40H can also contain and/or include, for each counterparty account serviced by the counterparty communication device 40, information about the counterparty, the counterparty's account number(s), payments made to the account, credits made to the account, refunds paid from the account, charge-backs made to the account, account statements, historical account statements, and/or any other data and/or information regarding the counterparty's account as well as any other data and/or information needed, desired, and/or necessary, to administering and/or managing the counterparty's account. The database 40H also contains and/or includes data and/or information regarding account statements, historical account statements, pending transactions, pending authorizations, and/or any other data and/or information regarding account activity and/or account activities for the counterparty's account.

In a preferred embodiment, the database 40H can also contain and/or include, for each counterparty and/or for each counterparty account serviced by the communication device 40, data and/or information regarding each counterparty who or which utilizes the counterparty communication device 40, and for each counterparty, his, her, or its, name, address, contact information, telephone number(s), cellular telephone number(s), wireless telephone number(s), personal communication device telephone number(s), e-mail address(es), IP address(es), text message number(s) or information, SMS message(s) or information, SMS message(s) or information, and/or any other contact or other information, account information for any account into which payments are received for the counterparty and/or any other accounts of the counterparty, information regarding any and/or all accounts of the counterparty, account numbers, account expiration dates, security codes or numbers, personal identification numbers (PINs), password(s), access code(s), social security numbers or employer identification numbers, account credit limit(s), account spending limit(s), account deductible(s), and/or any other data and/or information regarding each counterparty and his, her, or its, accounts. In the case of individuals, the database 40H can also contain and/or include data and/or information regarding the counterparty's contact information or emergency contact information.

The database 40H can also contain and/or include, for each counterparty or for each user of an account of a counterparty serviced by the counterparty communication device 40, a description of the counterparty, an employee or agent of the counterparty, or user, a photograph or video clip of the counterparty, an employee or agent of the counterparty, or user, data and/or information regarding a digital voiceprint of the counterparty, an employee or agent of the counterparty, or user, or data and/or information for verifying an identity of the counterparty, an employee or agent of the counterparty, or user, by his or her voiceprint, data and/or information regarding a retinal scan of the counterparty, an employee or agent of the counterparty, or user, or data and/or information for verifying an identity of the counterparty, an employee or agent of the counterparty, or user, by his or her retinal scan, data and/or information regarding a fingerprint of the counterparty, an employee or agent of the counterparty, or user, or data and/or information for verifying an identity of the counterparty, an employee or agent of the counterparty, or user, by his or her fingerprint, and/or any other data and/or information for identifying and identity of the counterparty, an employee or agent of the counterparty, or user, using biometric data and/or information.

In a preferred embodiment, the database 40H can also contain and/or include, for each counterparty, an employee or agent of the counterparty, or user of the counterparty communication device 40, data and/or information regarding each counterparty communication device 40 which is or can be used by the counterparty, an employee or agent of the counterparty, or user, in utilizing the apparatus 100 and method of the present invention, including, but not limited to, data and/or information regarding an identification of each counterparty communication device 40, a description of, or type or kind of, the counterparty communication device 40, manufacturer, model number, and/or serial number or any other identification information, of, for, or regarding, the counterparty communication device 40, and/or the assigned telephone number, e-mail address, text messaging or SMS messaging number, MMS messaging number, and/or IP address, or any network identification information, of, for, or associated with, the counterparty communication device 40.

The database 40H can also contain and/or include, for each counterparty account serviced by the counterparty communication device 40, data and/or information about the counterparty, the counterparty's account number(s) for any and/or all accounts of the counterparty, previous transactions made or involving the account, previous unauthorized transactions made on or involving the account or attempted to be made on or involving the account, previous unauthorized sales made on or involving the account or attempted to be made on or involving the account, number of authorized and/or unauthorized transactions or sales, account statements, historical account statements, and/or any other data and/or information needed, desired, and/or necessary, to manage and/or process an account transaction for a counterparty as described herein. The database 40H can also contain and/or include data and/or information regarding account statements, historical account statements, pending transactions, pending authorizations, and/or any other data and/or information regarding account activity and/or account activities for the counterparty.

The database 10H can also contain and/or include, for each account serviced by the counterparty communication device 40, data and/or information regarding a counterparty's requests or instructions to receive alerts or alert messages regarding any transactions occurring on any of his, her, or its accounts.

The database 40H can also contain or include, for each account serviced by the counterparty communication device 40, the phone number or IP address of the respective central processing computer 10 which performs transaction authorization processing for the respective account. The database 40H can also contain or include a link(s) or hyperlink(s) to any central processing computer(s) 10 associated with any of the accounts held by, owned by, or associated with, each counterparty serviced by the apparatus 100 of the present invention. The database 40H can also contain or include a link(s) or hyperlink(s) to any transaction page or web page or pages or web pages associated with the central processing computer(s) 10 associated with any of the accounts held by, owned by, or associated with, each counterparty who or which utilizes the apparatus 100 of the present invention and/or the counterparty communication device 40.

The database 40H can also contain or include, for each account of the counterparty serviced by the counterparty communication device 40, the times or hours of operation for each of the respective central processing computer(s) 10 which perform transaction authorization processing for any of the accounts serviced for the counterparty by the apparatus 100 of the present invention.

The database 40H can also contain or include, for each account of a counterparty serviced by the counterparty communication device 40, data and/or information regarding specific limitations and/or restrictions which may be placed on a particular account, which may be pre-selected and/or programmed by the counterparty and/or which may include limitations and/or restrictions on the usage of the account or any cards or account numbers associated with the account and/or which may be placed on the account by the entity which issued the account or which services the account. The limitations and/or restrictions may include the types of transactions which are allowed and/or authorized, the goods and/or services which may be sold with the account, the employees or agents of the counterparty, or other users, who or which may be authorized to perform transactions on or involving the account, limits on the dollar or other monetary amounts of transactions which can be entered into involving the account, daily use limitations, and/or the geographical area or location wherein authorized account use may be limited, and/or authorized times for account usage, such as, but not limited to, specific days, dates, time of day, time of month, year, and/or any other time of use, and/or any other limitation and/or restriction regarding amount of transaction, parties involved, geographical area, and/or times of allowed usage.

The database 40H can also contain or include, for each account of a counterparty serviced by the counterparty communication device 40, data and/or information regarding transactions processed on or involving the account. The data and/or information can also include, for each of any number of transactions for each or any number of accounts of a counterparty, a picture, a photograph, or a video clip, of the counterparty, or of an employee or agent of same, or other authorized user, who or which can be involved in a transaction on or involving the account, and/or audio information, a voice message or sample, and/or a voice print, which is a digital representation of a voice message or sample, obtained from the counterparty, or of an employee or agent of same, or other authorized user, who or which can be involved in a transaction on or involving the account, for each of any number of transactions processed by the central processing computer 10. For example, for any given account, the central processing computer 10 can store information for any number of transactions occurring on a given account. In this manner, a picture, a photograph, or a video clip, of the counterparty, or of an employee or agent of same, or other authorized user, who or which can be involved in a transaction on or involving the account, and/or audio information, a voice message or sample, and/or a voice print, which is a digital representation of a voice message or sample, obtained from the counterparty, or of an employee or agent of same, or other authorized user, who or which can be involved in a transaction on or involving the account, can be stored for any number of transactions on a respective counterparty account, in order to perform identity verification for a counterparty or other user or individual involved in a transaction on or involving an account of the counterparty.

The database 40H can also contain or include copies of any of the images, digital copies, photographs, or pictures, of any of the respective documents, authorization forms, checks, forms, receipts, request forms, or other entities, which have been, or which were, offered, presented, submitted, processed, involved, or used, in or involving, or related to, a transaction or transactions on or involving any of the accounts of a counterparty serviced by the counterparty communication device 40.

It is envisioned that a counterparty, or an employee or agent of the counterparty, or any other authorized user or individual, of a respective counterparty account can submit a photograph or picture or his or her face which can be stored in the database 40H as a “file photograph” or a “file picture” associated with the respective counterparty account. In a preferred embodiment, the “file photograph” or “file picture” can be stored as a digital file. It is also envisioned that the counterparty, or an employee or agent of the counterparty, or any other authorized user or individual, of a respective counterparty account can also submit a pre-recorded voice message which can be digitized into a voice print which can be stored as a “file voiceprint”.

In processing a transaction involving a respective counterparty account, the counterparty communication device 40 can process a picture, a photograph, or a video clip, of the counterparty, or an employee or agent of the counterparty, or any other authorized user or individual involved in the transaction, and/or audio information, a voice message or sample, and/or a voice print, obtained from the counterparty, or an employee or agent of the counterparty, or any other authorized user or individual involved in the transaction using the respective “file photograph”, “file picture”, and/or “file voice print”, and/or can provide the “file photograph”, “file picture”, and/or “file voice print”, to a communication device 20 so that the account holder or other authorized user of the account holder's account can use same in verifying that the counterparty, or an employee or agent of the counterparty, or any other authorized user or individual is, in fact, the counterparty, or an employee or agent of the counterparty, or any other authorized user or individual with whom the account holder or other authorized user or individual is intending to conduct the transaction.

The database 40H can also contain or include, for each counterparty account serviced by the counterparty communication device 40, data and/or information regarding account statements, historical statements, periodic transaction records, and/or any other data and/or information regarding past transactions and/or activities, and/or attempted transactions or attempted activities, on or involving the counterparty account, including transactions or activities that were authorized or completed and/or which were not authorized or disallowed.

The database 40H can also contain or include, for each counterparty account serviced by the counterparty communication device 40, data and/or information regarding a barcode containing information regarding the counterparty account number associated with the respective counterparty account, data and/or information regarding a two-dimensional containing information regarding the account number associated with the respective counterparty account, and/or data and/or information regarding a QR code or Quick Response code containing information regarding the account number associated with the respective counterparty account. The database 40H can also contain data and/or information and/or software processing routines for scanning, reading, and/or deciphering, data and/or information contained in a barcode, a two-dimensional barcode, and/or a QR code or Quick Response code.

The database 40H can also contain or include, for each account held by the counterparty which is serviced by the apparatus 100 of the present invention and/or the counterparty communication device 40, data and/or information regarding or pertaining to the counterparty's account, the type or kind of the account, such as, but not limited to, a financial account or a non-financial account, or any other of the types or variety of accounts described herein, the account number or an account identifier for the counterparty account, the telephone number, e-mail address, or the IP address, identified with the counterparty account, and/or data and/or information for or regarding the account issuer or the account service provider, servicing entity, or transaction authorizing processing provider or entity, including, but not limited to, the telephone number, e-mail address, or the IP address, for, associated with, or identified with, the counterparty account, and/or with the account issuer or the account service provider, servicing entity, or transaction authorizing processing provider or entity, or any other entity which issued and/or which services the counterparty account.

The database 40H can also contain or include, for each account held by the counterparty and which is serviced by the counterparty communication device 40, data and/or information regarding the counterparty communication device(s) 40 associated with the counterparty account, and the telephone number, e-mail address, or the IP address, or other contact information, identified with each counterparty communication device 40. In this regard, the data and/or information regarding the counterparty account also includes any needed and/or desired data and/or information for allowing any respective central processing computer 10 to access and/or communicate with the counterparty communication device 40 in or during, or as part of, a processing of a transaction authorization processing operation or activity and/or to obtain transaction authorization processing information from the counterparty communication device 40 and/or to transmit any of the herein-described messages, transaction authorized messages, transaction not authorized messages, or any other messages, signals, data and/or information, from the pertinent central processing computer 10, to the counterparty communication device 40. For example, in the case of a credit account transaction, the data and/or information for the counterparty's account can include a telephone number or IP address which can be utilized by the central processing computer 10, which performs transaction authorization processing for that credit account, to access and/or communicate with the counterparty communication device 40. The data and/or information for that account can include a telephone number or IP address which be utilized by the central processing computer 10, which performs transaction authorization processing for that credit account, to access and/or communication with, automatically and/or otherwise, the counterparty communication device 40.

The database 40H can also contain and/or include, for each account serviced by the counterparty communication device 40, any access code(s), security code(s), password(s), or any other data and/or information regarding the account. The database 40H can also contain and/or include, for each account and for each counterparty communication device 40 registered to be utilized with the counterparty account, the manufacturer, model number, and/or serial number, and/or telephone number, e-mail address, IP address, text messaging number, SMS messaging number, MMS messaging number, or any other identifying information and/or contact information for or regarding each such counterparty communication device 40.

The database 40H can also contain and/or include, for each counterparty account serviced by the counterparty communication device 40, information regarding a counterparty's requests or instructions to receive alerts or alert messages regarding any transactions occurring on any of his, her, or its account(s).

The database 40H can also contain or include data and/or information regarding specific limitations and/or restrictions which may be placed on a particular counterparty account, which may be pre-selected and/or programmed by the counterparty and which may include limitations and/or restrictions on the usage of the counterparty account or any cards or account numbers associated with the counterparty account. The limitations and/or restrictions may include the types of transactions which are allowed and/or authorized, the goods and/or services which may be purchased with the counterparty account, the vendors, stores and/or service providers, which may be authorized to accept the payment via the counterparty account, limits on the dollar or other monetary amounts of transactions pertaining to each authorized vendor, seller, and/or service provider, daily spending limits, and/or the geographical area or location wherein authorized counterparty account use may be limited, and/or authorized times for counterparty account usage, such as, but not limited to, specific days, dates, time of day, time of month, year, and/or any other time of use, and/or any other limitation and/or restriction regarding amount of transaction, parties involved, geographical area, and/or times of allowed usage.

The database 40H can also contain or include, for each account, data and/or information regarding transactions processed on the counterparty account. The data and/or information can also include, for each of any number of transactions for each or any number of counterparty accounts, a picture, a photograph, or a video clip, of the counterparty or other user or individual involved in a transaction, and/or audio information, a voice message or sample, and/or a voice print, which is a digital representation of a voice message or sample, obtained from the counterparty or other user or individual involved in the transaction, for each of any number of transactions processed by the counterparty communication device 40. For example, for any given counterparty account, the counterparty communication device 40 can store information for any number of transactions occurring on a given counterparty account. In this manner, a picture, a photograph, or a video clip, of the counterparty or user or individual involved in a transaction, and/or audio information, a voice message or sample, and/or a voice print, which is a digital representation of a voice message or sample, obtained from the counterparty or other user or individual involved in the transaction, can be stored for any number of transactions on a respective counterparty account, in order to perform identity verification for a counterparty or other user or individual involved in a transaction.

The database 40H can also contain or include copies of any of the images, digital copies, photographs, or pictures, of any of the respective documents, authorization forms, checks, forms, receipts, request forms, or other entities, which have been, or which were, offered, presented, submitted, processed, involved, or used, in or involving, or related to, a transaction or transactions on or involving any of the counterparty accounts serviced by the counterparty communication device 40.

As noted herein, it is envisioned that a counterparty, or other authorized user or individual, of a respective counterparty account can take a photograph or picture or his or her face which can be stored in the database 20H as a “file photograph” or a “file picture” associated with the respective counterparty account. In a preferred embodiment, the “file photograph” or “file picture” can be stored as a digital file in the counterparty communication device database 40H. It is also envisioned that the counterparty or authorized user or individual can also record a voice message which can be digitized into a voice print which can be stored as a “file voiceprint”.

In processing a transaction involving a respective counterparty account, the counterparty communication device 40 can process a picture, a photograph, or a video clip, of the counterparty or user or individual involved in the transaction, and/or audio information, a voice message or sample, and/or a voice print, obtained from the counterparty or user or individual involved in the transaction using the respective “file photograph”, “file picture”, and/or “file voice print”, and/or can provide the “file photograph”, “file picture”, and/or “file voice print”, to a communication device 20 so that the account holder or user or individual can use same in verifying that the counterparty or user or individual is the counterparty associated with the counterparty account or is an authorized user or individual associated with the counterparty account. In processing a transaction involving a respective counterparty account, the counterparty communication device 40 can process a picture, a photograph, or a video clip, of the counterparty or user or individual involved in the transaction, and/or audio information, a voice message or sample, and/or a voice print, obtained from the counterparty or user or individual involved in the transaction using the respective “file photograph”, “file picture”, and/or “file voice print”, and/or can provide the “file photograph”, “file picture”, and/or “file voice print”, to the central processing computer 10.

The database 40H can also contain or include, for each account, data and/or information regarding a barcode containing information regarding the account number associated with the respective account, data and/or information regarding a two-dimensional containing information regarding the account number associated with the respective account, and/or data and/or information regarding a QR code or Quick Response code containing information regarding the account number associated with the respective account. The database 40H can also contain data and/or information and/or software processing routines for scanning, reading, and/or deciphering, data and/or information contained in a barcode, a two-dimensional barcode, and/or a QR code or Quick Response code.

The database 40H can also contain or include any of the data and/or information described herein as being stored in the databases of any of the other counterparty communication devices 40 associated with the respective counterparty account or accounts and/or any counterparty communication devices 40 described herein. The database 40H can also contain or include any data and/or information stored in any of the account holder bank computer system(s) 30 and counterparty bank computer system(s) 50 described herein.

The database 40H can also contain or include any and/or all data and/or information and/or any software programs, routines, and/or software applications or “apps”, needed or desired for performing any and/or of the processing routines, functions, and/or functionality, described herein as being provided by or performed by the counterparty communication device 40, and/or by any of the apparatus 100 of the present invention and/or by the central processing computer(s) 10, and/or by any communication device(s) 20, any account holder bank computer system(s) 30, and/or any counterparty bank computer system(s) 50.

The database 40H can also contain or include any and/or all data and/or information and/or any software programs, routines, and/or software applications or “apps”, needed or desired for performing any and/or of the processing routines, functions, and/or functionality, described herein as being performed by or provided by the counterparty communication device 40, and any other counterparty communication devices 40 associated with the counterparty or the counterparty account, with such data and/or information and/or software applications or “apps”, being downloadable to the counterparty communication device 40 if and when needed or desired.

In a preferred embodiment, the database 40H can also contain or include any and/or all data and/or information needed, desired, or utilized, by the apparatus 100, or by the central processing computer(s) 10 and/or by the communication devices 20 and/or any other communication device 20 utilized with or associated with the account, and/or by any counterparty communication device(s) 40, any account holder bank computer system(s) 30, and/or any counterparty bank computer system(s) 50 described herein for or in performing any and/or all of the processing routines, operations, functions, and/or functionality, described herein as being performed by the counterparty communication device 40 and/or the apparatus 100 and method of the present invention.

The counterparty communication device 40 also includes an output device 401, which is also connected to the CPU 40A, for outputting any data and/or information, described herein. In the preferred embodiment, the output device 401 can be a printer, a display, a transmitter, a modem, and/or any other device which can be used to output data or information.

The counterparty communication device 40 can also be equipped with a global positioning device 40J which can be connected to the CPU 40A and which can be utilized to calculate, determine, or ascertain, the position or location of the counterparty communication device 40.

The counterparty communication device 40 can also include a video and/or audio recording device 40K which, in a preferred embodiment, can include a camera, a video recoding device, a microphone, and/or an audio recording device. The video and/or audio recording device 40K can be utilized to take a picture, record video, record a video clip, record sound, record audio, or record an audio clip, of a user of the counterparty communication device 40 and/or to record any picture, a sound or voice, video information, or audio information at the counterparty communication device 40.

In another preferred embodiment, the counterparty communication device 40 can include, and/or can be utilized in conjunction with, any of the herein-described user input devices 40D which can be separate and apart from the counterparty communication device 40. In such an embodiment, such user input device(s) 40D can be wirelessly linked to the CPU 40A or to the counterparty communication device 40 with, using, or via, a Wi-Fi connection or Wi-Fi equipment, or a Bluetooth connection or Bluetooth equipment, or any combination of same.

In another preferred embodiment, the counterparty communication device 40 can include, and/or can be utilized in conjunction with, any of the herein-described output devices 401 which can be separate and apart from the counterparty communication device 40. In such an embodiment, such output device(s) 401 can be wirelessly linked to the CPU 40A or to the counterparty communication device 40 with, using, or via, a Wi-Fi connection or Wi-Fi equipment, or a Bluetooth connection or Bluetooth equipment, or any combination of same.

In another preferred embodiment, the counterparty communication device 40 can include, and/or can be utilized in conjunction with, any of the herein-described camera/video/audio equipment systems 40K which can be separate and apart from the counterparty communication device 40. In such an embodiment, such camera/video/audio equipment system(s) 40K can be wirelessly linked to the CPU 40A or to the counterparty communication device 40 with, using, or via, a Wi-Fi connection or Wi-Fi equipment, or a Bluetooth connection or Bluetooth equipment, or any combination of same.

It is important to note any account holder described herein can also be a counterparty in any given transaction and that any counterparty described herein can also be an account holder in any given transaction.

In a preferred embodiment, the apparatus 100 and method of the present invention can be utilized to perform account security and/or transaction security in a transaction involving any of the herein-described and/or herein-identified accounts. In a preferred embodiment, the apparatus 100 and method of the present invention can provide account security and/or transaction security by allowing an account holder, or any other user or individual authorized to perform a transaction on or involving an account, to perform or engage in a transaction with a counterparty without having to provide his or her account information to that counterparty. In this manner, without having to provide account information to a counterparty, the threat of a security breach involving the account holder's account can be drastically reduced by the apparatus 100 of the present invention.

In a preferred embodiment, information involving the counterparty can be provided to the account holder or authorized user or individual. The information regarding the counterparty can include information regarding the identity of the counterparty, or information regarding an account of or associated with the counterparty to which payment is to be made to the counterparty, and/or any other information needed or desired for processing and/or for performing a transaction involving the account holder or authorized user or individual and the counterparty.

Once the account holder or authorized user or individual has obtained the information regarding the counterparty, the account holder or the authorized user or individual can utilize a communication device 20 in order to generate and transaction authorization message, which, in a preferred embodiment, can include the counterparty's information, the account holder's account information, and/or the transaction amount. The transaction authorization message can then be transmitted to the central processing computer 10 which can perform transaction authorization processing for the account holder's account. The central processing computer 10 can then process information regarding the transaction using the information contained in the transaction authorization message, and can any one or more of determine whether or not the account is active or not-active, whether or not a hold has been place on the account to prevent the accounts use in any transaction(s), whether or not an account card has been lost or stolen, whether or not an account number has been reported as having been compromised or inadvertently released to others, or whether or not account security has been breached, or whether or not the transaction is prohibited by any limitation(s) or restriction(s) placed on the account, whether or not an account credit or spending limit has been reached, or whether or not the transaction is authorized, or whether or not the transaction is not authorized.

If the central processing computer 10 determines for any reason that the transaction is not authorized, a message can be generated and transmitted to the communication device 20 and/or to the counterparty communication device 40. If the central processing computer 10 determines the transaction to be authorized, it can process the transaction and effectuate or make payment to the counterparty and/or can effectuate or make a corresponding entry, payment, and/or a respective credit, debit, or charge, entry, and/or effectuate or make any appropriate accounting entry or accounting entries to the account holder's account and/or to the counterparty's account. The central processing computer 10 can effectuate or make any accounting entry or accounting entries to the account holder's account by generating and transmitting a signal, data, information, or a message, to the account holder's account holder bank computer system 30. The central processing computer can also effectuate or make any accounting entry or accounting entries to the counterparty's account by generating and transmitting a signal, data, information, or a message, to the counterparty's counterparty bank computer system 50. In this regard, an account holder can utilize his or her account in a transaction involving a counterparty without having to provide his or her account information to that counterparty.

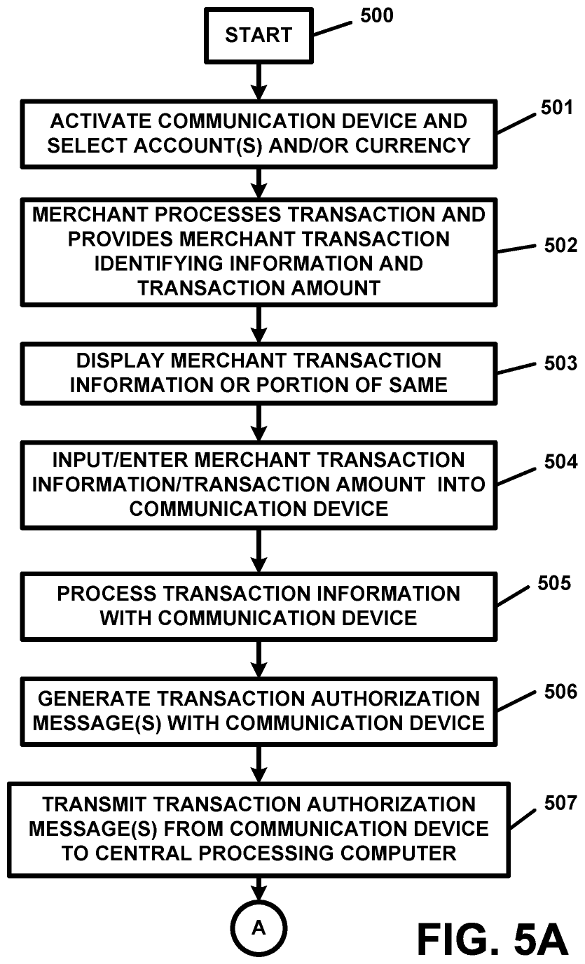

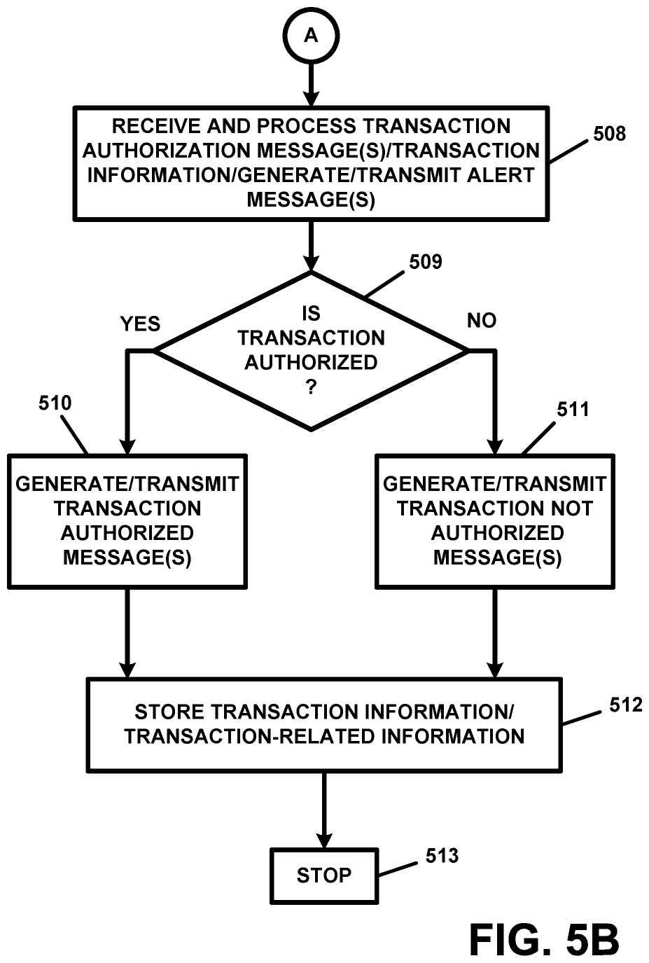

FIGS. 5A and 5B illustrate a preferred embodiment method for utilizing the apparatus 100 and method of the present invention, in flow diagram form. In the preferred embodiment of FIGS. 5A and 5B, the operation of the apparatus 100 is described in an exemplary embodiment in which an account holder is using a cellular telephone, a Smartphone or smart phone, or a personal digital assistant, in order to engage in an in-person transaction with a merchant or retail store using his or her credit account of credit card account. It is to be understood, however, that that preferred embodiment of FIGS. 5A and 5B can also be utilized in a same, a similar, and/or an analogous, manner in order to allow any account holder or authorized user or individual of an account of the account holder, to utilize any of the herein-described types or kinds of communication devices 20 in connection with any of the herein-described types or kinds of accounts in order to perform an in-person transaction, a face-to-face transaction, a telephone transaction, a mail order transaction, a remote transaction, an on-line transaction, and/or an Internet transaction, and/or any other type or kind of transaction, with any counterparty, counterpart, or third party.

With reference to FIGS. 5A and 5B, the operation of the apparatus 100 commences at step 500. At step 501, the account holder, desiring to perform a transaction with the merchant in the merchant's store, can activate the communication device 20. In a preferred embodiment, at step 501, the account holder can, for example, activate a transaction software application or software “app” on the communication device 20 which, in the preferred embodiment, is a cellular telephone, a Smartphone or smart phone, or a personal digital assistant. At step 501, the communication device 20 can provide the account holder with a menu showing all possible payment methods available to the account holder. For example, the communication device 20 can display any and/or all of the account holder's credit cards, charge cards, debit cards, banks accounts, checking accounts, savings accounts, electronic money accounts, electronic funds accounts, cryptocurrencies, cryptocurrency accounts, and/or any other payment accounts, from which the account holder can make or effectuate payment to the merchant in the transaction. At step 501, the account holder can select, via the user input device 20D or other means, the account or the payment type or kind which he or she desires to use in the transaction with the merchant.

In another preferred embodiment, the communication device 20 can allow the account holder to select, via the user input device 20D or other means, multiple accounts or payment types or kinds so as to divide up the total transaction amount among the selected accounts or payment types or kinds. In a preferred embodiment, the account holder can specify, via the user input device 20D or other means, the amounts to be paid using each selected account or payment type of kind by specifying a monetary amount to be paid with or using, or by specifying a percentage of the total transaction cost to be paid with or using, each selected account or payment type of kind. In another preferred embodiment, the communication device 20 can be programmed to automatically allocate the payment of the transaction cost, either by monetary amounts or percentages, among the selected accounts or payment types of kinds.

In the preferred embodiment, the account holder will select a credit account or a credit card account for effecting payment. In another preferred embodiment, the account holder can select any other account, from among any of the herein-described types or kinds of accounts for use in the transaction.

In another preferred embodiment, the account holder can select any cryptocurrency or any cryptocurrency account for use in the transaction. In another preferred embodiment, the account holder can select to use a plurality of accounts and/or a cryptocurrency or a cryptocurrency account, or any number of cryptocurrencies or cryptocurrency accounts, along with any one or more of the herein-described types or kinds of accounts, so as to use any combination of an account or accounts and/or an account, a cryptocurrency or cryptocurrency account of any combination of cryptocurrencies and/or cryptocurrency accounts, in the transaction. In a preferred embodiment, the account holder can select one or more of the accounts and/or cryptocurrencies or cryptocurrency accounts which he or she wants to use in a transaction from a menu of accounts and/or cryptocurrencies or cryptocurrency accounts provided via the display device 20E of the communication device 20. In a preferred embodiment, the account holder's use of a combination of accounts, a cryptocurrency or cryptocurrency accounts and/or cryptocurrencies or cryptocurrency accounts, can provide for additional transaction security by providing an enhanced form of a multi-factor authentication for transactions.

At step 502, the merchant can process information regarding the transaction, which can involve the sale and/or purchase of any good(s), product(s), or service(s), sold or provided by the merchant and can inform the account holder of total amount to be paid for the transaction. At step 502, the merchant can then provide the merchant's transaction identifying information to the account holder along with the amount of the transaction. In a preferred embodiment, the merchant's transaction identifying information can, for example, include the merchant's name, and/or the name of the merchant's bank or financial institution, and/or the merchant's bank account number or identifier, or the merchant's financial account number or identifier, of, for, or associated with, the merchant's account to which payment is to be made. The merchant's transaction identifying information can also include any merchant information or any merchant account information which can be utilized to effectuate payment to the merchant or the merchant's account.

The merchant's transaction identifying information can also include data and/or information for or regarding contact information, or data and/or information for identifying contact information, for or regarding the merchant's counterparty communication device 40 or, in instances in which the merchant has associated therewith, or utilizes, a number of counterparty communications devices(s) 40, the merchant's transaction identifying information can also include data and/or information for or regarding contact information, or data and/or information for identifying contact information, for or regarding the merchant's counterparty communication device 40 which is being utilized by the merchant in the transaction, and/or any other data and/or information, contact information, or data and/or information for identifying the contact information, for or regarding the merchant's counterparty communication device 40. In a preferred embodiment, contact information for or regarding the merchant's counterparty communication device 40 can include, but not be limited to, telephone number, e-mail address, text messaging number, SMS messaging number or information, MMS messaging number or information, IP address, or any network identifier information, for or associated with the merchant's counterparty communication device 40.

In a preferred embodiment, the merchant's transaction identifying information can also include position or location information for the merchant so as to establish the merchant's position or location at the time of the transaction. In the case of a merchant operating at a fixed or known location, the position or location of the merchant, or of the merchant's counterparty communication device 40, can be included in or among the merchant's transaction identifying information. In a preferred embodiment, the position or location information for the merchant can also be stored the database 10H of the central processing computer 10 and/or the database 40H of the merchant's counterparty communication device 40. In another preferred embodiment, in a case where the merchant's counterparty communication device 40 is a mobile of wireless device, or any other device, which is not associated with a fixed location, then the position or location of the merchant's counterparty communication device 40 can be determined by the global positioning device 40J of the merchant's counterparty communication device 40, and the merchant's counterparty communication device 40 can be programmed to generate the merchant's transaction identifying information, for the transaction, so as to include the determined position or location information of the merchant's counterparty communication device 40 at the time of the transaction.

In a preferred embodiment, at step 503, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, and/or any other data and/or information contained or included in the merchant's transaction identifying information can be displayed on the display device 40E of the merchant's counterparty communication device 40.

In a preferred embodiment, at step 503, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, and/or any other data and/or information contained or included in the merchant's transaction identifying, can be displayed on the display device 40E, or displayed in any other manner, at the point of sale (POS) or point-of-transaction, as text and/or numerical information. The information can also be visually displayed at the point of sale (POS) or at the point-of-transaction in any appropriate or suitable manner.

In another preferred embodiment, at step 503, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, and/or any other data and/or information contained or included in the merchant's transaction identifying, can be displayed on the display device 40E, or displayed in any other manner, at the point of sale (POS) or point-of-transaction, in, on, or as, a barcode(s), a two-dimensional barcode(s), a QR (Quick Response) code(s), or, on, or as, any other machine readable medium or form, or any combination of same. The information can also be visually displayed at the point of sale (POS) or at the point-of-transaction in any appropriate or suitable manner. In a preferred embodiment, the communication device 20 can be equipped with a barcode reader, a barcode scanner, a two-dimensional barcode reader, a two-dimensional barcode scanner, a QR code reader, a QR code scanner, an imaging device, or a camera for obtaining an image of a barcode, a two-dimensional barcode, and/or a QR code, and/or a two-dimensional image sensor, for reading or scanning and/or for inputting information contained in, the respective barcode, two-dimensional barcode, and/or QR code, and for inputting same into the communication device 20.

In another preferred embodiment, at step 503, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, and/or any other data and/or information contained or included in the merchant's transaction identifying, can be stored on or encoded on a magnetic stripe or other storage device or medium and can be provided to the account holder by the merchant or the merchant's agent or employee to the account holder. For example, the account holder can be handed a plastic card or any other type of card having a magnetic stripe on which the information is stored and which can be read by a card reader or swipe card reader of or used in connection with the communication device 20. In the preferred embodiment, the communication device 20 can have a card reader or a swipe card reader as a user input device 20D either attached to, removeably attached to, or integrated with, the communication device 20 so that the account holder can swipe the card to input the transaction identifying information into the communication device 20.

At step 504, the account holder can enter or input the merchant's transaction identifying information into communication device 20. At step 504, the account holder can enter any of the data and/or information contained in the merchant's transaction identifying information into the communication device 20 by using any appropriate user input device 20D. For example, the account holder, at step 504, can also input or enter any text or numerical information into the communication device 20 via a keyboard or keypad, via a mouse or user pointing device, via a touch pad or touch screen, via a camera or video recording device, via a microphone or audio recording device and/or voice recognition software or equipment, or via any other input device. At step 504, the account holder can also input or enter any information contained in any barcode(s), two-dimensional barcode(s), and/or QR code(s) using a respective barcode reader, barcode scanner, two-dimensional barcode reader, two-dimensional barcode scanner, QR code reader, QR code scanner, imaging device, a camera for obtaining an image of a barcode, a two-dimensional barcode, and/or a QR code, or a two-dimensional image sensor, as an input device 20D. For example, the account holder, at step 504, can also input or enter any data and/or information store on a magnetic stripe, magnetic stripe card, or any other magnetic storage medium, by swiping same through a card or stripe reader or scanner as an input device 20D.

At step 504, the account holder can also enter information regarding the amount of the transaction or the transaction amount into the communication device 20. At step 505, the communication device 20 will process the data and/or information contained in the merchant's transaction identifying information or any portion of same, the information regarding the amount of the transaction or transaction amount, and the information regarding the credit account or the credit card account, or any other account for effectuating payment, selected by the account holder for effecting payment to the merchant. In another preferred embodiment, if the account holder has selected to use any combination of accounts, a cryptocurrency, a cryptocurrency account, or any number of cryptocurrencies or cryptocurrency accounts, or any combination of same, in the transaction, then the communication device 20 will process the data and/or information for each of the selected combination of accounts, a cryptocurrency, a cryptocurrency account, or any number of cryptocurrencies or cryptocurrency accounts, or any combination of same. In a preferred embodiment, the communication device 20 can also create, and store in the database 20H, a transaction record for or corresponding to the transaction. In a preferred embodiment, the transaction record can include information regarding the transaction, the date and time of the transaction, the location of the transaction, which in a preferred embodiment, can be determined using the global position device 20J of the communication device 20, and any data and/or information contained in the merchant's transaction identifying information. In a preferred embodiment, the transaction record for or corresponding to the transaction can also include information regarding the account utilized in the transaction and, where a combination of accounts, a cryptocurrency, a cryptocurrency account, or any number of cryptocurrencies or cryptocurrency accounts, or any combination of same, are used in the transaction, information regarding each such account, cryptocurrency, or cryptocurrency account.

At step 506, the communication device 20 will generate a transaction authorization message. In a preferred embodiment, the transaction authorization message, which is generated by the communication device 20, at step 506, can contain or include any data and/or information needed or required for submitting same to the central processing computer 10, which services the selected credit account or credit card account, or other payment account, of the account holder, for transaction authorization processing. In a preferred embodiment, the data and/or information contained or included in the transaction authorization message can include information regarding the credit account or the credit card account, or other account, and/or the account number or other identifier of same, and/or the account expiration date and/or security code information. In a preferred embodiment, where a combination of accounts, a cryptocurrency, a cryptocurrency account, or any number of cryptocurrencies or cryptocurrency accounts, or any combination of same, are used in the transaction, the communication device 20 will generate a transaction authorization message for each such account, cryptocurrency, or cyptocurrency account and transmit same to the central processing computer 10 for appropriate processing. It is to be noted that the central processing computer 10, in a preferred embodiment, can be or can include multiple central processing computers 10, multiple computers, and/or multiple computer systems, for enabling the apparatus 100 to process all transactions necessary involving all accounts, cryptocurrencies, or cryptocurrency accounts, utilized in the transaction.

In a preferred embodiment, the data and/or information contained or included in the transaction authorization message, or in each of the transaction authorization messages, can also include data and/or information regarding the merchant, the merchant's bank, and/or the account number or other identifying information for the merchant's bank account or the merchant's financial account to which payment is to be made. In a preferred embodiment, the data and/or information contained or included in the transaction authorization message, or in each of the transaction authorization messages, can also include data and/or information regarding the amount of the transaction or transaction amount.

In a preferred embodiment, the data and/or information contained or included in the transaction authorization message, or in each of the transaction authorization messages, can also include data and/or information regarding the position or the location of the communication device 20, as determined by the global positioning device 20J of the communication device 20, at the time of the generation of the transaction authorization message or each of the transaction authorization messages. In a preferred embodiment, the position or the location information can be utilized in order to identify the position or the location of the communication device 20 at the time of the generation of the transaction authorization message or each of the transaction authorization messages, and/or at the time of the transaction, in order to determine whether the transaction, or the respective transaction, is an authorized transaction or an unauthorized transaction, or to identify a fraudulent use of an account in an instance in which the account holder was not at that position or that location at the time of the transaction or at the time of the attempted transaction. It is also important to note that, in instances where the communication device 20 is located at a fixed location, the position or location information for the communication device 20 can be stored in the database 20H of the communication device 20. The position or location information for the communication device 20 can also be stored in the database 10H of the central processing computer 10.

In a preferred embodiment, the data and/or information contained or included in the transaction authorization message, or each of the transaction authorization messages, can also include data and/or information regarding the date and time of the transaction.

In a preferred embodiment, the transaction authorization message can also be generated so as to include information identifying the communication device 20 which is being utilized in the transaction. In a preferred embodiment, the communication device 20 can store the transaction authorization message in the transaction record for the transaction. In a preferred embodiment, where a combination of accounts, a cryptocurrency, a cryptocurrency account, or any number of cryptocurrencies or cryptocurrency accounts, or any combination of same, are used in the transaction, each transaction authorization message can also be generated so as to include information identifying the communication device 20 which is being utilized in the transaction. In a preferred embodiment, the communication device 20 can store all of the transaction authorization messages in the transaction record for the transaction.

In a preferred embodiment, the communication device 20 can be, or can include hardware and software to allow it function as, and/or can function in a same, a similar, and/or analogous, manner as a point of sale (POS) transaction processing system or a point of sale (POS) transaction processing device, a point of sale (POS) transaction authorization device, or as a point-of-transaction transaction device or a point-of-transaction transaction authorization device. In another preferred embodiment, the communication device 20 can be equipped as a point of sale (POS) transaction processing system or device. In a preferred embodiment, the communication device 20 can store, for each account used by the account holder and for which information is stored in the database 20H of the communication device 20, the telephone number, e-mail address, text messaging number, SMS messaging number or information, MMS messaging number or information, IP address, or any network identifier information, for each central processing computer 10 which services each account and/or which performs transaction authorization processing for each account.

In a preferred embodiment, the communication device 20, for example, can be programmed to telephone the central processing computer 10, to establish a communication link with same, to transmit the transaction authorization message to the central processing computer 10, and to receive any signal(s), data, information, or message(s) described herein as being transmitted to the communication device 20 from the central processing computer 10 in the transaction authorization process and/or otherwise. In a preferred embodiment, where a combination of accounts, a cryptocurrency, a cryptocurrency account, or any number of cryptocurrencies or cryptocurrency accounts, or any combination of same, are used in the transaction, the communication device 20, for example, can be programmed transmit each of the transaction authorization messages to the central processing computer 10, and to receive any signal(s), data, information, or message(s) described herein as being transmitted to the communication device 20 from the central processing computer 10 in the transaction authorization process and/or otherwise.

In a preferred embodiment, the communication link between the communication device 20 and the central processing computer 10 can be established on, over, or via, a communication network or system, a telephone communication network or system, a wireless communication network or system, the Internet, the World Wide Web, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems. In a same, a similar, and/or an analogous, manner, the communication device 20 can also establish a communication link with a respective central processing computer 10 using the telephone number of the central processing computer 10, or and e-mail address, text messaging number, SMS messaging number or information, MMS messaging number or information, IP address, or any network identifier information, or, for, or associated with, the respective central processing computer 10.

At step 506, the account holder can also be prompted or instructed to take a picture or himself or herself and/or the merchant or an employee or agent of the merchant, and/or the account holder can be prompted or instructed to record a video clip of himself or herself and/or the merchant or an employee or agent of the merchant, and store same in a picture file or a video file, and/or the account holder can be prompted or instructed to record a voice sample and/or a conversation between himself or herself and the merchant or the employee of the merchant and store same in an audio file.

At step 506, the merchant or an employee or agent of the merchant can also be prompted or instructed to take a picture or himself or herself and/or the account holder, and/or record a video clip of himself or herself and/or the account holder, and store same in a picture file or a video file, and/or the merchant or an employee or agent of the merchant can be prompted or instructed to record a voice sample and/or a conversation between himself or herself and the account holder and store same in an audio file. In another preferred embodiment, the account holder can also take a picture or record a video clip of any goods or products involved in, or the subject of, the transaction, or can record a video clip and/or an audio clip of himself or herself and/or the merchant or an employee or agent of the merchant engaging in a conversation regarding the transaction. In a preferred embodiment, any data and/or information, and/or any picture(s), video clip(s), and/or audio clip(s), obtained at step 506 can also stored in the transaction record for the transaction in the database 20H of the communication device 20.

At step 507, the communication device 20 can transmit the transaction authorization message to the central processing computer 10. In a preferred embodiment, where a combination of accounts, a cryptocurrency, a cryptocurrency account, or any number of cryptocurrencies or cryptocurrency accounts, or any combination of same, are used in the transaction, each transaction authorization message can be transmitted to the central processing computer 10 at step 507. At step 507, the communication device 20 can also transmit the picture, the video file, and/or the audio file, to the central processing computer 10. At step 507, the communication device 20 can also transmit the picture, the video file, and/or the audio file, to the counterparty communication device 40. At step 507, the counterparty communication device 40 can also transmit the picture, the video file, and/or the audio file, to the central processing computer 10. At step 507, the counterparty communication device 40 can also transmit the picture, the video file, and/or the audio file, to the communication device 20. At step 507, the communication device 20 can also store any information regarding the merchant's transaction identifying information, the amount of the transaction or transaction amount, the transaction authorization message, the picture, the video file, and/or the audio file, pertaining to the transaction in the database 20H of the communication device 20 and/or in any file or record for or associated with the credit account or the credit card account, or other account being utilized. At step 507, the communication device 20 can also transmit the picture, the video file, and/or the audio file, to the merchant's counterparty communication device 40.

At step 508, the central processing computer 10 will receive and process the data and/or information contained in the transaction authorization message. At step 508, the central processing computer 10 can also process any data and/or information regarding the transaction and determine whether the transaction is allowed or authorized or disallowed or not authorized. At step 508, the central processing computer 10 can perform any processing routine(s) typically performed by a transaction authorization processing computer for the account in order to determine whether the transaction is authorized or allowed or not authorized or not allowed. In a preferred embodiment, in determining whether or not the transaction is authorized or allowed or not authorized or not allowed, the central processing computer 10 can also determine whether or not the account is active or not-active, or whether or not a hold has been placed on the account to prevent the account's use in any transaction(s), or whether or not an account card has been lost or stolen, or reported lost or stolen, or whether or not the transaction is deemed to be unusual for the account holder, or whether or not an account number has been reported as having been compromised or inadvertently released to others, or whether or not account security has been breached, or whether or not the transaction is prohibited by any limitation(s) or restriction(s) placed on the account, or whether or not an account credit or spending limit has been reached.

At step 508, the central processing computer 10 can also utilize any information regarding the position or the location of the communication device 20, as determined by the global positioning device 20J of the communication device 20, at the time of the generation of the transaction authorization message in order to determine whether or not the transaction is allowed or authorized or disallowed or not authorized. It is envisioned that an account holder can, at any time, place a geographical limitation(s) or restriction(s) on a use of the account. In this regard, by processing information regarding the position or the location of the communication device 20 at the time of the generation of the transaction authorization message, the central processing computer 10 can also, at step 508, determine whether or not the transaction is allowed or authorized or disallowed or not authorized in view of any such geographical limitation(s) or restriction(s) which may have been placed on the use of the account. In another preferred embodiment, the position or the location information, determined by the global positioning device 20J and transmitted along with the transaction authorization message, can be utilized by the account holder to show or prove that he or she was not at the location or place of, and, therefore, did not engage in, the transaction.

At step 508, the central processing computer 10 can also process data and/or information contained or included in the transaction authorization message in order to determine whether or not the communication device 20, which is identified as being utilized in the transaction, is an authorized communication device 20 which can be used in connection with transactions on or involving the account used for effectuating payment in or for the transaction.

In another preferred embodiment, where a combination of accounts, a cryptocurrency, a cryptocurrency account, or any number of cryptocurrencies or cryptocurrency accounts, or any combination of same, are used in the transaction, the central processing computer 10 will, at step 508, receive and process the data and/or information contained in each of the transaction authorization messages transmitted from the communication device 20 in the same and/or in a similar manner as described herein.

At step 508, the central processing computer 10 can also generate an account holder alert message or an account holder notification message, containing information regarding the transaction, including, but not limited to, the credit account or credit card account, or other account, involved, the merchant involved, and the amount of the transaction or transaction amount. In another preferred embodiment, where a combination of accounts, a cryptocurrency, a cryptocurrency account, or any number of cryptocurrencies or cryptocurrency accounts, or any combination of same, are used in the transaction, the central processing computer 10, at step 508, can generate the account holder alert message or an account holder notification message to include information regarding and/or identifying each of, and/or all of, the accounts, a cryptocurrency, a cryptocurrency account, or any number of cryptocurrencies or cryptocurrency accounts, or any combination of same, used in the transaction. In another preferred embodiment, the account holder alert message or an account holder notification message can also contain or include or have attached thereto the picture, the video file, and/or the audio file, submitted by the account holder. In another preferred embodiment, the account holder alert message can also contain or include data and/or information for identifying the communication device 20 utilized in the transaction. In this regard, the apparatus 100 and method of the present invention can also be utilized to provide an account holder with an alert message or a notification message so as to alert or notify the account holder regarding the use of the communication device 20 in a transaction involving an account of the account holder. At step 508, the central processing computer 10 can also transmit the account holder alert message or the account holder notification message to the communication device 20 and/or to another communication device 20, or to any number of communication devices 20, associated with the account holder.

At step 508, the central processing computer 10 can also generate a merchant alert message or a merchant notification message, containing information regarding the transaction, including, but not limited to, the credit account or credit card account, or other account, involved, the account holder involved, and the amount of the transaction or transaction amount. In another preferred embodiment, the merchant alert message or the merchant notification message can also contain or include or have attached thereto the picture, the video file, and/or the audio file, submitted by the account holder.

In a preferred embodiment, at step 508, the central processing computer 10 can also process any data and/or information contained in the merchant's transaction identifying information and/or any data and/or information stored in the database 10H for or regarding the merchant in order to identify, ascertain, or obtain, any needed contact information, telephone number, wireless telephone number, e-mail address, test messaging number, SMS messaging number, MMS messaging number, IP address, or network identifier information, for merchant's counterparty communication device 40 for use in establishing a communication link with the merchant's counterparty communication device 40. In a preferred embodiment, in instances where a merchant has more than one merchant counterparty communication devices 40, such as, but not limited to, instances when a retail merchant utilizes a counterparty communication device 40 or any number of counterparty communication devices 40 at any one or at any number of check-out locations, cashier locations, or point-of-sale transaction processing locations, the central processing computer 10 can process any data and/or information contained in the merchant's transaction identifying information and/or any data and/or information stored in the database 10H for or regarding the merchant in order to identify, ascertain, or obtain, any needed contact information, telephone number, wireless telephone number, e-mail address, test messaging number, SMS messaging number, MMS messaging number, IP address, or network identifier information, for the particular merchant's counterparty communication device 40 which is being utilized in the transaction. In a preferred embodiment, at step 508, the central processing computer 10 can also establish any needed or desired communication link with and between the counterparty communication device 40.

At step 508, the central processing computer 10 can also transmit the merchant alert message or the merchant notification message to the counterparty communication device 40 and/or to another counterparty communication device 40, or to any number of counterparty communication devices 40, associated with the merchant.

At step 508, the merchant can also transmit any supporting documentation or other transaction supporting information regarding the transaction from the merchant's counterparty communication device 40 to the central processing computer 10. For example, in the case of transaction involving the sale of goods, the merchant can transmit information regarding the goods involved in the transaction or an invoice or receipt. In another preferred embodiment, in which the apparatus of FIGS. 5A and 5B can be utilized in connection with claim being made pursuant to a healthcare insurance account or policy, once the healthcare provider receives the alert message or the notification message at step 508, which can represent that the healthcare insurance claim submission process has been initiated by the insured account holder, the healthcare provider can then transmit or submit, from his, her, or its, counterparty communication device 40 or from any other counterparty communication device 40, the healthcare insurance claim or claim form and/or any other documentation or supporting documentation to the central processing computer 10 for processing and/or payment.

In another preferred embodiment, the central processing computer 10 can, at step 508 or at any other time, transmit a position or a location request message to the merchant's counterparty communication device 40 in order to ascertain the position or the location of the merchant's counterparty communication device 40 at the time of the transaction or during the processing of the transaction. In this preferred embodiment, the merchant's counterparty communication device 40 can receive the position or the location request message, the global positioning device 40J of the merchant's counterparty communication device 40 can determine the position or the location of the merchant's counterparty communication device 40 in response to the position or the location request message, and the merchant's counterparty communication device 40 can transmit the position or the location information to the central processing computer 10. The central processing computer 10 can, at step 508 or at any other time, compare the position or the location of the communication device 20 with the position or the location of the merchant's counterparty communication device 40 in order to verify that the communication device 20 and the merchant's counterparty communication device 40 are at the same location or in close proximity to each other, thereby evidencing the likelihood that the parties are engaged in an authorized transaction. For example, if the transaction is an in-store transaction, it would be expected that the communication device 20 and the merchant's counterparty communication device 40 would be at the same location or in close proximity with one another, and such might be indicative that the transaction is an authorized transaction. If, on the other hand, it is determined that the communication device 20 and the merchant's counterparty communication device 40 are not at the same location or not in close proximity with one another, then such might be indicative that the transaction is not an authorized transaction.

In another preferred embodiment, if the information regarding the position or the location of the communication device 20 is ascertained by the global positioning device 20J and transmitted to the central processing computer 10 in the transaction authorization message, the information regarding the position or the location of the communication device 20 can also be included in or contained in the account holder alert message or the account holder notification message. In another preferred embodiment, if the information regarding the position or the location of the merchant's counterparty communication device 40 is ascertained by the global positioning device 40J and transmitted to the central processing computer 10, the information regarding the position or the location of the merchant's counterparty communication device 40 can also be included in or contained in the account holder alert message or the account holder notification message.

In another preferred embodiment, if the information regarding the position or the location of the communication device 20 is ascertained by the global positioning device 20J and transmitted to the central processing computer 10 in the transaction authorization message, the information regarding the position or the location of the communication device 20 can also be included in or contained in the merchant alert message or a merchant notification message. In another preferred embodiment, if the information regarding the position or the location of the merchant's counterparty communication device 40 is ascertained by the global positioning device 40J and transmitted to the central processing computer 10, the information regarding the position or the location of the merchant's counterparty communication device 40 can also be included in or contained in the merchant alert message or a merchant notification message.

In another preferred embodiment, in an instance when an account holder has notified one or more of the issuers or services of any of his or her accounts, that he or she will be traveling to a certain destination or destinations, the central processing computer 10 can compare the position or location of the communication device 20 with the position or location of the destination or destination as a manner by which to determine that the transaction is an authorized or an unauthorized transaction.

At step 509, the central processing computer 10 will determine whether the transaction is authorized or allowed or not authorized or not allowed. If, at step 509, the central processing computer 10 determines that the transaction is authorized or allowed, the operation of the central processing computer 10 will proceed to step 510 and the central processing computer 10 will generate a transaction authorized message and will transmit same to the merchant's counterparty communication device 40.

In another preferred embodiment, the central processing computer 10 can utilize the position or location data of either or both of the communication device 20 and/or the merchant's counterparty communication device 40, in any appropriate manner, in order to determine if the transaction authorized or allowed or not authorized or not allowed. In another preferred embodiment, the central processing computer 10 can utilize the position or location data of either or both of the communication device 20 and/or the merchant's counterparty communication device 40, along with or in conjunction with any limitation(s) or restriction(s) placed on the account, in any appropriate manner, in order to determine if the transaction authorized or allowed or not authorized or not allowed.

In a preferred embodiment, the central processing computer 10 can establish any needed communication link(s) with the counterparty communication device 40 prior to transmitting any of the above-described merchant alert message(s), merchant notification message(s), transaction authorized message(s), and/or any other messages, data, information, or signals, described herein as being transmitted from the central processing computer 10 to the counterparty communication device 40.

In a preferred embodiment, the communication link or any communication link between the central processing computer 10 and the counterparty communication device 40 can be established on, over, or via, a communication network or system, a telephone communication network or system, a wireless communication network or system, the Internet, the World Wide Web, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems. In a same, a similar, and/or an analogous, manner, the central processing computer 10 can also establish a communication link with a respective counterparty communication device 40 using the telephone number of the counterparty communication device 40, or and e-mail address, text messaging number, SMS messaging number or information, MMS messaging number or information, IP address, or any network identifier information, or, for, or associated with, the respective counterparty communication device 40.

At step 510, the central processing computer 10 can or will also effectuate payment, make payment, or transmit a payment message or a payment commitment message, evidencing and/or guaranteeing to the merchant that payment is being made or will be made to the merchant's account at the merchant's bank or the merchant's counterparty bank computer system 50. At step 510, the central processing computer 10 can also transmit the payment message and/or the payment commitment message to the merchant's counterparty communication device 40 and/or to the merchant's counterparty bank computer system 50. At step 510, the central processing computer 10 can also transmit the transaction authorized message, the payment message and/or the payment commitment message, to the communication device 20.

In a preferred embodiment, at step 510, the central processing computer 10 can process any data and/or information for effectuating or making payment to the merchant's account or effectuating the making of an appropriate credit to the merchant's account and/or can make the payment to the merchant's account or apply the credit to the merchant's account. At step 510, the central processing computer 10 can process any data and/or information for effectuating or for making payment to the merchant or the merchant's account and/or can effectuate or make any corresponding entry, payment, and/or a respective credit, debit, or charge, entry, and/or effectuate or make any appropriate accounting entry or accounting entries to the account holder's account and/or to the merchant's account. In a preferred embodiment, at step 510, the central processing computer 10 can effectuate or make any accounting entry or accounting entries to the account holder's account by generating and transmitting a signal, data, information, or a message, to the account holder's account holder bank computer system 30. The central processing computer 10 can also effectuate or make any accounting entry or accounting entries to the merchant's account by generating and transmitting a signal, data, information, or a message, to the merchant's counterparty bank computer system 50. In this regard, an account holder can utilize his or her account in a transaction involving a counterparty without having to provide his or her account information to that counterparty.

In another preferred embodiment, where a combination of accounts, a cryptocurrency, a cryptocurrency account, or any number of cryptocurrencies or cryptocurrency accounts, or any combination of same, are used in the transaction, the central processing computer 10 can, at step 510, perform the operations described herein for each of, and/or for all of, the accounts, cryptocurrency, or cryptocurrency account, or any number of cryptocurrencies or cryptocurrency accounts, or any combination of same, used in the transaction.

At step 510, the merchant can then complete the transaction. Thereafter the operation of the apparatus 100 will proceed to step 512.

If, at step 509, the central processing computer 10 determines that the transaction is not authorized or not allowed, the operation of the central processing computer 10 will proceed to step 511 and the central processing computer 10 will generate a transaction not authorized message and will transmit same to the merchant's counterparty communication device 40. At step 511, the central processing computer 10 can also transmit the transaction not authorized message to the communication device 20. At step 511, the merchant can then terminate the transaction. Thereafter the operation of the apparatus 100 will proceed to step 512.

At step 512, the central processing computer 10 can store in the database 10H any and/or all data and/or information regarding the transaction, the transaction authorization message, the picture, the video file, the audio file, the transaction authorized message, or the transaction not authorized message, and, if applicable, any payment message or payment commitment message, for or relating to the transaction or for each transaction. In another preferred embodiment, where a combination of accounts, a cryptocurrency, a cryptocurrency account, or any number of cryptocurrencies or cryptocurrency accounts, or any combination of same, are used in the transaction, the central processing computer 10 can, at step 512, store, in the database 10H, any and/or all data and/or information regarding the transaction, the transaction authorization messages, the picture, the video file, the audio file, the transaction authorized messages, or the transaction not authorized message, and, if applicable, any payment message, payment commitment message, payment messages, or payment messages for each account, cryptocurrency, or cryptocurrency account, used in the transaction. The central processing computer 10 can also store in the database 10H any account holder alert message, account holder notification message, merchant alert message, or merchant notification message, generated for each transaction. The central processing computer 10 can also store in the database 10H any transaction supporting documentation or information regarding the transaction. Thereafter, the operation of the apparatus 100 will cease at step 513.

In the above-described manner, the apparatus 100 and method of the present invention allows an account holder to engage in a transaction with a merchant or a counterparty without having to provide the merchant or the counterparty with any information regarding his or her account and without having to provide an account number, account identifier, or any other account information, which can be subject to any misappropriation or misuse. In any and/or all of the embodiments described herein, the apparatus 100 and method of the present invention can be utilized in a same, a similar, and/or an analogous, manner, with any of the herein-described communication devices 20. In any and/or all of the embodiments described herein, the apparatus 100 and method of the present invention can be utilized in a same, a similar, and/or an analogous, manner, with any of the herein-described accounts.

In the above-described manner, the apparatus 100 and method of the present invention also allows an account holder to engage in a transaction with a merchant or a counterparty by using any combination of accounts, a cryptocurrency, a cryptocurrency account, or any number of cryptocurrencies or cryptocurrency accounts, in a transaction, without having to provide the merchant or the counterparty with any information regarding any of his or her accounts, cryptocurrency, cryptocurrency account, or any number of cryptocurrencies or cryptocurrency accounts, and without having to provide an account number, account identifier, or any other account information, which can be subject to any misappropriation or misuse. In any and/or all of the embodiments described herein, the apparatus 100 and method of the present invention can also be utilized in a same, a similar, and/or an analogous, manner, with any of the herein-described communication devices 20. In any and/or all of the embodiments described herein, the apparatus 100 and method of the present invention can also be utilized in a same, a similar, and/or an analogous, manner, with any of the herein-described accounts, cryptocurrencies, or cryptocurrency accounts, or any combination of same.

In any and/or all of the preferred embodiments described herein, any of the transaction authorized messages described herein will not contain or will not include any data and/or information regarding the account of the account holder which is utilized in the transaction. In any and/or all of the preferred embodiments described herein, any of the transaction not authorized messages described herein will not contain or will not include any data and/or information regarding the account of the account holder which is utilized in the transaction. In any and/or all of the preferred embodiments described herein, any of the signals, data, information, or messages, described herein as being transmitted from the central processing computer 10 to the counterparty communication device 40 will not contain or will not include any data and/or information regarding the account of the account holder which is utilized in the transaction.

In another preferred embodiment, as well as any and/or all of the embodiments described herein, the transaction authorization message or transaction authorizations messages, if utilized, can also contain or include fingerprint scan data and/or information or fingerprint recognition data and/or information of the account holder or user involved in the transaction, with such fingerprint scan data and/or information or fingerprint recognition data and/or information being obtained by and/or using the communication device 20. In another preferred embodiment, as well as any and/or all of the embodiments described herein, the transaction authorization message or transaction authorizations messages, if utilized, can also contain or include fingerprint scan data and/or information or fingerprint recognition data and/or information of the merchant or the merchant's employee or agent involved in the transaction, with such fingerprint scan data and/or information or fingerprint recognition data and/or information being obtained by and/or using the communication device 20. In a preferred embodiment, the fingerprint scan data and/or information or fingerprint recognition data and/or information can be utilized in order to document or to ascertain the identity of the respective account holder, user, merchant, or merchant agent or merchant employee, involved in the transaction.

In another preferred embodiment, as well as any and/or all of the embodiments described herein, the transaction authorization message or transaction authorizations messages, if utilized, can also contain or include retinal scan data and/or information of the account holder or user involved in the transaction, with such retinal scan data and/or information being obtained by and/or using the communication device 20. In another preferred embodiment, as well as any and/or all of the embodiments described herein, the transaction authorization message or transaction authorizations messages, if utilized, can also contain or include retinal scan data and/or information of the merchant or the merchant's employee or agent involved in the transaction, with such retinal scan data and/or information being obtained by and/or using the communication device 20. In a preferred embodiment, the retinal scan data and/or information can be utilized in order to document or to ascertain the identity of the respective account holder, user, merchant, or merchant agent or merchant employee, involved in the transaction.

In any and/or all of the embodiments described herein, any of the herein-described communication devices 20 can be utilized in a same, a similar, and/or an analogous, manner in order to perform the same functionality described as being performed by the communication device 20 described in connection with the preferred embodiment of FIGS. 5A and 5B.

In any and/or all of the embodiments described herein, the apparatus 100 of the embodiment of FIGS. 5A and 5B can also be utilized in a same, a similar, and/or an analogous, manner, in connection with an on-line transaction, an Internet transaction, an electronic commerce transaction, a telephone transaction, or any other non-face-to-face transaction or non-in-person transaction.

In any and/or all of the embodiments described herein, any of the herein-described communication devices 20 can be utilized in a same, a similar, and/or an analogous, manner in order to perform the same functionality described herein as being performed by the communication device 20 and/or the central processing computer 10 described herein and/or described herein in connection with the preferred embodiment of FIGS. 5A and 5B.

In any and/or all of the embodiments described herein, the apparatus 100 of the embodiment of FIGS. 5A and 5B can also be utilized in a same, a similar, and/or an analogous, manner, in connection with an on-line transaction, an Internet transaction, an electronic commerce transaction, a telephone transaction, or any other non-face-to-face transaction or non-in-person transaction.

In any and/or all of the embodiments described herein, any of the various signals, data, information, and/or messages, or any other information, messages, communications, or transmissions, described herein as being generated or transmitted by any of the herein-described central processing computers 10, communication devices 20, and/or counterparty communication devices 40, can be generated and/or transmitted as or in an e-mail message, an instant messaging message, an SMS message, an MMS message, an electronic transmission, an electronic communication, an electronic data and/or information transfer, an electronic data and/or information exchange, interchange, or communication, a telephone call message, a recorded telephone call message, an answering machine message, a facsimile transmission, a facsimile message, or any other message, communication, or transmission.

In another preferred embodiment of the embodiment of FIGS. 5A and 5B, the manufacturer, brand name, model, and/or serial number, and/or IP address, of each communication device 20 associated with any account can be registered with the central processing computer 10 for processing transactions of the account. In another preferred embodiment, an account holder can limit or restrict account use to use in connection with a registered communication device 20 or to use in connection with one or more registered communication devices 20. In another preferred embodiment, the information regarding the manufacturer, the brand name, the model, and/or the serial number, and/or the IP address, of the communication device 20 used in the transaction can be included in the transaction authorization message. Thereafter, the central processing computer 10 can process the information in the transaction authorized message in connection with the information regarding the communication device 20 registered with the account and can, at step 508, authorize or allow the transaction if the communication device 20 is confirmed as being a communication device registered with the account, or the central processing computer 10 and not authorize or will disallow the transaction if the communication device 20 is determined to not be a registered communication device 20 on the account.

In another preferred embodiment wherein the account holder and the merchant are engaged in on-line transaction or an Internet transaction, at step 503, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, can be transmitted from the merchant's counterparty communication device 40 to the communication device and displayed on the display device 20E of the communication device 20.

The merchant's transaction identifying information, or any pertinent portion of same, can be transmitted to the communication device 20 can be contained in or displayed in or as text information, numerical information, or in, on, or as, a barcode(s), a two-dimensional barcode(s), a QR (Quick Response) code(s), or, on, or as, any other machine readable medium or form, or any combination of same. The account holder, in a preferred embodiment, can then utilize the merchant's transaction identifying information, or any pertinent portion of same, in any appropriate manner and/or as described herein in generating the transaction authorization message. As noted above, the communication device 20 can be equipped with a barcode reader, a barcode scanner, a two-dimensional barcode reader, a two-dimensional barcode scanner, a QR code reader, a QR code scanner, an imaging device, or a camera for obtaining an image of a barcode, a two-dimensional barcode, and/or a QR code, and/or a two-dimensional image sensor, for capturing, reading, or scanning, and/or for inputting, information contained in, the respective barcode, two-dimensional barcode, and/or QR code, and for inputting same into the communication device 20.

In another preferred embodiment, when the account holder and the merchant are engaged in a telephone transaction, the merchant's transaction identifying information, or any pertinent portion of same, can be verbally transmitted to or communicated to the account holder over the telephone to the communication device 20. The merchant's transaction identifying information, or any pertinent portion of same, can be verbally or orally transmitted to or communicated to the account holder by the merchant or merchant's employee and/or can be contained in pre-recorded audio message. The account holder, in a preferred embodiment, can then utilize the merchant's transaction identifying information, or any pertinent portion of same, in any appropriate manner and/or as described herein in generating the transaction authorization message.

In another preferred embodiment, the communication device 20 can, at step 505, be programmed to process any of the merchant's transaction identifying information, and/or information regarding the amount of the transaction or the transaction amount, and/or any information regarding, time, date, and/or the account used or selected, and/or any information regarding the position and/or location of the communication device 20, using any limitation(s) or restriction(s) placed on the account, and can automatically disallow the use of the account in the transaction prior to generating any transaction authorization message.

In another preferred embodiment, the account holder, at step 508, can transmit an alert response message or a notification response message to the central processing computer 10. The alert response message of the notification response message can contain information for allowing the transaction or disallowing the transaction. The central processing computer 10 can, at step 508, process the information contained in the alert response message or in the notification response message and, if the alert response message or in the notification response message contains information for cancelling or disallowing the transaction, the central processing computer 10 can disallow the transaction. If the alert response message or in the notification response message contains information for allowing the transaction, the central processing computer 10 can allow the processing of the transaction information to proceed as described at steps 508 and 509 herein.

In another preferred embodiment, the central processing computer 10 can also, at step 508, transmit a file photograph of the account holder and/or any user or individual authorized to use the account to the merchant's counterparty communication device 40 so that the merchant or the merchant's employee can ascertain if the individual conducting the transaction involving the account is, in fact, the account holder or an authorized user or individual. In another preferred embodiment, the central processing computer 10 can also, at step 508, transmit a file photograph of the counterparty or merchant to the communication device 20 so that the account holder can ascertain if the individual conducting the transaction involving the account is, in fact, the counterparty or merchant.

In another preferred embodiment, the apparatus 100 and method of the present invention can also be used to make recurring payments to a counterparty for or on behalf of the account holder. For example, if an account holder has a recurring bill or recurring bills, such as, for example, a regularly occurring bill or a monthly bill from a counterparty, the account holder can utilize the apparatus 100 and method of the present invention in order to pay the bill or bills when they are due to be paid. These recurring bills can be, but are not limited to, a monthly or other periodic bill from a utility service provider, a telephone company, an Internet service provider, a cable television company, a satellite television company, or any other provider of any good(s), product(s), or service(s), a healthcare professional, a legal professional, a bank, a financial institution, or a financial intermediary, or a club, a membership club or a membership association, a gym or fitness facility, an insurance company, or any other counterparty which may provide the account holder with a bill monthly, quarterly, semi-annually, annually, or at any other time interval.

In a preferred embodiment, the account holder can program the communication device 20 with information regarding the recurring bill, which information can include or contain information regarding the counterparty involved, any counterparty identifier information, any counterparty payment identifier information, any counterparty communication device 40 information, a telephone number of the counterparty's counterparty communication device 40, and/or a uniform resource locator (url), a website address, an IP address or web site address associated with the counterparty's transaction page or pages, or an IP address, of, assigned to, or associated with, the counterparty's counterparty communication device 40, and/or any other data and/or information regarding the counterparty, and/or any identifier information for or regarding the counterparty which can be utilized by the central processing computer 10 to identify and/or ascertain any of the herein described contact information for the counterparty's counterparty communication device 40, and/or any other data and/or information associated with the counterparty's counterparty communication device 40, and/or any data and/or information described herein as being included in or contained in the herein-described merchant's transaction identifying information for the counterparty, a counterparty's transaction identifying information for the counterparty, and/or the herein-described transaction authorization message.

The account holder can also program the communication device 20 with information regarding the account holder's account which is selected to be utilized in making the payment to the counterparty (“the selected account”), the date on which payment is to be made to the counterparty for the recurring bill, the transaction amount or an authorized range for the transaction amount for the recurring bill, and/or any counterparty issued or counterparty assigned account number or account identifier, billing number or billing identifier, or payment number or payment identifier, which was previously assigned to the account holder by the counterparty for the specific purpose of making the recurring payments to the counterparty, and/or any other data and/or information described herein as being included in or contained in the herein-described transaction authorization message.

In another preferred embodiment, the account holder can program the communication device 10 to effectuate a payment of a recurring bill by using any of the herein-described accounts, cryptocurrencies, or cryptocurrency accounts, or any combination of same.

Once programmed, the communication device 20 can automatically detect the occurrence of the date on which payment is to be made for the recurring bill, and, upon detecting the date on which the payment is to be made for the recurring bill, the communication device 20 can automatically access the central processing computer 10 which services the account holder's selected account. Thereafter, the central processing computer 10 can process information for the transaction and/or process information for authorizing the transaction, can access and communicate with the counterparty's counterparty communication device 40, and/or can determine if the transaction is authorized or allowed or not authorized or not allowed, and, if the transaction is determined to be authorized or allowed, the central processing computer 10 can make or effectuate the making of the payment to the counterparty pursuant to or for the recurring bill. The central processing computer 10 can make or effectuate the payment to the counterparty and/or can transmit a payment message or a payment commitment message, evidencing and/or guaranteeing to the counterparty that payment is being made or will be made to the counterparty's account at the counterparty's bank or the counterparty's counterparty bank computer system 50. The central processing computer can also transmit the payment message and/or the payment commitment message to the counterparty's counterparty communication device 40 and/or to the counterparty's counterparty bank computer system 50. The central processing computer 10 can also transmit the transaction authorized message, the payment message and/or the payment commitment message, to the communication device 20. The central processing computer 10 can also perform any function or functionality described herein as being performed by the central processing computer 10 at steps 510 and 512 of the embodiment of FIGS. 5A and 5B.

In making payment of the recurring bill, the central processing computer 10 can also provide the counterparty with the counterparty issued or counterparty assigned account number or account identifier, billing number or billing identifier, or payment number or payment identifier, which was previously assigned to the account holder by the counterparty so as to insure proper crediting to the account holder's account with the counterparty. In a preferred embodiment, the counterparty issued or counterparty assigned account number or account identifier, billing number or billing identifier, or payment number or payment identifier, which was previously assigned to the account holder by the counterparty, can be included in or contained in, or can be transmitted along with, the payment message and/or the payment commitment message.

In a preferred embodiment, the central processing computer 10, if applicable, can also perform any of processing steps and/or routines described herein as being performed by the central processing computer 10 in its interaction with the counterparty's counterparty communication device 40, in a same, a similar, and/or an analogous, manner as described herein in steps 508 through 512 of the embodiment of FIGS. 5A and 5B. In a preferred embodiment, the central processing computer 10 can report the transaction to the account holder by generating and transmitting an account holder alert message or an account holder notification message and can transmit same to the communication device 20 and/or to any other communication device(s) 20 of or associated with the account holder. In a preferred embodiment, the central processing computer 10 can also record and/or store any and/or all of the data and/or information pertaining to the transaction or the attempted transaction regarding the payment of the recurring bill.

In a preferred embodiment, the central processing computer 10, if applicable, can also perform any of processing steps and/or routines described herein as being performed by the central processing computer 10 in its interaction with the counterparty's counterparty communication device 40, in a same, a similar, and/or an analogous, manner as described herein in steps 508 through 512 of the embodiment of FIGS. 5A and 5B. In a preferred embodiment, the central processing computer 10 can also report the transaction to the account holder by generating and transmitting an account holder alert message or an account holder notification message and can transmit same to the communication device 20 and/or to any other communication device(s) 20 of or associated with the account holder. In a preferred embodiment, the central processing computer 10 can also record and/or store any and/or all of the data and/or information pertaining to the transaction or the attempted transaction regarding the payment of the recurring bill.

In another preferred embodiment, the account holder can use the communication device 20 in order to program the central processing computer 10, which services the account which is to be used in making the payment, to automatically make the payments to the counterparty for or regarding the recurring bill or recurring bills.

In a preferred embodiment, the account holder can use the communication device 20 to access the central processing computer 10, which services the account which is to be used in making the payment, and to program the central processing computer 10 with information regarding the recurring bill, which information can include or contain information regarding the counterparty involved, any counterparty identifier information, any counterparty payment identifier information, any counterparty communication device 40 information, a telephone number of the counterparty's counterparty communication device 40, and/or a uniform resource locator (url), a website address, an IP address or web site address associated with the counterparty's transaction page or pages, or an IP address, of, assigned to, or associated with, the counterparty's counterparty communication device 40, and/or any other data and/or information regarding the counterparty, and/or any identifier information for or regarding the counterparty which can be utilized by the central processing computer 10 to identify and/or ascertain any of the herein described contact information for the counterparty's counterparty communication device 40, and/or any other data and/or information associated with the counterparty's counterparty communication device 40, and/or any data and/or information described herein as being included in or contained in the herein-described merchant's transaction identifying information for the counterparty, a counterparty's transaction identifying information for the counterparty, and/or the herein-described transaction authorization message.

The account holder can also program the central processing computer 10, which services the account which is to be used in making the payment, with information regarding the account holder's account which is selected to be utilized in making the payment to the counterparty (“the selected account”), the date on which payment is to be made to the counterparty for the recurring bill, the transaction amount or an authorized range for the transaction amount for the recurring bill, and/or any counterparty issued or counterparty assigned account number or account identifier, billing number or billing identifier, or payment number or payment identifier, which was previously assigned to the account holder by the counterparty for the specific purpose of making the recurring payments to the counterparty, and/or any other data and/or information described herein as being included in or contained in the herein-described transaction authorization message.

Once programmed, the central processing computer 10 can automatically detect the occurrence of the date on which payment is to be made for the recurring bill, and, upon detecting the date on which the payment is to be made for the recurring bill, the central processing computer 10 can process information for the transaction and/or process information for authorizing the transaction, can access and communicate with the counterparty's counterparty communication device 40, and/or can determine if the transaction is authorized or allowed or not authorized or not allowed, and, if the transaction is determined to be authorized or allowed, the central processing computer 10 can effectuate the making of the payment to the counterparty pursuant to the recurring bill. The central processing computer 10 can make or effectuate the payment to the counterparty and/or can transmit a payment message or a payment commitment message, evidencing and/or guaranteeing to the counterparty that payment is being made or will be made to the counterparty's account at the counterparty's bank or the counterparty's counterparty bank computer system 50. The central processing computer can also transmit the payment message and/or the payment commitment message to the counterparty's counterparty communication device 40 and/or to the counterparty's counterparty bank computer system 50. The central processing computer 10 can also transmit the transaction authorized message, the payment message and/or the payment commitment message, to the communication device 20. The central processing computer 10 can also perform any function or functionality described herein as being performed by the central processing computer 10 at steps 510 and 512 of the embodiment of FIGS. 5A and 5B.

In making payment of the recurring bill, the central processing computer 10 can also provide the counterparty with the counterparty issued or counterparty assigned account number or account identifier, billing number or billing identifier, or payment number or payment identifier, which was previously assigned to the account holder by the counterparty so as to insure proper crediting to the account holder's account with the counterparty. In a preferred embodiment, the counterparty issued or counterparty assigned account number or account identifier, billing number or billing identifier, or payment number or payment identifier, which was previously assigned to the account holder by the counterparty, can be included in or contained in, or can be transmitted along with, the payment message and/or the payment commitment message.

In a preferred embodiment, the central processing computer 10, if applicable, can also perform any of processing steps and/or routines described herein as being performed by the central processing computer 10 in its interaction with the counterparty's counterparty communication device 40, in a same, a similar, and/or an analogous, manner as described herein in steps 508 through 512 of the embodiment of FIGS. 5A and 5B. In a preferred embodiment, the central processing computer 10 can also report the transaction to the account holder by generating and transmitting an account holder alert message or an account holder notification message and can transmit same to the communication device 20 and/or to any other communication device(s) 20 of or associated with the account holder. In a preferred embodiment, the central processing computer 10 can also record and/or store any and/or all of the data and/or information pertaining to the transaction or the attempted transaction regarding the payment of the recurring bill.

In another preferred embodiment, the communication device 20 can store electronic money or electronic funds which can be transferred to the communication device 20 in a transaction and/or which can also be transferred from the communication device 20 in a transaction. In this preferred embodiment, a digital representation of the electronic money or the electronic funds can be stored in the database 20H of the communication device 20. Electronic money or electronic funds can be added or electronically deposited into the communication device 20 and can be electronically withdrawn when needed to make a payment pursuant to a transaction. In this preferred embodiment, the communication device 20 can also serve as an electronic wallet.

In another preferred embodiment, the counterparty communication device 40 can also store electronic money or electronic funds which can be transferred to the counterparty communication device 40 in a transaction and/or which can also be transferred from the counterparty communication device 40 in a transaction. In this preferred embodiment, a digital representation of the electronic money or the electronic funds can be stored in the database 40H of the counterparty communication device 40. Electronic money or electronic funds can be added or electronically deposited into the counterparty communication device 40 and can be electronically withdrawn when needed to make a payment pursuant to a transaction. In this preferred embodiment, the counterparty communication device 40 can also serve as an electronic wallet.

In another preferred embodiment, any of the herein-described communication devices 20 can be utilized as an electronic wallet and/or an personal electronic valet which can store information regarding, and enable an account holder or individual to gain immediate access to and/or use of, any and/or all of an account holder's or an individual's various accounts, which can be or which can include any and/or all of the account holder's or the individual's credit card accounts, credit accounts, charge card accounts, charge accounts, debit card accounts, or debit accounts, bank accounts, checking accounts, or savings accounts, gambling accounts, gaming accounts, sports betting accounts, lottery gaming accounts, lottery accounts, brokerage accounts, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, electronic money accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, text messaging accounts, customer loyalty accounts, social network membership accounts, or any other accounts of any type or kind.

In addition to providing access to and use of any and/or all of the account holder's or the individual's various accounts, the communication device 20 can also store and provide immediate access to the account holder's or the individual's driver's license, identification information, social security card, any professional license(s), vehicle registration(s), automobile insurance card(s), passport(s), home insurance policy, malpractice insurance policy, health insurance policy, life insurance policy, disability insurance policy, employee identification information, student identification information, association or club membership information, and/or an electronic version or any account card(s) associated with any of the account holder's various accounts, memberships, club memberships, and/or any other activities. In this regard, the communication device 20 can also store and provide easy access to any other information, personal information, and/or professional information, regarding the account holder or the individual.

In another preferred embodiment, the apparatus 100 and method of the present invention can be utilized to dispense with the need for using paper checks in connection with transactions involving bank accounts, checking accounts, or savings accounts. A counterparty need only provide an account holder with information regarding the account in or into which a payment is to be made, the account holder can effectuate payment in a same, a similar, or an analogous, manner as described herein, and payment can be made to a respective account of the counterparty.

In another preferred embodiment, the apparatus 100 and method of the present invention can be utilized to dispense with the need to provide any account information, or any other information, of, associated with, or regarding, a respective account holder to a counterparty in a transaction.

In another preferred embodiment, the account holder need only be identified as a payor or payer in a transaction by his or her name, user name, e-mail address, or any other identifier, without his or her respective account or account number, or other account identifying information, having to be disclosed to the counterparty.

The apparatus 100 and method of the present invention provides account security and/or transaction security by allowing an account holder to engage in a transaction without having to disclose or divulge, or without having to provide, to a counterparty, any of his or her account information. Further, the apparatus 100 and method of the present invention provides account security and/or transaction security for the counterparty as the counterparty need only provide account information for an account to which only a payment can be made. Put simply, the counterparty is only using an account for which he, she, or it, can only be paid, and/or the counterparty is only using an account which can never be used to create a liability for the counterparty or otherwise expose the counterparty to a liability.

In a preferred embodiment, with the account of the counterparty being one for or to which a payment can only be made to the counterparty, and not an account which from which a payment can from the counterparty, the counterparty's account is protected as well. In this regard, the apparatus 100 and method of the present invention provides account security and/or transaction security to or for the account of the account holder and to or for the account of a counterparty in a transaction.

In any and/or all of the embodiments described herein, any of the counterparties described herein can also be any merchant, vendor, supplier, goods provider, products provider, service provider, professional services provider, healthcare services provider, entertainment services provider, legal services provider, insurance company or provider, or any other individual, person, or entity, or any third party who or which can engage in any type or kind of transaction with any other individual, person, entity, or account holder.

In any and/or all of the embodiments described herein, any central processing computer 10 can also be programmed to automatically generate a periodic transaction record(s) or a periodic transaction statement(s) showing activity and/or transactions, and/or attempted transactions, on or involving a respective account. In a preferred embodiment, the central processing computer 10 can generate and transmit the periodic transaction record(s) or periodic transaction statement(s) to the communication device 20 of the account holder or authorized user or individual periodically, daily, weekly, monthly, bi-monthly, quarterly, annually, or at any pre-determined or pre-specified time interval. In a preferred embodiment, the central processing computer 10 can also generate and transmit the periodic transaction record(s) or periodic transaction statement(s) to the communication device 20 of the account holder at any time and/or upon request by the account holder or authorized user or individual. In another preferred embodiment, the apparatus 100 of the present invention can provide period transaction records or periodic transaction statements for any account and/or for any and/or all accounts serviced by the apparatus 100 of the present invention for an account holder.

In any and/or all of the embodiments described herein, any central processing computer 10 can also be programmed to automatically generate, and/or to generate upon a request by the account holder, a periodic transaction record(s) or a periodic transaction statement(s) showing activity and/or transactions, and/or attempted transactions, on or involving a respective account along with information regarding the communication device 20 which was utilized or involved in the transaction. In a preferred embodiment, the periodic transaction record(s) or a periodic transaction statement(s) can also provide information regarding any transaction and/or all transactions which have occurred, or which were attempted, for or involving each communication device 20 of, associated with, or used, by an account holder. In this regard, the account holder can be provided with information showing which transactions occurred, or which transactions were attempted, using each communication device 20 of, associated with, or used, by an account holder.

In a preferred embodiment, for example, the transactions which occurred on an account, or which were attempted on an account, can be shown or grouped by communication device 20, for each communication device 20 of, associated with, or used, by an account holder. In a preferred embodiment, the above-described periodic transaction record(s) or periodic transaction statement(s), which can show or group to the transactions, or attempted transactions, by communication device, can also be provided by the apparatus 100 of the present invention periodically, daily, weekly, monthly, bi-monthly, quarterly, annually, or at any pre-determined or pre-specified time interval. In a preferred embodiment, the central processing computer 10 can also generate and transmit any of the herein-described periodic transaction record(s) or periodic transaction statement(s) to the communication device 20, and/or to any of other communication device(s) 20, of the account holder at any time and/or upon request by the account holder or authorized user or individual. In another preferred embodiment, the apparatus 100 of the present invention can provide period transaction records or periodic transaction statements for any account and/or for any and/or all accounts serviced by the apparatus 100 of the present invention for an account holder.

In another preferred embodiment, any and/or all of the periodic transaction records or periodic transaction statements described herein as being generated by and/or provided by the apparatus 100 of the present invention, can also include, for each transaction or for each attempted transaction on or involving an account, a photograph, picture, video, a video clip, audio, or an audio clip, of the account holder or any other user, individual, or entity, involved in the transaction, and/or a photograph, picture, video, a video clip, audio, or an audio clip, of the counterparty, or of an agent or employee of the counterparty to or involved in the transaction.

In another preferred embodiment, any and/or all of the periodic transaction records or periodic transaction statements described herein as being generated by and/or provided by the apparatus 100 of the present invention, can also include, for each transaction or for each attempted transaction on or involving an account, any of the herein-described information regarding the position or the location of the communication device 20, if determined and/or utilized, and/or any of the herein-described information regarding the position or the location of the merchant's counterparty communication device 40, if determined and/or utilized.

In another preferred embodiment, any and/or all of the periodic transaction records or periodic transaction statements described herein as being generated by and/or provided by the apparatus 100 of the present invention, can also include, for each transaction or for each attempted transaction on or involving an account, any of the data and/or information described herein as being transmitted to, provided to, processed by, stored by, generated by, and/or transmitted from, the central processing computer 10 for or regarding each transaction or each attempted transaction.

In another preferred embodiment, as well as in any and/or all of the embodiments described herein, the apparatus 100 and methods of the present invention can also be utilized in connection with, or in conjunction with, a distributed ledger and with Blockchain technology. In a preferred embodiment, a distributed ledger and Blockchain technology can be utilized along with a central processing computer, in a combined system, wherein certain of the transactions, described herein as being performed by the apparatus 100, can be processed and/or performed by and/or with a central processing computer and/or certain other transactions can be processed and/or performed by and/or with, and/or using, a distributed ledger and Blockchain technology or Blockchain technologies. In another preferred embodiment, any and/or all transactions, described herein as being performed and/or processed by the apparatus 100, can also be processed and/or performed by and/or with, and/or using, a distributed ledger and Blockchain technology or Blockchain technologies, and/or any cryptocurrency Blockchain technology or technologies.

In a preferred embodiment, any type of Blockchain technology can be utilized in connection with the apparatus 100 and methods of the present invention. In a preferred embodiment, for example, the apparatus 100 and methods of the present invention can utilize a distributed ledger(s) along with any Blockchain technology or technologies, Bitcoin Blockchain technology or technologies, Ethereum Blockchain technology or technologies, Bitcoin Cash Blockchain technology or technologies, Litecoin Blockchain technology or technologies, Privacy Coin Bitcoin technology or technologies, and/or any other suitable Blockchain technology or technologies, and/or Smart contracts and/or Smart contract technology or technologies and/or decentralized autonomous organizations (DAOs), decentralized autonomous organizations (DAOs) technology or technologies, and/or any combination of same.

In any and/or all of the embodiments described herein, the apparatus and methods of the present invention can also be utilized with any suitable cryptocurrency, such as, but not limited to, Bitcoin, Bitcoin Cash, Ethereum, Ripple, Dash, Monero, Zcash, Digibyte, Litecoin, any privacy coins, and/or any other cryptocurrency and/or privacy coin cryptocurrency. In this regard, any of the embodiments described herein can be performed with or utilizing any currency or any cryptocurrency. Further, any of the accounts described herein, and any of the transactions on or involving any of the accounts described herein can involve or utilize any currency or cryptocurrency.

Applicant incorporates by reference herein the subject matter and teachings of “Blockchain Technology Explained” by Alan T. Norman, “Blockchain” by Abraham K. White, “Blockchain—A Practical Guide To Developing Business, Law, And Technology Solutions” by Joseph J. Bambara and Paul R. Allen, and “Blockchain—Ultimate Guide To Understanding Blockchain, Bitcoin, Cryptocurrencies, Smart Contracts And The Future of Money” by Mark Gates, in their entirety, for all of their respective subject matter and teachings regarding distributed ledger technology and/or technologies, Blockchain technology and/or technologies, Bitcoin technology and/or technologies, Bitcoin Blockchain technology and/or technologies, Ethereum technology and/or technologies, Ethereum Blockchain technology and/or technologies, cryptocurrencies, cryptocurrency technology and/or technologies, and/or smart contract technology and/or technologies, and/or decentralized autonomous organizations (DAOs) technologies, and/or peer-to-peer technology and/or technologies, and/or any other technology or technologies related thereto or which can be utilized in conjunction distributed ledgers, Blockchain technologies, Smart contracts, decentralized autonomous organizations (DAOs), and/or cryptocurrencies.

By utilizing a distributed ledger and a suitable Blockchain technology, the apparatus and methods of the present invention can reduce the amount of processing performed by, and reliance on, a central processing computer and/or can eliminate the need for a central processing computer and any centralized entity which might operate the central processing computer.

It is important to note that the distributed ledger and the Blockchain technology utilized with same can also be referred to herein as a “distributed ledger/Blockchain technology”, “distributed ledger and Blockchain technology”, “distributed ledger/Blockchain technology system”, or “distributed ledger and Blockchain technology system”, or that the distributed ledger and the Blockchain technology utilized with same can also be referred by using any suitable phrase or terminology indicative of an application or system which utilizes or which includes a distributed ledger which is used with any Blockchain technology or which is used in connection, or in conjunction, with any Blockchain technology.

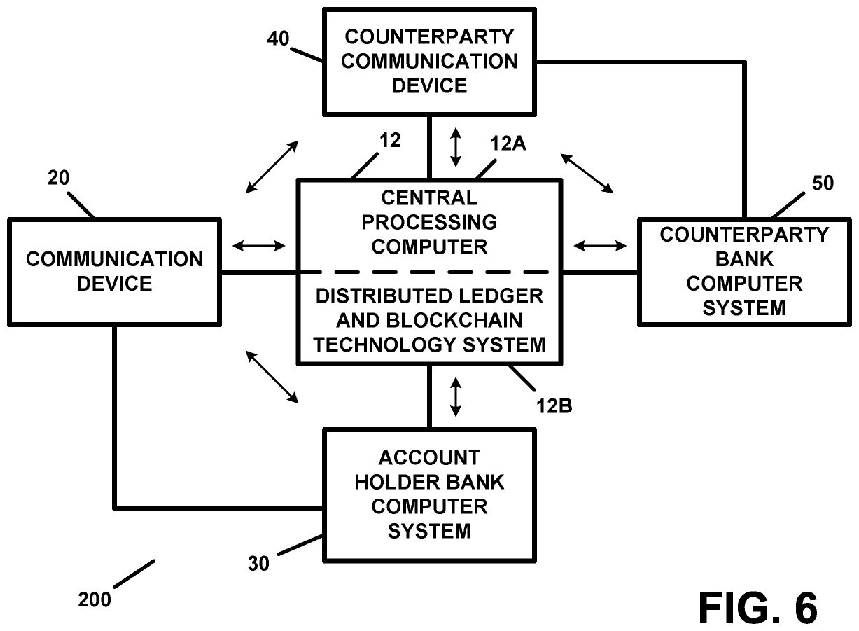

FIG. 6 illustrates another preferred embodiment apparatus of the present invention, which is designated by the reference numeral 200, in block diagram form. With reference to FIG. 6, the apparatus 200 includes a central processing computer and distributed ledger and Blockchain technology system 12 (hereinafter “central processing computer/distributed ledger/Blockchain technology system 12”) as well as any of, or each of, the other noted components of the apparatus 100 of FIG. 1. The central processing computer/distributed ledger/Blockchain technology system 12 includes a central processing computer component 12A, which can perform any and/or all of the functions described herein as being performed by the central processing computer 10 and/or the apparatus 100 of FIG. 1, and a distributed ledger and Blockchain technology system component 12B, which can also perform any and/or all of the functions described herein as being performed by the central processing computer 10 and/or the apparatus 100 of FIG. 1.

With reference once again to FIG. 6, the apparatus 200 can also include any number of communication devices 20, account holder bank computer systems 30, counterparty communication devices 40, and/or counterparty bank computer systems 50. In a preferred embodiment, any and/or all of the various transactions, functions, and/or functionalities, described herein as being provided or performed by the apparatus 100 of FIG. 1 can be provided or performed by the apparatus 200 of FIG. 6 and, in particular, can be performed by either the central processing computer component 12A of the central processing computer/distributed ledger/Blockchain technology system 12 and/or by the distributed ledger and Blockchain technology system component 12B of the central processing computer/distributed ledger/Blockchain technology system 12.

In a preferred embodiment, the transaction authorization message can be transmitted to, received by, and/or processed at or by, the central processing computer component 12A of the central processing computer/distributed ledger/Blockchain technology system 12 and/or the distributed ledger and Blockchain technology system component 12B of the central processing computer/distributed ledger/Blockchain technology system 12. In a preferred embodiment, any of the herein-described alerts, alert messages, account holder alert messages, account holder notification messages, transaction authorization messages, transaction notification messages, merchant alert messages, merchant notification messages, payment messages, payment commitment messages, and/or any of the various signals, data, information, and/or messages, or any other information, messages, communications, or transmissions, described herein as being generated, transmitted, and/or stored, by apparatus of the present invention can be generated by, transmitted from, and/or stored by the central processing computer component 12A of the central processing computer/distributed ledger/Blockchain technology system 12 and/or by the distributed ledger and Blockchain technology system component 12B of the central processing computer/distributed ledger/Blockchain technology system 12.

In a preferred embodiment, any photograph, picture, video, a video clip, audio, or an audio clip, described herein as being utilized by, or in connection with, the apparatus of the present invention can also be transmitted by or from, and/or can be stored by, the central processing computer component 12A of the central processing computer/distributed ledger/Blockchain technology system 12 and/or by the distributed ledger and Blockchain technology system component 12B of the central processing computer/distributed ledger/Blockchain technology system 12.

In another preferred embodiment, any and/or all of the processing of any financial transactions or any other transactions described herein can be performed by and/or with the distributed ledger and Blockchain technology system component 12B of the central processing computer/distributed ledger/Blockchain technology system 12 while any and/or all non-financial transactions or other functionalities can be processed or performed by or with the central processing computer component 12A of the central processing computer/distributed ledger/Blockchain technology system 12. For example, the central processing computer component 12A can be utilized to generate, transmit, and/or store, any of the alerts, alert messages, account holder alert messages, account holder notification messages, transaction authorization messages, transaction notification messages, merchant alert messages, merchant notification messages, payment messages, payment commitment messages, alert response messages, notification response messages, and/or any of the various signals, data, information, and/or messages, or any other information, messages, communications, or transmissions, described herein as being generated, transmitted, and/or stored, by any of the herein-described central processing computers, communication devices, counterparty communication devices, and/or by the apparatus of the present invention, and/or the central processing computer component 12A can be utilized to generate, transmit, and/or store, any of the statements, records, historical statements, historical records, transaction records, periodic transaction records, and/or periodic transaction statement, and/or any data and/or information, and/or any of the transaction information, and/or any of photographs, pictures, videos, video clips, audio, or audio clips, described herein.

In a preferred embodiment, the apparatus 200 of FIG. 6 can be utilized in a same, a similar, and/or an analogous, manner in order to perform any and/or all of the functionalities and/or processing routines described herein as being performed by the apparatus and method of the present invention. The apparatus 200 of FIG. 6 can also be utilized in a same, a similar, and/or an analogous, manner in order to perform any and/or all of the functionalities and/or processing routines described as being performed by the apparatus and method of the present invention in the preferred embodiment of FIGS. 5A and 5B, as well as any and/or all of the functionalities and/or processing routines described herein as being performed by the apparatus and method of the present invention. In this regard, any and/or all of the steps, processing routines, and/or functionalities, described herein as being performed by the apparatus 100 and/or by the central processing computer 10 can be performed by the apparatus 200 and/or by the central processing computer/distributed ledger/Blockchain technology system 12 of FIG. 6.

In another preferred embodiment of the apparatus 200 of FIG. 6, any financial and/or non-financial transaction(s) or function(s) can be performed by the distributed ledger and Blockchain technology system component 12B of the central processing computer/distributed ledger/Blockchain technology system 12, and/or any financial and/or non-financial transaction(s) or function(s) can be performed by the central processing computer component 12A of the central processing computer/distributed ledger/Blockchain technology system 12.

In a preferred embodiment, the apparatus 200 can also be utilized with any cryptocurrency or cryptocurrencies and/or can be utilized with no cryptocurrency. It is important to note that the apparatus 100 of FIG. 1, as with the apparatus 200, can also be utilized with any cryptocurrency or cryptocurrencies or can be utilized with no cryptocurrency.

In another preferred embodiment, the apparatus 200 of FIG. 6 can provide for all of the benefits of using a distributed ledger and Blockchain technology system in order to secure any and/or all of the transactions, including, but not limited to, financial transactions and/or non-financial transactions, which can be processed by, or which can be performed by or with, the apparatus 200.

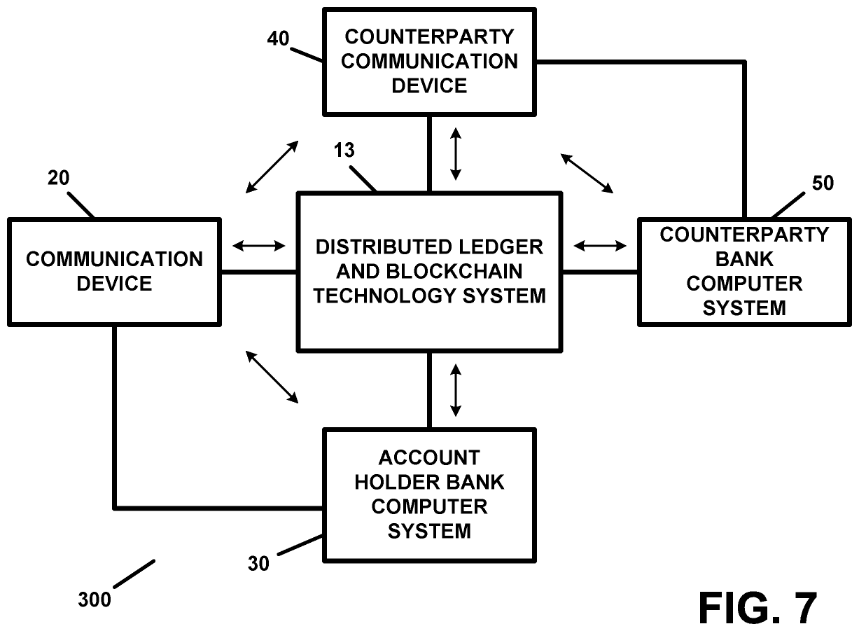

In another preferred embodiment, a distributed ledger and Blockchain technology system can be utilized to process and/or to perform any and/or all of the transactions and/or functions described herein as being provided and/or performed by the apparatus and method of the present invention. FIG. 7 illustrates another preferred embodiment of the apparatus of the present invention, which is designated by the reference numeral 300, in block diagram form.

With reference to FIG. 7, the apparatus 300 includes a distributed ledger and Blockchain technology system 13, instead of, and in place of, a central processing computer, and the apparatus 300 can also include any of, or each of, the other noted components of the apparatus 100 of FIG. 1. The distributed ledger and Blockchain technology system 13 can perform and/or can process any and/or all of the functions and/or transactions described herein as being performed by the central processing computer 10 and/or the apparatus 100 of FIG. 1.

With reference once again to FIG. 7, the apparatus 300 can also include any number of communication devices 20, account holder bank computer systems 30, counterparty communication devices 40, and/or counterparty bank computer systems 50. In a preferred embodiment, any and/or all of the various transactions, functions, and/or functionalities, described herein as being provided or performed by the apparatus 100 of FIG. 1 can be provided or performed by the apparatus 300 of FIG. 7 and/or can be provided or performed by the distributed ledger and Blockchain technology system 13.

In a preferred embodiment, the transaction authorization message can be transmitted to, received by, and/or processed at or by, the distributed ledger and Blockchain technology system 13. In a preferred embodiment, any of the herein-described alerts, alert messages, account holder alert messages, account holder notification messages, transaction authorization messages, transaction notification messages, merchant alert messages, merchant notification messages, payment messages, payment commitment messages, and/or any of the various signals, data, information, and/or messages, or any other information, messages, communications, or transmissions, described herein as being generated, transmitted, and/or stored, by apparatus of the present invention can be generated by, transmitted from, and/or stored by distributed ledger and Blockchain technology system 13.

In a preferred embodiment, any photograph, picture, video, a video clip, audio, or an audio clip, described herein as being utilized by, or in connection with, the apparatus of the present invention can also be transmitted by or from, and/or can be stored by, the distributed ledger and Blockchain technology system 13.

In a preferred embodiment, the apparatus 300 of FIG. 7 can be utilized in a same, a similar, and/or an analogous, manner in order to perform any and/or all of the functionalities and/or processing routines described herein as being performed by the apparatus and method of the present invention. The apparatus 300 of FIG. 7 can also be utilized in a same, a similar, and/or an analogous, manner in order to perform any and/or all of the functionalities and/or processing routines described as being performed by the apparatus and method of the present invention in the preferred embodiment of FIGS. 5A and 5B, as well as any and/or all of the functionalities and/or processing routines described herein as being performed by the apparatus and method of the present invention. In this regard, any and/or all of the steps, processing routines, and/or functionalities, described herein as being performed by the apparatus 100 and/or by the central processing computer 10 can be performed by the apparatus 300 and/or by the distributed ledger and Blockchain technology system 13 of FIG. 7. Further, any and/or all of the various transactions, functions, and/or functionalities, described herein as being provided or performed by the present invention can be provided or performed by the apparatus 300 of FIG. 7 by utilizing the distributed ledger and Blockchain technology system 13.

In a preferred embodiment, the apparatus 300 can also be utilized with any cryptocurrency or cryptocurrencies and/or can be utilized with no cryptocurrency.

The apparatus 300 of FIG. 7 can also provide for all of the benefits of using a distributed ledger and Blockchain technology system in order to secure any and/or all of the transactions, including, but not limited to, financial transactions and/or non-financial transactions, which can be processed by, or which can be performed by or with, the apparatus 300.

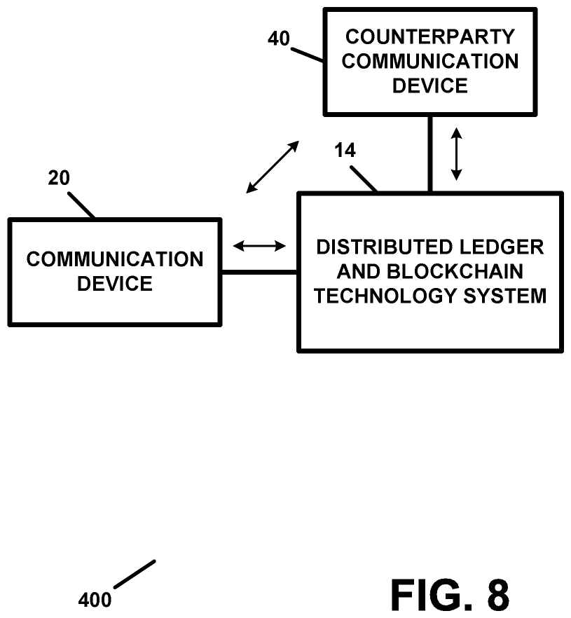

In another preferred embodiment, the apparatus of the present invention can include a distributed ledger and Blockchain technology system which can be utilized without an account holder bank computer system and without a counterparty bank computer system in order to process and/or to perform any and/or all of the transactions and/or functions described herein as being provided and/or performed by the apparatus and method of the present invention. FIG. 8 illustrates another preferred embodiment of the apparatus of the present invention, which is designated by the reference numeral 400, in block diagram form.

With reference to FIG. 8, the apparatus 400 includes a distributed ledger and Blockchain technology system 14, instead of, and in place of, a central processing computer. The distributed ledger and Blockchain technology system 14 can perform and/or can process any and/or all of the functions and/or transactions described herein as being performed by the central processing computer 10 and/or the apparatus 100 of FIG. 1.

With reference once again to FIG. 8, the apparatus 400 can also include any number of communication devices 20 and/or any number of counterparty communication devices 40. In a preferred embodiment, the apparatus 400 dispenses with the need for any account holder bank computer systems 30 and any counterparty bank computer systems 50. In a preferred embodiment, any and/or all of the various transactions, functions, and/or functionalities, described herein as being provided or performed by the apparatus 100 of FIG. 1 can be provided or performed by the apparatus 400 of FIG. 8 and/or can be provided or performed by the distributed ledger and Blockchain technology system 14.

In a preferred embodiment, the transaction authorization message can be transmitted to, received by, and/or processed at or by, the distributed ledger and Blockchain technology system 14. In a preferred embodiment, any of the herein-described alerts, alert messages, account holder alert messages, account holder notification messages, transaction authorization messages, transaction notification messages, merchant alert messages, merchant notification messages, payment messages, payment commitment messages, and/or any of the various signals, data, information, and/or messages, or any other information, messages, communications, or transmissions, described herein as being generated, transmitted, and/or stored, by apparatus of the present invention can be generated by, transmitted from, and/or stored by the distributed ledger and Blockchain technology system 14.

In a preferred embodiment, any photograph, picture, video, a video clip, audio, or an audio clip, described herein as being utilized by, or in connection with, the apparatus of the present invention can also be transmitted by or from, and/or can be stored by, the distributed ledger and Blockchain technology system 14.

In a preferred embodiment, the apparatus 400 of FIG. 8 can be utilized in a same, a similar, and/or an analogous, manner in order to perform any and/or all of the functionalities and/or processing routines described herein as being performed by the apparatus and method of the present invention. The apparatus 400 of FIG. 8 can also be utilized in a same, a similar, and/or an analogous, manner in order to perform any and/or all of the functionalities and/or processing routines described as being performed by the apparatus and method of the present invention in the preferred embodiment of FIGS. 5A and 5B, as well as any and/or all of the functionalities and/or processing routines described herein as being performed by the apparatus and method of the present invention. In this regard, any and/or all of the steps, processing routines, and/or functionalities, described herein as being performed by the apparatus 100 and/or by the central processing computer 10 can be performed by the apparatus 400 and/or by the distributed ledger and Blockchain technology system 14 of FIG. 8. Further, any and/or all of the various transactions, functions, and/or functionalities, described herein as being provided or performed by the present invention can be provided or performed by the apparatus 400 of FIG. 8 by utilizing the distributed ledger and Blockchain technology system 14. In a preferred embodiment, the apparatus 400 can also be utilized with any cryptocurrency or cryptocurrencies and/or can be utilized with no cryptocurrency.

The apparatus 400 of FIG. 8 can provide for all of the benefits of using a distributed ledger and Blockchain technology system in order to secure any and/or all of the transactions, including, but not limited to, financial transactions and/or non-financial transactions, which can be processed by, or which can be performed by or with, the apparatus 400.

In any and/or all the embodiments described herein, the apparatus and method of the present invention can be utilized to process and/or to provide security for transactions of all types or kinds involving accounts of all types or kinds. In any and/or all of the embodiments described herein, the apparatus and method of the present invention can also process and/or provide security for transactions of all types or kinds, including, but not limited to, transactions between individuals, transactions between entities, transactions between individuals and entities, and/or peer-to-peer transactions.

In any and/or all of the embodiments described herein, the apparatus 100, the apparatus 200, the apparatus 300, the apparatus 400, and/or any of the herein-described central processing computer(s) 10, the central processing computer/distributed ledger/Blockchain technology systems 12, the distributed ledger/Blockchain technology systems 13, the distributed ledger/Blockchain technology systems 14, the communication device(s) 20, the counterparty communication device(s) 40, the account holder bank computer systems 30, and/or the counterparty bank computer systems 50, can be programmed for automatic activation, automatic operation, and/or automatic de-activation.

In another preferred embodiment, the apparatus and method of the present invention can be utilized in order to allow an account holder to select or to dictate the type or manner of transaction processing utilized in processing a transaction involving his or her accounts, cryptocurrencies, cryptocurrency accounts, and/or any other payment accounts. For example, the apparatus and method of the present invention can be utilized in order to allow an account holder to select or to dictate that a transaction be processed using a distributed ledger and blockchain technology system. In another preferred embodiment, the apparatus and method of the present invention can be utilized in order to allow an account holder to select or to dictate that a transaction be processed using a traditional or conventional centralized transaction system, such as those utilized in processing credit transactions, debits card transactions, banking transactions, and/or any other non-blockchain transactions.

In another preferred embodiment, the apparatus and method of the present invention can be utilized in order to allow an account holder to select or to dictate that a transaction be processed using a combination of a distributed ledger and blockchain technology system along with a traditional or conventional centralized transaction system, such as those utilized in processing credit transactions, debits card transactions, banking transactions, and/or any other non-blockchain transactions. In such applications, certain portions of the transaction can be processed using a distributed ledger and blockchain technology system while another portions of the transaction can be processed using a traditional or conventional centralized transaction system and information regarding, or a record of, the transaction can be stored on, and accessible via, a central processing computer, such as the central processing computer 10, or any other suitable server computer.

In another preferred embodiment, the apparatus 200 of FIG. 6 can be utilized in order to allow an account holder to select or to dictate the type or manner of transaction processing utilized in processing a transaction involving his or her accounts, cryptocurrencies, cryptocurrency accounts, and/or any other payment accounts.

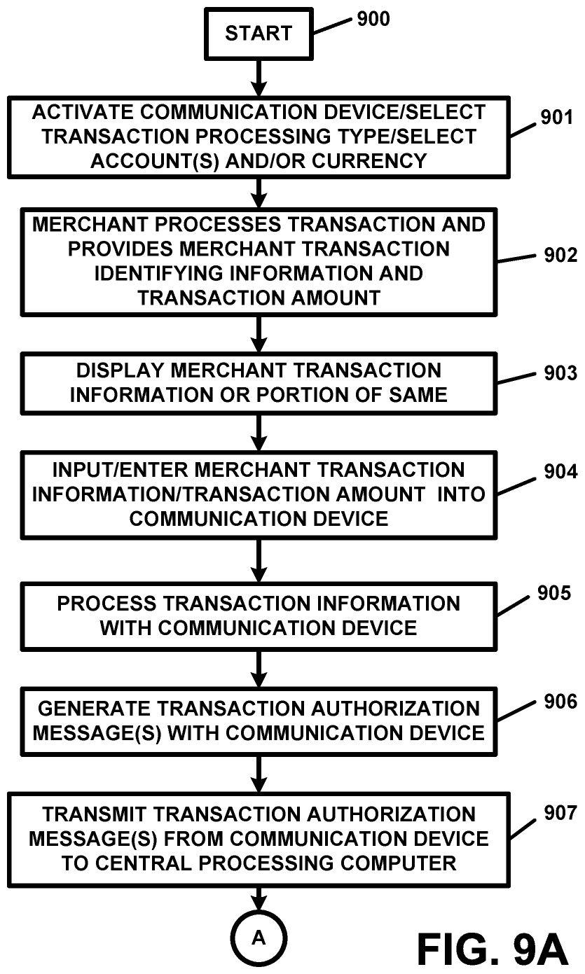

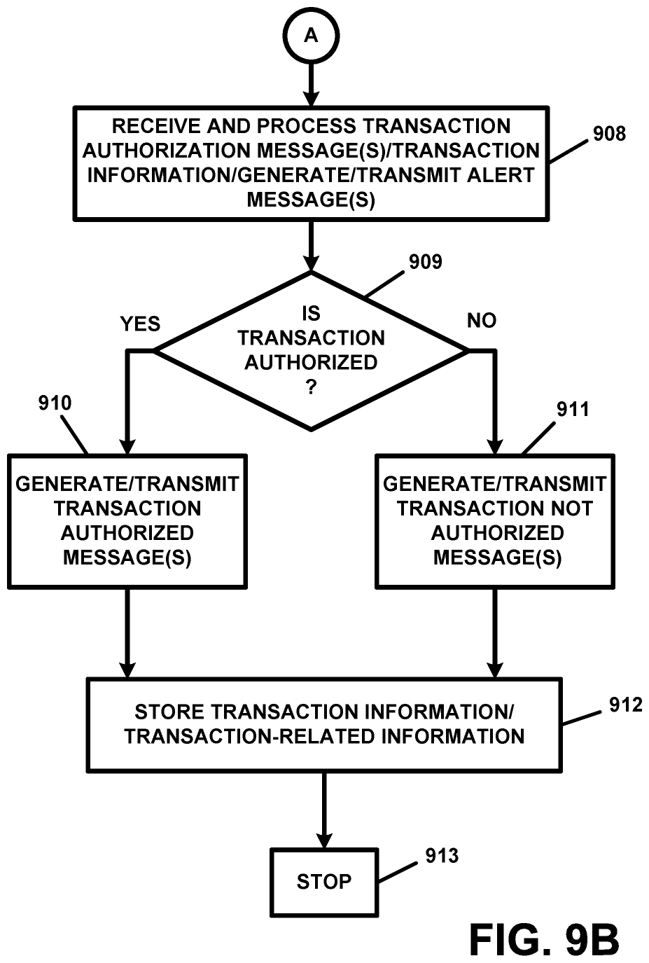

FIGS. 9A and 9B illustrate another preferred embodiment method for utilizing the apparatus 200 of FIG. 6, in flow diagram form. In the preferred embodiment of FIGS. 9A and 9B, the operation of the apparatus 200 is described in an exemplary embodiment in which an account holder is using a cellular telephone, a Smartphone or smart phone, or a personal digital assistant, in order to engage in an in-person transaction with a merchant or retail store using his or her credit account of credit card account. It is to be understood, however, that that preferred embodiment of FIGS. 9A and 9B can also be utilized in a same, a similar, and/or an analogous, manner in order to allow any account holder or authorized user or individual of an account of the account holder, to utilize any of the herein-described types or kinds of communication devices 20 in connection with any of the herein-described types or kinds of accounts in order to perform an in-person transaction, a face-to-face transaction, a telephone transaction, a mail order transaction, a remote transaction, an on-line transaction, and/or an Internet transaction, and/or any other type or kind of transaction, with any counterparty, counterpart, or third party.

With reference to FIGS. 9A and 9B, the operation of the apparatus 200 commences at step 900. At step 901, the account holder, desiring to perform a transaction with the merchant in the merchant's store, can activate the communication device 20. In a preferred embodiment, at step 901, the account holder can, for example, activate a transaction software application or software “app” on the communication device 20 which, in the preferred embodiment, is a cellular telephone, a Smartphone or smart phone, or a personal digital assistant.

At step 901, the communication device 20 can provide the account holder with a menu showing the transaction processing types, such as, for example, any and/or all distributed ledger and blockchain system processing systems available for use to process the transaction for the account holder's accounts, cryptocurrencies, cryptocurrency accounts, and/or any other payment accounts, and any and/or all traditional or conventional centralized transaction processing systems available for use to process the transaction for the account holder's accounts, cryptocurrencies, cryptocurrency accounts, and/or any other payment accounts. At step 901, in a preferred embodiment, the account holder can select to use a distributed ledger and blockchain system processing system to process the transaction. In another preferred embodiment, at step 901, the account holder can select to use a distributed ledger and blockchain system along with a traditional or conventional centralize transaction processing system in order to process the transaction.

At step 901, the communication device 20 can also provide the account holder with a menu showing all of the payment methods available to the account holder. For example, the communication device 20 can display any and/or all of the account holder's credit cards, charge cards, debit cards, banks accounts, checking accounts, savings accounts, electronic money accounts, electronic funds accounts, cryptocurrencies, cryptocurrency accounts, and/or any other payment accounts, from which the account holder can make or effectuate payment to the merchant in the transaction. At step 901, the account holder can select, via the user input device 20D or other means, the account or the payment type or kind which he or she desires to use in the transaction with the merchant.

In another preferred embodiment, the communication device 20 can allow the account holder to select, via the user input device 20D or other means, multiple accounts or payment types or kinds so as to divide up the total transaction amount among the selected accounts or payment types or kinds. In a preferred embodiment, the account holder can specify the amounts to be paid using each selected account or payment type or kind by specifying a monetary amount to be paid with or using, or by specifying a percentage of the total transaction cost to be paid with or using, each selected account or payment type of kind. In another preferred embodiment, the communication device 20 can be programmed to automatically allocate the payment of the transaction cost, either by monetary amounts or percentages, among the selected accounts or payment types of kinds.

In the preferred embodiment, at step 901, the account holder will select, via the user input device 20D or other means, a distributed ledger and blockchain technology system and a credit account or a credit card account for effecting payment.

In another preferred embodiment, the account holder can select any cryptocurrency or any cryptocurrency account for use in the transaction. In another preferred embodiment, the account holder can select to use a plurality of accounts and/or a cryptocurrency or a cryptocurrency account, or any number of cryptocurrencies or cryptocurrency accounts, along with any one or more of the herein-described types or kinds of accounts, so as to use any combination of an account or accounts and/or an account, a cryptocurrency or cryptocurrency account of any combination of cryptocurrencies and/or cryptocurrency accounts, in the transaction. In a preferred embodiment, the account holder can select one or more of the accounts and/or cryptocurrencies or cryptocurrency accounts which he or she wants to use in a transaction from a menu of accounts and/or cryptocurrencies or cryptocurrency accounts provided via the display device 20E of the communication device 20. In a preferred embodiment, the account holder's use of a combination of accounts, a cryptocurrency or cryptocurrency accounts and/or cryptocurrencies or cryptocurrency accounts, can provide for additional transaction security by providing an enhanced form of a multi-factor authentication for transactions.

At step 902, the merchant can process information regarding the transaction, which can involve the sale and/or purchase of any good(s), product(s), or service(s), sold or provided by the merchant and can inform the account holder of total amount to be paid for the transaction. At step 902, the merchant can then provide the merchant's transaction identifying information to the account holder along with the amount of the transaction. In a preferred embodiment, the merchant's transaction identifying information can, for example, include the merchant's name, and/or the name of the merchant's bank or financial institution, and/or the merchant's bank account number or identifier, or the merchant's financial account number or identifier, of, for, or associated with, the merchant's account to which payment is to be made. The merchant's transaction identifying information can also include any merchant information or any merchant account information which can be utilized to effectuate payment to the merchant or the merchant's account.

The merchant's transaction identifying information can also include data and/or information for or regarding contact information, or data and/or information for identifying contact information, for or regarding the merchant's counterparty communication device 40 or, in instances in which the merchant has associated therewith, or utilizes, a number of counterparty communications devices(s) 40, the merchant's transaction identifying information can also include data and/or information for or regarding contact information, or data and/or information for identifying contact information, for or regarding the merchant's counterparty communication device 40 which is being utilized by the merchant in the transaction, and/or any other data and/or information, contact information, or data and/or information for identifying the contact information, for or regarding the merchant's counterparty communication device 40. In a preferred embodiment, contact information for or regarding the merchant's counterparty communication device 40 can include, but not be limited to, telephone number, e-mail address, text messaging number, SMS messaging number or information, MMS messaging number or information, IP address, or any network identifier information, for or associated with the merchant's counterparty communication device 40.

In a preferred embodiment, the merchant's transaction identifying information can also include position or location information for the merchant so as to establish the merchant's position or location at the time of the transaction. In the case of a merchant operating at a fixed or known location, the position or location of the merchant, or of the merchant's counterparty communication device 40, can be included in or among the merchant's transaction identifying information. In a preferred embodiment, the position or location information for the merchant can also be stored the database (not shown) of the central processing computer component 12A of the central processing computer/distributed ledger/Blockchain technology system 12 and/or the database 40H of the merchant's counterparty communication device 40. In another preferred embodiment, in a case where the merchant's counterparty communication device 40 is a mobile of wireless device, or any other device, which is not associated with a fixed location, then the position or location of the merchant's counterparty communication device 40 can be determined by the global positioning device 40J of the merchant's counterparty communication device 40, and the merchant's counterparty communication device 40 can be programmed to generate the merchant's transaction identifying information, for the transaction, so as to include the determined position or location information of the merchant's counterparty communication device 40 at the time of the transaction.

In a preferred embodiment, at step 903, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, and/or any other data and/or information contained or included in the merchant's transaction identifying information can be displayed on the display device 40E of the merchant's counterparty communication device 40.

In a preferred embodiment, at step 903, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, and/or any other data and/or information contained or included in the merchant's transaction identifying, can be displayed on the display device 40E, or displayed in any other manner, at the point of sale (POS) or point-of-transaction, as text and/or numerical information. The information can also be visually displayed at the point of sale (POS) or at the point-of-transaction in any appropriate or suitable manner.

In another preferred embodiment, at step 903, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, and/or any other data and/or information contained or included in the merchant's transaction identifying, can be displayed on the display device 40E, or displayed in any other manner, at the point of sale (POS) or point-of-transaction, in, on, or as, a barcode(s), a two-dimensional barcode(s), a QR (Quick Response) code(s), or, on, or as, any other machine readable medium or form, or any combination of same. The information can also be visually displayed at the point of sale (POS) or at the point-of-transaction in any appropriate or suitable manner. In a preferred embodiment, the communication device 20 can be equipped with a barcode reader, a barcode scanner, a two-dimensional barcode reader, a two-dimensional barcode scanner, a QR code reader, a QR code scanner, an imaging device, or a camera for obtaining an image of a barcode, a two-dimensional barcode, and/or a QR code, and/or a two-dimensional image sensor, for reading or scanning and/or for inputting information contained in, the respective barcode, two-dimensional barcode, and/or QR code, and for inputting same into the communication device 20.

In another preferred embodiment, at step 903, that portion of the merchant's transaction identifying information which includes the merchant's name, and/or the name of the merchant's bank or financial institution, and/or the merchant's bank account number or identifier, or the merchant's financial account number or identifier, of, for, or associated with, the merchant's account to which payment is to be made, and/or any other data and/or information contained or included in the merchant's transaction identifying, can be stored on or encoded on a magnetic stripe or other storage device or medium and can be provided to the account holder by the merchant or the merchant's agent or employee to the account holder. For example, the account holder can be handed a plastic card or any other type of card having a magnetic stripe on which the information is stored and which can be read by a card reader or swipe card reader of or used in connection with the communication device 20. In the preferred embodiment, the communication device 20 can have a card reader or a swipe card reader as a user input device 20D either attached to, removeably attached to, or integrated with, the communication device 20 so that the account holder can swipe the card to input the transaction identifying information into the communication device 20.

At step 904, the account holder can enter or input the merchant's transaction identifying information into communication device 20. At step 904, the account holder can enter any of the data and/or information contained in the merchant's transaction identifying information into the communication device 20 by using any appropriate user input device 20D. For example, the account holder, at step 904, can also input or enter any text or numerical information into the communication device 20 via a keyboard or keypad, via a mouse or user pointing device, via a touch pad or touch screen, via a camera or video recording device, via a microphone or audio recording device and/or voice recognition software or equipment, or via any other input device. At step 904, the account holder can also input or enter any information contained in any barcode(s), two-dimensional barcode(s), and/or QR code(s) using a respective barcode reader, barcode scanner, two-dimensional barcode reader, two-dimensional barcode scanner, QR code reader, QR code scanner, imaging device, a camera for obtaining an image of a barcode, a two-dimensional barcode, and/or a QR code, or a two-dimensional image sensor, as an input device 20D. For example, the account holder, at step 904, can also input or enter any data and/or information store on a magnetic stripe, magnetic stripe card, or any other magnetic storage medium, by swiping same through a card or stripe reader or scanner as an input device 20D.

At step 904, the account holder can also enter information regarding the amount of the transaction or the transaction amount into the communication device 20. At step 905, the communication device 20 will process the data and/or information contained in the merchant's transaction identifying information or any portion of same, the information regarding the amount of the transaction or transaction amount, and the information regarding the credit account or the credit card account, or any other account for effectuating payment, selected by the account holder for effecting payment to the merchant. In another preferred embodiment, if the account holder has selected to use any combination of accounts, a cryptocurrency, a cryptocurrency account, or any number of cryptocurrencies or cryptocurrency accounts, or any combination of same, in the transaction, then the communication device 20 will process the data and/or information for each of the selected combination of accounts, a cryptocurrency, a cryptocurrency account, or any number of cryptocurrencies or cryptocurrency accounts, or any combination of same. In a preferred embodiment, the communication device 20 can also create, and store in the database 20H, a transaction record for or corresponding to the transaction.

In a preferred embodiment, the transaction record can include information regarding the transaction, the date and time of the transaction, the transaction processing type(s) selected by the account holder for processing the transaction, the location of the transaction, which in a preferred embodiment, can be determined using the global position device 20J of the communication device 20, and any data and/or information contained in the merchant's transaction identifying information. In a preferred embodiment, the transaction record for or corresponding to the transaction can also include information regarding the account utilized in the transaction and, where a combination of accounts, a cryptocurrency, a cryptocurrency account, or any number of cryptocurrencies or cryptocurrency accounts, or any combination of same, are used in the transaction, information regarding each such account, cryptocurrency, or cryptocurrency account.

At step 906, the communication device 20 will generate a transaction authorization message. In a preferred embodiment, the transaction authorization message, which is generated by the communication device 20, at step 906, can contain or include any data and/or information needed or required for submitting same to the central processing computer/distributed ledger/Blockchain technology system 12, which services the selected credit account or credit card account, or other payment account, of the account holder, for transaction authorization processing. In a preferred embodiment, the data and/or information contained or included in the transaction authorization message can include information regarding the credit account or the credit card account, or other account, and/or the account number or other identifier of same, and/or the account expiration date and/or security code information.

In a preferred embodiment, where a combination of accounts, a cryptocurrency, a cryptocurrency account, or any number of cryptocurrencies or cryptocurrency accounts, or any combination of same, are used in the transaction, the communication device 20 will generate a transaction authorization message for each such account, cryptocurrency, or cryptocurrency account and transmit same to the central processing computer/distributed ledger/Blockchain technology system 12 for appropriate processing. It is to be noted that the central processing computer/distributed ledger/Blockchain technology system 12, in a preferred embodiment, can include multiple central processing computer components 12A and multiple Blockchain technology system components 12B for enabling the apparatus 200 to process all transactions necessary involving all accounts, cryptocurrencies, or cryptocurrency accounts, utilized in the transaction.

In a preferred embodiment, the data and/or information contained or included in the transaction authorization message, or in each transaction authorization message, can also include data and/or information regarding the merchant, the merchant's bank, and/or the account number or other identifying information for the merchant's bank account or the merchant's financial account to which payment is to be made. In a preferred embodiment, the data and/or information contained or included in the transaction authorization message, or in each transaction authorization message, can also include data and/or information regarding the amount of the transaction or transaction amount.

In a preferred embodiment, the data and/or information contained or included in the transaction authorization message, or in each transaction authorization message, can also include data and/or information regarding the position or the location of the communication device 20, as determined by the global positioning device 20J of the communication device 20, at the time of the generation of the transaction authorization message. In a preferred embodiment, the position or the location information can be utilized in order to identify the position or the location of the communication device 20 at the time of the generation of the transaction authorization message or each of the transaction authorization messages, and/or at the time of the transaction, in order to determine whether the transaction is an authorized transaction or an unauthorized transaction, or to identify a fraudulent use of an account in an instance in which the account holder was not at that position or that location at the time of the transaction or at the time of the attempted transaction. It is also important to note that, in instances where the communication device 20 is located at a fixed location, the position or location information for the communication device 20 can be stored in the database 20H of the communication device 20. The position or location information for the communication device 20 can also be stored in the database (not shown) of the central processing computer component 12A of the central processing computer/distributed ledger/Blockchain technology system 12.

In a preferred embodiment, the data and/or information contained or included in the transaction authorization message, or in each transaction authorization message, can also include data and/or information regarding the date and time of the transaction.

In a preferred embodiment, the transaction authorization message transaction authorization message can also be generated so as to include information identifying the communication device 20 which is being utilized in the transaction. In a preferred embodiment, the communication device 20 can store the transaction authorization message in the transaction record for the transaction. In a preferred embodiment, where a combination of accounts, a cryptocurrency, a cryptocurrency account, or any number of cryptocurrencies or cryptocurrency accounts, or any combination of same, are used in the transaction, each transaction authorization message can also be generated so as to include information identifying the communication device 20 which is being utilized in the transaction. In a preferred embodiment, the communication device 20 can store all of the transaction authorization messages in the transaction record for the transaction.

In a preferred embodiment, the communication device 20 can be, or can include hardware and software to allow it function as, and/or can function in a same, a similar, and/or analogous, manner as a point of sale (POS) transaction processing system or a point of sale (POS) transaction processing device, a point of sale (POS) transaction authorization device, or as a point-of-transaction transaction device or a point-of-transaction transaction authorization device. In another preferred embodiment, the communication device 20 can be equipped as a point of sale (POS) transaction processing system or device. In a preferred embodiment, the communication device 20 can store, for each account used by the account holder and for which information is stored in the database 20H of the communication device 20, the telephone number, e-mail address, text messaging number, SMS messaging number or information, MMS messaging number or information, IP address, or any network identifier information, for each central processing computer/distributed ledger/Blockchain technology system 12 which services each account and/or which performs transaction authorization processing for each account.

In a preferred embodiment, the communication device 20, for example, can be programmed to telephone the central processing computer/distributed ledger/Blockchain technology system 12, to establish a communication link with same, to transmit the transaction authorization message to the central processing computer/distributed ledger/Blockchain technology system 12, and to receive any signal(s), data, information, or message(s) described herein as being transmitted to the communication device 20 from the central processing computer/distributed ledger/Blockchain technology system 12 in the transaction authorization process and/or otherwise. In a preferred embodiment, where a combination of accounts, a cryptocurrency, a cryptocurrency account, or any number of cryptocurrencies or cryptocurrency accounts, or any combination of same, are used in the transaction, the communication device 20, for example, can be programmed transmit each of the transaction authorization messages to the central processing computer/distributed ledger/Blockchain technology system 12, and to receive any signal(s), data, information, or message(s) described herein as being transmitted to the communication device 20 from the central processing computer/distributed ledger/Blockchain technology system 12 in the transaction authorization process and/or otherwise.

In a preferred embodiment, the communication link between the communication device 20 and the central processing computer/distributed ledger/Blockchain technology system 12 can be established on, over, or via, a communication network or system, a telephone communication network or system, a wireless communication network or system, the Internet, the World Wide Web, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems. In a same, a similar, and/or an analogous, manner, the communication device 20 can also establish a communication link with a respective central processing computer/distributed ledger/Blockchain technology system 12 using the telephone number of the central processing computer/distributed ledger/Blockchain technology system 12, or and e-mail address, text messaging number, SMS messaging number or information, MMS messaging number or information, IP address, or any network identifier information, or, for, or associated with, the respective central processing computer/distributed ledger/Blockchain technology system 12.

At step 906, the account holder can also be prompted or instructed to take a picture or himself or herself and/or the merchant or an employee or agent of the merchant, and/or the account holder can be prompted or instructed to record a video clip of himself or herself and/or the merchant or an employee or agent of the merchant, and store same in a picture file or a video file, and/or the account holder can be prompted or instructed to record a voice sample and/or a conversation between himself or herself and the merchant or the employee of the merchant and store same in an audio file.

At step 906, the merchant or an employee or agent of the merchant can also be prompted or instructed to take a picture or himself or herself and/or the account holder, and/or record a video clip of himself or herself and/or the account holder, and store same in a picture file or a video file, and/or the merchant or an employee or agent of the merchant can be prompted or instructed to record a voice sample and/or a conversation between himself or herself and the account holder and store same in an audio file. In another preferred embodiment, the account holder can also take a picture or record a video clip of any goods or products involved in, or the subject of, the transaction, or can record a video clip and/or an audio clip of himself or herself and/or the merchant or an employee or agent of the merchant engaging in a conversation regarding the transaction. In a preferred embodiment, any data and/or information, and/or any picture(s), video clip(s), and/or audio clip(s), obtained at step 506 can also stored in the transaction record for the transaction in the database 20H of the communication device 20.

At step 907, the communication device 20 can transmit the transaction authorization message to the central processing computer/distributed ledger/Blockchain technology system 12. In a preferred embodiment, where a combination of accounts, a cryptocurrency, a cryptocurrency account, or any number of cryptocurrencies or cryptocurrency accounts, or any combination of same, are used in the transaction, each transaction authorization message can be transmitted to the central processing computer/distributed ledger/Blockchain technology system 12 at step 907. At step 907, the communication device 20 can also transmit the picture, the video file, and/or the audio file, to the central processing computer/distributed ledger/Blockchain technology system 12.

At step 907, the communication device 20 can also transmit the picture, the video file, and/or the audio file, to the counterparty communication device 40. At step 907, the counterparty communication device 40 can also transmit the picture, the video file, and/or the audio file, to the central processing computer/distributed ledger/Blockchain technology system 12. At step 907, the counterparty communication device 40 can also transmit the picture, the video file, and/or the audio file, to the communication device 20. At step 907, the communication device 20 can also store any information regarding the merchant's transaction identifying information, the amount of the transaction or transaction amount, the transaction authorization message, the picture, the video file, and/or the audio file, pertaining to the transaction in the database 20H of the communication device 20 and/or in any file or record for or associated with the credit account or the credit card account, or other account being utilized. At step 907, the communication device 20 can also transmit the picture, the video file, and/or the audio file, to the merchant's counterparty communication device 40.

At step 908, the central processing computer/distributed ledger/Blockchain technology system 12 will receive and process the data and/or information contained in the transaction authorization message. In a preferred embodiment, at step 908, if the transaction is to be processed using a distributed ledger and blockchain technology system, then the transaction will be processed as a blockchain transaction by the distributed ledger and Blockchain technology system component 12B of the central processing computer/distributed ledger/Blockchain technology system 12. In a preferred embodiment, at step 908, if the transaction is to be processed using a using a traditional or conventional centralized transaction system, then the transaction will be processed by the central processing computer component 12A of the central processing computer/distributed ledger/Blockchain technology system 12.

In a preferred embodiment, at step 908, if the transaction is to be processed by using a distributed ledger and blockchain technology system for a certain portion(s) thereof and by using a traditional or conventional centralized transaction system or the remaining portion(s) thereof, then the portion(s) to be processed by the distributed ledger and blockchain technology system will be processed by the distributed ledger and Blockchain technology system component 12B of the central processing computer/distributed ledger/Blockchain technology system 12, and the portion(s) to be processed by the traditional or conventional centralized transaction system will be processed by the central processing computer component 12A of the central processing computer/distributed ledger/Blockchain technology system 12.

In the preferred embodiment of FIGS. 9A and 9B, as well as in any and/or all the embodiments described herein, data and information regarding any and/or all of the transactions processed by the central processing computer component 12A of the central processing computer/distributed ledger/Blockchain technology system 12 or by the distributed ledger and Blockchain technology system component 12B of the central processing computer/distributed ledger/Blockchain technology system 12, for any given transaction, will be stored in the central processing computer component 12A of the central processing computer/distributed ledger/Blockchain technology system 12 in a record or file for the respective transaction.

At step 908, the central processing computer/distributed ledger/Blockchain technology system 12 can also process any data and/or information regarding the transaction and determine whether the transaction is allowed or authorized or disallowed or not authorized. At step 908, the central processing computer/distributed ledger/Blockchain technology system 12 can perform any processing routine(s) typically performed by a transaction authorization processing computer for the account in order to determine whether the transaction is authorized or allowed or not authorized or not allowed. In a preferred embodiment, in determining whether or not the transaction is authorized or allowed or not authorized or not allowed, the central processing computer/distributed ledger/Blockchain technology system 12 can also determine whether or not the account is active or not-active, or whether or not a hold has been placed on the account to prevent the account's use in any transaction(s), or whether or not an account card has been lost or stolen, or reported lost or stolen, or whether or not the transaction is deemed to be unusual for the account holder, or whether or not an account number has been reported as having been compromised or inadvertently released to others, or whether or not account security has been breached, or whether or not the transaction is prohibited by any limitation(s) or restriction(s) placed on the account, or whether or not an account credit or spending limit has been reached.

At step 908, the central processing computer/distributed ledger/Blockchain technology system 12 can also utilize any information regarding the position or the location of the communication device 20, as determined by the global positioning device 20J of the communication device 20, at the time of the generation of the transaction authorization message in order to determine whether or not the transaction is allowed or authorized or disallowed or not authorized. It is envisioned that an account holder can, at any time, place a geographical limitation(s) or restriction(s) on a use of the account. In this regard, by processing information regarding the position or the location of the communication device 20 at the time of the generation of the transaction authorization message, the central processing computer/distributed ledger/Blockchain technology system 12 can also, at step 908, determine whether or not the transaction is allowed or authorized or disallowed or not authorized in view of any such geographical limitation(s) or restriction(s) which may have been placed on the use of the account. In another preferred embodiment, the position or the location information, determined by the global positioning device 20J and transmitted along with the transaction authorization message, or with each transaction authorization message, can be utilized by the account holder to show or prove that he or she was not at the location or place of, and, therefore, did not engage in, the transaction.

At step 908, the central processing computer/distributed ledger/Blockchain technology system 12 can also process data and/or information contained or included in the transaction authorization message in order to determine whether or not the communication device 20, which is identified as being utilized in the transaction, is an authorized communication device 20 which can be used in connection with transactions on or involving the account used for effectuating payment in or for the transaction.

In another preferred embodiment, where a combination of accounts, a cryptocurrency, a cryptocurrency account, or any number of cryptocurrencies or cryptocurrency accounts, or any combination of same, are used in the transaction, the central processing computer/distributed ledger/Blockchain technology system 12 will, at step 908, receive and process the data and/or information contained in each of the transaction authorization messages transmitted from the communication device 20 in the same and/or in a similar manner as described herein.

At step 908, the central processing computer/distributed ledger/Blockchain technology system 12 can also generate an account holder alert message or an account holder notification message, containing information regarding the transaction, including, but not limited to, the credit account or credit card account, or other account, involved, the merchant involved, and the amount of the transaction or transaction amount. In another preferred embodiment, where a combination of accounts, a cryptocurrency, a cryptocurrency account, or any number of cryptocurrencies or cryptocurrency accounts, or any combination of same, are used in the transaction, the central processing computer/distributed ledger/Blockchain technology system 12, at step 908, can generate the account holder alert message or an account holder notification message to include information regarding and/or identifying each of, and/or all of, the accounts, a cryptocurrency, a cryptocurrency account, or any number of cryptocurrencies or cryptocurrency accounts, or any combination of same, used in the transaction.

In another preferred embodiment, the account holder alert message or an account holder notification message can also contain or include or have attached thereto the picture, the video file, and/or the audio file, submitted by the account holder. In another preferred embodiment, the account holder alert message can also contain or include data and/or information for identifying the communication device 20 utilized in the transaction. In this regard, the apparatus 200 and method of the present invention can also be utilized to provide an account holder with an alert message or a notification message so as to alert or notify the account holder regarding the use of the communication device 20 in a transaction involving an account of the account holder. At step 908, the central processing computer/distributed ledger/Blockchain technology system 12 can also transmit the account holder alert message or the account holder notification message to the communication device 20 and/or to another communication device 20, or to any number of communication devices 20, associated with the account holder.

At step 908, the central processing computer/distributed ledger/Blockchain technology system 12 can also generate a merchant alert message or a merchant notification message, containing information regarding the transaction, including, but not limited to, the credit account or credit card account, or other account, involved, the account holder involved, and the amount of the transaction or transaction amount. In another preferred embodiment, the merchant alert message or the merchant notification message can also contain or include or have attached thereto the picture, the video file, and/or the audio file, submitted by the account holder.

In a preferred embodiment, at step 908, the central processing computer/distributed ledger/Blockchain technology system 12 can also process any data and/or information contained in the merchant's transaction identifying information and/or any data and/or information stored in the database of the central processing computer component 12A (not shown) of the central processing computer/distributed ledger/Blockchain technology system 12 for or regarding the merchant in order to identify, ascertain, or obtain, any needed contact information, telephone number, wireless telephone number, e-mail address, test messaging number, SMS messaging number, MMS messaging number, IP address, or network identifier information, for merchant's counterparty communication device 40 for use in establishing a communication link with the merchant's counterparty communication device 40.

In a preferred embodiment, in instances where a merchant has more than one merchant counterparty communication devices 40, such as, but not limited to, instances when a retail merchant utilizes a counterparty communication device 40 or any number of counterparty communication devices 40 at any one or at any number of check-out locations, cashier locations, or point-of-sale transaction processing locations, the central processing computer/distributed ledger/Blockchain technology system 12 can process any data and/or information contained in the merchant's transaction identifying information and/or any data and/or information stored in the database of the central processing computer component 12A (not shown) of the central processing computer/distributed ledger/Blockchain technology system 12 for or regarding the merchant in order to identify, ascertain, or obtain, any needed contact information, telephone number, wireless telephone number, e-mail address, test messaging number, SMS messaging number, MMS messaging number, IP address, or network identifier information, for the particular merchant's counterparty communication device 40 which is being utilized in the transaction. In a preferred embodiment, at step 908, the central processing computer/distributed ledger/Blockchain technology system 12 can also establish any needed or desired communication link with and between the counterparty communication device 40.

At step 908, the central processing computer/distributed ledger/Blockchain technology system 12 can also transmit the merchant alert message or the merchant notification message to the counterparty communication device 40 and/or to another counterparty communication device 40, or to any number of counterparty communication devices 40, associated with the merchant.

At step 908, the merchant can also transmit any supporting documentation or other transaction supporting information regarding the transaction from the merchant's counterparty communication device 40 to the central processing computer/distributed ledger/Blockchain technology system 12. For example, in the case of transaction involving the sale of goods, the merchant can transmit information regarding the goods involved in the transaction or an invoice or receipt. In another preferred embodiment, in which the apparatus of FIGS. 9A and 9B can be utilized in connection with claim being made pursuant to a healthcare insurance account or policy, once the healthcare provider receives the alert message or the notification message at step 908, which can represent that the healthcare insurance claim submission process has been initiated by the insured account holder, the healthcare provider can then transmit or submit, from his, her, or its, counterparty communication device 40 or from any other counterparty communication device 40, the healthcare insurance claim or claim form and/or any other documentation or supporting documentation to the central processing computer/distributed ledger/Blockchain technology system 12 for processing and/or payment.

In another preferred embodiment, the central processing computer/distributed ledger/Blockchain technology system 12 can, at step 908 or at any other time, transmit a position or a location request message to the merchant's counterparty communication device 40 in order to ascertain the position or the location of the merchant's counterparty communication device 40 at the time of the transaction or during the processing of the transaction. In this preferred embodiment, the merchant's counterparty communication device 40 can receive the position or the location request message, the global positioning device 40J of the merchant's counterparty communication device 40 can determine the position or the location of the merchant's counterparty communication device 40 in response to the position or the location request message, and the merchant's counterparty communication device 40 can transmit the position or the location information to the central processing computer/distributed ledger/Blockchain technology system 12.

The central processing computer/distributed ledger/Blockchain technology system 12 can, at step 908, or at any other time, compare the position or the location of the communication device 20 with the position or the location of the merchant's counterparty communication device 40 in order to verify that the communication device 20 and the merchant's counterparty communication device 40 are at the same location or in close proximity to each other, thereby evidencing the likelihood that the parties are engaged in an authorized transaction. For example, if the transaction is an in-store transaction, it would be expected that the communication device 20 and the merchant's counterparty communication device 40 would be at the same location or in close proximity with one another, and such might be indicative that the transaction is an authorized transaction. If, on the other hand, it is determined that the communication device 20 and the merchant's counterparty communication device 40 are not at the same location or not in close proximity with one another, then such might be indicative that the transaction is not an authorized transaction.

In another preferred embodiment, if the information regarding the position or the location of the communication device 20 is ascertained by the global positioning device 20J and transmitted to the central processing computer/distributed ledger/Blockchain technology system 12 in the transaction authorization message, the information regarding the position or the location of the communication device 20 can also be included in or contained in the account holder alert message or the account holder notification message. In another preferred embodiment, if the information regarding the position or the location of the merchant's counterparty communication device 40 is ascertained by the global positioning device 40J and transmitted to the central processing computer/distributed ledger/Blockchain technology system 12, the information regarding the position or the location of the merchant's counterparty communication device 40 can also be included in or contained in the account holder alert message or the account holder notification message.

In another preferred embodiment, if the information regarding the position or the location of the communication device 20 is ascertained by the global positioning device 20J and transmitted to the central processing computer/distributed ledger/Blockchain technology system 12 in the transaction authorization message, the information regarding the position or the location of the communication device 20 can also be included in or contained in the merchant alert message or a merchant notification message. In another preferred embodiment, if the information regarding the position or the location of the merchant's counterparty communication device 40 is ascertained by the global positioning device 40J and transmitted to the central processing computer/distributed ledger/Blockchain technology system 12, the information regarding the position or the location of the merchant's counterparty communication device 40 can also be included in or contained in the merchant alert message or a merchant notification message.

In another preferred embodiment, in an instance when an account holder has notified one or more of the issuers or services of any of his or her accounts, that he or she will be traveling to a certain destination or destinations, the central processing computer/distributed ledger/Blockchain technology system 12 can compare the position or location of the communication device 20 with the position or location of the destination or destination as a manner by which to determine that the transaction is an authorized or an unauthorized transaction.

At step 909, the central processing computer/distributed ledger/Blockchain technology system 12 and/or the central processing computer component 12A or the distributed ledger and Blockchain technology system component 12B of the central processing computer/distributed ledger/Blockchain technology system 12 will determine whether the transaction is authorized or allowed or not authorized or not allowed. If, at step 909, the central processing computer/distributed ledger/Blockchain technology system 12 and/or the central processing computer component 12A or the distributed ledger and Blockchain technology system component 12B of the central processing computer/distributed ledger/Blockchain technology system 12 determines that the transaction is authorized or allowed, the operation of the central processing computer/distributed ledger/Blockchain technology system 12 will proceed to step 910 and the central processing computer/distributed ledger/Blockchain technology system 12 will generate a transaction authorized message and will transmit same to the merchant's counterparty communication device 40.

In another preferred embodiment, the central processing computer/distributed ledger/Blockchain technology system 12 can utilize the position or location data of either or both of the communication device 20 and/or the merchant's counterparty communication device 40, in any appropriate manner, in order to determine if the transaction authorized or allowed or not authorized or not allowed. In another preferred embodiment, the central processing computer/distributed ledger/Blockchain technology system 12 can utilize the position or location data of either or both of the communication device 20 and/or the merchant's counterparty communication device 40, along with or in conjunction with any limitation(s) or restriction(s) placed on the account, in any appropriate manner, in order to determine if the transaction authorized or allowed or not authorized or not allowed.

In a preferred embodiment, the central processing computer/distributed ledger/Blockchain technology system 12 can establish any needed communication link(s) with the counterparty communication device 40 prior to transmitting any of the above-described merchant alert message(s), merchant notification message(s), transaction authorized message(s), and/or any other messages, data, information, or signals, described herein as being transmitted from the central processing computer/distributed ledger/Blockchain technology system 12 to the counterparty communication device 40.

In a preferred embodiment, the communication link or any communication link between the central processing computer/distributed ledger/Blockchain technology system 12 and the counterparty communication device 40 can be established on, over, or via, a communication network or system, a telephone communication network or system, a wireless communication network or system, the Internet, the World Wide Web, a communication network or system, a telecommunication network or system, a telephone communication network or system, a cellular communication network or system, a wireless communication network or system, a line or wired communication network or system, a wireless Internet network or system, a wireless World Wide Web network or system, a digital communication network or system, a personal communication network or system, a personal communication services (PCS) network or system, a satellite communication network or system, a broad band communication network or system, a low earth orbiting (LEO) satellite network or system, a public switched telephone network or system, a telephone communication network or system, a radio communication network or system, a cable television network or system, and/or any other communication network or system, and/or any combination of the above communication networks or systems. In a same, a similar, and/or an analogous, manner, the central processing computer/distributed ledger/Blockchain technology system 12 can also establish a communication link with a respective counterparty communication device 40 using the telephone number of the counterparty communication device 40, or and e-mail address, text messaging number, SMS messaging number or information, MMS messaging number or information, IP address, or any network identifier information, or, for, or associated with, the respective counterparty communication device 40.

At step 910, the central processing computer/distributed ledger/Blockchain technology system 12 can or will also effectuate payment, make payment, or transmit a payment message or a payment commitment message, evidencing and/or guaranteeing to the merchant that payment is being made or will be made to the merchant's account at the merchant's bank or the merchant's counterparty bank computer system 50. At step 910, the central processing computer/distributed ledger/Blockchain technology system 12 can also transmit the payment message and/or the payment commitment message to the merchant's counterparty communication device 40 and/or to the merchant's counterparty bank computer system 50. At step 910, the central processing computer/distributed ledger/Blockchain technology system 12 can also transmit the transaction authorized message, the payment message and/or the payment commitment message, to the communication device 20.

In a preferred embodiment, at step 910, the central processing computer/distributed ledger/Blockchain technology system 12 and/or the central processing computer component 12A or the distributed ledger and Blockchain technology system component 12B of same can process any data and/or information for effectuating or making payment to the merchant's account or effectuating the making of an appropriate credit to the merchant's account and/or can make the payment to the merchant's account or apply the credit to the merchant's account. At step 910, the central processing computer/distributed ledger/Blockchain technology system 12 and/or the central processing computer component 12A or the distributed ledger and Blockchain technology system component 12B of same can process any data and/or information for effectuating or for making payment to the merchant or the merchant's account and/or can effectuate or make any corresponding entry, payment, and/or a respective credit, debit, or charge, entry, and/or effectuate or make any appropriate accounting entry or accounting entries to the account holder's account and/or to the merchant's account.

In a preferred embodiment, at step 910, the central processing computer/distributed ledger/Blockchain technology system 12 and/or the central processing computer component 12A or the distributed ledger and Blockchain technology system component 12B of same can effectuate or make any accounting entry or accounting entries to the account holder's account by generating and transmitting a signal, data, information, or a message, to the account holder's account holder bank computer system 30. The central processing computer/distributed ledger/Blockchain technology system 12 and/or the central processing computer component 12A or the distributed ledger and Blockchain technology system component 12B of same can also effectuate or make any accounting entry or accounting entries to the merchant's account by generating and transmitting a signal, data, information, or a message, to the merchant's counterparty bank computer system 50. In this regard, an account holder can utilize his or her account in a transaction involving a counterparty without having to provide his or her account information to that counterparty.

In another preferred embodiment, where a combination of accounts, a cryptocurrency, a cryptocurrency account, or any number of cryptocurrencies or cryptocurrency accounts, or any combination of same, are used in the transaction, the central processing computer/distributed ledger/Blockchain technology system 12 can, at step 910, perform the operations described herein for each of, and/or for all of, the accounts, cryptocurrency, or cryptocurrency account, or any number of cryptocurrencies or cryptocurrency accounts, or any combination of same, used in the transaction.

At step 910, the merchant can then complete the transaction. Thereafter the operation of the apparatus 200 will proceed to step 912.

If, at step 909, the central processing computer/distributed ledger/Blockchain technology system 12 determines that the transaction is not authorized or not allowed, the operation of the central processing computer/distributed ledger/Blockchain technology system 12 will proceed to step 911 and the central processing computer/distributed ledger/Blockchain technology system 12 will generate a transaction not authorized message and will transmit same to the merchant's counterparty communication device 40. At step 911, the central processing computer/distributed ledger/Blockchain technology system 12 can also transmit the transaction not authorized message to the communication device 20. At step 911, the merchant can then terminate the transaction. Thereafter the operation of the apparatus 200 will proceed to step 912.

At step 912, the central processing computer/distributed ledger/Blockchain technology system 12 can store, in the database (not shown) of the central processing computer component 12A of the central processing computer/distributed ledger/Blockchain technology system 12, any and/or all data and/or information regarding the transaction, the transaction authorization message(s), the picture, the video file, the audio file, the transaction authorized message(s), or the transaction not authorized message(s), and, if applicable, any payment message or payment commitment message(s), for or relating to the transaction or for each transaction.

In another preferred embodiment, where a combination of accounts, a cryptocurrency, a cryptocurrency account, or any number of cryptocurrencies or cryptocurrency accounts, or any combination of same, are used in the transaction, the central processing computer/distributed ledger/Blockchain technology system 12, can also, at step 912, store, in the database (not shown) of the central processing computer component 12A of the central processing computer/distributed ledger/Blockchain technology system 12, any and/or all data and/or information regarding the transaction, the transaction authorization messages, the picture, the video file, the audio file, the transaction authorized messages, or the transaction not authorized message, and, if applicable, any payment message, payment commitment message, payment messages, or payment messages for each account, cryptocurrency, or cryptocurrency account, used in the transaction.

The central processing computer/distributed ledger/Blockchain technology system can also store in the database (not shown) of the central processing computer component 12A of the central processing computer/distributed ledger/Blockchain technology system 12, any account holder alert message(s), account holder notification message(s), merchant alert message(s), or merchant notification message(s), generated for each transaction. The central processing computer/distributed ledger/Blockchain technology system 12 can also store in the database (not shown) of the central processing computer component 12A of the central processing computer/distributed ledger/Blockchain technology system 12, any transaction supporting documentation or information regarding the transaction. Thereafter, the operation of the apparatus 200 will cease at step 913.

In another preferred embodiment, the central processing computer component 12A of the central processing computer/distributed ledger/Blockchain technology system 12 can perform any and/or all of the processing routines and/or functionalities described herein as being performed by the central processing computer/distributed ledger/Blockchain technology system 12 in the preferred embodiment of FIGS. 9A and 9B. In another preferred embodiment, the distributed ledger and Blockchain technology system component 12B of the central processing computer/distributed ledger/Blockchain technology system 12 can perform any and/or all of the processing routines and/or functionalities described herein as being performed by the central processing computer/distributed ledger/Blockchain technology system 12 in the preferred embodiment of FIGS. 9A and 9B.

In another preferred embodiment, the apparatus 300 of FIG. 7 can be utilized to perform any and/or all of the processing routines and/or functionalities described herein as being performed by the preferred embodiment of FIGS. 9A and 9B. In a preferred embodiment, when the apparatus 300 is utilized, the distributed ledger and Blockchain technology system 13 can perform any and/or all of the processing routines and/or functionalities described herein as being performed by the central processing computer/distributed ledger/Blockchain technology system 12 in the preferred embodiment of FIGS. 9A and 9B.

In another preferred embodiment, the apparatus 400 of FIG. 8 can be utilized to perform any and/or all of the processing routines and/or functionalities described herein as being performed by the preferred embodiment of FIGS. 9A and 9B. In a preferred embodiment, when the apparatus 400 is utilized, the distributed ledger and Blockchain technology system 14 can perform any and/or all of the processing routines and/or functionalities described herein as being performed by the central processing computer/distributed ledger/Blockchain technology system 12 in the preferred embodiment of FIGS. 9A and 9B.

The preferred embodiment of FIGS. 9A and 9B can be utilized in order to perform transaction processing for a transaction using one or more accounts, cryptocurrencies, and/or cryptocurrency accounts, while also allowing an account holder to select the type of transaction processing, such as, for example, a blockchain type transaction processing, or a traditional or conventional centralized transaction system type transaction processing, or both, used for processing a transaction, or for processing one or more component parts or payments, or other actions or operations, in a transaction.

In the above-described manner, the apparatus 200 and method of the present invention allows an account holder to engage in a transaction with a merchant or a counterparty without having to provide the merchant or the counterparty with any information regarding his or her account and without having to provide an account number, account identifier, or any other account information, which can be subject to any misappropriation or misuse. In any and/or all of the embodiments described herein, the apparatus 200 and method of the present invention can be utilized in a same, a similar, and/or an analogous, manner, with any of the herein-described communication devices 20. In any and/or all of the embodiments described herein, the apparatus 100 and method of the present invention can be utilized in a same, a similar, and/or an analogous, manner, with any of the herein-described accounts.

In the above-described manner, the apparatus 200 and method of the present invention also allows an account holder to engage in a transaction with a merchant or a counterparty by using any selected transaction processing type and by using any combination of accounts, a cryptocurrency, a cryptocurrency account, or any number of cryptocurrencies or cryptocurrency accounts, in a transaction, without having to provide the merchant or the counterparty with any information regarding any of his or her accounts, cryptocurrency, cryptocurrency account, or any number of cryptocurrencies or cryptocurrency accounts, and without having to provide an account number, account identifier, or any other account information, which can be subject to any misappropriation or misuse. In any and/or all of the embodiments described herein, the apparatus 200 and method of the present invention can also be utilized in a same, a similar, and/or an analogous, manner, with any of the herein-described communication devices 20. In any and/or all of the embodiments described herein, the apparatus 200 and method of the present invention can also be utilized in a same, a similar, and/or an analogous, manner, with any of the herein-described accounts, cryptocurrencies, or cryptocurrency accounts, or any combination of same.

In another preferred embodiment, the apparatus and methods of the present invention, in any and/or all of the embodiments described herein, can be utilized to provide account security, or an enhanced account security, for any account, cryptocurrency, or cryptocurrency account, by allowing an account holder to require or to provide an instruction to the respective apparatus that no single account, cryptocurrency, or crytocurrency account, can be utilized to effectuate payment for an entire amount or for the total cost of any given transaction. In this regard, for example, an account holder or other individual, in effectuating payment for a transaction, would be required to utilize two or more accounts, two or more cryptocurrencies, two or more cryptocurrency accounts, any combination of an account(s) and a cryptocurrency or cryptocurrencies, any combination of an account(s) and a cryptocurrency account(s), any combination of a cryptocurrency or cryptocurrencies and a cryptocurrency account(s), or any other combination of two or more sources for payment, in effectuating payment for or regarding a transaction. In this regard, if so dictated by the account holder, no one single account, cryptocurrency, or cryptocurrency account, can be utilized to effectuate payment in a transaction. In this manner, no one single account, cryptocurrency, or crytocurrency account, can be utilized in an unauthorized manner unless utilized with one or more other accounts, cryptocurrencies, or crytocurrency accounts. It is submitted that such a practice would require that any individual, attempting a transaction using an account of an account holder, possess or have access to information regarding at least one other account, crytocurrency, or cryptocurrency account, before using any account, crytocurrency, or cryptocurrency account, of the account holder.

In a preferred embodiment, the account holder, upon registering his or her accounts, cryptocurrencies, cryptocurrency accounts, with the apparatus of the present invention, can require that one or more other accounts, cryptocurrencies, cryptocurrency accounts, be required in paying for a transaction, with each account, cryptocurrency, or cryptocurrency account being used to make a partial payment for or in any single transaction. Thereafter, each transaction authorization message generated by the communication device 20 can, in addition to including any of the information described herein as being included in the same, can also include information regarding the total amount of the respective transaction along with information regarding the account holder's requirement or instruction that no single account, cryptocurrency, or crytocurrency account, can be utilized to effectuate payment for an entire amount or total cost of any given transaction.

Thereafter, any time a transaction authorization message is received from the communication device 20, the respective central processing computer 10, central processing computer/distributed ledger/Blockchain technology system 12, distributed ledger and Blockchain technology system 13, or distributed ledger and Blockchain technology system 14, can process the information contained in the transaction authorization message to ascertain if the account holder's has required or has instructed that no single account, cryptocurrency, or crytocurrency account, be utilized to effectuate payment for an entire amount or total cost of any given transaction. If it is determined, by the respective central processing computer 10, central processing computer/distributed ledger/Blockchain technology system 12, distributed ledger and Blockchain technology system 13, or distributed ledger and Blockchain technology system 14, that the account holder has required or has instructed that no single account, cryptocurrency, or crytocurrency account, be utilized to effectuate payment for an entire amount or total cost of any given transaction, then the respective central processing computer 10, central processing computer/distributed ledger/Blockchain technology system 12, distributed ledger and Blockchain technology system 13, or distributed ledger and Blockchain technology system 14, can reject, as being associated with an unauthorized transaction, any transaction message wherein the amount sought to be paid by the respective account, cryptocurrency, or cryptocurrency account, is equal to the entire amount or total cost of the transaction.

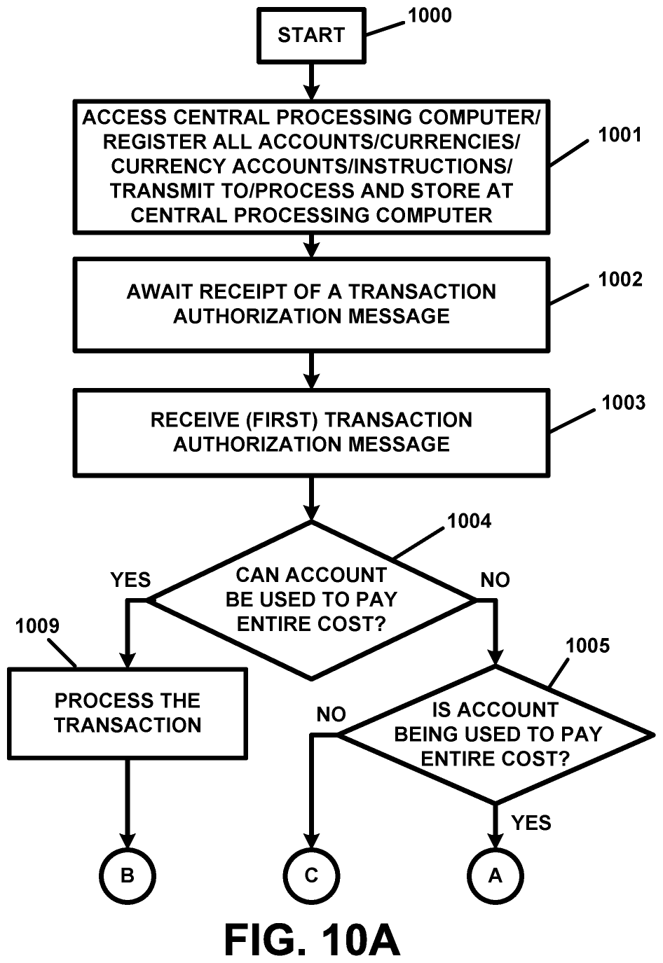

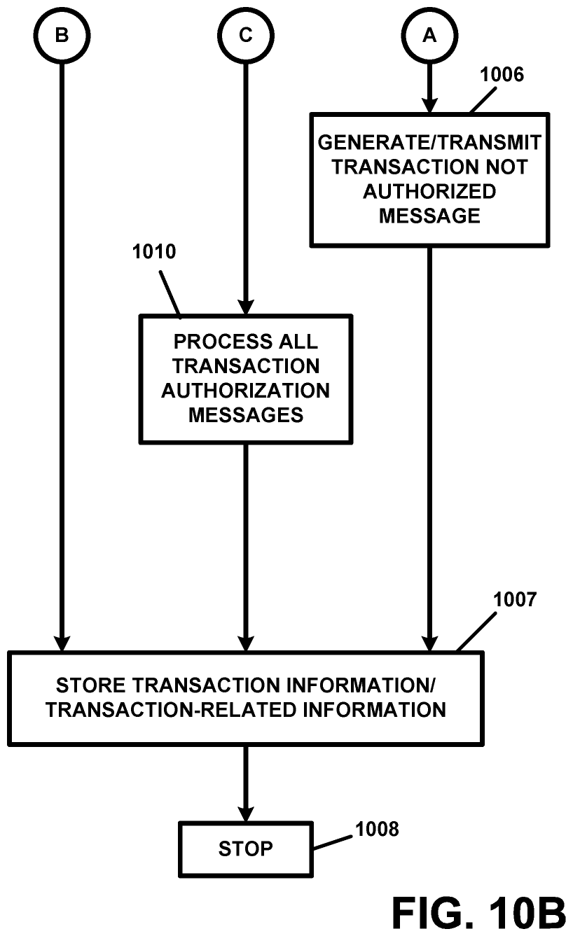

FIGS. 10A and 10B illustrate a preferred embodiment method for utilizing the apparatus 100 of FIG. 1, in flow diagram form. It is to be noted that, although described as being utilized in connection with the apparatus 100 of FIG. 1, the embodiment of FIGS. 10A and 10B can also be utilized in a same, a similar, or an analogous, manner in connection with the apparatus 200 of FIG. 6, the apparatus 300 of FIG. 7, and/or the apparatus 400 of FIG. 8.

With reference to FIGS. 10A and 10B, the operation of the apparatus 100 can commence at step 1000. At step 1001, the account holder can access the central processing computer 10 using his or her communication device 20 and can register each of his or her account(s), cryptocurrencies, or cryptocurrency accounts, with the central processing computer 10 and/or the apparatus 100. At step 1001, any information regarding any registration of any account, cryptocurrency, or cryptocurrency account, can be entered, by the account holder, into the communication device 20 and can be transmitted to, and can be received, processed, and/or stored in the database 10H, by the central processing computer 10.

At step 1001, the account holder can, for each account, cryptocurrency, or cryptocurrency account, which he or she registers with the apparatus 100, register his or her requirement or instruction that the respective account, cryptocurrency, or cryptocurrency account, cannot be utilized to effectuate payment for the entire amount or total cost of any given transaction. In this regard, the account holder will be requiring, for a respective account, cryptocurrency, or cryptocurrency account, that another account, cryptocurrency, or cryptocurrency account, must also be utilized to effectuate payment for the transaction. At step 1001, the information entered by the account holder into the communication 20 can be transmitted to, and received by, processed by, and/or stored in on the database 10H by, the central processing computer 10. Thereafter, at step 1002, the central processing computer 10 can await the receipt of a transaction authorization message for or involving any account, cryptocurrency, or cryptocurrency account, of the account holder.

At step 1003, the central processing computer 10 can receive a transaction authorization message or a plurality of transaction authorization messages for a given transaction involving an individual (who may or not be the account holder) who is using an account, cryptocurrency, or cryptocurrency account, of the account holder. At step 1003, the central processing computer 10 can process information regarding the transaction authorization message or a first of the plurality of transaction authorization messages received.

At step 1004, the central processing computer 10 can determine if the account, cryptocurrency, or cryptocurrency account, identified in the transaction authorization message, is an account, cryptocurrency, or cryptocurrency account, which cannot be utilized to effectuate payment for the entire amount or total cost of any given transaction. If, at step 1004, it is determined by the central processing computer 10 that the account, cryptocurrency, or cryptocurrency account, cannot be utilized to effectuate payment for the entire amount or total cost of any given transaction, then the operation of the apparatus 100 can proceed to step 1005 and the central processing computer 10 can determine if the account, cryptocurrency, or cryptocurrency account, is being utilized to effectuate payment for the entire amount or total cost of the transaction. If, at step 1005, the central processing computer 10 determines that the account, cryptocurrency, or cryptocurrency account, is being utilized to effectuate payment for the entire amount or total cost of the transaction, then the operation of the apparatus 100 can proceed to step 1006. At step 1006, the central processing computer 10 can disallow the transaction and generate a transaction not authorized message and can transmit the transaction not authorized message to the counterparty communication device 40 of the merchant counterparty or other counterparty in the transaction with the individual. Thereafter, the operation of the apparatus 100 can proceed to step 1007 and the central processing computer 10 can store any and/or all data and/or information regarding the transaction in the database 10H. Thereafter, the operation of the apparatus 100 will cease at step 1008.

If, at step 1004, it is determined by the central processing computer 10 that the account, cryptocurrency, or cryptocurrency account, can be utilized to effectuate payment for the entire amount or total cost of any given transaction, then the operation of the apparatus 100 can proceed to step 1009, and the central processing computer 10 can process the transaction in a manner consistent with the processing routines and/or steps described herein regarding steps 509 through 513 of the preferred embodiment of FIGS. 5A and 5B and/or in a manner consistent with the processing routines and/or steps described herein regarding steps 909 through 913 of the preferred embodiment of FIGS. 9A and 9B. Thereafter, the operation of the apparatus 100 can proceed to step 1007 and the central processing computer 10 can store any and/or all data and/or information regarding the transaction in the database 10H. Thereafter, the operation of the apparatus 100 will cease at step 1008.

If, at step 1005, it is determined by the central processing computer 10 that the account, cryptocurrency, or cryptocurrency account, is not being utilized to effectuate payment for the entire amount or total cost of the transaction, then the operation of the apparatus 100 can proceed to step 1010 and the central processing computer 10 can process the transaction by processing all of the transaction authorization messages associated with the transaction in a manner consistent with the processing routines and/or steps described herein regarding steps 509 through 513 of the preferred embodiment of FIGS. 5A and 5B and/or in a manner consistent with the processing routines and/or steps described herein regarding steps 909 through 913 of the preferred embodiment of FIGS. 9A and 9B. Thereafter, the operation of the apparatus 100 can proceed to step 1007 and the central processing computer 10 can store any and/or all data and/or information regarding the transaction in the database 10H. Thereafter, the operation of the apparatus 100 will cease at step 1008.

In another preferred embodiment, the apparatus 200 of FIG. 6 can be utilized to perform the preferred embodiment method of FIGS. 10A and 10B, with the central processing computer/distributed ledger/Blockchain technology system 12 of the apparatus 200 performing all of operations, function, and/or functionalities, described herein as being performed by the central processing computer 10. In another preferred embodiment, the apparatus 300 of FIG. 7 can be utilized to perform the preferred embodiment method of FIGS. 10A and 10B, with the distributed ledger and Blockchain technology system 13 of the apparatus 300 performing all of operations, function, and/or functionalities, described herein as being performed by the central processing computer 10. In another preferred embodiment, the apparatus 400 of FIG. 8 can be utilized to perform the preferred embodiment method of FIGS. 10A and 10B, with the distributed ledger and Blockchain technology system 14 of the apparatus 400 performing all of operations, function, and/or functionalities, described herein as being performed by the central processing computer 10.

In another preferred embodiment, the apparatus and methods of the present invention, in any and/or all of the embodiments described herein, can also be utilized to perform or effectuate various conventional banking and/or investing transactions, functionalities, and/or services, such as, for example, effectuating interest payments for or regarding, and/or for overseeing, administering, and/or servicing, loans of any type or kind, for or regarding any of the herein-described accounts, cryptocurrencies, and/or cryptocurrency accounts. In such a preferred embodiment, a distributed ledger and Blockchain technology system can be utilized in conjunction with smart contracts and/or smart contract technology in order to effectuate interest payments to accounts, cryptocurrencies, and/or cryptocurrency accounts, as well as to oversee, administer, and/or service, loans and/or mortgages and/or liens involving any type or kind of personal property, real property, commercial property, or any other article or entity which can be the subject of, or can be involved in or in connection with, a respective loan, mortgage, or lien, and/or which can serve as collateral for and/or as security for a respective loan, mortgage, or lien.

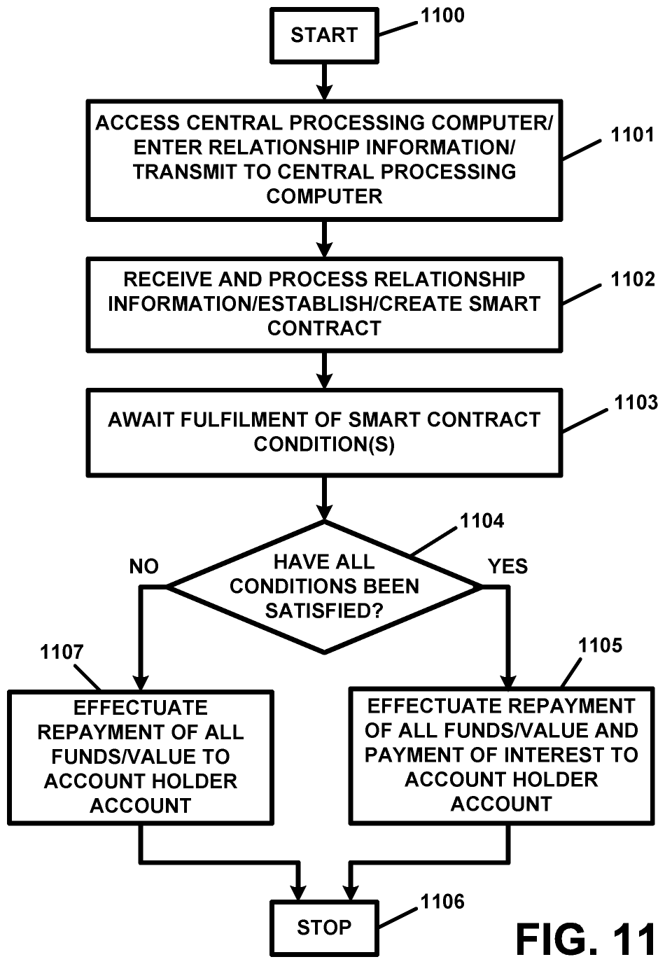

FIG. 11 illustrates a preferred embodiment method for using the apparatus 200 of FIG. 6, in flow diagram form. In a preferred embodiment, the apparatus 200 of FIG. 6 can be utilized in performing the preferred embodiment method of FIG. 11. In another preferred embodiment, the apparatus 300 of FIG. 7 can be utilized in performing the preferred embodiment method of FIG. 11. In another preferred embodiment, the apparatus 400 of FIG. 8 can be utilized in performing the preferred embodiment method of FIG. 11. In a preferred embodiment, the preferred embodiment method of FIG. 11 can be utilized to effectuate an interest payment to, for, or regarding, any account, cryptocurrency, or cryptocurrency account, after a predetermined amount of a monetary value or cryptocurrency value has been held in the respective account, cryptocurrency, or cryptocurrency account, for a pre-specified amount of time. It is, however, important to note that the embodiment of FIG. 11 can also be utilized in a same, a similar, and/or an analogous, manner, in order to automatically make loan payments for or on behalf of an account holder, by automatically deducting loan payment amounts from his or her account, cryptocurrency, or cryptocurrency account, and by effectuating payment to an account, cryptocurrency, or cryptocurrency account, of a counterparty lender or agent of same, and/or can be utilized in order to automatically release a loan or mortgage and/or lift, release, or remove, a lien when a loan or mortgage has been paid in full and/or forgiven and/or when all conditions for lifting, releasing, or removing, a lien have been satisfied, and/or can be utilized to effectuate any other conventional banking and/or investing transaction, function, and/or service.

With reference to FIG. 11, the operation of the apparatus 200 commences at step 1100. At step 1101, a counterparty to a banking or investment transaction with the account holder, after the counterparty and account holder have agreed upon terms to an interest paying relationship (also referred to as “the relationship”) which will provide the account holder's account, cryptocurrency, or cryptocurrency account, with an interest payment upon the satisfaction of certain defined conditions, can access the central processing computer 10 by using his, her, or its, counterparty communication device 40. At step 1101, the counterparty can enter information regarding the interest paying relationship or the relationship by entering information into the counterparty communication device 40 and by transmitting the same to the central processing computer/distributed ledger/Blockchain technology system 12.

In a preferred embodiment, the counterparty can agree to pay an interest payment based on a stated interest rate, or a stated monetary amount, to the respective account, cryptocurrency, or cryptocurrency account, of the account holder in exchange for the counterparty having access to, and being able to borrow, withdraw, and/or use, the account holder's funds or value in the account holder's respective account, cryptocurrency, or cryptocurrency account, for a specified period of time (such as, for example, three months, six months, one years, or any other period of time). In a preferred embodiment, the account holder can agree to leave all of the funds or value, or to maintain at least a specified amount of funds or value, in the account holder's respective account, cryptocurrency, or cryptocurrency account, for that specified period of time, and, in exchange, the counterparty will agree to repay any and all borrowed, withdrawn, and/or used, funds or value, along with the interest payment or stated monetary amount, to the account holder's respective account, cryptocurrency, or cryptocurrency account, at the end of the specified period of time. In a preferred embodiment, the counterparty can provide or identify an account, cryptocurrency, or cryptocurrency account, of the counterparty from which the borrowed, withdrawn, and/or used, funds or value can be repaid, and from which the interest payment or stated monetary amount can be paid, to the account holder's account, cryptocurrency, or cryptocurrency account.

At step 1101, the counterparty communication device 40 can transmit all information regarding the banking or investment transaction and/or the relationship to the central processing computer/distributed ledger/Blockchain technology system 12. At step 1102, the central processing computer/distributed ledger/Blockchain technology system 12 can receive the information regarding the banking or investment transaction and/or the relationship and the central processing computer component 12A can process the same and establish, or create, a smart contract regarding the banking or investment transaction and/or relationship which can be implemented, administered, and executed, by the distributed ledger and Blockchain technology system component 12B of the central processing computer/distributed ledger/Blockchain technology system 12. In a preferred embodiment, the central processing computer component 12A can store any and/or all information regarding the banking or investment transaction and/or the relationship, and any information regarding the smart contract, in the database (not shown) of the central processing computer component 12A.

Thereafter, at step 1103, the apparatus 200 will await the elapsing of the specified period of time.

At the end of the specified period of time, the operation of the apparatus 200 can proceed to step 1104 and the central processing computer/distributed ledger/Blockchain technology system 12 can determine if the account holder complied with all of the conditions of the smart contract. In particular, the distributed ledger and Blockchain technology system component 12B of the central processing computer/distributed ledger/Blockchain technology system 12 can determine if the account holder provided the counterparty with access to all funds or value in the account, cryptocurrency, or cryptocurrency account, and/or that the account holder left all of the funds or value, or maintained at least the specified amount of funds or value, in the account holder's respective account, cryptocurrency, or cryptocurrency account, for access by the counterparty for the specified period of time.

If, at step 1104, the distributed ledger and Blockchain technology system component 12B of the central processing computer/distributed ledger/Blockchain technology system 12 determines that the account holder provided the counterparty with access to all funds or value in the account, cryptocurrency, or cryptocurrency account, and/or that the account holder left all of the funds or value, or maintained at least the specified amount of funds or value, in the account holder's respective account, cryptocurrency, or cryptocurrency account, for access by the counterparty for the specified period of time and, therefore, complied with all terms and conditions of the smart contract, then the operation of the apparatus 200 can proceed to step 1105, and the apparatus 200 and/or the distributed ledger and Blockchain technology system component 12B of the central processing computer/distributed ledger/Blockchain technology system 12, can effectuate the repayment of all borrowed, withdrawn, and/or used, funds or value to the account holder's account, cryptocurrency, or cryptocurrency account, and can effectuate the payment of the interest payment or the stated monetary amount, to the account holder's account, cryptocurrency, or cryptocurrency account. Thereafter, the operation of the apparatus 200 will cease at step 1106.

If, however, at step 1104, the distributed ledger and Blockchain technology system component 12B of the central processing computer/distributed ledger/Blockchain technology system 12 determines that the account holder did not provide the counterparty with access to all funds or value in the account, cryptocurrency, or cryptocurrency account, and/or that the account holder did not leave all of the funds or value, or did not maintained at least the specified amount of funds or value, in the account holder's respective account, cryptocurrency, or cryptocurrency account, for access by the counterparty for the specified period of time and, therefore, did not comply with all terms and conditions of the smart contract, then the operation of the apparatus 200 can proceed to step 1107, and the apparatus 200 and/or the distributed ledger and Blockchain technology system component 12B of the central processing computer/distributed ledger/Blockchain technology system 12, can effectuate the repayment of all borrowed, withdrawn, and/or used, funds or value to the account holder's account, cryptocurrency, or cryptocurrency account. In a preferred embodiment, if the account holder failed to comply with all terms and conditions of the smart contract, then no interest payment or payment of any stated monetary amount will be paid the account holder's account, cryptocurrency, or cryptocurrency account. Thereafter, the operation of the apparatus 200 will cease at step 1106.

In another preferred embodiment, the embodiment of FIG. 11 can be utilized in a same, a similar, and/or an analogous, manner in order to allow the apparatus 200 to utilize a distributed ledger and Blockchain technology system in conjunction with smart contract technology in order to oversee and/or administer the repayment of a loan, the payment of a mortgage obligation, the release or lifting of a lien, of any type or kind, including, but not limited to, loans and/or mortgages and/or liens involving any type or kind of personal property, real property, commercial property, or any other article or entity which can be the subject of, or can be involved in or in connection with, a respective loan, mortgage, or lien, and/or which can serve as collateral for and/or as security for a respective loan, mortgage, or lien.

In another preferred embodiment, the embodiment of FIG. 11 can be utilized in a same, a similar, and/or an analogous, manner in order to allow the apparatus 200 to utilize a distributed ledger and Blockchain technology system in conjunction with smart contract technology in order to perform and/or to provide any banking, financial, and/or investment, transaction, function, and/or service, and/or to provide any banking, financial, and/or investment, product or service using a distributed ledger and Blockchain technology system in conjunction with smart contract technology.

In another preferred embodiment, the apparatus 100, 200, 300, and/or 400, and/or methods of the present invention, can be utilized in order to perform position-based or location-based transaction security, account security, or transaction, authentication, which authentication can be based on the position, location, or geographic location (also referred to herein as the “geolocation”), of the communication device 20 and, hence, the user or individual, at a time, or at the time, of any performance, or attempted performance, by the user or individual, of any transaction on, with, using, or involving, any of the herein-described accounts, or cards associated with any of the herein-described accounts, at a time, or at the time, of any action or transaction with the central processing computer 10, the central processing computer/distributed ledger/Blockchain technology system 12, the distributed ledger and Blockchain technology system 13, or the distributed ledger and Blockchain technology system 14, and/or at a time, or at the time, of any transmission of any of the data, information, signal(s), message(s), or response(s), described herein or otherwise, from the communication device 20 to the central processing computer 10, the central processing computer/distributed ledger/Blockchain technology system 12, the distributed ledger and Blockchain technology system 13, or the distributed ledger and Blockchain technology system 14.

In a preferred embodiment, each of the central processing computer 10, the central processing computer/distributed ledger/Blockchain technology system 12, the distributed ledger and Blockchain technology system 13, or the distributed ledger and Blockchain technology system 14, can be equipped with any and/or all necessary hardware and/or software needed or required, and/or can be capable or configured, for performing all of the functions and/or functionalities described herein.

In a preferred embodiment, the position, location, or geographic location, information for, or associated with, the communication device 20 can be obtained, in the case of stationary communication devices 20, such as, for example, home, work, or personal, computers, by determining the position or location of, for, or associated with, the IP address of, for, associated with, or assigned to, the respective communication device 20, or, in the case of mobile communication devices 20, such as, for example, cellular telephones, Smartphones or smart phones, personal digital assistants, tablets, tablet computers, laptop computers, notebook computers, handheld computers, or other mobile devices, by determining the position or location of the respective communication device 20 by using the global positioning device 20J of the communication device 20. In another preferred embodiment, and under certain circumstances, it may also be possible to determine or ascertain the position or location, of the mobile communication device 20 via an IP address or by “pinging” the same. By “pinging”, Applicant refers to the technique(s) known and used by those skilled in the art, at the time of the filing of this application, to request, obtain, and/or determine, the position or location of a mobile communication device 20.

In a preferred embodiment, the central processing computer 10, the central processing computer/distributed ledger/Blockchain technology system 12, the distributed ledger and Blockchain technology system 13, or the distributed ledger and Blockchain technology system 14, can determine or can ascertain, or can look-up, the position, location, or geographic location, of a stationary communication device 20, which is utilized in any transaction, or attempted transaction, on, with, using, or involving, any of the herein-described accounts, or cards associated with any of the herein-described accounts, any action or transaction, or attempted action or transaction, with the central processing computer 10, the central processing computer/distributed ledger/Blockchain technology system 12, the distributed ledger and Blockchain technology system 13, or the distributed ledger and Blockchain technology system 14, and/or any transmission of any of the data, information, signal(s), message(s), or response(s), described herein or otherwise, from the communication device 20 to the central processing computer 10, the central processing computer/distributed ledger/Blockchain technology system 12, the distributed ledger and Blockchain technology system 13, or the distributed ledger and Blockchain technology system 14, at a time, or at the time, of the same, by using the IP address of the respective communication device 20.

In a preferred embodiment, the central processing computer 10, the central processing computer/distributed ledger/Blockchain technology system 12, the distributed ledger and Blockchain technology system 13, or the distributed ledger and Blockchain technology system 14, can also determine or can ascertain, or can look-up, the position, location, or geographic location, of a mobile communication device 20, which is utilized in any transaction, or attempted transaction, on, with, using, or involving, any of the herein-described accounts, or cards associated with any of the herein-described accounts, any action or transaction, or attempted action or transaction, with the central processing computer 10, the central processing computer/distributed ledger/Blockchain technology system 12, the distributed ledger and Blockchain technology system 13, or the distributed ledger and Blockchain technology system 14, and/or any transmission of any of the data, information, signal(s), message(s), or response(s), described herein or otherwise, from the communication device to the central processing computer 10, the central processing computer/distributed ledger/Blockchain technology system 12, the distributed ledger and Blockchain technology system 13, or the distributed ledger and Blockchain technology system 14, at a time, or at the time, of the same, by using global positioning system data and/or information, which can be obtained with or using the global positioning device 20J, and/or data and/or information obtained via the global positioning device 20J, of the respective mobile communication device 20, and which can be transmitted to and processed by the central processing computer 10, the central processing computer/distributed ledger/Blockchain technology system 12, the distributed ledger and Blockchain technology system 13, or the distributed ledger and Blockchain technology system 14.

In a preferred embodiment, the central processing computer 10, the central processing computer/distributed ledger/Blockchain technology system 12, the distributed ledger and Blockchain technology system 13, or the distributed ledger and Blockchain technology system 14, can also determine or can ascertain, or can look-up, the position, location, or geographic location, of a mobile communication device 20 by transmitting a request for position or location information of or for a respective mobile communication device 20 (also referred to as “pinging” the respective mobile communication device 20), and by receiving information in response to that request. In another preferred embodiment, if the respective stationary communication device 20 is equipped with a global positioning device 20J, the central processing computer 10, the central processing computer/distributed ledger/Blockchain technology system 12, the distributed ledger and Blockchain technology system 13, or the distributed ledger and Blockchain technology system 14, can also determine or can ascertain, or can look-up, the position, location, or geographic location, of that stationary communication device 20 by “pinging” the same as well.

In a preferred embodiment, once the position, location, or geographic location, of the respective communication device 20 is determined or ascertained, then the central processing computer 10, the central processing computer/distributed ledger/Blockchain technology system 12, the distributed ledger and Blockchain technology system 13, or the distributed ledger and Blockchain technology system 14, can compare the position, location, or geographic location, of the respective communication device 20 with an expected location of the individual or user using the same at a time, or at the time, of any such action or transaction, and/or at a time, or at the time, of any performance, by the user or individual, of any action or transaction with the central processing computer 10, the central processing computer/distributed ledger/Blockchain technology system 12, the distributed ledger and Blockchain technology system 13, or the distributed ledger and Blockchain technology system 14, at a time, or at the time, of any performance, by the user or individual, of any transaction on, with, using, or involving, any of the herein-described accounts, or cards associated with any of the herein-described accounts, at a time, or at the time, of any action or transaction with the central processing computer 10, the central processing computer/distributed ledger/Blockchain technology system 12, the distributed ledger and Blockchain technology system 13, or the distributed ledger and Blockchain technology system 14, and/or at a time, or at the time, of any transmission of any of the data, information, signal(s), message(s), or response(s), described herein or otherwise, from the communication device 20 to the central processing computer 10, the central processing computer/distributed ledger/Blockchain technology system 12, the distributed ledger and Blockchain technology system 13, or the distributed ledger and Blockchain technology system 14.

In a preferred embodiment, it is envisioned that any user or individual, who utilizes the apparatus 100, 200, 300, and/or 400, of the present invention in order to use or access, and/or to perform any transaction on, with, using, or involving, any of the herein-described accounts, or cards associated with any of the herein-described accounts, can have stored for or on his or her behalf, in the central processing computer 10, the central processing computer/distributed ledger/Blockchain technology system 12, the distributed ledger and Blockchain technology system 13, or the distributed ledger and Blockchain technology system 14, or in the respective database of the same, information regarding his or her typical or usual itinerary or schedule, including any typical or usual traveling itinerary or schedule (hereinafter also referred to as an “itinerary” or “schedule”).

In a preferred embodiment, the information regarding the user's or individual's itinerary or schedule can include information regarding the user's or individual's typical or regular itinerary or schedule for any and/or all days of the user's or individual's typical week, work week, weekend, or any trips, vacations, or any deviations from the user's or individual's typical or regular itinerary or schedule. In a preferred embodiment, the information regarding the user's or individual's itinerary or schedule can be entered into a communication device 20 used by, or associated with, the user or individual and can be transmitted to, and received at, the central processing computer 10, the central processing computer/distributed ledger/Blockchain technology system 12, the distributed ledger and Blockchain technology system 13, or the distributed ledger and Blockchain technology system 14, and can be stored in the respective database of same.

In a preferred embodiment, information regarding the user's or individual's itinerary or schedule, for given times during given days of the week, can also be monitored and recorded automatically by the communication device 20, data and/or information regarding or corresponding to same can be stored in the database 20H of the communication device 20, and/or can be automatically transmitted to, and received at, the the central processing computer 10, the central processing computer/distributed ledger/Blockchain technology system 12, the distributed ledger and Blockchain technology system 13, or the distributed ledger and Blockchain technology system 14, and can be stored in the respective database of same.

In this regard, in a preferred embodiment, the communication device 20 can be programmed to periodically and/or continuously, and automatically, monitor the position or location and/or the global positioning position or location, as determined by the global positioning device 20J, of the user's or individual's travels and/or movement, at pre-determined and/or at pre-selected time intervals, in order to record the user's or individual's travels or movements during certain times and/or days of the week so as to determine, ascertain, or predict, an expected itinerary or schedule, or an expected travel itinerary or schedule, for the user of individual for a given day or for given days. This information can thereafter be utilized as, or to supplement, to complement, or to modify, any data and/or information regarding a previously stored itinerary or schedule of or for the user or individual.

In a preferred embodiment, information recorded automatically by the communication device 20 can also be utilized for determining and/or for storing an expected itinerary or schedule for the user or individual. In another preferred embodiment, the apparatus 100, 200, 300, and/or 400, the central processing computer 10, the central processing computer/distributed ledger/Blockchain technology system 12, the distributed ledger and Blockchain technology system 13, or the distributed ledger and Blockchain technology system 14, and/or the communication device 20, can utilize any software, programs, or algorithms, or any artificial intelligence (AI) or machine learning software, programs, or algorithms, for recording, for storing, and/or for predicting, and/or for updating, any itinerary or schedule, for determining, for ascertaining, or for predicting, a user's or individual's position, location, or geographic location, at any given time during any given day. In a preferred embodiment, the respective databases 10H and 20H of the central processing computer 10 and the communication device 20, and/or any respective databases of the central processing computer/distributed ledger/Blockchain technology system 12, the distributed ledger and Blockchain technology system 13, or the distributed ledger and Blockchain technology system 14, can include or contain any itinerary or schedule information for the user or individual as well as any software, programs, or algorithms, or any artificial intelligence (AI) or machine learning software, programs, or algorithms, for recording, storing, and/or predicting, and/or for updating, the itinerary or schedule of or for the user or individual.

In a preferred embodiment, and as an example, the database 10H of the central processing computer 10 and/or the database 20H of the communication device 20, and/or any respective database of the central processing computer/distributed ledger/Blockchain technology system 12, the distributed ledger and Blockchain technology system 13, or the distributed ledger and Blockchain technology system 14, can contain and/or can include, as part of the information regarding the user's or individual's itinerary or schedule, information regarding places, locations, or venues, to which the user or individual travels or spends time, data and/or information regarding the daily schedule or daily schedules of or for the user or the individual, and/or any data and/or information regarding the daily routine or daily routines of or for the user or individual, any places where the user or individual is or has to be at a given time(s), and/or any other data and/or information regarding the user's or the individual's daily routines, weekly routines, travel routines, travel routes used, alternate travel routes used, travel times, and/or time of travel regarding any travel by the user or individual, and/or any other data and/or information regarding the user's or the individual's activities or routines that can be stored or recorded and which can be utilized to predict a position, location, or geographic location, of or for the user or the individual at a certain instant in time.

The database 10H and/or the database 20H, and/or any respective database of the central processing computer/distributed ledger/Blockchain technology system 12, the distributed ledger and Blockchain technology system 13, or the distributed ledger and Blockchain technology system 14, can also contain and/or include data and/or information regarding past travels, movements, or activities, including, but not limited to, travel routes and dates and/or times of same, as well as future travel plans, movements, or activities, for the user or individual.

In a preferred embodiment, the database 10H of the central processing computer 10 and/or the database 20H of the communication device 20, and/or any respective database of the central processing computer/distributed ledger/Blockchain technology system 12, the distributed ledger and Blockchain technology system 13, or the distributed ledger and Blockchain technology system 14, can also contain and/or can include, as part of the information regarding the user's or individual's itinerary or schedule, information regarding travel itineraries and/or travel schedules for traveling to and between one address, place, or location, to another address, place, or location, and information regarding travel routes or directions for traveling to and between one address, place, or location, to another address, place, or location. In a preferred embodiment, the database 10H of the central processing computer 10 and/or the database 20H of the communication device 20, and/or any respective database of the central processing computer/distributed ledger/Blockchain technology system 12, the distributed ledger and Blockchain technology system 13, or the distributed ledger and Blockchain technology system 14, can also contain and/or can include software programs, navigation programs, or any algorithms or software applications, for identifying, determining, ascertaining, or calculating, any travel routes or directions for traveling to and between one address, place, or location, to another address, place, or location.

As and for another example, in a preferred embodiment, the database 10H of the central processing computer 10 and/or the database 20H of the communication device 20, and/or any respective database of the central processing computer/distributed ledger/Blockchain technology system 12, the distributed ledger and Blockchain technology system 13, or the distributed ledger and Blockchain technology system 14, as part of the information regarding the user's or individual's itinerary or schedule, can also contain and/or include any data and/or information regarding the daily weekday schedule for the user or individual, such as, for example, the user's or individual's home address, the time or approximate time when the user or individual leaves home for work or some other activity or venue, a preferred travel route the user or individual typically takes to go to work or to some other activity or venue, any typical alternate travel routes to work, to the activity, or to the venue, the time or the approximate time the user or individual arrives at work, the activity, or the venue, the time or the approximate time the user or individual leaves work, the activity, or the venue, a typical travel route to another activity or venue, if applicable, a typical travel route to the other activity or venue, a typical alternate travel route to the other activity or venue, a time or an approximate time of a travel to the other activity or venue, a time or an approximate time when the user or individual leaves the other activity or venue, a typical travel route from the other activity or venue back to the user's or individual's home, a typical travel route to the user's or individual's home, a typical alternate travel route to the user's or individual's home, and/or a typical time or an approximate time when the user or individual is expected to arrive at home.

The database 10H and the database 20H, and/or any respective database of the central processing computer/distributed ledger/Blockchain technology system 12, the distributed ledger and Blockchain technology system 13, or the distributed ledger and Blockchain technology system 14, can also contain and/or can include, as part of the information regarding the user's or individual's itinerary or schedule, any data and/or information regarding any school(s), workplace(s), club(s), activity venue(s), recreational venue(s), entertainment venue(s), or any other place(s), location(s), and/or other venue(s), of the user or individual and/or to which the user or individual travels and/or at which the user or individual is known to spend time. The database 10H and/or the database 20H, and/or any respective database of the central processing computer/distributed ledger/Blockchain technology system 12, the distributed ledger and Blockchain technology system 13, or the distributed ledger and Blockchain technology system 14, as part of the information regarding the user's or individual's itinerary or schedule, can also contain and/or can include any data and/or information regarding the location(s) of any school(s), workplace(s), club(s), activity venue(s), recreational venue(s), entertainment venue(s), or any other place(s), location(s), and/or other venue(s), of the user or individual, which data and/or information can include the name, the address, the telephone number, the website address, the IP address, a description of same, schedule information of or for same, and/or any other information regarding same.

The database 10H and/or the database 20H, and/or any respective database of the central processing computer/distributed ledger/Blockchain technology system 12, the distributed ledger and Blockchain technology system 13, or the distributed ledger and Blockchain technology system 14, can also contain and/or can include, as part of the information regarding the user's or individual's itinerary or schedule, any data and/or information regarding any weekday or weekend day schedules or itineraries of the user or individual. The database 10H and/or the database 20H, and/or any respective database of the central processing computer/distributed ledger/Blockchain technology system 12, the distributed ledger and Blockchain technology system 13, or the distributed ledger and Blockchain technology system 14, can also contain and/or can include, as part of the information regarding the user's or individual's itinerary or schedule, any data and/or information regarding the daily schedule for each weekday or for each weekend day for the user or the individual, travel routes traveled for each day and/or for any trip or expected travel, and/or time(s) associated with each trip or travel segment of each trip or expected travel.

The database 10H and/or the database 20H, and/or any respective database of the central processing computer/distributed ledger/Blockchain technology system 12, the distributed ledger and Blockchain technology system 13, or the distributed ledger and Blockchain technology system 14, can also contain and/or include, as part of the information regarding the user's or individual's itinerary or schedule, data and/or information regarding travel records for the user or individual, which can contain and/or include data and/or information regarding a date and/or time of travel and/or travel routes taken or traveled by, and/or any other data and/or information regarding, the user or individual for or during any period of time or during and/or for or relating to any schedule or routine.

The database 10H and/or the database 20H, and/or any respective database of the central processing computer/distributed ledger/Blockchain technology system 12, the distributed ledger and Blockchain technology system 13, or the distributed ledger and Blockchain technology system 14, can also contain and/or include, as part of the information regarding the user's or individual's itinerary or schedule, any other data and/or information, software, programs, and/or algorithms, needed, required, or desired, for performing any and/or all of the functions, functionalities, and/or operations, described herein as being performed by the apparatus 100, 200, 300, and/or 400, and/or by the central processing computer 10, the central processing computer/distributed ledger/Blockchain technology system 12, the distributed ledger and Blockchain technology system 13, or the distributed ledger and Blockchain technology system 14, of the present invention.

In a preferred embodiment, the apparatus 100, 200, 300, and/or 400, and/or methods of the present invention can be utilized in order to authenticate a user or individual, or a transaction, or attempted transaction, on, with, using, or involving, any of the herein-described accounts, or cards associated with any of the herein-described accounts, any action or transaction, or attempted action or transaction, with the central processing computer 10, the central processing computer/distributed ledger/Blockchain technology system 12, the distributed ledger and Blockchain technology system 13, or the distributed ledger and Blockchain technology system 14, and/or any transmission of any of the data, information, signal(s), message(s), or response(s), described herein or otherwise, from the communication device to the central processing computer 10, the central processing computer/distributed ledger/Blockchain technology system 12, the distributed ledger and Blockchain technology system 13, or the distributed ledger and Blockchain technology system 14, by using and processing information regarding the position, location, or geographic location, of the communication device 20 which is being used by the user or individual and, hence, the position, location, or geographic location, of the user.

In a preferred embodiment, the apparatus 100, 200, 300, and/or 400, and/or methods of the present invention can be utilized in order to authenticate a user or individual by the position, location, or geographic location, of the user's or individual's communication device 20 (also referred to herein as “location-based authentication”) each time and/or any time the user or individual performs, or attempts to perform, any transaction on, with, using, or involving, any of the herein-described accounts, or cards associated with any of the herein-described accounts, any time the user or individual performs, or attempts to perform, any action or transaction with the central processing computer 10, the central processing computer/distributed ledger/Blockchain technology system 12, the distributed ledger and Blockchain technology system 13, or the distributed ledger and Blockchain technology system 14, and/or any time the user or individual transmits any of the data, information, signal(s), message(s), or response(s), described herein or otherwise, from the communication device 20 to the central processing computer 10, the central processing computer/distributed ledger/Blockchain technology system 12, the distributed ledger and Blockchain technology system 13, or the distributed ledger and Blockchain technology system 14, and/or any time the user or individual performs, or attempts to perform, any action or transaction which is or may be capable of being performed or being effectuated by or via the apparatus 100, 200, 300, and/or 400, and/or methods of the present invention.

In a preferred embodiment, the apparatus 100, 200, 300, and/or 400, of the present invention can perform location-based authentication for or regarding any action or transaction performed, or attempted to be performed, with, involving, or using, any of the herein-described accounts, or cards associated with any of the herein-described accounts, and/or with the central processing computer 10, the central processing computer/distributed ledger/Blockchain technology system 12, the distributed ledger and Blockchain technology system 13, or the distributed ledger and Blockchain technology system 14, and/or the apparatus 100, 200, 300, and/or 400, of the present invention.

In a preferred embodiment, the central processing computer 10, the central processing computer/distributed ledger/Blockchain technology system 12, the distributed ledger and Blockchain technology system 13, or the distributed ledger and Blockchain technology system 14, can perform processing routines to determine whether or not the user or individual, and/or any herein-described action, transaction, or activity, performed, or attempted to be performed, by the user or individual is authenticated. If determined to be authenticated, the central processing computer 10, the central processing computer/distributed ledger/Blockchain technology system 12, the distributed ledger and Blockchain technology system 13, or the distributed ledger and Blockchain technology system 14, can authenticate and allow the respective, action, transaction, or activity, on, with, using, or involving, the respective account, the respective action or transaction with the central processing computer 10, the central processing computer/distributed ledger/Blockchain technology system 12, the distributed ledger and Blockchain technology system 13, or the distributed ledger and Blockchain technology system 14, the respective transmission of any data, information, signal(s), message(s), or response(s), described herein or otherwise, from the communication device 20 to the central processing computer 10, the central processing computer/distributed ledger/Blockchain technology system 12, the distributed ledger and Blockchain technology system 13, or the distributed ledger and Blockchain technology system 14, or the action, transaction, or activity, which is or may be capable of being performed or being effectuated by or via the apparatus 100, 200, 300, and/or 400, and methods of the present invention. If determined to not be authenticated, the central processing computer 10, the central processing computer/distributed ledger/Blockchain technology system 12, the distributed ledger and Blockchain technology system 13, or the distributed ledger and Blockchain technology system 14, can disallow the respective, action, transaction, or activity, on, with, using, or involving, the respective account, the respective action or transaction with the central processing computer 10, the central processing computer/distributed ledger/Blockchain technology system 12, the distributed ledger and Blockchain technology system 13, or the distributed ledger and Blockchain technology system 14, the respective transmission of any data, information, signal(s), message(s), or response(s), described herein or otherwise, from the communication device 20 to the central processing computer 10, the central processing computer/distributed ledger/Blockchain technology system 12, the distributed ledger and Blockchain technology system 13, or the distributed ledger and Blockchain technology system 14, or the action, transaction, or activity, which is or may be capable of being performed or being effectuated by or via the apparatus 100, 200, 300, and/or 400, and/or methods of the present invention, or the respective attempt to do the same.

In a preferred embodiment, the central processing computer 10, the central processing computer/distributed ledger/Blockchain technology system 12, the distributed ledger and Blockchain technology system 13, or the distributed ledger and Blockchain technology system 14, can also determine whether or not the determined and authenticated position, location, or geographic location, is located within the geographic limits of a jurisdiction, state, province, region, or country, so as to ensure and/or to document, in any appropriate manner, that any respective action, transaction, or activity, is legally performed within the geographic limits of a jurisdiction, state, province, region, or country.

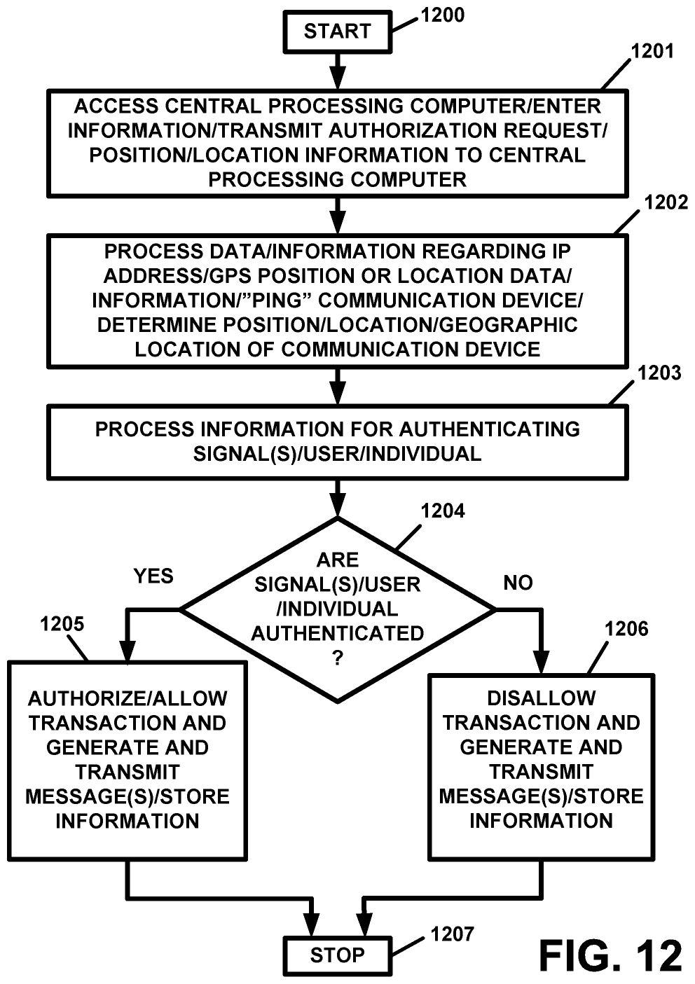

FIG. 12 illustrates another preferred embodiment method for utilizing the apparatus 100 of the present invention, in flow diagram form. In the preferred embodiment of the method of FIG. 12, the apparatus 100 is described as being utilized in connection with a transaction on, with, or involving, a credit card account. It is important to note, however, that the method of the embodiment of FIG. 12 can also be utilized with each of the apparatus 200, the apparatus 300, and/or the apparatus 400 in a same, a similar, and/or in an analogous, manner.

It is also important to note that the method of the embodiment of FIG. 12 can also be utilized in a same, similar, or an analogous, manner, in connection with transactions on, with, or involving, credit accounts, charge card accounts, charge accounts, debit card accounts, or debit accounts, bank accounts, checking accounts, or savings accounts, cryptocurrencies, cryptocurrency accounts, gambling accounts, gaming accounts, sports betting accounts, lottery gaming accounts, lottery accounts, brokerage accounts, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, electronic money accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, text messaging accounts, a customer loyalty accounts, social network membership accounts, or any other accounts, as well as any cards, devices, and/or other entities, which can be used with or which can be associated with any of the herein-described accounts.

It is also important to note that the method of the embodiment of FIG. 12 can also be utilized in a same, similar, or an analogous, manner, in connection with transactions on, with, or involving, any action or transaction with or involving the central processing computer 10, the central processing computer/distributed ledger/Blockchain technology system 12, the distributed ledger and Blockchain technology system 13, or the distributed ledger and Blockchain technology system 14, and/or in connection with any transmission of any of the data, information, signal(s), message(s), or response(s), described herein or otherwise, from the communication device to the central processing computer 10, the central processing computer/distributed ledger/Blockchain technology system 12, the distributed ledger and Blockchain technology system 13, or the distributed ledger and Blockchain technology system 14.

With reference to FIG. 12, the operation of the apparatus 100 commences at step 1200 when the user or individual enters into, or attempts to enter into, a transaction with a merchant or a counterparty using a credit card account. At step 1201, the user or individual can access the central processing computer 10 in order to initiate a credit card transaction with the merchant or the counterparty. In a preferred embodiment, the transaction can be an in-person or face-to-face transaction, or the transaction can be a transaction which takes place on or over the Internet and/or World Wide Web and/or any other on-line transaction.

In a preferred embodiment, at step 1201, the user or individual can enter, into his or her communication device 20, any information regarding the respective credit card transaction, including, but not limited to, his or her selection of a credit card account to use or the credit card account to use, information regarding the amount of the transaction, information regarding the merchant or the counterparty, and/or any other information regarding the transaction (hereinafter also referred to a the “credit card transaction information”).

At step 1201, the communication device 20 can transmit an appropriate signal or appropriate signals (hereinafter also referred to as “signal or signals” or “signal(s)”) as a transaction authorization request, containing the credit card transaction information, to the central processing computer 10.

In a preferred embodiment, at step 1201, the signal or signals, which are transmitted from the communication device 20 to the central processing computer 10, can also contain or include information needed for performing the location-based authentication of or for the communication device 20 and, hence, the user or individual. In a preferred embodiment, for stationary communication devices 20, the signal of signals can contain the IP address of, or information regarding the IP address of, the stationary communication device 20 from which the signal or signals is/are transmitted. In a preferred embodiment, for mobile communication devices 20 having an assigned IP address, the signal of signals can contain the IP address of, or information regarding the IP address of, the mobile communication device 20 from which the signal or signals is/are transmitted.

In a preferred embodiment, for mobile communication devices 20, the signal or signals can contain or include position or location data and/or information, as obtained from the global positioning device 20J, at the time of the transmission of the signal or signals from the mobile communication device 20. In a preferred embodiment, for stationary communication devices 20 having a global positioning device 20J, the signal or signals can also contain or include position or location data and/or information, as obtained from the global positioning device 20J, at the time of the transmission of the signal or signals from the stationary communication device 20.

At step 1201, the central processing computer 10 can receive the signal or signals which is/are transmitted from the communication device 20. In a preferred embodiment, any data and/or information contained in any signal or signals transmitted to, and received by, the central processing computer 10 can be time-stamped and/or data stamped and/or can be stored in the database 10H of the central processing computer 10, and/or can be used for any appropriate purpose thereafter.

At step 1202, the central processing computer 10 can process information regarding the IP address, or the position or location information which was determined by the global positioning device 20J of the respective communication device 20, or any combination of information regarding the IP address and any position or location information which was determined by the global positioning device 20J of the respective communication device 20, in order to determine the position, location, or geographic location, of the communication device 20 at the time of the transmission of the above-referenced signal or signals from the communication device 20 to the central processing computer 10. At step 1202, the central processing computer 10 can determine the position, location, or geographic location, of the communication device 20 at the time of the transmission of the signal or signals to the central processing computer 10.

In another preferred embodiment, at step 1202, the central processing computer 10 can also transmit, to the communication device 20, a request for the communication device's 20 position or location information, and can receive data and/or information, in response to the request, from the communication device 20 regarding its position or location, as determined by the global positioning device 20J of the communication device 20, in order to, or so as to, “ping” the communication device 20, or so as to effectuate a “pinging” operation of or for the communication device 20. By performing such a “pinging” operation, the central processing computer 10 can independently obtain position or location information from the communication device 20. In this regard, by “pinging” the communication device 20, either directly or by using a cellular, wireless, or other, telecommunication or other provider or service, the central processing computer 10 can validate, confirm, or re-confirm, the position, location, or geographic location, of the communication device 20.

In a preferred embodiment, at step 1202, if an IP address, or information regarding an IP address, is received by the central processing computer 10, the central processing computer 10 can determine or can ascertain the position, location, or geographic location, of, for, or associated with, the IP address of, for, or assigned to, the communication device 20 by performing any appropriate IP address look-up processing routine(s) or by using any other appropriate processing routine(s) for determining or for ascertaining the position or location information of or associated with the IP address.

At step 1202, the central processing computer 10 can also utilize the services of any IP address look-up service provider to determine or ascertain the position, location, or geographic location, of, for, or associated with, the IP address. In a preferred embodiment, any position, location, or geographic location, information for or associated with the IP address can include information regarding the IP address, the IP address itself, and information regarding the Internet Service Provider (ISP) servicing the communication device 20, information regarding the network service provider servicing the communication device 20, information regarding street address for or associated with the IP address (and the communication device 20), information regarding map address, position, or location, for or associated with the IP address (and the communication device 20), information regarding the latitude or the latitude for or associated with the IP address (and the communication device 20), information regarding the longitude or the longitude for or associated with the IP address (and the communication device 20), information regarding the locality or municipality, state or province, and/or country or territory, in which the communication device 20 is located, a digitized map or information for providing a digitized map showing the position or location of the IP address (and the communication device 20) on the same, and/or any other information for or associated with the IP address.

In a preferred embodiment, at step 1202, if global positioning device information is received by the central processing computer 10 from the communication device 20, such as when the communication device 20 transmits the same in or along with the signal or signals described herein, or when the communication device 20 responds to a “pinging” request made by, or initiated by, the central processing computer 10, the central processing computer 10 can determine or can ascertain the position, location, or geographic location, of the communication device 20, from or using the global positioning device information received by performing any appropriate processing routine(s) in order to determine or ascertain the position, location, or geographic location, of the communication device 20.

In a preferred embodiment, any position, location, or geographic location, information for or associated with the global positioning information can include information regarding the actual global positioning information received, information regarding the Internet Service Provider (ISP) servicing the communication device 20, information regarding the network service provider servicing the communication device 20, information regarding the street address of the communication device 20, information regarding map address, position, or location, for or associated with the IP address, information regarding the latitude or the latitude of the communication device 20, information regarding the longitude or the longitude of the communication device 20, information regarding the locality or municipality, state or province, and/or country or territory, in which the communication device 20 is located, a digitized map or information for providing a digitized map showing the position or location of the communication device 20 on the same, and/or any other information for or associated with the position or location of the communication device 20.

At step 1203, the central processing computer 10 can perform a processing routine, or any number of processing routines, for authenticating the user or individual based on the determined position, location, or geographic location, of the communication device 20 at the time of the transmission of the signal or signals from the communication device 20 to the central processing computer 10. In a preferred embodiment, the central processing computer 10 can compare the determined position, location, or geographic location, of the communication device 20, at the time of the transmission of the signal or signals, from the communication device 20 to the central processing computer 10, to, with, or against, an expected position, location, or geographic location, of or for the user or individual, for that time of transmission, based on information regarding the user's or individual's itinerary or schedule. In a preferred embodiment, the central processing computer 10 can determine the user's or individual's expected position, location, or geographic location, from or using any of the herein-described or other information stored in the database 10H regarding the user's or individual's itinerary or schedule and/or his or her expected position, location, or geographic location, for the day and the time of the transmission.

In a preferred embodiment, the central processing computer 10 can, at step 1203, determine whether or not the determined position, location, or geographic location, of the communication device 20, at the time of the transmission of the signal or signals from the communication device 20 to the central processing computer 10, is the same as, or is within a pre-selected, pre-defined, and/or pre-determined, distance differential, or distance differential factor, of, from, or relative to, or is within a pre-defined distance differential allowance of, from, or relative to, the user's or individual's expected position, location, or geographic location. If, at step 1203, the determined position, location, or geographic location, of the communication device 20, at the time of the transmission of the signal or signals from the communication device 20 to the central processing computer 10, is the same as, or is within a pre-selected, pre-defined, and/or pre-determined, distance differential, or distance differential factor, of, from, or relative to, or is within a pre-defined distance differential allowance of, from, or relative to, the user's or individual's expected position, then the transmission of the signal or signals from the communication device 20, and the user or individual, is/are deemed to be authentic and/or authenticated.

If, however, it is determined that the determined position, location, or geographic location, of the communication device 20, at the time of the transmission of the signal or signals from the communication device 20 to the central processing computer 10, is not the same as, and is not within a pre-selected, pre-defined, and/or pre-determined, distance differential, or distance differential factor, of, from, or relative to, and is not within a pre-defined distance differential allowance of, from, or relative to, the user's or individual's expected position, then the transmission of the signal or signals from the communication device 20, and the user or individual, is/are deemed to be not authentic and/or not authenticated. In a preferred embodiment, the pre-selected, pre-defined, and/or pre-determined, distance differential, or distance differential factor, or pre-defined distance differential allowance, can be chosen or selected and/or can be pre-programmed, or re-programmed at any time, by or for the user or individual or for the credit card account which is sought to be accessed and/or used by the user or individual.

In a preferred embodiment, the pre-selected, pre-defined, and/or pre-determined, distance differential, or distance differential factor, or pre-defined distance differential allowance, is utilized and/or employed in order to, or so as to account for, and/or to provide reconciliation regarding, the fact that differences in distances can and will typically and normally exist, between the determined positions, locations, or geographic locations, and the expected positions, locations, or geographic locations, in most instances of everyday life and in use of the apparatus 100 when the user or individual can or may be using his or her communication device 20 in performing any actions or transactions with, in conjunction with, or in connection with, the apparatus 100 and/or the central processing computer 10. Further, it is understood that such differences, between the determined positions, locations, or geographic locations, and the expected positions, locations, or geographic locations, can be typical in most cases in which the user or individual utilizes the apparatus 100 and methods of the present invention.

As and for an example, a user's or individual's positions, locations, or geographic locations, while within his or her home, place of work, or other place, can and/or will be different as the user or individual moves about inside or within his or her home, place of work, or other place, and/or as the user or individual can or may deviate in his or her position within a vehicle, and/or as the user or individual deviates from or while on a travel route or travel plan or itinerary. In a preferred embodiment, for example, the pre-selected, pre-defined, and/or pre-determined, distance differential, distance differential factor, or pre-defined distance differential allowance, can be defined to be any distance or distances, such as, for example, 100 feet, 250 feet, 1000 feet, or any other pre-selected or pre-defined amount, and such can be changed at any time by programming or by re-programming the same with the central processing computer 10 for or by the user or individual for or regarding an account with the central processing computer 10 and/or apparatus 100 or for or regarding the credit card account of or associated with user or individual.

In a preferred embodiment, artificial intelligence (AI) and/or machine learning techniques and/or routines can also be utilized by the central processing computer 10 in determining or ascertaining expected positions, locations, or geographic locations, and/or in determining and/or in reconciling any differences between determined positions, locations, or geographic locations, and expected positions, locations, or geographic locations, for or regarding the user or individual and/or his or her itinerary or schedule.

At step 1203, if the transmission of the signal or signals from the communication device 20, and the user or individual, is/are deemed by the central processing computer 10 to be not authentic and/or not authenticated, then the central processing computer 10 can, at step 1203, attempt to authenticate the transmission of the signal or signals, and/or the user or individual, by utilizing one or more of a number of alternate authentication routines or means.

In a preferred embodiment, at step 1203, the central processing computer 10 can attempt to authenticate the transmission of the signal or signals from the communication device 20, and/or the user or individual, by requiring that the user or individual correctly answer security questions, the answers for which were previously provided by the user or individual in establishing his or her account with the central processing computer 10 and/or the apparatus 100 and/or in establishing and/or in registering his or her credit card account, with the apparatus 100.

In a preferred embodiment, examples of such security questions can be questions for which the answers to same can be, or can include, a name, an email address, a mother's maiden name, a password, favorite school subject, a make and model of first car, or any other answer to any other subject or question, which can be a response to a security question. At step 1203, the central processing computer 10 can also prompt and/or require the user or individual to record, at the communication device 20 (via a microphone of the video and/or audio recording device 20K), and to transmit to the central processing system 10, a voice sample which can be compared to a previously provided voiceprint for the user or individual which can be stored in the database 10H of the central processing computer 10.

At step 1203, the central processing computer 10 can also prompt the user or individual to provide, and/or require that the user or individual provide, and transmit to the central processing computer 10, any one or more of a retinal scan, a fingerprint, a handprint, or a facial picture, or any other biometric feature or measurement, as obtained and/or as recorded by a respective retinal scanner, fingerprint device, handprint device, camera, or other biometric device, of or associated with the user input device 20D of the communication device 20. In a preferred embodiment, the user input device 20D can include a retinal scanner, a fingerprint scanning or reading device, a handprint scanning or reading device, a camera, or any other biometric measurement or reading device.

At step 1203, the central processing computer 10 can process any information provided by the user or individual in an attempt to authenticate the transmission of the signal or signals and/or the user or individual using any of the herein-described alternative authentication routines. For example, at step 1203, the central processing computer 10 can compare the user's or individual's answers to his or her security questions, or can compare the user's or individual's voice sample to a pre-stored voiceprint of or for the user or individual, or can compare the user's or individual's retinal scan, fingerprint, handprint, or facial picture, or any other biometric feature or measurement, with or against a respective and/or pre-stored retinal scan information, fingerprint information, handprint information, facial recognition information, or biometric feature or measurement information, which can be stored in the database 10H for the user or individual. In a preferred embodiment, the central processing computer 10 and/or the communication device 20 can also be equipped with any software algorithms and/or programs for processing retinal scan information, fingerprint information, handprint information, facial recognition information, or biometric feature or measurement information.

In a preferred embodiment, if the central processing computer 10 can ascertain matches between any one or more of the respective answers, data, or information, provided by the user or individual in the above-described alternate authentication operation, then the central processing computer 10 can and will deem the transmission of the signal or signals from the communication device 20, and the user or individual, as being authentic or authenticated. If, however, the central processing computer 10 does not ascertain any matches between any one or more of the respective answers, data, or information, provided by the user or individual in the above-described alternate authentication operation, then the central processing computer 10 can and will deem the transmission of the signal or signals from the communication device 20, and the user or individual, as being not authentic or not authenticated.

At step 1204, the central processing computer 10 will determine whether or not the transmission of the signal or signals from the communication device 20, and the user or individual, has been authenticated. If at step 1204, the central processing computer 10 determines that the transmission of the signal or signals from the communication device 20, and the user or individual, has been authenticated, then the operation of the apparatus will proceed to step 1205.

At step 1205, the central processing computer 10, having authenticated the transmission of the signal or signals, and the user or individual, will authorize and/or allow the transaction on the credit card account. At step 1205, the central processing computer 10 can generate a transaction authorized message which can include information indicating that the transaction is authorized and/or transaction authorization information and/or any other information needed or desired for informing the merchant or the counterparty that the transaction has been, and is, authorized. At step 1205, the central processing computer 10 can transmit the transaction authorized message to the counterparty communication device 40 of, associated with, or used by, the merchant or the counterparty involved in the transaction with the user or individual. Thereafter, payment may be made to the merchant or the counterparty in or by any accepted or acceptable method or manner. At step 1205, the central processing computer 10 can also transmit the transaction authorized message to the communication device 20 and/or to any other communication device(s) 20 of, associated with, or used by, the user or individual.

At step 1205, the central processing computer 10 can also generate an authentication alert message which can contain information regarding the user's or individual's authenticated use of his or her credit card account, and/or information regarding the date and time of the transaction, or attempted transaction, transaction amount, information regarding the merchant or the counterparty, and/or any other information regarding the transaction. In a preferred embodiment, the authentication alert message can also contain or include any of the herein-described position, location, or geographic location, IP address information, global positioning information, “pinging” information, and/or any other information described herein as being received, processed, utilized, and/or generated, by the central processing computer 10 at steps 1201, 1202, and 1203, in performing the herein-described location-based authentication and/or in performing any of the herein-described alternative authentication processing operations or routines described as being performed at step 1203.

In this regard, it is to be understood, that any data and/or information described as being received, processed, utilized, and/or generated, by the central processing computer 10 at steps 1201, 1202, and 1203, can be included in the authentication alert message. In a preferred embodiment, the authentication alert message can also contain date-stamped and/or time-stamped data and/or information regarding any performance of, or any attempt to perform, the transaction on the user's or individual's credit card account.

Thereafter, at step 1205, the central processing computer 10 can transmit the authentication alert message to the communication device 20, or to any number of communication devices 20 of, associated with, or used by, the user or individual. In a preferred embodiment, the authentication alert message can be transmitted as, in, or as an attachment to, an email message, an SMS message, an instant message, a text message, an electronic transmission of any kind or type, a pre-recorded telephone call, or any other electronic communication. Thereafter, the central processing computer 10 can store any and/or all of the data and/or information described herein as being provided by the user or individual and/or any information regarding any action or transaction performed by, and/or with, the user or individual in any of steps 1201 through 1203, and/or any and/or all data and/or information regarding any of the herein-described processing operations or routines performed by the central processing computer 10 at steps 1201 through 1205, and/or the authentication alert message, in the database 10H.

In another preferred embodiment, at step 1205, prior to authorizing or allowing the transaction, the central processing computer 10 can also determine whether or not the determined and authenticated position, location, or geographic location, is located within the geographic limits of a jurisdiction, state, province, region, or country, so as to ensure and/or document that the transaction is being legally performed within the respective jurisdiction, state, province, region, or country. In a preferred embodiment, in a situation in which the transaction is determined to have been performed within the respective jurisdiction, state, province, region, or country, the central processing computer 10 can allow the transaction. In a preferred embodiment, in a situation in which the transaction is determined to have not been performed within the respective jurisdiction, state, province, region, or country, the central processing computer 10 can disallow the transaction.

If, at step 1204, the central processing computer 10 determines that the transmission of the signal or signals, from the communication device 20, and the user or individual, has not been authenticated, then the operation of the apparatus 100 will proceed to step 1206.

At step 1206, the central processing computer 10, having not authenticated the transmission of the signal or signals, and the user or individual, will reject the transaction authorization request, and the transaction, and will deny, disallow, or prevent, the user or individual from performing the transaction with the merchant or the counterparty.

At step 1206, the central processing computer 10 can also generate a failed authentication alert message which can contain information regarding the user's or individual's attempted transaction on, with, or involving, the credit card account. In the preferred embodiment, the failed authentication alert message can contain information regarding the attempted use of the user's or individual's credit card account, and/or information regarding the date and time of the attempted transaction, transaction amount, information regarding the merchant or the counterparty, and/or any other information regarding the transaction.

In a preferred embodiment, the failed authentication alert message can also contain or include any of the herein-described position, location, or geographic location, IP address information, global positioning information, “pinging” information, and/or any other of the information described herein as being received, processed, utilized, and/or generated, by the central processing computer 10 at steps 1201, 1202, and 1203 in performing the herein-described location-based authentication and/or in performing any of the herein-described alternative authentication processing operations or routines described as being performed at step 1203.

In this regard, it is to be understood, that any data and/or information described as being received, processed, utilized, and/or generated, by the central processing computer 10 at steps 1201, 1202, and 1203, can be included in the failed authentication alert message. In a preferred embodiment, the failed authentication alert message can also contain date-stamped and/or time-stamped data and/or information regarding the attempt to use the user's or individual's credit card account in the transaction.

Thereafter, at step 1206, the central processing computer 10 can transmit the failed authentication alert message to the communication device 20, or to any number of communication devices 20 of, associated with, or used by, the user or individual. In a preferred embodiment, the failed authentication alert message can be transmitted as, in, or as an attachment to, an email message, an SMS message, an instant message, a text message, an electronic transmission of any type or kind, a pre-recorded telephone call, or any other electronic communication. Thereafter, the central processing computer 10 can store any and/or all of the data and/or information described herein as being provided by user or individual, and/or any information regarding the attempted transaction, in any of steps 1201 through 1203, and/or any and/or all data and/or information regarding any of the herein-described processing operations or routines performed by the central processing computer 10 at steps 1201 through 1204 and 1206, and/or the failed authentication alert message, in the database 10H. Thereafter, the operation of the apparatus 100 will cease at step 1207.

In another preferred embodiment, of the embodiment of FIG. 12, the video and/or audio recording device 20K, of the communication device 20, can record a video recording or a video clip and/or an audio recording or an audio clip of the user or individual during any portion, or during the entire portion, of the transaction, or attempted transaction, with the merchant or the counterparty. In a preferred embodiment, the respective video recording or video clip and/or audio recording or audio clip can be attached to the transaction authorized message, the authentication alert message, or the failed authentication alert message, can be stored in an account transaction statement or profile for the user or individual, and/or for the user's or individual's credit card account, in the database 10H along with any other data and/or information, stored in the database 10H, regarding the user's or individual's use or attempted use of the credit card account in the embodiment of FIG. 12.

In another preferred embodiment, the apparatus 100 of the present invention can also be utilized in a same, a similar, and/or an analogous, manner, as described in the preferred embodiment of FIG. 12, in order to authenticate any merchant or counterparty involved in any transaction with any user or individual. In this regard, the apparatus 100 of the present invention can perform the herein-described position-based authentication or location-based authentication methods and/or routines, as described herein in the embodiment of FIG. 12, for or regarding a counterparty communication device 40 of, associated with, or used by, any merchant or counterparty who or which is involved in any transaction with the user or individual and which involves any account. In a preferred embodiment, therefore, the apparatus 100 can perform the herein-described position-based authentication or location-based authentication methods and/or routines for or regarding the merchant or counterparty by determining the position, location, and/or geographic location, of and for the merchant's or counterparty's counterparty communication device 40 and by comparing the same against an expected position, location, or geographic location, for the merchant or counterparty, based on the merchant's or counterparty's itinerary or schedule.

As noted above, the preferred embodiment method of the embodiment of FIG. 12 can also be utilized with each of the apparatus 200, the apparatus 300, and/or the apparatus 400 in a same, a similar, and/or in an analogous, manner. As also noted above, the preferred embodiment method of the embodiment of FIG. 12 can also be utilized in a same, similar, or an analogous, manner, in connection with transactions on, with, or involving, credit accounts, charge card accounts, charge accounts, debit card accounts, or debit accounts, bank accounts, checking accounts, or savings accounts, cryptocurrencies, cryptocurrency accounts, gambling accounts, gaming accounts, sports betting accounts, lottery gaming accounts, lottery accounts, brokerage accounts, pension accounts, individual retirement accounts (IRAs), or self-employed pension (SEP) accounts, “smart” card accounts, currency card accounts, healthcare accounts, Medicare accounts, Medicaid accounts, employee benefits accounts, cafeteria accounts, or spending accounts, subscription accounts for any goods, products, or services, or insurance accounts, healthcare insurance accounts, healthcare spending accounts, life insurance accounts, or disability insurance accounts, or tuition accounts, pharmacy accounts, credit report accounts, cable television accounts, digital television accounts, or satellite television accounts, social security accounts, liability insurance accounts, or lease insurance accounts, ticket accounts, telephone calling card accounts, utility accounts, electrical utility accounts, gas utility accounts, or fuel oil utility accounts, accounts monitoring use of official seals, accounts monitoring use of private, individual, and/or organizational, seals or access codes, security access accounts, computer access code accounts, facility access accounts, or facility security accounts, financial accounts, electronic money accounts, or electronic cash accounts, communication accounts, telephone accounts, wireless communication device accounts, non-wireless communication device accounts, cellular communication device accounts, cellular telephone accounts, Internet accounts, or Internet service provider accounts, electronic signature accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, or health club membership accounts, merchant credit accounts for customers, merchant accounts, association membership accounts, professional association membership accounts, or trade association membership accounts, text messaging accounts, a customer loyalty accounts, social network membership accounts, or any other accounts, as well as any cards, devices, and/or other entities, which can be used with or which can be associated with any of the herein-described accounts.

In a preferred embodiment, each of the central processing computer/distributed ledger/Blockchain technology system 12, the distributed ledger and Blockchain technology system 13, and the distributed ledger and Blockchain technology system 14, can contain or include, and/or can be equipped with, any and/or all necessary hardware and/or software needed for performing any and/or all of the processing routines, functions, and/or functionalities, described herein as being performed by the central processing computer 10, the apparatus 100, the apparatus 200, the apparatus 300, and/or the apparatus 400.

In another preferred embodiment, any communication device(s) 20 associated with an account holder can be de-activated by the account holder, or by any other authorized user or individual, via the central processing computer 10 and/or by the central processing computer/distributed ledger/Blockchain technology system 12. The account holder, or other authorized user or individual, can access any central processing computer 10 and/or the central processing computer/distributed ledger/Blockchain technology system 12 with which the lost, stolen, misplaced, or defective, communication device 20 is registered, or which central processing computer 10 and/or which central processing computer/distributed ledger/Blockchain technology system 12 services an account which is also serviced with or by the lost, stolen, misplaced, or defective, communication device 20. The account holder can access the central processing computer 10 and/or the central processing computer/distributed ledger/Blockchain technology system 12 with any other authorized communication device 20 and can transmit a signal, data, information, or a message, which included information regarding an instruction to de-activate the lost, stolen, misplaced, or defective, communication device 20.

In another preferred embodiment, any counterparty communication device(s) 40 associated with a counterparty can be de-activated by the counterparty, or by an agent or employee, or other authorized user or individual, of or associated with the counterparty via the central processing computer 10 and/or the central processing computer/distributed ledger/Blockchain technology system 12. The counterparty, or an agent or employee, or other authorized user or individual, of or associated with the counterparty, can access any central processing computer 10 and/or the central processing computer/distributed ledger/Blockchain technology system 12 with which the lost, stolen, misplaced, or defective counterparty communication device 40 is registered, or which central processing computer 10 or which central processing computer/distributed ledger/Blockchain technology system 12 services an account which is also serviced with or by the lost, stolen, misplaced, or defective, counterparty communication device 40. The counterparty, or an agent or employee, or other authorized user or individual, of or associated with the counterparty, can access the central processing computer 10 and/or the central processing computer/distributed ledger/Blockchain technology system 12 with any other authorized counterparty communication device 40 and can transmit a signal, data, information, or a message, which includes information regarding an instruction to de-activate the lost, stolen, misplaced, or defective, counterparty communication device 40.

The apparatus and methods of the present invention can be utilized to perform a transaction on and/or involving any of the herein-described and/or herein-identified accounts. The apparatus and methods of the present invention can allow an account holder to select to perform or engage in a transaction by using a single account, or by using multiple accounts. The apparatus and methods of the present invention can also allow an account holder to select to the transaction processing type for processing a transaction or for certain portions of a transaction.

The apparatus and methods of the present invention can also utilize position or location information regarding the position or location of a communication device 20 and/or a merchant's counterparty communication device 40 is processing a transaction and/or for determining if the transaction is authorized or allowed or unauthorized or not allowed. The apparatus and methods of the present invention also provides a system for providing multifactor authentication in and for transactions by providing a video recording, video information, or a video clip, a picture or a photograph, or an audio recording or an audio clip, of individuals or parties involved in a transaction. The apparatus and methods of the present invention also provides a system for providing multifactor authentication in and for transactions by providing for the processing of transactions which involve multiple accounts or multiple types or kinds of accounts, cryptocurrencies, and/or crypto currency accounts.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A transaction security apparatus, comprising:
a database, wherein the database stores information regarding an account, information regarding a user associated with the account, and information regarding a travel itinerary or schedule of the user;
a receiver, wherein the receiver receives information regarding a transaction on or involving the account, wherein the information regarding the transaction on or involving the account is transmitted from a communication device associated with the user, wherein the information regarding the transaction on or involving the account includes information regarding the transaction, information regarding the account used in the transaction, and information regarding a position or location of the communication device at a time of a transmission of the information regarding the transaction on or involving the account; and
a processor, wherein the processor processes information regarding the transaction, and further wherein the processor determines a position, location, or geographic location, of the communication device at the time of the transmission of the information regarding the transaction on or involving the account, and further wherein the processor processes information for authenticating the user by processing information for comparing the position, location, or geographic location, of the communication device with or against an expected position, location, or geographic location, of the user, based on the itinerary or schedule of the user, and further wherein, if the processor determines that the user is authenticated, the processor processes information for allowing the transaction.

2. The apparatus of claim 1, wherein the account is a credit card account or a credit account.

3. The apparatus of claim 1, wherein the account is a debit card account or a debit account.

4. The apparatus of claim 1, wherein the account is a sports betting account.

5. The apparatus of claim 1, wherein the account is a gaming account, a gambling account, an on-line gaming account, an on-line gambling account, an Internet gaming account, or an Internet gambling account.

6. The apparatus of claim 1, wherein the communication device is a personal computer, a laptop computer, or a notebook computer.

7. The apparatus of claim 1, wherein the communication device is a cellular telephone, a smart phone, a Smartphone, a personal digital assistant, or a mobile telephone.

8. The apparatus of claim 1, wherein the communication device is a tablet computer or a tablet.

9. The apparatus of claim 1, wherein the communication device is an interactive television.

10. A transaction security apparatus, comprising:
a database, wherein the database stores information regarding an account, information regarding a user associated with the account, and information regarding a travel itinerary or schedule of the user;
a receiver, wherein the receiver receives information regarding a transaction on or involving the account, wherein the information regarding the transaction on or involving the account is transmitted from a communication device associated with the user, wherein the communication device comprises a global positioning device, wherein the information regarding the transaction on or involving the account includes information regarding the transaction, information regarding the account used in the transaction, and information regarding a position or location of the communication device, as determined or obtained by the global positioning device at a time of a transmission of the information regarding the transaction on or involving the account; and
a processor, wherein the processor processes information regarding the transaction, and further wherein the processor determines a position, location, or geographic location, of the communication device, at the time of the transmission of the information regarding the transaction on or involving the account, by using the position or location information determined or obtained by the global positioning device, and further wherein the processor processes information for authenticating the user by processing information for comparing the position, location, or geographic location, of the communication device with or against an expected position, location, or geographic location, of the user, based on the itinerary or schedule of the user, and further wherein, if the processor determines that the user is authenticated, the processor processes information for allowing the transaction.
